(19) United States
(12) Patent Application Publication
(10) Pub. No.: US 2026/0347095 A1
(43) Pub. Date: Nov. 5, 2026

(54) REFUSE COLLECTION SYSTEM

(71) Applicant: Oshkosh Corporation, Oshkosh, WI (US)

(72) Inventors: Bryan Fenster, Oshkosh, WI (US); Lee Dreas, Oshkosh, WI (US); John Bonczyk, Oshkosh, WI (US); Brian Brost, Oshkosh, WI (US); Jon Honig, Oshkosh, WI (US)

(73) Assignee: Oshkosh Corporation, Oshkosh, WI (US)

(21) Appl. No.: 19/666,111

(22) Filed: May 1, 2026

Related U.S. Application Data
(60) Provisional application No. 63/799,636, filed on May 4, 2025.
(60) Provisional application No. 63/799,686, filed on May 4, 2025.
(60) Provisional application No. 63/799,634, filed on May 4, 2025.
(60) Provisional application No. 63/799,633, filed on May 4, 2025.
(60) Provisional application No. 63/799,681, filed on May 4, 2025.
(60) Provisional application No. 63/799,635, filed on May 4, 2025.
(60) Provisional application No. 63/799,623, filed on May 4, 2025.
(60) Provisional application No. 63/799,626, filed on May 4, 2025.
(60) Provisional application No. 63/897,339, filed on Oct. 10, 2025.
(60) Provisional application No. 63/896,892, filed on Oct. 10, 2025.
(60) Provisional application No. 63/896,906, filed on Oct. 10, 2025.
(60) Provisional application No. 63/896,943, filed on Oct. 10, 2025.
(60) Provisional application No. 63/896,937, filed on Oct. 10, 2025.
(60) Provisional application No. 63/896,952, filed on Oct. 10, 2025.
(60) Provisional application No. 63/897,365, filed on Oct. 10, 2025.
(60) Provisional application No. 63/896,979, filed on Oct. 10, 2025.

(51) Int. Cl. B65F 3/02; G05D 1/43; G05D 1/656; G05D 105/00; G05D 109/10

(52) U.S. Cl. CPC B65F 3/02; G05D 1/43; G05D 1/656; B65F 2003/0216; B65F 2003/025; B65F 2210/138; G05D 2105/14; G05D 2109/10

(57) ABSTRACT

Systems and methods of refuse collection scheduling for a plurality of refuse collection drones. The method includes receiving activity data and location data from sensors within a venue; determining an activity level of multiple areas within a venue based on the activity data and the location data; and adjusting a refuse collection schedule associated with refuse collection by a plurality of refuse collection drones based on the activity level.

### CROSS-REFERENCE TO RELATED PATENT APPLICATIONS

This application claims the benefit of and priority to U.S. Provisional Application No. 63/799,636, filed May 4, 2025, U.S. Provisional Application No. 63/799,634, filed May 4, 2025, U.S. Provisional Application No. 63/799,623, filed May 4, 2025, U.S. Provisional Application No. 63/799,626, filed May 4, 2025, U.S. Provisional Application No. 63/799,681, filed May 4, 2025, U.S. Provisional Application No. 63/799,686, filed May 4, 2025, U.S. Provisional Application No. 63/799,633, filed May 4, 2025, U.S. Provisional Application No. 63/799,635, filed May 4, 2025, U.S. Provisional Application No. 63/896,906, filed Oct. 10, 2025, U.S. Provisional Application No. 63/896,937, filed Oct. 10, 2025, U.S. Provisional Application No. 63/896,979, filed Oct. 10, 2025, U.S. Provisional Application No. 63/896,892, filed Oct. 10, 2025, U.S. Provisional Application No. 63/897,339, filed Oct. 10, 2025, U.S. Provisional Application No. 63/897,365, filed Oct. 10, 2025, U.S. Provisional Application No. 63/896,943, filed Oct. 10, 2025, U.S. Provisional Application No. 63/896,952, filed Oct. 10, 2025, the entire contents of each of which are hereby incorporated by reference herein.

### BACKGROUND

The present disclosure relates generally to the collection of refuse, such as recyclable or non-recyclable waste, garbage, trash, organics, etc. More specifically, the present disclosure relates to systems that collect refuse from a customer and transport the refuse to a disposal site, such as a landfill, recycling center, composting facility, or organics processing facility.

Traditionally, refuse is collected from a pickup site associated with a customer by a refuse vehicle. These refuse vehicles are manually operated, requiring the presence of a driver throughout operation. The refuse vehicle operates according to a predetermined schedule, providing limited flexibility to the customer to have their refuse collected outside of the schedule.

### SUMMARY

At least one embodiment relates to a refuse collection system. The refuse collection system may include a refuse container and a refuse collection drone. The refuse container defines a storage volume configured to receive refuse and includes a controller and an actuator. The refuse collection drone is configured to collect the refuse from the refuse container. The controller is configured to determine that an amount of the refuse within the storage volume exceeds a threshold amount. The controller is further configured to transmit a collection request in response to determining that the amount of the refuse exceeds the threshold amount. The controller is further configured to detect that the refuse collection drone is positioned to receive the refuse from the refuse container. The controller is further configured to actuate the actuator to release at least a portion of the refuse from the storage volume into the refuse collection drone.

Another embodiment relates to a method of collecting refuse using a refuse collection drone. The method may include navigating to a refuse container positioned along a route traveled by the refuse collection drone. The method may further include requesting refuse information from the refuse container, the refuse information indicating at least one of an amount of refuse within the refuse container or a type of refuse within the refuse container. The method may further include determining that the refuse collection drone is suitable to collect the refuse within the refuse container based on the refuse information. The method may further include collecting the refuse from the refuse container in response to determining that the refuse collection drone is suitable to collect the refuse within the refuse container.

Another embodiment relates to a refuse container. The refuse container may include a body, a door, a locking mechanism, an identification device, and a controller. The body defines a storage volume configured to receive refuse. The door is configured to selectively restrict access to the storage volume. The locking mechanism is configured to selectively lock the door. The identification device is configured to read an identifier associated with a customer. The controller is configured to receive the identifier from the identification device. The controller is further configured to compare the identifier to identification numbers associated with authorized customers. The controller is further configured to actuate the locking mechanism to unlock the door in response to determining that the identifier is associated with one of the authorized customers, to permit a customer associated with the identifier to deposit refuse into the storage volume.

Another embodiment relates to a refuse collection system. The refuse collection system includes a refuse container, a refuse collection drone, and a controller. The refuse container defines a storage volume in which refuse may be placed by a customer. The refuse collection drone is configured to retrieve refuse from the refuse container and deposit refuse in a refuse depot. The controller is configured to perform operations including determining if the storage volume requires emptying, requesting collection of the refuse within the storage volume, detecting a presence of the refuse collection drone positioned to collect the refuse within the storage volume, and releasing the refuse within the storage volume.

In some embodiments, the refuse container is configured to receive the refuse collection drone in a lower portion of the refuse container and releasing the refuse within the storage volume includes actuating a retention mechanism of the refuse container to allow the refuse within the storage volume to descend into the refuse collection drone. In some embodiments, the refuse container includes a user input device, and determining if the storage volume requires emptying includes receiving an input from the user input device indicating the storage volume is full. In some embodiments, the refuse container comprises a releasable portion, the releasable portion defining the storage volume. In some such embodiments, the refuse collection drone is configured to engage and transport the releasable portion. In some such embodiments, releasing the refuse within the storage volume includes actuating one or more mechanism to release the releasable portion of the refuse container. In some such embodiments, the controller is further configured to receive a second releasable portion.

Another embodiment relates to a refuse collection system. The refuse collection system may include a refuse collection drone. The refuse collection drone may include a chassis, one or more tractive elements, a refuse container, a location sensor, and a controller. The one or more tractive elements are supported by the chassis and configured to facilitate transport of the refuse collection drone. The refuse container is coupled to the chassis and defines a storage volume configured to receive refuse therein. The location sensor is configured to provide drone location information indicative of a present location of the refuse collection drone. The controller is configured to receive, from a remote device, a request to perform a refuse collection operation at a customer location. The controller is further configured to cause the refuse collection drone to travel to the customer location to perform the refuse collection operation in response to receiving the request. The controller is further configured to transmit, to the remote device, an indication that the refuse collection drone is enroute to perform the refuse collection operation. The controller is further configured to obtain the drone location information from the location sensor while the refuse collection drone travels to the customer location. The controller is further configured to transmit, to the remote device, the drone location information.

Another embodiment relates to a refuse collection system. The refuse collection system may include a refuse collection drone and a refuse depot. The refuse collection drone may include a chassis, one or more tractive elements, and a removable insert. The one or more tractive elements are supported by the chassis and configured to facilitate transport of the refuse collection drone. The removable insert is supported by the chassis and defines a drone storage volume configured to receive refuse therein. The refuse depot may include a container and a lift assembly. The container defines a depot storage volume. The lift assembly is configured to selectively engage the removable insert, lift the removable insert from the chassis, and invert the removable insert to empty refuse from the drone storage volume into the depot storage volume.

Another embodiment relates to a refuse collection drone. The refuse collection drone may include a chassis, one or more tractive elements, a refuse container, one or more sensors, and a controller. The one or more tractive elements are supported by the chassis and configured to facilitate transport of the refuse collection drone. The refuse container is coupled to the chassis and defines multiple compartments, each designated for a different type of refuse. The one or more sensors are positioned to obtain data related to refuse deposited in the multiple compartments. The controller is configured to determine, based on the data, an amount of refuse deposited into the multiple compartments during a refuse collection operation and a type of refuse deposited into the multiple compartments during the refuse collection operation.

Another embodiment relates to a refuse collection system. The refuse collection system includes a refuse depot, a refuse collection drone, and a user device. The refuse collection drone is configured to retrieve refuse from a customer and deposit refuse in the refuse depot. The user device is configured to transmit a request for a refuse collection drone to perform a refuse collection operation, receive an indication that the refuse collection drone is enroute to perform the refuse collection operation, receive location information indicative of a present location of the refuse collection drone, and display the location information.

In some embodiments, the refuse collection drone comprises a removable insert, the removable insert defining a first storage volume to store refuse during a refuse collection operation. In some such embodiments, the refuse depot includes a container defining a second storage volume and a lift assembly actuatable to engage the removable insert and to invert the removable insert so that refuse disposed within the first storage volume defined by the removable insert is emptied into the second storage volume defined by the container. In some such embodiments, the lift assembly is further configured to replace the removable insert into the refuse collection drone when the refuse disposed within the first storage volume has been emptied into the second storage volume defined by the container.

Another embodiment relates to a refuse container repositioning and collection system. The refuse container repositioning and collection system includes a refuse vehicle and a refuse container repositioning system. The refuse vehicle includes a lift system. The refuse container repositioning system is configured to deploy based on a refuse collection schedule. The refuse container repositioning system includes a drive system, a container engagement apparatus configured to engage the refuse container, and a control system configured to control the drive system and the container engagement apparatus to retrieve the refuse container and bring the refuse container to a location where the refuse container is accessible by the lift system.

Another embodiment relates to a method for repositioning and collecting refuse from a refuse container. The method includes determining a collection location by identifying a refuse container for refuse to be collected therefrom by a refuse vehicle, determining a staging location for the refuse container, with the refuse container accessible via a lift system of the refuse vehicle when positioned at the staging location, driving a refuse container repositioning system to the refuse container at the collection location, engaging the refuse container via a container engagement apparatus of the refuse container repositioning system, and moving the refuse container from the collection location to the staging location.

Another embodiment relates to a refuse vehicle including a lift system configured to engage a refuse container and deposit refuse material from the refuse container into a refuse compartment defined in a body of the refuse vehicle. The refuse vehicle includes a refuse container repositioning system deployable from the refuse vehicle. The refuse container repositioning system including a drive system, a container engagement apparatus to engage the refuse container, and a control system to control the drive system and the container engagement apparatus. The control system is configured to operate the drive system to drive the refuse container repositioning system from the refuse vehicle to a collection location of the refuse container, and operate the container engagement apparatus to engage the refuse container, and operate the drive system to drive the refuse container repositioning system to move the refuse container to a staging location, where the refuse container is accessible by the lift system of the refuse vehicle at the staging location.

Another embodiment relates to a refuse container system including a refuse container and a refuse container repositioning system configured to support or be integrated into the refuse container. The refuse container repositioning system includes a drive system, and a control system configured to control the drive system to bring the refuse container from a collection location to a staging location where the refuse container is accessible by a lift system of a refuse vehicle, based on a refuse collection schedule for the refuse container.

Another embodiment relates to a method for repositioning and collecting refuse from a refuse container. The method includes determining a staging location for the refuse container, with the refuse container accessible via a lift system of a refuse vehicle when positioned at the staging location. The method includes driving a refuse container via a refuse container repositing system from a collection location to the staging location, based on a refuse collection schedule for the refuse container.

Another embodiment relates to a control system including one or more processing circuits including one or more memory devices coupled to one or more processors, with the one or more memory devices configured to store instructions thereon that, when executed by the one or more processors, cause the one or more processors to determine a staging location for a refuse container at a customer location, the refuse container accessible via a lift system of a refuse vehicle when positioned at the staging location, and drive a refuse container via a drive system of a refuse container repositing system that is coupled to the refuse container from a collection location to the staging location, based on a refuse collection schedule for the refuse container.

Another embodiment of the present disclosure relates to a refuse collection system including: a refuse collection vehicle; a refuse container defining a storage volume; a fill sensor configured to detect a fill status of the storage volume; and a controller in communication with the fill sensor, the controller being configured to: determine if a fill status indicates that the storage volume is full; and in response to determining that the storage volume is full, provide an indication to the refuse collection vehicle that the storage volume is full.

Another embodiment of the present disclosure relates to a refuse collection system including: a refuse container defining a storage volume; a fill sensor configured to detect a fill status of the storage volume; and a controller in communication with the fill sensor, the controller being configured to: determine if a fill status indicates that the storage volume is full; and in response to determining that the storage volume is full, instruct one or more electric motors to navigate the refuse container from a home position to a pickup position.

Another embodiment of the present disclosure relates to a refuse collection system including: a refuse collection vehicle; a refuse container defining a storage volume; an odor sensor configured to detect an odor status of refuse in the storage volume; and a controller in communication with the odor sensor, the controller being configured to: determine if an odor status indicates that an odor level exceeds an odor level threshold; and in response to determining that the odor level exceeds an odor level threshold, provide an indication to the refuse collection vehicle that the odor level exceeds the odor level threshold.

Another embodiment of the present disclosure relates to a refuse collection system including: a refuse container defining a storage volume; an odor sensor configured to detect an odor status of refuse in the storage volume; and a controller in communication with the odor sensor, the controller being configured to: determine if an odor status indicates that the odor level exceeds an odor level threshold; and in response to determining that the odor level exceeds the odor level threshold, instruct one or more electric motors to navigate the refuse container from a home position to a pickup position.

Another embodiment relates to a method of refuse collection scheduling for a plurality of refuse collection drones. The method includes receiving activity data and location data from sensors within a venue; determining an activity level of multiple areas within a venue based on the activity data and the location data; and adjusting a refuse collection schedule associated with refuse collection by a plurality of refuse collection drones based on the activity level.

Another embodiment relates to a refuse collection system including: a plurality of refuse collection drones; a plurality of refuse containers disposed within a venue; and a venue control system including processing circuitry configured to: receive activity data and location data indicative of attendee activity across multiple areas of the venue; determine an activity level for the multiple areas based on the activity data and the location data; and determine or adjust a refuse collection schedule for the plurality of refuse collection drones based on the activity level.

Another embodiment relates to a refuse collection drone including: an environmental sensor configured to generate sensor data indicative of activity proximate to the refuse collection drone; a location sensor configured to generate location data indicative of a location of the refuse collection drone within a venue; and a communications interface configured to be communicably coupled to a venue control system, the communications interface configured to transmit the sensor data and the location data to a venue control system, and receive a refuse collection schedule based on the sensor data and the location data.

One aspect of the present disclosure relates to a refuse collection system including a building including a plurality of zones connected by one or more access points, where the one or more access points selectively separate the plurality of zones, and a refuse collection drone configured to travel throughout the building. The refuse collection drone includes one or more sensors, and a controller communicably coupled to one or more sensors. The controller is configured to drive the refuse collection drone throughout the building between the plurality of zones, based on the sensor data from the one or more sensors, transmit a signal to an access point within the building, the access point separating a first zone of the building from a second zone of the building, where the signal is configured to cause the access point to actuate, and navigate the refuse collection drone from the first zone to the second zone via the access point to collect refuse within the second zone of the building.

Another aspect relates to a refuse collection system including a building including a plurality of refuse containers configured to store multiple types of refuse, and a refuse collection drone configured to travel throughout the building. The refuse collection drone including a storage volume, one or more sensors configured to provide sensor data indicative of (i) the building and (ii) a type of refuse within the storage volume of the refuse collection drone, and a controller communicably coupled to one or more sensors. The controller is configured to determine, based on the sensor data from the one or more sensors, a type of refuse collected by the refuse collection drone; communicate with the plurality of refuse containers to determine a refuse container of the plurality of refuse containers configured to receive the type of refuse collected by the refuse collection drone; navigate the refuse collection drone throughout the building and to the refuse container of the plurality of refuse containers; and cause the refuse collection drone to deposit the refuse from the storage volume into the refuse container configured to receive the type of refuse collected by the refuse collection drone.

Another embodiment relates to a refuse collection system including a building including a plurality of zones connected by one or more access points, and a plurality of units located within the plurality of zones, with the one or more access points selectively separating the plurality of zones. The refuse collection system includes a refuse collection drone configured to travel throughout the building along a refuse collection route between the plurality of units to collect refuse from pickup zones corresponding to the plurality of units. The refuse collection drone is configured to drive throughout the building between the plurality of zones and through the one or more access points along the refuse collection route, collect refuse from pickup zones corresponding to the plurality of units along the refuse collection route, drive the refuse collection drone throughout the building and to a refuse container within the building, and deposit refuse into the refuse container.

Another embodiment relates to a refuse collection drone including a drive system configured to move the refuse collection drone throughout a building and through one or more access points along a refuse collection route between a plurality of units to collect refuse from pickup zones corresponding to the plurality of units, one or more sensors, and a controller communicably coupled to one or more sensors. The controller is configured tonavigate the refuse collection drone throughout the building based on sensor data from the one or more sensors between the plurality of zones and through the one or more access points along the refuse collection route, collect refuse from pickup zones corresponding to the plurality of units along the refuse collection route, navigate the refuse collection drone throughout the building and to a refuse container within the building, and deposit refuse into the refuse container.

Another embodiment relates to a multi-function drone including a chassis, a propulsion system comprising one or more wheels and a drive motor to propel the one or more wheels, a battery to power the propulsion system, a first storage volume and a second storage volume, and two receptacles removably positioned within the first storage volume and the second storage volume. The two receptacles comprising at least two of: a first receptacle configured to store a first type of refuse material, a second receptacle configured to store a second type of refuse material, and a secured container configured to store an item for delivery to a customer. The drone further includes a controller configured to receive a refuse collection request from the customer, receive a delivery request from the customer or second customer, and drive the drone to collect refuse in at least one of the first receptacle and the second receptacle from the customer, based on the refuse collection request.

Another embodiment relates to a method for servicing a building via a multi-function drone. The method includes receiving a refuse collection request from a customer, navigating the multi-function drone to a pick up zone corresponding to the customer for refuse collection, collecting refuse from the customer into a first storage volume of the multi-function drone, receiving a delivery request from the customer or a second customer, where the delivery request is to deliver a package stored in a second storage volume of the multi-function drone, and navigating the multi-function drone based on the delivery request.

Another embodiment relates to a method for servicing a building via a multi-function drone. The method includes navigating the multi-function drone to a pick up zone corresponding to a customer for refuse collection, collecting a first type of refuse into a first receptacle of the multi-function drone, collecting a second type of refuse into a second receptacle of the multi-function drone, and navigating the multi-function drone to a refuse depot to deposit refuse into one or more refuse containers positioned at the refuse depot, where the one or more refuse containers correspond to one or more types of refuse received by the multi-function drone.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a refuse collection system, according to an exemplary embodiment.

FIG. 2A is a plan view of an implementation of the refuse collection system of FIG. 1 within a residential neighborhood.

FIG. 2B is a plan view of an implementation of the refuse collection system of FIG. 1 within a building.

FIG. 3 is a block diagram of a method for collecting refuse to be performed by the refuse collection system of FIG. 1.

FIG. 4 is a block diagram of a refuse collection drone of the refuse collection system of FIG. 1, according to an exemplary embodiment.

FIG. 5 is a perspective view of the refuse collection drone of FIG. 4, according to an exemplary embodiment.

FIG. 6 is a perspective view of the refuse collection drone of FIG. 4, according to an alternative embodiment.

FIG. 7 is a perspective view of the refuse collection drone of FIG. 4, according to an alternative embodiment.

FIG. 8 is a block diagram of a refuse depot of the refuse collection system of FIG. 1, according to an exemplary embodiment.

FIG. 9 is a plan view of the refuse depot of FIG. 8, according to an exemplary embodiment.

FIG. 10 is a front view of the refuse depot of FIG. 9 with a gate in an open position.

FIG. 11 is a front view of the refuse depot of FIG. 9 with the gate in a closed position.

FIG. 12 is a perspective view of the refuse depot of FIG. 8, according to an alternative embodiment.

FIG. 13A is a perspective view of a refuse vehicle of the refuse collection system of FIG. 1, according to an exemplary embodiment.

FIG. 13B is a side view of a refuse vehicle of the refuse collection system of FIG. 1, according to another exemplary embodiment.

FIG. 14 is a block diagram of a user device of the refuse collection system of FIG. 1, according to an exemplary embodiment.

FIG. 15 is a block diagram of a service manager of the refuse collection system of FIG. 1, according to an exemplary embodiment.

FIG. 16 is a plan view of an implementation of the refuse collection system of FIG. 1 within a residential neighborhood, according to an alternative embodiment.

FIG. 17-19 are perspective views of the refuse collection drone of FIG. 4, according to various alternative embodiments.

FIG. 20 is a block diagram of a refuse collection system, according to an exemplary embodiment.

FIG. 21 is a block diagram of a refuse container of the refuse collection system of FIG. 20, according to an exemplary embodiment.

FIG. 22 is a block diagram of a method for collecting refuse to be performed by the refuse collection system of FIG. 20, according to an exemplary embodiment.

FIG. 23 is a block diagram of another method for collecting refuse to be performed by the refuse collection system of FIG. 20, according to an exemplary embodiment.

FIG. 24 is a perspective view of the refuse collection drone of FIG. 4 approaching the refuse container of FIG. 21, according to an exemplary embodiment.

FIG. 25 is a perspective view of the refuse collection drone of FIG. 4 collecting refuse from the refuse container of FIG. 21, according to an exemplary embodiment.

FIG. 26 is a block diagram for a method of controlling access to the refuse container of FIG. 21, according to an exemplary embodiment.

FIG. 27 is a block diagram of a method for collecting refuse to be performed by the user device of FIG. 14, according to an exemplary embodiment.

FIG. 28 is a front view of the user interface of the user device of FIG. 14, according to an exemplary embodiment.

FIG. 29 is a block diagram of a method for collecting refuse to be performed by the refuse collection drone of FIG. 4, according to an exemplary embodiment.

FIG. 30 is a perspective view of the refuse collection drone of FIG. 4 being unloaded at the refuse depot of FIG. 9, according to an exemplary embodiment.

FIG. 31 is a perspective view of the refuse collection drone of FIG. 4 being unloaded at the refuse depot of FIG. 9, according to an exemplary embodiment.

FIG. 32 is a block diagram of a refuse collection drone of the refuse collection system of FIG. 1, according to an exemplary embodiment.

FIG. 33 is a block diagram of a method of analyzing refuse deposited into the refuse collection drone of FIG. 32, according to an exemplary embodiment.

FIG. 34 is a block diagram of a control system for the refuse vehicles of FIGS. 13A-13B interoperable with a refuse container repositioning system, according to an exemplary embodiment.

FIG. 35 is a diagram illustrating a collection route for autonomous transport and collection by the refuse vehicles of FIGS. 13A-13B, according to an exemplary embodiment.

FIG. 36 is a block diagram of a refuse collection system including a refuse container repositioning system and the refuse vehicles of FIGS. 13A-13B, according to an exemplary embodiment.

FIG. 37 is a perspective view of the refuse container repositioning system of FIG. 36, according to an exemplary embodiment.

FIG. 38 is a front view of the refuse container repositioning system of FIG. 37 in a first configuration relative to ta refuse container, according to an exemplary embodiment.

FIG. 39 is a front view of the refuse container repositioning system of FIG. 37 in a second configuration relative to a refuse container, according to an exemplary embodiment.

FIG. 40 is a perspective view of the refuse container repositioning system of FIG. 36, according to another exemplary embodiment.

FIG. 41 is a perspective view of a refuse container associated with the refuse container repositioning system of FIG. 40, according to another exemplary embodiment.

FIG. 42 is a diagram illustrating use of the refuse container repositioning system of FIG. 36, according to an exemplary embodiment.

FIG. 43 is a flow chart of a process for utilizing the refuse container repositioning system of FIG. 36, according to an exemplary embodiment.

FIG. 44 is a front view of the refuse container repositioning system of FIG. 36, according to another exemplary embodiment.

FIG. 45-48 are various views showing a process for utilizing the refuse container repositioning system of FIG. 44, according to various embodiments.

FIG. 49 is a diagram illustrating use of the refuse container repositioning system, according to an exemplary embodiment.

FIG. 50 is a diagram illustrating use of the refuse container repositioning system, according to another exemplary embodiment.

FIG. 51 is a schematic illustration of a refuse container, according to an exemplary embodiment.

FIG. 52 is a schematic illustration of a refuse container including wheels, according to an exemplary embodiment.

FIG. 53 is a schematic illustration of a refuse collection method or process, according to an exemplary embodiment.

FIG. 54 is a schematic illustration of a refuse container moving from a home location to a pickup location, according to an exemplary embodiment.

FIGS. 55A-55C illustrate a refuse collection method or process, according to an exemplary embodiment.

FIG. 56 is a flow chart illustrating a refuse collection method or process, according to an exemplary embodiment.

FIG. 57 is a schematic illustration of a refuse container, according to an exemplary embodiment.

FIG. 58 is a schematic illustration of a refuse container including wheels, according to an exemplary embodiment.

FIG. 59 is a flow chart illustrating a refuse collection method or process, according to an exemplary embodiment.

FIG. 60 is a block diagram of an activity-based refuse collection system, according to an exemplary embodiment.

FIG. 61A is a perspective view of a refuse collection drone configured for use with the activity-based refuse collection system of FIG. 60, according to an exemplary embodiment.

FIG. 61B is a side view of the refuse collection drone of FIG. 61A.

FIG. 62 is a flow diagram of a method of scheduling deployment of a refuse collection robot, according to an exemplary embodiment.

FIG. 63 is a flow diagram of a method of determining and/or adjusting a refuse collection schedule, according to an exemplary embodiment.

FIG. 64 is a schematic diagram of a venue that implements the activity-based refuse collection system of FIG. 60, according to an exemplary embodiment.

FIG. 65 is a perspective view of a refuse collection drone navigating within a multi-unit building, according to an exemplary embodiment.

FIG. 66 is a block diagram of a refuse collection drone of a refuse collection system, according to an exemplary embodiment.

FIG. 67 is a perspective view of a refuse collection drone navigating within a multi-unit building, according to an exemplary embodiment.

FIG. 68 is a plan view of an implementation of a refuse collection system within a multi-unit building, according to an exemplary embodiment.

FIG. 69 is a block diagram of a refuse collection system, according to an exemplary embodiment.

FIG. 70-72 are perspective views of a refuse collection system including a refuse chute, according to an exemplary embodiment.

FIG. 73 is a block diagram of a refuse collection system including a refuse collection drone in communication with an access point, according to an exemplary embodiment.

FIG. 74 is a block diagram of a refuse collection system including a refuse collection drone in communication with a refuse container, according to an exemplary embodiment.

FIG. 75 is a top view of a multi-function refuse collection drone, according to an exemplary embodiment.

FIG. 76-77 are top views of a multi-function refuse collection drone, according to various exemplary embodiments.

FIG. 78 is a perspective view of a multi-function system, according to an exemplary embodiment.

FIG. 79 is a block diagram of a multi-function system, according to the exemplary embodiment of FIG. 78;

FIG. 80 is a block diagram for a method for automated multi-function service providing;

FIG. 81 is a block diagram for another method for automated multi-function service providing.

FIG. 82 is a top view of a multi-function refuse collection drone including multiple receptacles for storing refuse, according to an exemplary embodiment.

FIG. 83 is a block diagram for configuring a multi-function refuse collection drone with various receptacles for storing different types of refuse material, according to an exemplary embodiment.

FIG. 84 is a block diagram of communications between a user device and a multi-function refuse collection drone for collecting refuse, according to an exemplary embodiment.

FIG. 85 is a top view of a multi-function refuse collection drone including a secured container for delivery services, according to an exemplary embodiment.

FIG. 86 is a block diagram of communications between a user device and a multi-function refuse collection drone for providing delivery services, according to an exemplary embodiment.

FIG. 87 is a block diagram of a method for automated multi-function service via a refuse collection drone, according to an exemplary embodiment.

FIG. 88 is a block diagram of another method for automated multi-function service via a refuse collection drone, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As utilized herein, the term “customer” means an individual or group of individuals requesting a service, such as a refuse collection service. The customer may or may not be required to transfer payment (e.g., funds) in exchange for such a service.

Referring generally to the figures, a refuse collection system includes one or more refuse collection drones, refuse depots, and refuse vehicles. In response to a customer request (e.g., through a user device such as a smartphone or voice activated home device, such as a smart speaker), a refuse collection drone autonomously travels to a pickup zone associated with the customer to receive refuse from the customer. The system can operate in an on-demand fashion, such that the refuse collection drone begins traveling to the pickup zone immediately in response to the request. Once loaded with refuse, the refuse collection drone autonomously navigates to the refuse depot where the refuse is transferred to a centralized storage. This process may be repeated by multiple refuse collection drones until the refuse depot is filled. A refuse vehicle may then empty the refuse from the centralized storage and transport the refuse to a disposal facility. The refuse collection system provides refuse collection services at any time the customer desires, as opposed to operating according to a fixed schedule. Additionally, the refuse collection system can be easily reconfigured for different sized applications by adding or removing refuse collection drones, refuse depots, and refuse vehicles. Because the refuse collection system can provide on-demand removal of refuse, the system can eliminate the need for on-site storage of refuse (e.g., that would otherwise require a permanent garbage can or dumpster to be provided at the customer's pickup location).

### System Overview

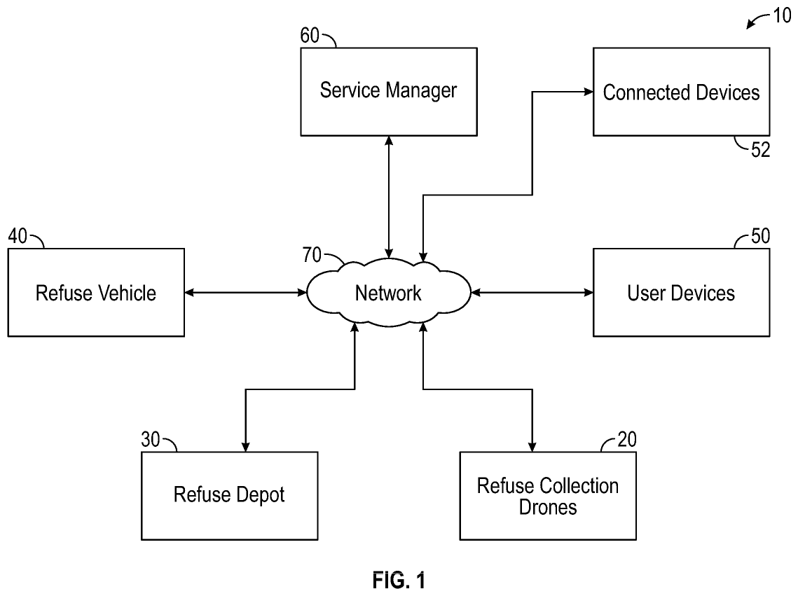

Referring to FIG. 1, an autonomous or partially autonomous refuse collection system is shown as system 10, according to an exemplary embodiment. The system 10 is configured to retrieve refuse, such as recyclable or non-recyclable waste, garbage, trash, organics (e.g., organic material such as food waste, yard clippings, wood, brush, etc.), etc., from one or more pickup sites. Each pickup site may be associated with a customer or other individual or group of individuals requesting refuse collection service. By way of example, the pickup site may be a home (e.g., a single family home, a duplex, an apartment building, a condominium, etc.), a business (e.g., a restaurant, an office, a factory, a farm, etc.), a school (e.g., a college campus), a room within a building (e.g., an apartment within an apartment building, a patient room or surgical suite within a hospital, a classroom within a school, an office within an office building, etc.), a stadium, an amusement park, or another type of location having refuse for collection. The system 10 may operate in an exterior location (e.g., outdoors) and/or within one or more buildings (e.g., indoors). The system 10 transports the refuse to a disposal site, such as a landfill, recycling center, composting facility, or organics processing facility (e.g., a methane harvesting facility).

The system 10 includes one or more autonomous, partially autonomous, or remote-controlled robots or drones, shown as refuse collection drones 20. The refuse collection drones 20 travel to one or more pickup sites, retrieving refuse from a customer at each pickup site. The refuse collection drones 20 transport the refuse to a collection area, staging area, base station, or depot, shown as refuse depot 30. Refuse is unloaded from the refuse collection drones 20 into a larger collection vessel (e.g., a dumpster) of the refuse depot 30. Once several payloads of refuse have been stored in the collection vessel of the refuse depot 30, a refuse collection vehicle (e.g., a front-loading refuse vehicle, etc.), shown as refuse vehicle 40, retrieves the collected refuse from the refuse depot 30 and transports the refuse to a disposal site.

The refuse depot 30 may also facilitate staging the refuse collection drones 20. By way of example, the refuse depot 30 may have a predefined storage area for the refuse collection drones 20 when not in use. The storage area may include one or more chargers to recharge one or more energy storage devices (e.g., batteries) of the refuse collection drones 20.

The system 10 may further include one or more user interfaces or user devices (e.g., smartphones, tables, laptop computers, desktop computers, pagers, smart speakers, AI assistants, etc.), shown as user devices 50. The user devices 50 facilitate communication between a customer and the system 10. By way of example, a customer may provide a command, such as a request for pickup of refuse to the system 10, through the user device 50. By way of another example, the system 10 may communicate the current location of a refuse collection drone 20 to the customer through the user devices 50.

The system 10 may include one or more network attached devices or internet of things devices, shown as connected devices 52. Each of the connected devices 52 may include one or more interfaces, sensors, actuators, and/or controllers. By way of example, the connected devices 52 may include refuse bins, smoke detectors, kitchen appliances, garage door openers, door locks, motion detectors, speakers, etc.

The system 10 further includes a cloud device or refuse service manager, shown as service manager 60 (e.g., a cloud server, a cloud device, a cloud controller, etc.) configured to store and process data. The service manager 60 may store data and manage the flow of information throughout the system 10. By way of example, the service manager 60 may track (e.g., retrieve and store) the current location of the refuse collection drones 20, the current amount of refuse in the refuse depot 30, the amount and/or type of refuse collected from each customer, the locations of each customer, or other information.

The service manager 60 may control operation of the refuse collection drones 20, the refuse depot 30, the refuse vehicle 40, and/or the user devices 50. By way of example, in response to receiving a request for refuse collection from a user device 50 of a customer, the service manager 60 may select one of the refuse collection drones 20 and command the selected drone to navigate to the location of the customer. By way of another example, the service manager 60 may command the refuse depot 30 to unload refuse from one of the refuse collection drones 20. By way of another example, the service manager may request for the refuse vehicle 40 to unload refuse from the refuse depot 30.

The components of the system 10 (e.g., the refuse collection drones 20, the refuse depot 30, the refuse vehicle 40, the user devices 50, the connected devices 52, and/or the service manager 60) may communicate with one another directly and/or across a network 70 (e.g., a cellular network, the Internet, etc.). In some embodiments, the components of the system 10 communicate wirelessly. By way of example, the system 10 may utilize a cellular network, Bluetooth, near field communication (NFC), infrared communication, radio, or other types of wireless communication. In other embodiments, the system 10 utilizes wired communication.

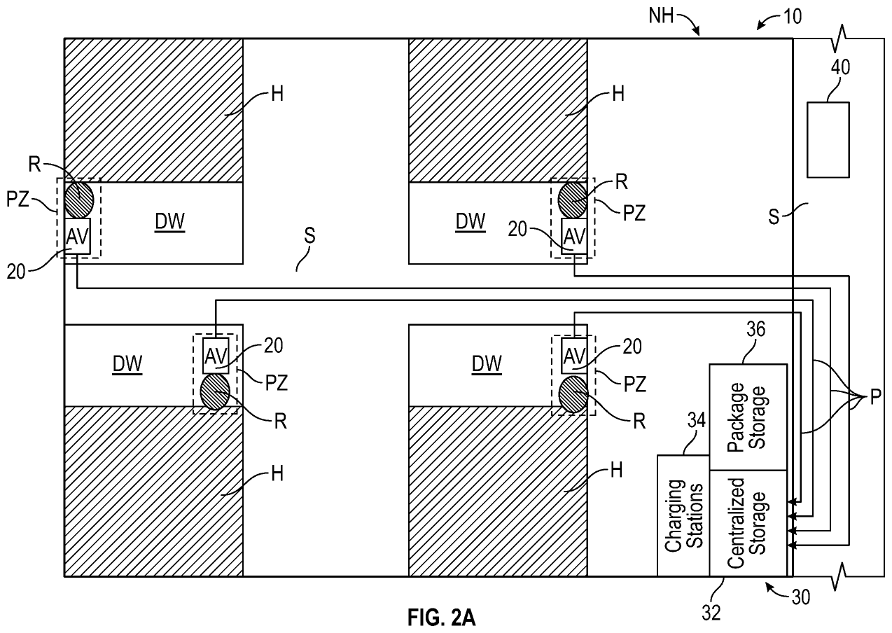

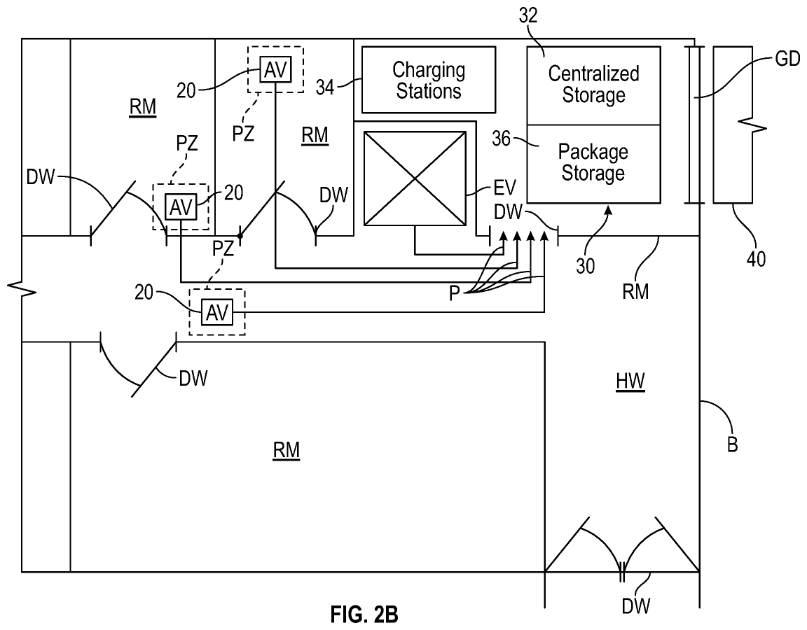

Referring to FIG. 2A, an exemplary application of the system 10 is illustrated. Specifically, in FIG. 2A the system 10 is applied to collect refuse from a grouping or cluster of buildings, shown as residential neighborhood NH. FIG. 2A may represent an outdoor application of the system 10. The neighborhood NH includes a series of structures, shown as houses H. Each house H is associated with a customer that receives refuse collection service from the system 10. The customer may bring a payload of refuse R within a pickup zone PZ, and the refuse collection drones 20 travel to the pickup zones PZ to retrieve the refuse R.

The refuse depot 30 may be positioned within or nearby the neighborhood NH to facilitate a rapid transit of the refuse collection drones 20 between the houses H and the refuse depot 30. By arranging the refuse depot 30 in this way, the response time of a refuse collection drone 20 to a request for refuse collection service may be reduced. Additionally, the energy required by the refuse collection drones 20 to travel between the refuse depot 30 and a house H may be reduced. The refuse depot 30 may be immobile such that the refuse depot 30 has a predetermined, fixed location relative to the neighborhood NH.

In some embodiments, the refuse depot 30 is connected to the houses H by one or more pathways, shown as streets S. The refuse collection drones 20 travel along paths P that are defined along the streets S. The streets S may be designated (e.g., by a municipality or other organization) for use by other types of traffic (e.g., as a road, street, highway, bicycle path, sidewalk, etc.). Accordingly, the streets S may be shared between the refuse collection drones 20 and cars, trucks, bicycles, pedestrians, or other types of traffic. In some embodiments, the refuse vehicles 40 also travel along the streets S. In other embodiments, the paths P of the refuse collection drones 20 extend along paths that are designated for use exclusively by the refuse collection drones 20. In some embodiments, the pickup zones PZ are positioned in an area, such as a driveway DW, that can be accessed directly by the refuse collection drones 20 from the streets S (e.g., without having to travel offroad or along an unpaved path).

As shown in FIG. 2A, the refuse depot 30 includes a centralized storage 32 (e.g., a dumpster) for temporarily holding refuse collected by the refuse collection drones 20. The centralized storage 32 and/or the refuse collection drones 20 may include a transfer mechanism for transferring refuse from the refuse collection drones 20 to the centralized storage 32. The centralized storage 32 is sized to contain a large volume of refuse (e.g., a greater volume of refuse than the capacity of each refuse collection drone 20). In this way, the refuse collection drones 20 may be emptied into the centralized storage 32 several times before the centralized storage 32 is filled. The centralized storage 32 may include one or more separate volumes for collecting refuse. By way of example, the centralized storage 32 may include a first storage volume for recyclable refuse, a second storage volume for non-recyclable refuse, and a third storage volume for compostable refuse. Each storage volume may be individually removable (e.g., configured as separate dumpsters) to facilitate the refuse vehicle 40 separately emptying each storage volume as necessary.

The refuse depot 30 further includes one or more power transfer assemblies, shown as charging stations 34. The charging stations 34 may be configured to transfer energy (e.g., electrical energy, etc.) to the refuse collection drones 20. When idle and/or when transferring refuse to the centralized storage 32, the refuse collection drones 20 may interface with the charging stations 34 to recharge the onboard energy storage devices.

The refuse depot 30 may include a cargo storage area, shown as package storage 36. The package storage 36 may contain, store or otherwise house packages or other cargo intended for delivery by the refuse collection drones 20 to one or more customers. The refuse depot 30 may include a structure for placing the packages into the refuse collection drones 20. Accordingly, the system 10 may be a multi-functional system that is capable of transporting packages to customers and retrieving refuse from the customers.

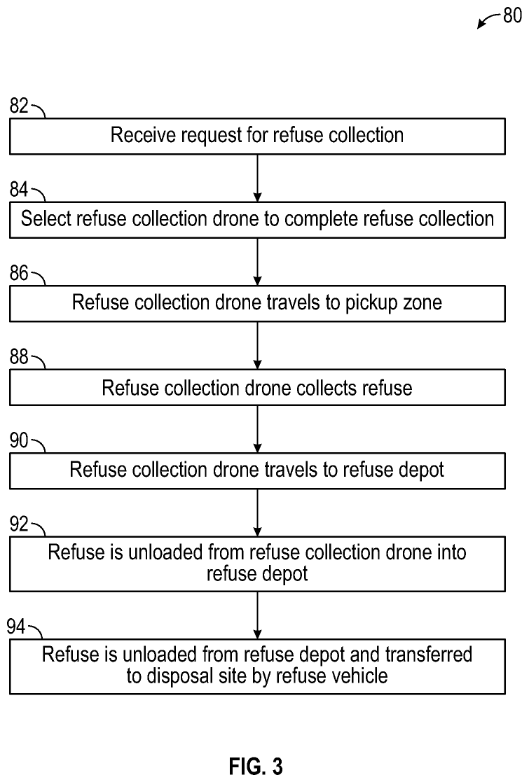

FIG. 3 illustrates a method 80 of collecting refuse that is performed by the system 10 within the area of FIG. 2A. In step 82 of the method 80, the system receives a request for refuse collection. A customer may request a refuse collection service through a user device 50. Based on information included in the request, the service manager 60 may identify a location of a pickup zone PZ associated with the customer (e.g., an address of a house H associated with the customer, a specific area adjacent the house H, etc.). The location of the pickup zone PZ may be contained within the request or determined based on the identity of the customer. The customer may initiate the request for refuse collection service at any time of day and as frequently as they desire. Alternatively, the request may be initiated according to a predetermined schedule (e.g., weekly biweekly, monthly, etc.).

In step 84, a refuse collection drone 20 is selected for completing the refuse collection. The service manager 60 may select a refuse collection drone 20 that is available at the time of the request based on various factors. By way of example, the service manager 60 may review the status of each refuse collection drone 20 to determine which refuse collection drones are eligible for selection (e.g., not currently occupied or experiencing an error). The service manager 60 may review the location of each eligible refuse collection drone 20 and select the refuse collection drone 20 that is capable of arriving at the pickup zone PZ first. By selecting this refuse collection drone 20, the system 10 minimizes the amount of time that the customer is required to wait for refuse collection.

In step 86, the selected refuse collection drone 20 travels to the pickup zone PZ associated with the customer. The service manager 60 may provide the refuse collection drone 20 with a drone route including navigation instructions that direct the refuse collection drone 20 to follow a path P to the pickup zone PZ. The service manager 60 may adjust the path P to account for any obstructions or changes in the location of the pickup zone PZ. By way of example, the pickup zone PZ may be defined based on the current location of a user device 50, such that the path P is adjusted based on movement of the user device 50.

In step 88, the refuse collection drone 20 collects the refuse provided by the customer. Specifically, upon arrival of the refuse collection drone 20 at the pickup zone PZ, the customer may place the refuse into the refuse collection drone 20. The refuse collection drone 20 may detect the placement of the refuse into the refuse collection drone using one or more sensors (e.g., a weight sensor that detects the added weight of the refuse). Additionally or alternatively, the customer may indicate that all of the refuse has been added to the refuse collection drone 20 through an interaction with the user device 50.

In step 90, the refuse collection drone 20 travels to the refuse depot 30. The drone route provided by the service manager 60 may include navigation instructions that guide the refuse collection drone 20 to the refuse depot 30. The navigation instructions may cause the refuse collection drone 20 to follow part or all of the path P used to navigate to the pickup zone PZ.

In step 92, refuse is unloaded from the refuse collection drone 20 into the centralized storage of the refuse depot 30. The refuse may be unloaded by the refuse collection drone 20 and/or by the refuse depot 30. By way of example, the refuse depot 30 may lift and invert the refuse collection drone 20 to dump refuse from the refuse collection drone 20 into the centralized storage 32. At this point, the refuse collection drone 20 may engage the charging station 34 to recharge or proceed to collect refuse from another customer.

The service manager 60 may record time and date of the refuse collection event as well as the type and amount of refuse collected (e.g., as measured by sensors in the refuse collection drones 20 and/or the refuse depot 30). The service manager 60 may then bill the customer based on their particular level of usage of the system 10 (e.g., charging based on the number of refuse collection events, the time at which the refuse collection event occurred, the type of refuse collected, the amount of refuse collected, etc.).

This refuse collection process of steps 82-92 may be repeated several times and by multiple refuse collection drones 20 until the centralized storage 32 is filled. In step 94, the refuse from the centralized storage 32 is unloaded from the refuse depot 30 into the refuse vehicle 40, and the refuse vehicle 40 transfers the unloaded refuse to a disposal site. The system 10 may include many refuse depots 30 and many refuse vehicles 40. Each refuse depot 30 may be associated with a different group of refuse collection drones 20. Each refuse vehicle 40 may retrieve refuse from several refuse depots 30.

Although FIG. 2A illustrates an outdoor application of the system 10, the system 10 may operate similarly in an indoor environment. FIG. 2B illustrates the system 10 being used within a structure, shown as building B. The system 10 may operate exclusively within the building B or include components that are positioned outside the building B or move outside the building B during operation. By way of example, the system 10 may move between two buildings to collect refuse from both buildings.

As shown in FIG. 2B, the building B includes a series of rooms RM that are interconnected by one or more hallways HW. The walls of each room RM may define one or more doorways DW that connect the hallway HW to each room RM, permitting the refuse collection drones 20 to pass between a room RM and a hallway HW. The building B may additionally or alternatively include one or more exterior doorways DW that permit into or egress from the building B. One or more of the rooms RM may have an associated user (e.g., an occupant of the room RM) and an associated pickup zone PZ. The pickup zone PZ may be within the room RM or adjacent the room RM in the hallway HW.

As shown, the building B includes an elevator EV that permits the refuse collection drones 20 to pass between different floors of the building B. The refuse collection drones 20 may include an interface (e.g., an arm capable of pressing buttons in the elevator EV, the communication interface 250 that wirelessly transmits commands, etc.) that permits the refuse collection drone 20 command the elevator EV (e.g., to open or close elevator doors, to move to a desired floor, etc.).

As shown in FIG. 2B, one of the rooms RM contains the refuse depot 30. To facilitate emptying the centralized storage 32, the building B may include a specialized doorway, shown as garage door GD, that permits exterior access to the room RM containing the refuse depot 30. By way of example, the garage door GD may be opened to permit a refuse vehicle RV to directly access the storage centralized storage 32. The refuse vehicle may engage with the centralized storage 32 (e.g., using a pair of forks), remove the centralized storage 32 from the room RM, empty the centralized storage 32, and/or replace the centralized storage 32 back in the room RM.

By way of example, the system 10 may be utilized on a college campus, and the building B may be a classroom building or apartment building (e.g., a student dorm). By way of another example, the building B may be a hospital, an apartment building, a condominium complex, an office building, The refuse collection drones 20 may be capable of navigating through apartment buildings and classroom buildings to reach the pickup locations identified by users. A refuse collection drone 20 may start at a charging station 34 outside of an apartment building. A customer may request a pickup at a certain apartment number in one of the buildings. The refuse collection drone 20 may navigate into the building through a doorway DW, through the building (e.g., through hallways HW, along stairs, within an elevator, etc.), and to the desired apartment. The customer may open the door to the apartment and load refuse into the refuse collection drone 20, at which point the refuse collection drone 20 may exit the building.

The system 10 offers several advantages over other refuse collection systems. By way of example, a refuse collection may be initiated whenever the customer desires (i.e., on demand). The refuse collection may occur regardless of the time of day (e.g., at night) and as frequently or infrequently as the customer desires. By not operating on a fixed schedule, the system 10 can avoid unnecessary travel to a customer's home if they have not produced sufficient a sufficient volume of refuse to justify a refuse collection event. The customer can be charged based on the amount of refuse that they produce (e.g., a customer that produces less refuse can be charged less, and a customer that produces more refuse can be charged more). The system 10 reduces the manpower required to collect refuse, as refuse can be collected from the customer autonomously. Additionally, the system 10 provides an operator of the refuse vehicle 40 with flexibility, as the refuse can be collected at the refuse depot 30 for an extended period of time and emptied whenever is most convenient for the operator of the refuse vehicle 40.

The system 10 may be flexible to facilitate use in a variety of different applications of a variety of different sizes. The system 10 may include as many refuse collection drones 20, refuse depots 30, and refuse vehicles 40 as necessary to scale to the demands of a particular region. As the demands of certain areas within the region change over time, refuse collection drones 20 and/or refuse vehicles 40 may be reassigned to different refuse depots 30 within the region. Additionally or alternatively, refuse depots 30 may be relocated as desired. Should the demands of the region grow, more refuse collection drones 20, refuse depots 30, and/or refuse vehicles 40 may be added.

### Refuse Collection Drones

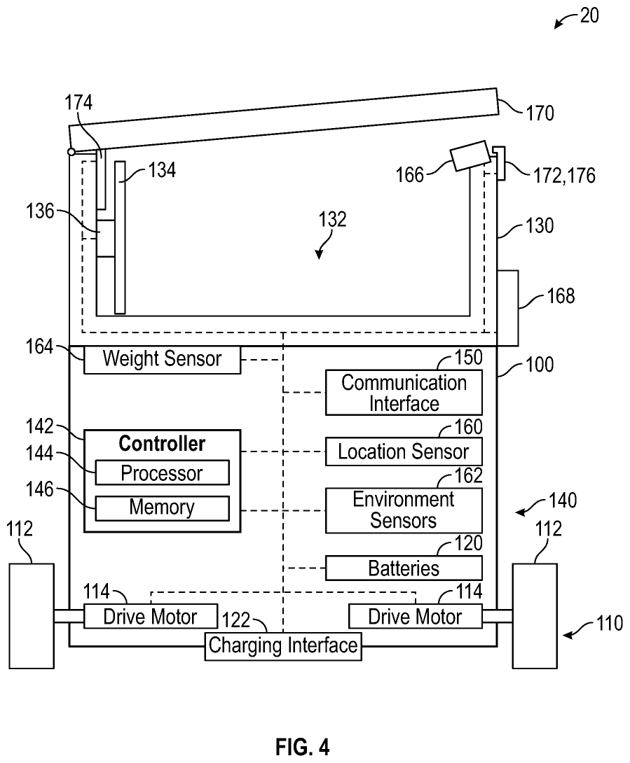

Referring to FIG. 4, a refuse collection drone 20 is shown according to an exemplary embodiment. The refuse collection drone 20 includes a frame, housing, or chassis, shown as chassis 100, that supports the other components of the refuse collection drone 20. The chassis 100 may include one or more components (e.g., frame members, housings, etc.) coupled to one another to form the chassis 100.

The refuse collection drone 20 further includes drivetrain, shown as a propulsion system 110, that is configured to propel the refuse collection drone 20. The propulsion system 110 includes one or more tractive elements, shown as wheels 112, rotatably coupled to the chassis 100. The wheels 112 are configured to engage a support surface (e.g., the ground) to support the refuse collection drone 20. The propulsion system 110 includes one or more actuators (e.g., electric motors), shown as drive motors 114, coupled to the chassis 100. Each drive motor 114 is coupled to one or more of the wheels 112 and configured to drive movement of one or more of the wheels 112. In some embodiments, a first drive motor 114 is coupled to the wheels 112 on a left side of the chassis 100, and a second drive motor 114 is coupled to the wheels 112 on a right side of the chassis 100. In such embodiments, the drive motors 114 can drive the wheels 112 on the left and right sides of the chassis 100 independently to facilitate steering of the refuse collection drone 20.

The refuse collection drone 20 further includes one or more energy storage devices, shown as batteries 120, coupled to the chassis 100. The batteries 120 may store energy to power the systems of the refuse collection drone 20. The batteries 120 may be electrically coupled to one or more systems of the refuse collection drone 20 (e.g., the drive motors 114, the packing actuator 136, etc.) to supply the stored electrical energy. In other embodiments, the refuse collection drone 20 is otherwise powered, and the refuse collection drone 20 includes a different type of energy storage device. By way of example, the refuse collection drone 20 may be powered by a hydrogen fuel cell, and the energy storage device may be a tank of hydrogen. By way of another example, the refuse collection drone 20 may be powered by an internal combustion engine, and the energy storage device may be a fuel tank.

The refuse collection drone 20 further includes an energy transfer interface, shown as charging interface 122, coupled to the chassis 100. The charging interface 122 is configured to transfer electrical energy into and/or out of the refuse collection drone 20 (e.g., between the refuse collection drone 20 and the charging stations 34 of the refuse depot 30). The charging interface 122 may supply electrical energy to charge the batteries 120. In some embodiments, the charging interface 122 transfers energy wirelessly. In such embodiments, the charging interface 122 may include a wireless energy transfer coil to transfer energy through induction. In some embodiments, the charging interface 122 is configured to transfer electrical energy through a wired connection. In such embodiments, the charging interface 122 may include a set of electrical contacts positioned to engage a set of external electrical contacts.

Referring still to FIG. 4, the refuse collection drone 20 further includes a refuse container or basket, shown as bin 130. The bin 130 defines a storage volume 132 (e.g., a space, a containing space, a refuse storage volume, a drone storage volume, etc.) for containing a payload of refuse (e.g., received from a customer). The refuse may be completely contained within the storage volume 132, or the refuse may extend beyond the storage volume 132 (e.g., overflow the bin 130). The bin 130 is coupled to the chassis 100. In some embodiments, the bin 130 is removably coupled to the chassis 100 to facilitate lifting and dumping the bin 130 without having to lift the rest of the refuse collection drone 20. By making the bin 130 removable, the bin 130 can easily be transported to a different location for cleaning or replaced if damaged. The bin 130 and the storage volume 132 may be sized to receive a single kitchen garbage bag, or a single garbage bag of a garbage can. For example, the storage volume 132 may be sized to receive a discrete number of kitchen garbage bags (e.g., a single kitchen garbage bag, two kitchen garbage bags, etc.) having a size of approximately 12 to 20 gallons. Similarly, the storage volume 132 may be sized to receive a discrete number of smaller sized kitchen garbage bags such as 7 to 10 gallon bags, or 4 gallon bags. The storage volume 132 may also be sized to receive a single or multiple garbage can bags having a capacity of 20 to 30 gallons.

In some embodiments, the refuse collection drone 20 includes a compactor including a packing element, shown as pack panel 134, and an actuator (e.g., a hydraulic cylinder, an electric linear actuator, etc.), shown as packing actuator 136. The pack panel 134 partially defines the storage volume 132. The packing actuator 136 is coupled to the bin 130 and the pack panel 134 and configured to move the pack panel 134 relative to the bin 130. The packing actuator 136 may be operatively coupled to the components of the chassis 100 (e.g., the batteries 120) to facilitate operation of the packing actuator 136. By moving the pack panel 134 relative to the bin 130, the packing actuator 136 reduces the volume of the storage volume 132, compressing and compacting the refuse. Accordingly, the compactor facilitates storing a larger amount of refuse within the storage volume 132. In some embodiments, the refuse collection drone 20 additionally or alternatively includes a shredder that shreds the refuse placed within the bin 130. By shredding the refuse, the packing actuator 136 can pack the refuse even more densely. Additionally, the shredder may help to maintain customer privacy when transporting sensitive refuse.

The refuse collection drone 20 further includes a control system 140 including a controller 142 that controls operation of the refuse collection drone 20. The controller 142 is operatively coupled to the drive motor 114 and the packing actuator 136. The controller 142 includes a processing circuit, shown as processor 144, and a memory device, shown as memory 146. The memory 146 may contain one or more instructions that, when executed by the processor 144, cause the controller 142 to perform the processes described herein. While some processes may be described as being performed by the controller 142, it should be understood that those processes may be performed by any other controller of the system 10 or distributed across multiple controllers of the system 10. The controller 142 may control the drive motors 114 to navigate (e.g., between the pickup zones PZ and the refuse depot 30) as instructed by the service manager 60. In some embodiments, the controller 142 navigates the refuse collection drone 20 autonomously (e.g., without any directional control by a user).

The control system 140 further includes a network interface, shown as communication interface 150, operatively coupled to the controller 142. The communication interface 150 is configured to transfer data between the refuse collection drone 20 and other components of the system 10 (e.g., other refuse collection drones 20, the refuse depot 30, the refuse vehicle 40, the user devices 50, the service manager 60, the network 70, etc.). The communication interface 150 may facilitate wired and/or wireless communication.

The control system 140 further includes one or more position, velocity, and/or acceleration sensors, shown as location sensor 160, operatively coupled to the controller 142. The location sensor 160 is configured to provide location data relating to the current location of the refuse collection drone 20. By way of example, the location sensor 160 may include a global positioning system (GPS) that provides the current location of the refuse collection drone 20 relative to the Earth. By way of another example, the location sensor 160 may include one or more accelerometers and/or gyroscopes that track movement of the refuse collection drone 20. The controller 142 may utilize the location data to navigate to a pickup location.

The control system 140 further includes one or more environment sensors 162 operatively coupled to the controller 142. The environment sensors 162 are configured to provide environment data relating to the environment surrounding the refuse collection drone 20. By way of example, the environment sensors 162 may include cameras, LiDAR sensors, light sensors, switches that detect contact with other objects, or other types of sensors that provide environment data. The controller 142 may utilize the environment data to identify objects in the surrounding environment and facilitate navigation. By way of example, the controller 142 may use the environment data to identify and avoid one or more obstacles in the surrounding environment. By way of another example, the controller 142 may use the environment data to identify the pickup zone and drive toward the pickup zone. By way of another example, the controller 142 may use the environment data to identify and navigate along a street or other path.

The control system 140 further includes one or more refuse amount sensors or refuse position sensors, shown as weight sensor 164, operatively coupled to the controller 142. The weight sensor 164 is configured to provide refuse amount data (e.g., weight data) relating to the amount of refuse loaded into the storage volume 132. By way of example, the weight sensor 164 may measure the change in weight supported by the bin 130 over time. The controller 142 may use the weight data to determine the amount (e.g., weight) of refuse loaded by a customer. Accordingly, the weight data may be used (e.g., by the service manager 60) to determine how much to charge the customer for a refuse collection event (e.g., to generate the billing data 540). In some embodiments, the control system 140 includes multiple weight sensors 164 positioned at various predetermined locations throughout the storage volume. By comparing the weights supported by each of the weight sensors 164, the controller 142 may determine the weight distribution (e.g., the position of the center of gravity) of the refuse within the storage volume 132.

The control system 140 further includes one or more refuse type sensors or refuse position sensors, shown as camera 166, operatively coupled to the controller 142. The camera 166 is configured to provide refuse type data relating to the type of refuse loaded into the storage volume 132. As shown, the camera 166 faces toward the storage volume 132, such that the camera 166 records image data of the refuse within the storage volume 132. The controller 142 may analyze the image data to determine the type of refuse (e.g., glass, plastic, metal, electronics, food waste, yard waste, etc.) and if the refuse falls under a certain type of category (e.g., non-recyclable, recyclable, compostable, mixed, etc.). By way of example, the controller 142 may perform image recognition (e.g., using artificial intelligence). The controller 142 may use the refuse type data to determine how the refuse should be disposed (e.g., recycled, landfilled, burned, composted, etc.) and determine an associated designation for the refuse. The controller 142 may use the refuse type data to determine how much to charge the customer for a refuse collection event (e.g., charging more for certain categories of refuse, providing a credit for recycling metals, etc.).

The camera 166 may additionally be used to provide refuse position data indicating the amount and distribution of refuse within and/or nearby the storage volume 132. By performing image recognition on the image data from the camera 166, the controller 142 may identify which areas of the storage volume 132 contain refuse. Based on this analysis, the controller 142 may determine the remaining available capacity of the storage volume 132. The image data from the camera 166 may also indicate if any of the refuse extends beyond the storage volume 132, indicating that bin 130 has been overfilled. In other embodiments, another type of sensor is utilized to determine if the refuse extends beyond the storage volume 132, such as a break beam sensor.

The control system 140 further includes a user interface or customer-facing interface, shown as customer display 168, operatively coupled to the controller 142. The customer display 168 may include one or more output devices (e.g., display, speakers, haptic feedback devices, lights, projectors, etc.). In some embodiments, the customer display 168 includes one or more input devices (e.g., buttons, touch screens, microphones, etc.). The controller 142 may control the customer display 168 to provide information to a user (e.g., the customer). By way of example, the controller 142 may control the customer display 168 to provide commands, instructions, or other information to the customer (e.g., “please wait,” “place your refuse within the bin,” “close the lid,” etc.). The controller 142 may control the customer display 168 to indicate a current status of the refuse collection drone 20 (e.g., “traveling to customer,” “returning from customer,” “charging needed,” “error—awaiting service,” etc.). Any messages or other information provided by the customer display 168 may additionally or alternatively be provided to the customer through a user device 50 associated with the customer.

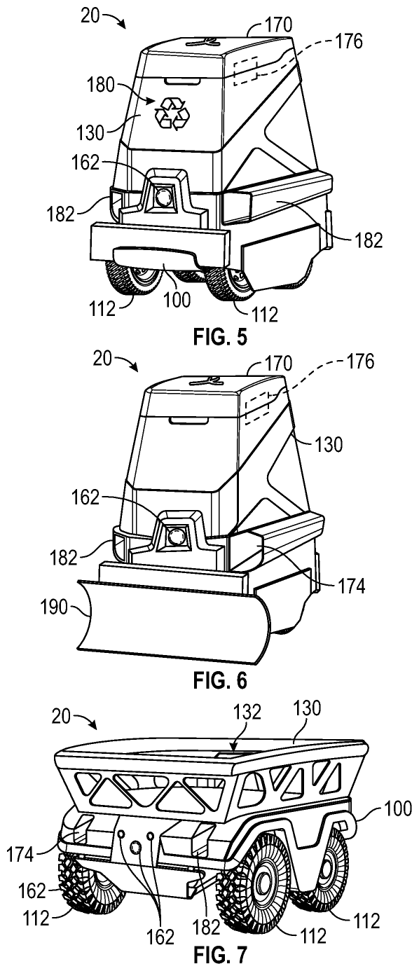

The refuse collection drone 20 includes a lid, shown as cover 170, rotatably coupled to the bin 130. The cover 170 is selectively repositionable between a closed position, shown in FIG. 5, and an open position. In the closed position, the cover 170 extends across the top of the storage volume 132, preventing refuse from entering or exiting the storage volume 132. The closed position may be useful to prevent material flying out of the bin 130 during transit. In the open position, the cover 170 permits refuse to enter and exit the storage volume 132. The cover 170 may be repositioned into the open position by lifting the cover 170 or inverting the bin 130.

The control system 140 further includes a position sensor, shown as closure sensor 172, operatively coupled to the controller 142. The closure sensor 172 may indicate whether or not the cover 170 is fully closed. By way of example, the closure sensor 172 may include a limit switch positioned to contact the cover 170 when the cover 170 is fully closed.

The control system 140 further includes an actuator, shown as cover actuator 174, operatively coupled to the controller 142. The cover actuator 174 is coupled to the bin 130 and configured to apply an upward force on the cover 170 to lift or otherwise move the cover 170 toward the open position. The cover actuator 174 may be used to automatically open the cover 170 when the refuse collection drone 20 is ready to receive refuse. Similarly, the cover actuator 174 may be used to automatically close the cover 170 when the refuse collection drone 20 is in transit or otherwise not ready to receive refuse.

The control system 140 further includes a security device, movement restrictor, or cover control, shown as lock 176, that selectively limits (e.g., prevents) movement of the cover 170. By securing the cover 170 in place, the lock 176 may prevent unauthorized addition or removal of items (e.g., refuse, packages, etc.) from the storage volume 132. By way of example, with the lock 176 in a disengaged configuration, the cover 170 may be permitted to move freely between the closed position and the open position. In an engaged configuration, the lock 176 may prevent the cover 170 from leaving the closed position. The lock 176 may include a clasp, hook, or pawl that engages the cover 170 in the engaged configuration to prevent the movement of the cover 170. Additionally or alternatively, the cover actuator 174 may act as the lock 176. By way of example, the cover actuator 174 may oppose external forces on the cover 170 to limit movement of the cover 170. The lock 176 may be transitionable between a locked state in which movement of the cover 170 is prevented or limited, and an unlocked state in which movement of the cover 170 is allowed.

In some embodiments, the refuse collection drone 20 is configured to monitor the accumulation of refuse within the storage volume 132 and determine if the refuse is likely to cause an instability condition (e.g., cause the refuse collection drone 20 to tip). If heavy objects are positioned at a sufficient elevation within the storage volume 132, the overall center of gravity of the refuse collection drone 20 and the refuse may be elevated, reducing the stability of the refuse collection drone 20. The controller 142 may utilize one or more weight sensors 164 to determine the effect of the refuse on the position of the center of gravity. Additionally, or alternatively, the controller 142 may utilize image data from the camera 166 to determine if the refuse is likely to cause an instability condition. By way of example, the controller 142 may use the image data to determine the height of the refuse within the refuse compartment. The controller 142 may perform image recognition to identify the addition of items known to be dense or heavy (e.g., appliances, containers of liquid, wood, etc.). The controller 142 may verify such an identification using the weight sensors 164. Based on the weight of the refuse and the vertical position at which the refuse is placed, the controller 142 may predict if the refuse is likely to cause an instability condition. Additionally, or alternatively, the controller 142 may detect an instability condition while the refuse collection drone 20 is traveling using the location sensors 160 and/or the environment sensors 162. By way of example, the controller 142 may use a gyroscope to determine if the refuse collection drone 20 is close to tipping.

In response to detecting or predicting an instability condition, the controller 142 may limit operation of the refuse collection drone 20 until the instability condition is eliminated. By way of example, the controller 142 may limit operation of the drive motors 114 (e.g., prevent operation of the drive motors 114, limit a speed of the drive motors 114, limit an acceleration of the drive motors 114, etc.). The controller 142 may control the customer display 168 to display instructions for a customer or other user to rearrange or remove the refuse to address the instability condition.

In some embodiments, the controller 142 is configured to use the image data from the camera 166 to identify forbidden items within the storage volume 132 (e.g., using image recognition as items are added to the storage volume 132). The controller 142 may store a predetermined list of such forbidden items. Forbidden items may include items that are potentially dangerous (e.g., flammable, explosive, corrosive, etc.), subject to government regulations (e.g., firearms, illegal substances, etc.), living beings (e.g., humans or animals), or otherwise undesirable to transport. Additionally, or alternatively, the controller 142 may utilize other sensor data to verify the presence of a forbidden item within the storage volume 132. By way of example, fluctuations in the weight detected by the weight sensor 164 may indicate the presence of a living being in the storage volume 132. In response to detecting a forbidden item, the controller 142 may control the customer display 168 to instruct the customer to remove the forbidden item. The displayed instructions may include an image of the forbidden item (e.g., as captured using the camera 166). The controller 142 may limit operation of the drive motors 114 until the forbidden item is removed. Additionally, or alternatively, the controller 142 may provide a notification to another party indicating the presence and type of forbidden item. By way of example, the controller 142 may provide the notification to the company operating the system 10. By way of another example, the controller 142 may provide the notification to a governmental body (e.g., a police department, a fire department, etc.).

In some embodiments, the controller 142 is configured to use the image data from the camera 166 to identify items within the storage volume 132 that the refuse collection drone 20 is not intended to transport (e.g., using image recognition as items are added to the storage volume 132). By way of example, if the refuse collection drone 20 is designated to collect recyclables, the controller 142 may seek to identify non-recyclable items within the storage volume 132. By way of another example, if the refuse collection drone 20 is designated to collect non-recyclables, the controller 142 may seek to identify recyclable items within the storage volume 132. In response to detecting a non-compliant item, the controller 142 may control the customer display 168 to instruct the customer to remove the identified item. The displayed instructions may include an image of the non-compliant item (e.g., as captured using the camera 166). The controller 142 may limit operation of the drive motors 114 until the identified item is removed. Alternatively, if the identified item is not removed, the refuse collection drone 20 may provide a notification to the service manager 60 indicating that a non-compliant item was added and the identity of the customer that added the item. The service manager 60 may apply a penalty (e.g., an additional charge) to the customers to account for the added cost of sorting out the non-compliant item from the rest of the refuse at a sorting facility, thereby discouraging the customer from providing non-compliant items in the future.

In some embodiments, the controller 142 is configured to identify if the refuse extends beyond the storage volume 132. In some such embodiments, the controller 142 monitors the position of the cover 170 using the closure sensor 172. If the cover 170 is unable to close fully, this may indicate that refuse is extending outside of the storage volume 132 and blocking the cover 170 from closing. In other such embodiments, the controller 142 monitors the position of refuse using the camera 166 to determine if any part of the refuse extends outside of the storage volume 132. In other embodiments, the control system 140 includes another type of sensor, such as a break beam sensor, that detects when refuse extends beyond the storage volume 132.

In response to detecting that the refuse extends beyond the storage volume 132, the controller 142 may control the customer display 168 to instruct the customer to remove the identified item. The displayed instructions may include an image of the portion of the refuse that extends beyond the storage volume 132 (e.g., as captured using the camera 166). The controller 142 may limit operation of the drive motors 114 until the identified item is removed. The shape and size of the storage volume 132 may be predetermined, facilitating the controller 142 determining how far from other obstacles the refuse collection drone 20 must travel to avoid collisions. By fully containing the refuse within the storage volume 132, the refuse is prevented from expanding beyond the predetermined dimensions of the refuse collection drone 20 and coming into contact with outside obstacles. Automated detection of the refuse extending outside of the intended storage volume 132 may be particularly useful for refuse collection drones 20 that are intended to carry oversized items, as the bins 130 of such refuse collection drones 20 may not completely enclose the refuse during normal operation (e.g., the bin 130 may leave the refuse exposed to the surroundings).

FIG. 5-7 illustrate several possible variants of the refuse collection drone 20 of FIG. 4. The refuse collection drones 20 of FIG. 5-7 may each be suited to collection of a different type of refuse. As such, the system 10 may utilize two or more of the refuse collection drones 20 of FIG. 5-7 simultaneously.

The refuse collection drone 20 of FIG. 5 is configured for transport of relatively small recyclable refuse. The refuse collection drone 20 includes a visual indicator, shown as decal 180, that is associated with recycling and instructs the customer to load only recycling into the bin 130. The bin 130 defines a pair of interfaces, pockets, channels, voids, etc., shown as fork passages 182. The fork passages 182 are each configured to receive a fork to facilitate engagement with the bin 130 (e.g., when emptying the bin 130).

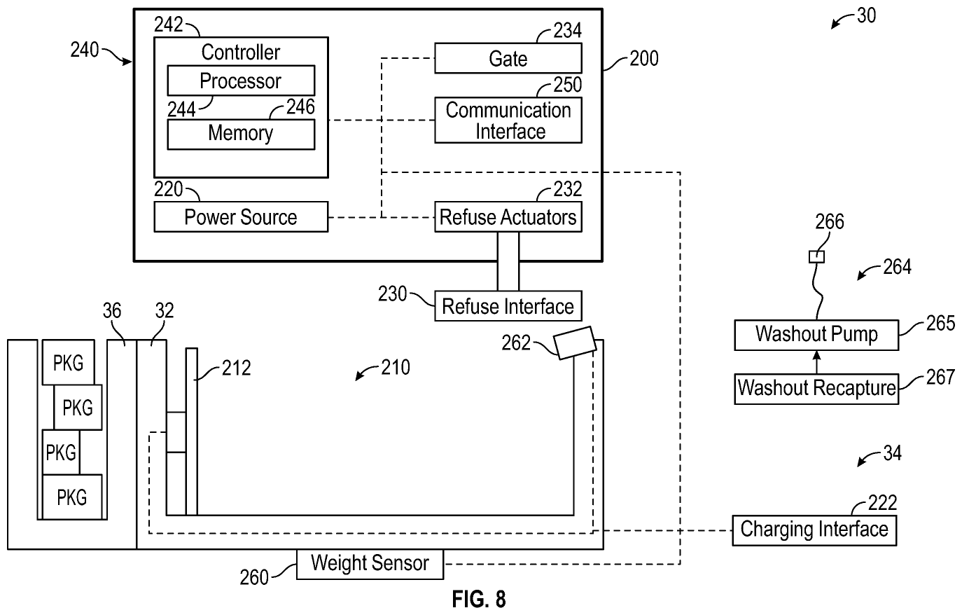

The refuse collection drone 20 of FIG. 6 may be substantially similar to the refuse collection drone 20 of FIG. 5. The refuse collection drone 20 of FIG. 6 is configured for transport of relatively small non-recyclable refuse, and thus omits the decal 180 of FIG. 5. Alternatively, the bin 130 may include a decal 180 that is associated with non-recyclable refuse and instructs the customer to load only non-recyclable refuse into the bin 130.

As shown in FIG. 6, the refuse collection drone 20 includes an implement (e.g., a brush, a salt dispenser, a lawn mowing unit, a sand dispenser, a heating element, etc.) such as a snow removal element, shown as plow 190, that is coupled to the chassis 100. The plow 190 may be utilized with any of the refuse collection drones 20 described herein. In other embodiments, the refuse collection drone 20 utilizes a different type of snow removal element, such as a snowblower. The plow 190 may be removably coupled to the chassis 100 (e.g., to reconfigure the refuse collection drone 20 into or out of a snow removal configuration). The plow 190 is positioned along a front side of the refuse collection drone 20 such that longitudinal movement of the refuse collection drone 20 (e.g., driven by the wheels 112) causes the plow 190 to scrape and push snow or other debris out of the path of the refuse collection drone 20. Using the plow 190, the refuse collection drone 20 may be used to perform snow removal (e.g., from the streets S, from the driveways DW, etc.). The snow removal capability of the refuse collection drone 20 may permit the refuse collection drone 20 to navigate after a snowfall. The refuse collection drones 20 may be used to provide a snow removal service to one or more customers.

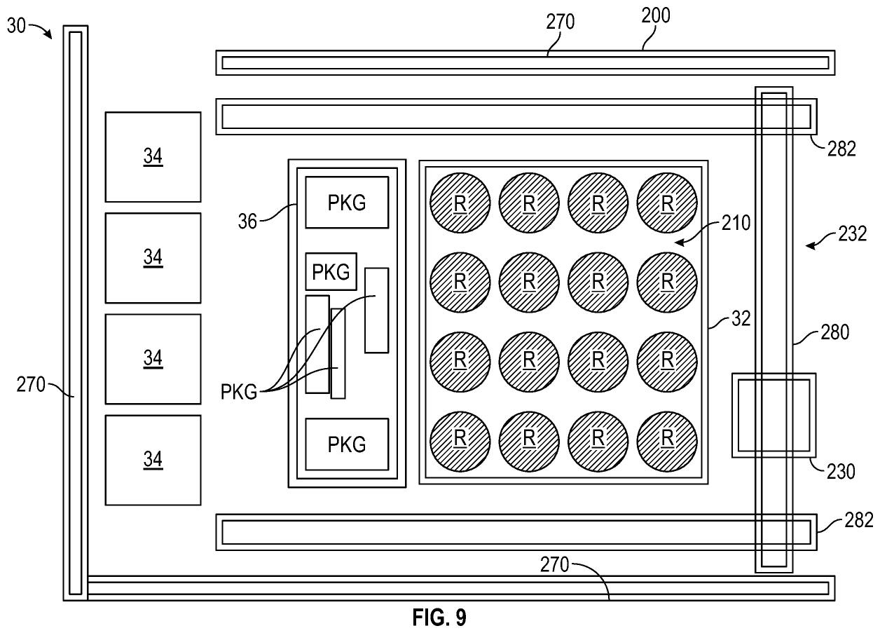

The refuse collection drone 20 of FIG. 7 may be substantially similar to the refuse collection drone 20 of FIG. 6, except that the refuse collection drone 20 of FIG. 7 is configured for transport of relatively large refuse (e.g., oversized items that are unable to fit within the refuse collection drones 20 of FIGS. 5 and 6). The refuse collection drone 20 may omit the cover 170, such that the storage volume 132 is constantly exposed. This may be suitable for carrying large items that may be larger than the storage volume 132.

### Refuse Depot

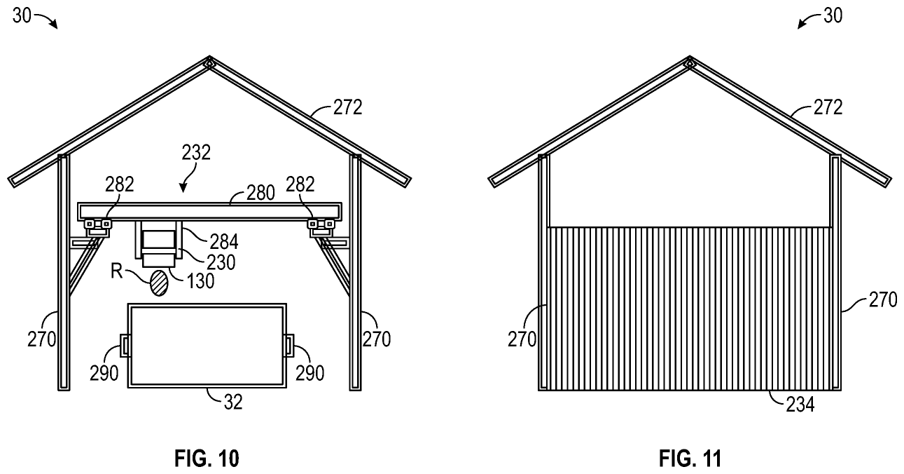

Referring to FIG. 8, the refuse depot 30 is shown according to an exemplary embodiment. The refuse depot 30 includes a frame, housing, or chassis, shown as chassis 200, that supports the other components of the refuse depot 30. The chassis 200 may include one or more components (e.g., frame members, housings, etc.) coupled to one another to form the chassis 200. The chassis 200 may be coupled to the centralized storage 32 or separate from the centralized storage 32. The chassis 200 may be stationary, fixedly coupled to a ground surface (e.g., the ground, a foundation embedded into the ground, etc.), or otherwise incapable of moving under its own power. Accordingly, the refuse depot 30 may remain in a constant, predetermined location during normal operation.

The centralized storage 32 (e.g., a container) defines a storage volume 210 (e.g., a volume defined within walls of one or more containers) for containing refuse (e.g., received from the refuse collection drones 20). The refuse may be completely contained within the storage volume 210, or the refuse may extend beyond the storage volume 210 (e.g., overflow the bin 130). In some embodiments, the storage volume 210 of the centralized storage 32 is larger than the storage volumes 132 of the refuse collection drones 20 to facilitate storing several payloads of refuse from the refuse collection drones 20. In some embodiments, the storage volume 210 is a single, continuous volume. In other embodiments, the storage volume 210 includes two or more separate volumes. Each separate volume may be used to store a different type of refuse (e.g., recyclables, non-recyclables, compostables, etc.). By way of example, the centralized storage 32 may include several dumpsters.

In some embodiments, the refuse depot 30 includes one or more compactors including a packing element, shown as pack panel 212, and an actuator (e.g., a hydraulic cylinder, an electric linear actuator, etc.), shown as packing actuator 214. The pack panel 212 partially defines the storage volume 210. The packing actuator 214 is coupled to the centralized storage 32 and the pack panel 212 and configured to move the pack panel 212 relative to the centralized storage 32. The packing actuator 214 may be operatively coupled to the components of the chassis 200 (e.g., the power source 220) to facilitate operation of the packing actuator 214. By moving the pack panel 212 relative to the centralized storage 32, the packing actuator 214 reduces the volume of the storage volume 210, compressing and compacting the refuse. Accordingly, the compactor facilitates storing a larger amount of refuse within the storage volume 210.

The refuse depot 30 further includes a source of energy (e.g., electrical energy), shown as power source 220, coupled to the chassis 200. The power source 220 may provide energy to power the systems of the refuse depot 30. The power source 220 may provide energy from an energy storage device (e.g., batteries, capacitors, etc.) or from another source (e.g., a power grid). Additionally, or alternatively, the power source 220 may include a device that generates energy (e.g., a solar panel, a fuel cell, a generator including an internal combustion engine, etc.). The power source 220 may be electrically coupled to one or more systems of the refuse depot 30 (e.g., packing actuator 214, the refuse actuators 232, etc.) to supply the electrical energy.

Each charging station 34 of the refuse depot 30 further includes an energy transfer interface, shown as charging interface 222. The charging interfaces 222 are configured to transfer electrical energy between the power source 220 and the refuse collection drones 20. The charging interfaces 222 may supply electrical energy to the refuse collection drones 20 to charge the batteries 120. In some embodiments, the charging interface 222 transfers energy wirelessly. In such embodiments, the charging interfaces 222 may include a wireless energy transfer coil to transfer energy to the charging interfaces 122 through induction. In other embodiments, the charging interfaces 222 are configured to transfer electrical energy through a wired connection. In such embodiments, the charging interface 222 may each include a set of electrical contacts positioned to engage a corresponding set of electrical contacts on a refuse collection drone 20. In some embodiments, the charging interfaces 222 are fixedly coupled to the centralized storage 32 to form the refuse depot 30.

Referring still to FIG. 8, the refuse depot 30 further includes a refuse engagement interface, grasper, scoop, collection implement, or grabber, shown as refuse interface 230. The refuse interface 230 is configured to engage (e.g., selectively couple to) refuse to facilitate moving refuse into and/or out of the centralized storage 32. By way of example, the refuse interface 230 may directly engage the refuse (e.g., with a grabber or a scoop, etc.). By way of another example, the refuse interface 230 may engage the bin 130 to move refuse contained within the bin 130. By way of another example, the refuse interface 230 may engage the centralized storage 32 to move refuse contained within the centralized storage 32.

The refuse depot 30 further includes one or more actuators, shown as refuse actuators 232, that move the refuse interface 230 to move the refuse engaged by the refuse interface 230. The refuse actuators 232 may include electric actuators (e.g., electric motors), hydraulic actuators (e.g., hydraulic cylinders), pneumatic actuators (e.g., pneumatic cylinders), or another type of actuator. The refuse actuators 232 may lift the refuse interface 230 and/or translate the refuse interface 230 horizontally. The refuse depot 30 may utilize the refuse interface 230 and the refuse actuators 232 to move refuse from the refuse collection drones 20 to the centralized storage 32, to move refuse within the centralized storage 32 (e.g., to reorganize the centralized storage 32), and/or to move refuse from the centralized storage 32 to the refuse vehicle 40.

The refuse depot 30 further includes a covering, shown as gate 234, coupled to the chassis 200. The gate 234 is configured to selectively prevent access to the storage volume 210 from outside of the refuse depot 30. Specifically, the gate 234 may be movable between a closed position, in which the gate 234 prevents access to the storage volume 210, and an open position, in which the gate 234 permits access to the storage volume 210. The gate 234 may include an actuator (e.g., an electric motor) that moves the gate between the open position and the closed position.

The refuse depot 30 further includes a control system 240 including a controller 242 that controls operation of the refuse depot 30. The controller 242 is operatively coupled to the packing actuator 214 and the refuse actuators 232. The controller 242 includes a processing circuit, shown as processor 244, and a memory device, shown as memory 246. The memory 246 may contain one or more instructions that, when executed by the processor 244, cause the controller 242 to perform the processes described herein. While some processes may be described as being performed by the controller 242, it should be understood that those processes may be performed by any other controller of the system 10 or distributed across multiple controllers of the system 10. The refuse actuators 232 and the refuse interface 230 may be configured to perform both an unloading and a loading operation. The loading operation can include grasping or selectively coupling refuse from one of the refuse drones 20 with the refuse interface 230, lifting, moving, and placing the refuse into the storage volume 210. Similarly, the loading operation can include selectively coupling a portion of the refuse drones 20 with the refuse interface 230, lifting, and emptying the refuse of the portion of the refuse drones 20 into the storage volume 210. The loading operation can include grasping a package or object from a nearby area via the refuse interface 230, and operating the refuse actuators 232 to move the refuse interface 230 to one of the refuse drones 20. The package or object may be placed in a storage volume, bin, or other support area of the refuse drones 20 for delivery of the package or object by the refuse drone 20 to a customer or target address.

The control system 240 further includes a network interface, shown as communication interface 250, operatively coupled to the controller 242. The communication interface 250 is configured to transfer data between the refuse depot 30 and other components of the system 10 (e.g., the refuse collection drones 20, the refuse vehicle 40, the user devices 50, the service manager 60, the network 70, etc.). The communication interface 250 may facilitate wired and/or wireless communication.

The control system 240 further includes one or more refuse amount sensors, shown as weight sensor 260, operatively coupled to the controller 242. The weight sensor 260 is configured to provide refuse amount data (e.g., weight data) relating to the amount of refuse loaded into the storage volume 210. By way of example, the weight sensor 260 may measure the change in weight supported by the centralized storage 32 over time. The controller 242 may use the weight data to determine the amount (e.g., weight) of refuse loaded from a refuse collection drone 20. The weight data may be used (e.g., by the service manager 60) to determine how much to charge the customer for a refuse collection event (e.g., to generate the billing data 540). Additionally, or alternatively, the weight data may be used to determine the current capacity of the centralized storage 32 and determine when the centralized storage 32 should be emptied.

The control system 240 further includes one or more refuse type sensors or image sensors, shown as camera 262, operatively coupled to the controller 242. The camera 262 is configured to provide refuse layout data relating to the layout of the refuse loaded into the storage volume 210. As shown, the camera 262 faces toward the storage volume 210, such that the camera 262 records image data of the refuse within the storage volume 210. The controller 242 may analyze the image data to determine the layout of refuse within the storage volume 210 (e.g., the locations and amount of refuse within the storage volume 210. The controller 242 may use the refuse layout data to determine where to place new refuse within the storage volume 210. Additionally, or alternatively, the controller 242 may analyze the image data to determine the type of refuse (e.g., glass, plastic, metal, electronics, food waste, yard waste, etc.) and if the refuse falls under a certain type of category (e.g., non-recyclable, recyclable, compostable, mixed, etc.).

The refuse depot 30 further includes a washout system 264 that is configured to provide a supply of cleaning fluid to remove debris from or otherwise clean the refuse depot 30 (e.g., the centralized storage 32) and the refuse collection drones 20 (e.g., the storage volumes 132). The cleaning fluid may include water and/or an additive (e.g., a detergent, a solvent, etc.) that facilitates removal of debris. The washout system 264 includes a pump, shown as washout pump 265, that provides a pressurized flow of the cleaning fluid to a nozzle 266. The nozzle 266 may be manually aimed by a user or automatically aimed by the control system 240 (e.g., using one or more nozzle actuators) to direct the cleaning fluid toward the area to be cleaned. The used cleaning fluid is captured by a drain system, shown as washout recapture 276. The washout recapture 276 may include a drain positioned beneath the refuse depot 30, such that the used cleaning fluid drains into the washout recapture 276. The washout recapture 276 may include a filter that separates the debris and leachate from the water. The filtered water may be supplied back to the washout pump 265 for recycled use.

In some embodiments, the refuse depot 30 is further configured to store cargo, shown as packages PKG, in the package storage 36 for delivery to one or more customers. The package storage 36 and the centralized storage 32 may both be contained within the walls 270. The packages PKG may be placed in the package storage 36 by a delivery service or postal service, with the system 10 handling the last leg of the delivery process. The refuse depot 30 may be configured to retrieve packages from the package storage 36 and place them in the storage compartments 132 of the refuse collection drones 20. By way of example, the refuse depot 30 may utilize the refuse interface 230 to extract the packages PKG from the package storage 36 and place the packages PKG in the storage compartments. A similar process may be followed in reverse (e.g., to process a product return by a customer).

In some embodiments, the controller 242 utilizes the camera 262 and/or additional cameras 262 to monitor the packages PKG. Image data from the cameras 262 may provide location data indicating the positions and orientations of packages PKG within the package storage 36. The image data may provide package attribute data, such as the shapes and sizes of the packages PKG. The image data may provide package identifier data, such as bar codes or QR codes, that identify the package. The package identifier data may include a seller or location where the package originated, a destination for the package, or other information. Using the package identifier data, the controller 242 or the service manager 60 may identify a customer associated with the package PKG.

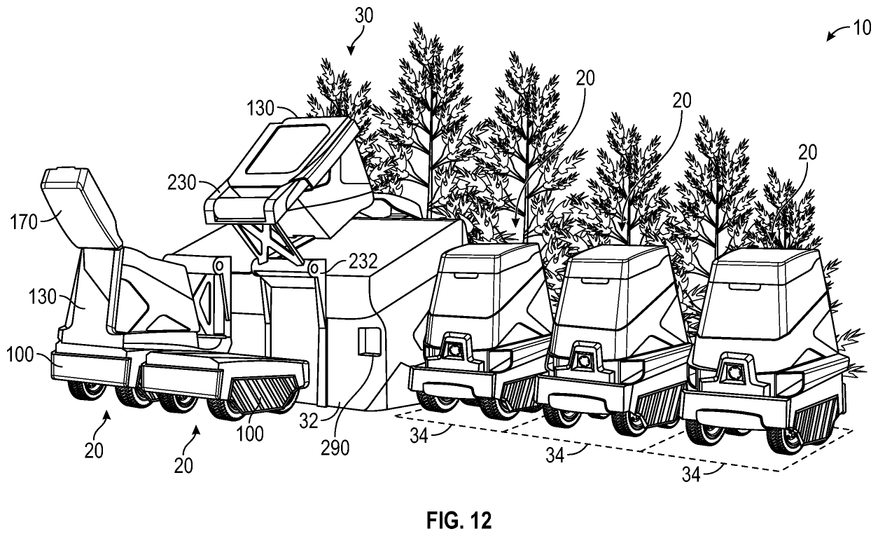

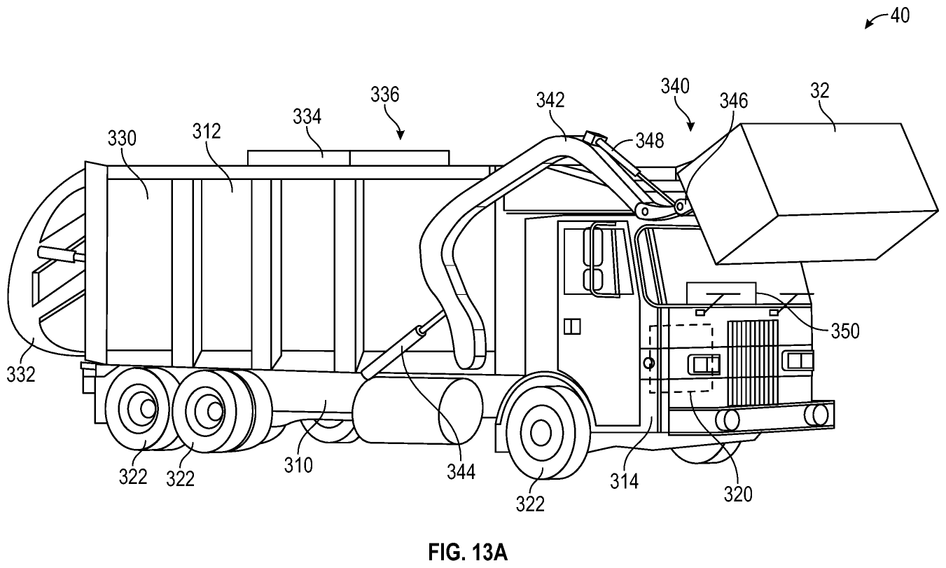

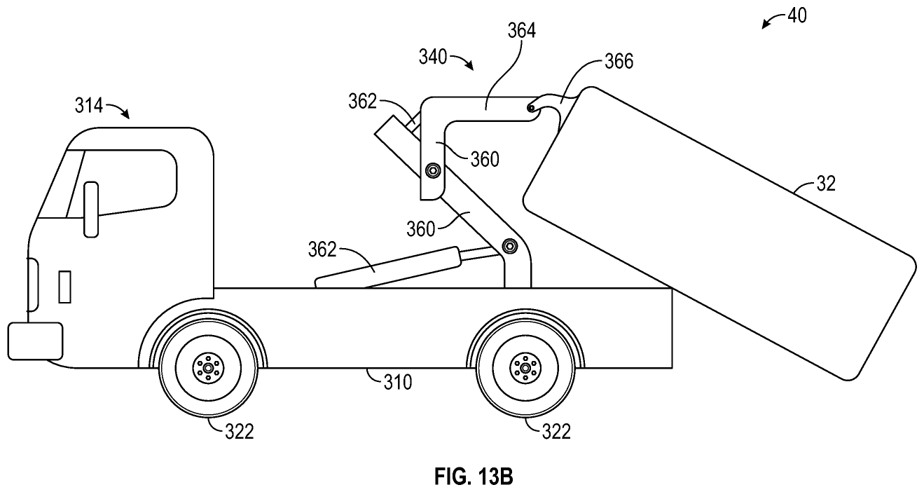

Referring to FIG. 9-11, the refuse depot 30 is shown according to an exemplary embodiment. In the embodiment of FIG. 9-11, the chassis 200 is an enclosure including a series of walls 270 and a roof 272. The walls 270 support the roof 272 such that the roof 272 is spaced a distance above the ground. Together, the walls 270 and the roof 272 enclose a volume that contains the components of the refuse depot 30 (e.g., the centralized storage 32, the charging stations 34, etc.), protecting the refuse depot 30 from weather and intruders. A gate 234 is selectively repositionable between the open position, shown in FIG. 10, and the closed position, shown in FIG. 11, to selectively prevent access to the enclosed volume.

As shown, the refuse actuators 232 include a first actuator, shown as lateral actuator 280, a pair of second actuators, shown as longitudinal actuators 282, and a third actuator, shown as vertical actuator 284. The lateral actuators 280 are coupled to the refuse interface 230 and move the refuse interface 230 in a first direction (e.g., laterally). The longitudinal actuators 282 are coupled to the lateral actuator 280 and the chassis 200. The longitudinal actuators 282 are coupled to the lateral actuator 280 and the chassis 200 and move the refuse interface 230 and the lateral actuator 280 in a second direction (e.g., longitudinally). In some embodiments, the first direction and the second direction are both within a common horizontal plane. Accordingly, the lateral actuator 280 and the longitudinal actuators 282 facilitate moving the refuse interface 230 to a desired position (e.g., above the centralized storage 32, above a refuse collection drone 20, above the refuse vehicle 40, etc.). The vertical actuator 284 moves the refuse interface 230 vertically (i.e., raises and lowers the refuse interface 230). The refuse actuators 232 may include electric motors that drive movement of the refuse interface 230.

During operation, the controller 242 may utilize the camera 262 and the refuse actuators 232 to facilitate efficient packing of the centralized storage 32, optimizing the amount of refuse that can be contained within the fixed storage volume 210 of the centralized storage 32. The controller 242 may utilize the refuse layout data to identify (a) filled sections of the storage volume 210 containing refuse and (b) empty sections of the storage volume 210 that are empty and available to receive refuse. By way of example, the controller 242 may divide the storage volume 210 into a lateral, longitudinal, and vertical grid of sections or zones (e.g., each zone having a lateral coordinate, a longitudinal coordinate, and a vertical coordinate). The controller 242 may assign each section an identifier indicating if the section is an empty section or a filled section. The controller 242 may move the refuse actuators 232 to fill empty sections with refuse, and once filled, reassign the identifier for that section to indicate that the section is a filled section.

The controller 242 may seek to fill the sections in a particular order. By way of example, the controller 242 may fill a lateral row of empty sections, then subsequently fill the adjacent lateral row. This process may be repeated until a vertical layer is completely filled. The controller 242 may seek to completely fill each vertical layer of the storage volume 210 prior to filling subsequent (i.e., higher) layers. By filling the storage volume 210 in this way, the controller 242 may ensure that the refuse is packed as tightly as possible. If the positions of the refuse within the storage volume 210 shifts during operation (e.g., due to settling of refuse due to gravity, due to compaction by the packing actuator 214, etc.), the change may be identified using the camera 262, and the controller 242 may adjust the packing strategy accordingly.

The centralized storage 32 may include a pair of interfaces, shown as fork passages 290. The fork passages 290 are each configured to receive a fork to facilitate engagement of the refuse vehicle 40 with the centralized storage 32. The centralized storage 32 may be lifted by the refuse vehicle 40 using the fork passages 290 to permit emptying the centralized storage 32 (e.g., by lifting and inverting the centralized storage 32). Alternatively, refuse may be unloaded from the centralized storage 32 into the refuse vehicle 40 by the refuse interface 230 and the refuse actuators 232.

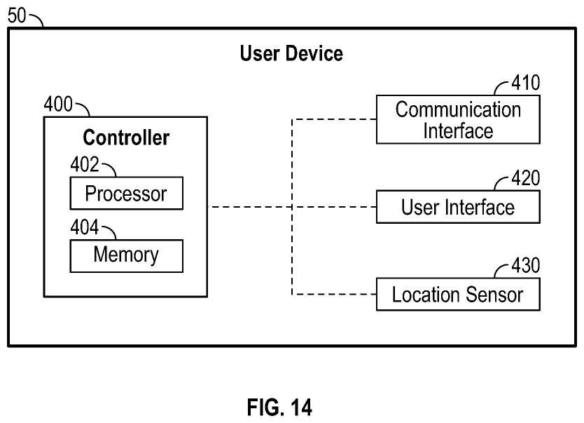

Referring to FIG. 12, the refuse depot 30 is illustrated according to an alternative embodiment. In the refuse depot 30 of FIG. 12, a refuse actuator 232 are coupled to the centralized storage 32. The refuse interface 230 is a grabber including a pair of forks that are configured to be received within the fork passages 182 of the bins 130 to couple the refuse interface 230 to the bins 130. The refuse actuator 232 is configured to rotate about a first horizontal axis relative to the centralized storage 32 and configured to rotate about a second horizontal axis relative to the refuse interface 230. This rotation raises and inverts the bin 130 to empty the refuse into the centralized storage 32.

### Refuse Vehicle

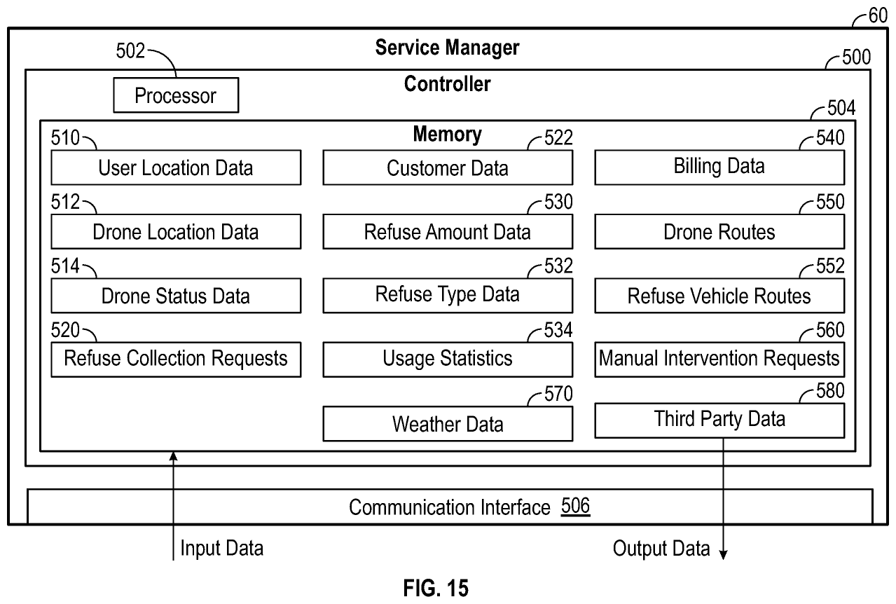

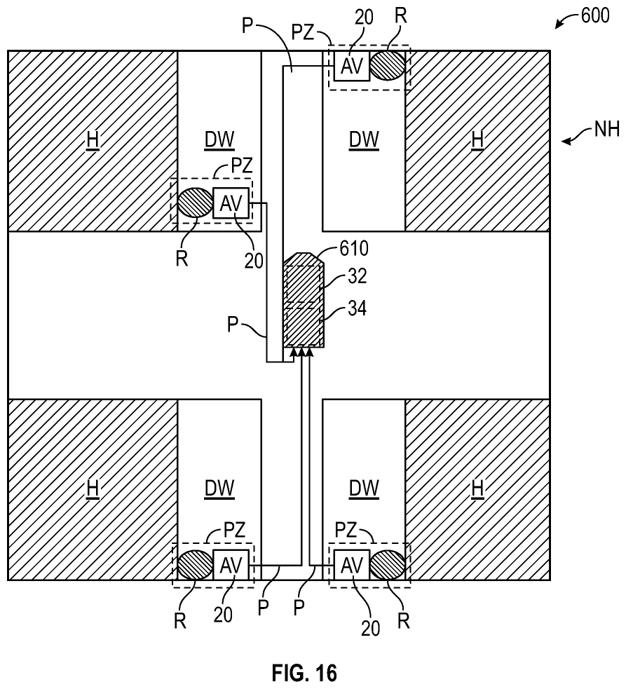

Referring to FIG. 13A, a vehicle, shown as refuse vehicle 40 (e.g., a garbage truck, a waste collection truck, a sanitation truck, etc.), is configured as a front-loading refuse vehicle. In other embodiments, the refuse vehicle 40 is configured as a side-loading refuse vehicle, a zero radius side-loading refuse vehicle, or a rear-loading refuse vehicle. In still other embodiments, the vehicle is another type of vehicle (e.g., a skid-loader, a telehandler, a plow truck, a boom lift, etc.). As shown in FIG. 13A, the refuse vehicle 40 includes a chassis, shown as frame 310; a body assembly, shown as body 312, coupled to the frame 310 (e.g., at a rear end thereof, etc.); and a cab, shown as cab 314, coupled to the frame 310 (e.g., at a front end thereof, etc.). The cab 316 may include various components to facilitate operation of the refuse vehicle 40 by an operator (e.g., a seat, a steering wheel, hydraulic controls, a user interface, an acceleration pedal, a brake pedal, a clutch pedal, a gear selector, switches, buttons, dials, etc.). In other embodiments, the refuse vehicle 40 is operated autonomously.

As shown in FIG. 13A, the refuse vehicle 40 includes a prime mover, shown as engine 320, coupled to the frame 310 at a position beneath the cab 314. The engine 320 is configured to provide power to tractive elements, shown as wheels 322, and/or to other systems of the refuse vehicle 40 (e.g., a pneumatic system, a hydraulic system, etc.). The engine 320 may be configured to utilize one or more of a variety of fuels (e.g., gasoline, diesel, bio-diesel, ethanol, natural gas, etc.), according to various exemplary embodiments. According to an alternative embodiment, the engine 320 additionally or alternatively includes one or more electric motors coupled to the frame 310 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 40.

According to an exemplary embodiment, the refuse vehicle 40 is configured to transport refuse from the refuse depot 30 to a disposal facility (e.g., a landfill, an incineration facility, a recycling facility, etc.). As shown in FIG. 13A, the body 312 includes a plurality of panels, shown as panels 330, a tailgate 332, and a cover 334. The panels 330, the tailgate 332, and the cover 334 define a collection chamber (e.g., hopper, etc.), shown as refuse compartment 336. Loose refuse may be placed into the refuse compartment 336 where it may thereafter be compacted. The refuse compartment 336 may provide temporary storage for refuse during transport to a disposal facility. In some embodiments, at least a portion of the body 312 and the refuse compartment 336 extend in front of the cab 16. According to the embodiment shown in FIG. 13A, the body 312 and the refuse compartment 336 are positioned behind the cab 314. In some embodiments, the refuse compartment 336 includes a hopper volume and a storage volume. Refuse may be initially loaded into the hopper volume and thereafter compacted into the storage volume. According to an exemplary embodiment, the hopper volume is positioned between the storage volume and the cab 314 (e.g., refuse is loaded into a position of the refuse compartment 336 behind the cab 314 and stored in a position further toward the rear of the refuse compartment 336). In other embodiments, the storage volume is positioned between the hopper volume and the cab 314 (e.g., a rear-loading refuse vehicle, etc.).

As shown in FIG. 13A, the refuse vehicle 40 includes a first lift mechanism/system (e.g., a front-loading lift assembly, etc.), shown as lift assembly 340. The lift assembly 340 includes a pair of arms, shown as lift arms 342, coupled to the frame 310 and/or the body 312 on either side of the refuse vehicle 40 such that the lift arms 342 extend forward of the cab 314 (e.g., a front-loading refuse vehicle, etc.). In other embodiments, the lift assembly 340 extends rearward of the body 312 (e.g., a rear-loading refuse vehicle, etc.). In still other embodiments, the lift assembly 340 extends from a side of the body 312 (e.g., a side-loading refuse vehicle, etc.). The lift arms 342 may be rotatably coupled to the frame 310 with a pivot (e.g., a lug, a shaft, etc.). As shown in FIG. 13A, the lift assembly 340 includes first actuators, shown as lift arm actuators 344 (e.g., hydraulic cylinders, etc.), coupled to the frame 310 and the lift arms 342. The lift arm actuators 344 are positioned such that extension and retraction thereof rotates the lift arms 342 about an axis extending through the pivot, according to an exemplary embodiment. The lift arms 342 may be removably coupled to the centralized storage 32. The lift assembly 340 further includes a pair of lift forks 346 that selectively engage the fork passages 290 of the centralized storage 32 to selectively couple the centralized storage 32 to the lift assembly 340. The lift assembly 340 includes a pair of second actuators, shown as fork actuators 348, that cause rotation of the lift forks 346 relative to the lift arms 342. Through actuation of the lift arm actuators 344 and the fork actuators 348, the lift assembly 340 may raise and invert the centralized storage 32 to empty the refuse from the centralized storage 32 into the refuse compartment 336. Alternatively, the centralized storage 32 may be a roll-off dumpster that is sized to be supported by the frame 310 of the refuse vehicle 40 for transport. In such embodiments, the lift assembly 340 may be used to raise, lower, and secure the dumpster onto the frame 310.

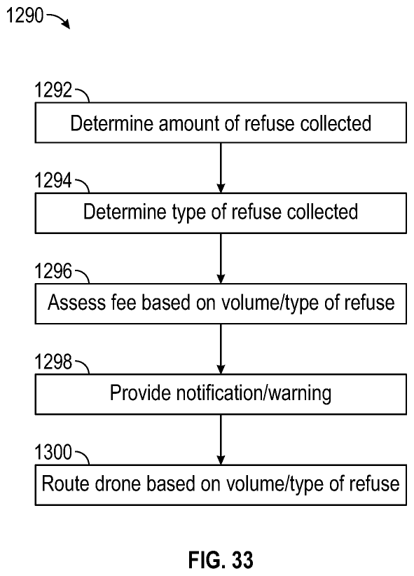

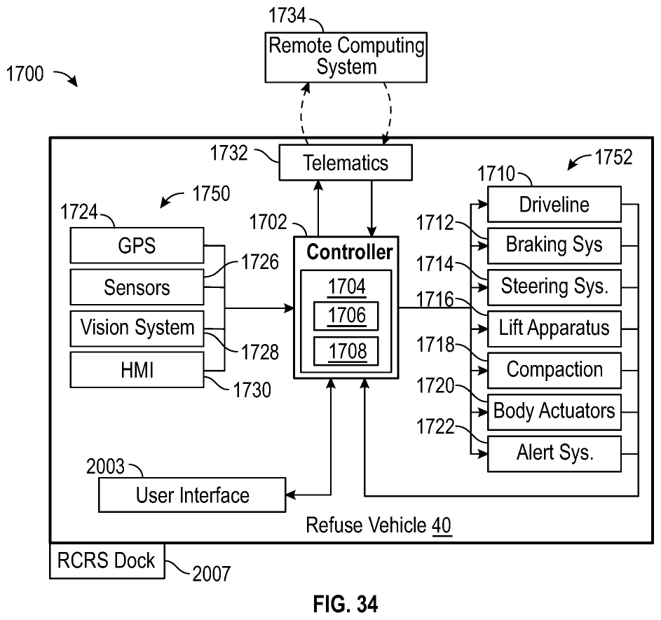

In some embodiments, the refuse vehicle 40 is configured to collect refuse from the refuse collection drone 20 and to transport refuse the refuse to a disposal facility (e.g., a landfill, an incineration facility, a recycling facility, etc.). The lift assembly 340 may be configured to grab, lift, and invert the refuse collection drone 20 to transfer refuse within the storage volume 132 of the refuse collection drone 20 into the refuse compartment 336 of the refuse vehicle 40. In some embodiments, and as will be discussed in reference to FIGS. 30 and 31 below, the refuse collection drone 20 includes a removable insert defining the storage volume 132 of the refuse collection drone 20. The lift assembly 340 of the refuse vehicle 40 may be configured to engage, lift, and invert the removable insert, leaving the refuse collection drone 20 on the ground, to transfer refuse from the removable insert into the refuse compartment 336 of the refuse vehicle 40.

In some embodiments, the refuse vehicle 40 includes an operator interface, shown as vehicle interface 350. The vehicle interface 350 may include a controller including a processor and a memory, a communication interface that facilitates communication with the other devices of the system 10, and a user interface (e.g., a display). The vehicle interface 350 may relay commands to an operator of the refuse vehicle 40. By way of example, the service manager 60 may provide a request for pickup to the vehicle interface 350. The request may include instructions for an operator to empty a centralized storage 32 of a particular refuse depot 30 and/or instructions for navigating to the refuse depot 30 (e.g., turn-by-turn instructions). Alternatively, the refuse vehicle 40 may be an autonomous vehicle, and the vehicle interface 350 may control operation (e.g., steering, propulsion, braking, movement of the lift assembly 340) autonomously according to instructions from the service manager 60.

Referring to FIG. 13B, the refuse vehicle 40 is shown according to an alternative embodiment. The refuse vehicle 40 of FIG. 13B may be substantially similar to the refuse vehicle 40 of FIG. 13A, except as otherwise specified herein. The refuse vehicle 40 of FIG. 13B is configured as a roll off dumpster truck that supports the centralized storage 32 on the frame 310. The lift assembly 340 of FIG. 13B includes a pair of structural segments, shown as arms 360. One arm 360 is pivotally coupled to the frame 310, and a second arm 360 is pivotally coupled to a distal end portion of the first arm 360. A pair of actuators (e.g., hydraulic cylinders), shown as lift actuators 362, control movement of the arms 360. A distal end of the second arm 360 includes an interface, shown as hook 364, that selectively engages an interface 366 of the centralized storage 32 to selectively couple the centralized storage 32 to the lift assembly 340.

In operation, the refuse vehicle 40 approaches the centralized storage 32, and the lift actuators 362 are operated to move the hook 364 into engagement with the interface 366. The lift actuators 362 then retract to raise the centralized storage onto the frame 310, such that the centralized storage 32 moves with the refuse vehicle 40. When interacting with the refuse depot 30, the refuse vehicle 40 may drop off an empty centralized storage 32 and pick up a centralized storage 32 that is filled with refuse. The refuse vehicle 40 may transport the filled centralized storage 32 to a refuse processing facility. In other embodiments, the refuse vehicle 40 otherwise engages and transports the centralized storage 32. By way of example, the centralized storage 32 may be mounted on a trailer, and the refuse vehicle 40 may engage the trailer such that the centralized storage 32 is trailed behind the frame 310.

### User Device

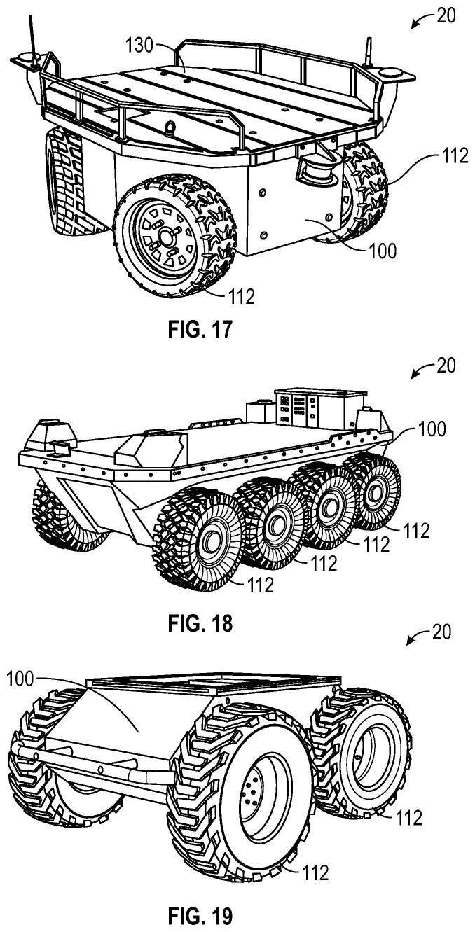

Referring to FIG. 14, the user device 50 is shown according to an exemplary embodiment. The user device 50 includes a controller 400 that controls operation of the user device 50. The controller 400 includes a processing circuit, shown as processor 402, and a memory device, shown as memory 404. The memory 404 may contain one or more instructions that, when executed by the processor 402, cause the controller 400 to perform the processes described herein. While some processes may be described as being performed by the controller 400, it should be understood that those processes may be performed by any other controller of the system 10 or distributed across multiple controllers of the system 10.

The user device 50 further includes a network interface, shown as communication interface 410, operatively coupled to the controller 400. The communication interface 410 is configured to transfer data between the user device 50 and other components of the system 10 (e.g., the refuse collection drones 20, the refuse depot 30, the refuse vehicle 40, other user devices 50, the service manager 60, the network 70, etc.). The communication interface 410 may facilitate wired and/or wireless communication.

The user device 50 further includes an input/output device, shown as user interface 420, operatively coupled to the controller 400. The user interface 420 facilitates communication between a user (e.g., a customer) and the user device 50. The user interface 420 may include one or more input devices (e.g., touchscreens, buttons, switches, microphones, keyboards, mice, etc.) that facilitate the user providing inputs (e.g., commands) to the user device 50. The user interface 420 may include one or more output devices (e.g., displays, speakers, haptic feedback devices, etc.) that facilitate providing information to the user. In some embodiments, the user interface 420 provides integration with a voice-based assistant. By way of example, the user interface 420 may permit a user to request a refuse collection or a status update regarding an in-progress refuse collection through a voice command. The user may initiate a request for refuse collection through the user interface 420. The user interface may provide information to a user such as a current location of a refuse collection drone 20, or billing information.

The user device 50 further includes one or more position, velocity, and/or acceleration sensors, shown as location sensor 430, operatively coupled to the controller 400. The location sensor 430 is configured to provide location data relating to the current location of the user device 50. By way of example, the location sensor 430 may include a global positioning system (GPS) that provides the current location of the user device 50 relative to the Earth. The location data may be used to determine a pickup location for the refuse collection drones 20. By way of example, a user may interact with the user interface 420 to request refuse collection at their current location. The user device 50 may use the location sensor 430 to determine the current location of the user device 50 and instruct a refuse collection drone 20 to travel to the current location.

### Service Manager

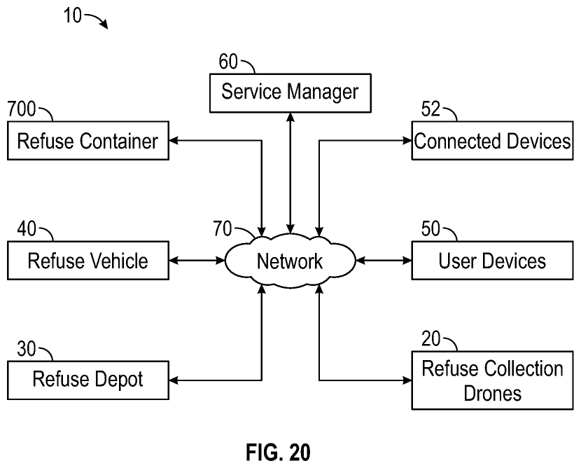

Referring to FIG. 15, the service manager 60 is shown according to an exemplary embodiment. The service manager 60 includes a controller 500 that controls operation of the service manager 60. The controller 500 includes a processing circuit, shown as processor 502, and a memory device, shown as memory 504. The memory 504 may contain one or more instructions that, when executed by the processor 502, cause the controller 500 to perform the processes described herein. While some processes may be described as being performed by the controller 500, it should be understood that those processes may be performed by any other controller of the system 10 or distributed across multiple controllers of the system 10.

The service manager 60 further includes a network interface, shown as communication interface 506, operatively coupled to the controller 500. The communication interface 506 is configured to transfer data between the service manager 60 and other components of the system 10 (e.g., the refuse collection drones 20, the refuse depot 30, the refuse vehicle 40, the user devices 50, the network 70, etc.). The communication interface 506 may facilitate wired and/or wireless communication.

The service manager 60 may receive various inputs (e.g., input data) and provide various outputs (e.g., output data) throughout operation. Specifically, the data is transferred between the service manager 60 and the other components of the system 10 through the communication interface 506. The data may be stored (e.g., temporarily or permanently) in the memory 504. The data may be transferred to other components of the system 10 or analyzed by the controller 500. By way of example, the service manager 60 may utilize multiple sources of data to generate new data that is utilized by the system 10. In some embodiments, the service manager 60 has greater processing capabilities than the other controllers of the system 10. Accordingly, it may be advantageous for certain complex calculations to be performed by the service manager 60. In some embodiments, the service manager 60 utilizes advanced calculation techniques, such as artificial intelligence, machine learning, neural networks, etc. The service manager 60 may utilize this enhanced processing ability along with all of the data available within the system 10 (e.g., the usage statistics 534) to continuously optimize operation of the system (e.g., minimizing customer wait times and energy usage, etc.).

### Drone and User Location

The memory 504 stores user location data 510 that indicates a location of one or more users (e.g., customers) or the location of one or more user devices 50. The user location data 510 may be generated by the location sensor 430 of a user device 50. By way of example, when initiating a request for refuse collection, the user device 50 may determine the current location of the user associated with the user device 50 (e.g., using the location sensor 430) and transfer the user location data 510 to the service manager 60. The user location data 510 may be updated periodically throughout the refuse collection process to ensure accuracy in the event that the user changes locations.

The memory 504 stores drone location data 512 that indicates the location of one or more refuse collection drones 20. The drone location data 512 may be generated by the location sensor 160 of a refuse collection drone 20 and periodically transferred to the service manager 60. The drone location data 512 may provide a real-time or periodic view into the current locations of the refuse collection drones 20. The drone location data 512 may facilitate navigation of the refuse collection drones 20 and determining which of the refuse collection drones 20 to assign to a particular route.

### Drone Status

The memory 504 stores drone status data 514 that indicates a current status of one or more refuse collection drones 20. The drone status data 514 may be generated by the controller 142 of a refuse collection drone 20, by the refuse depot 30, and/or by the service manager 60. In some embodiments, the drone status data 514 indicates a current assignment or task associated with a refuse collection drone 20. By way of example, the drone status data 514 may indicate if the refuse collection drone 20 is (a) on the way to a pickup zone to perform a refuse collection event, (b) being loaded with refuse by a customer, (c) returning from a pickup zone to the refuse depot 30, (d) being unloaded at the refuse depot 30, (e) idle at the refuse depot 30 and charging, or (f) idle at the refuse depot 30 and not charging. In some embodiments, the drone status data 514 indicates data measured by one or more sensors onboard the refuse collection drone 20, such as a current charge level of the batteries 120, an amount of refuse currently being carried by a refuse collection drone 20 (e.g., indicative of an available capacity of the refuse collection drone 20), a number of hours that the refuse collection drone 20 has operated (e.g., since the last time the refuse collection drone 20 was maintained, etc.), or other conditions.

In some embodiments, the drone status data 514 indicates if a refuse collection drone 20 has experienced an error or is likely to experience an error. Such an error may indicate that the refuse collection drone 20 is incapable of completing a current task without manual intervention by a user (e.g., maintenance, moving the refuse collection drone 20, removing an obstacle, etc.). The controller 142 may analyze data from the location sensor 160, the environment sensors 162, and/or the camera 166 to determine if an error has occurred or is likely to occur. By way of example, the controller 142 may determine that refuse collection drone 20 is currently immobilized (e.g., due to a loss of traction, a failure of a component, a lack of charge in the batteries 120, etc.). By way of another example, the controller 142 may determine a current path of the refuse collection drone 20 is obstructed by an obstacle.

### Collection Requests

The memory 504 may store refuse collection requests 520 from customers. The refuse collection requests 520 may originate in the user devices 50 and/or the connected devices 52. The refuse collection requests 520 may indicate an identity of the customer requesting the refuse collection, a desired location for the refuse collection (e.g., a location of the pickup zone), a desired timing of the refuse collection, a desired type or amount of refuse to be collected, or other information regarding the refuse collection. By way of example, the user device 50 may monitor the location of the customer through the location sensor 430, and set the current location of the customer as the pickup zone.

In some embodiments, user device 50 runs an application (e.g., a refuse collection hailing application) that facilitates generation of the refuse collection requests 520 by a customer. The application may be stored within the memory 404 of the user device 50. The application may control a display of the user interface 420 to provide a graphical user interface (GUI) that communicates information to the customer and/or receives commands from the customer. By way of example, the customer may interact with elements of the GUI through a touch screen of the user interface 420 to generate and/or modify the refuse collection request 520.

The customer may use the application to initiate a refuse collection request 520. The GUI may provide various options for the timing of the refuse collection (e.g., “as soon as possible,” “on my collection day,” “request a specific pickup time,” etc.). If a user selects “as soon as possible,” the service manager 60 may assign the refuse collection request 520 to the closest refuse collection drone 20 that is available. If the user selects “on my collection day” (e.g., indicating a predetermined, recurring day of the week or date) or “request a specific pickup time,” the service manager 60 may schedule a refuse collection drone 20 to arrive at the specified day and/or time. The GUI may also provide various options for selecting a desired location for the refuse collection (e.g., entering an address, based on the sensed location of the user device 50, etc.), a desired type of refuse to be collected (e.g., garbage, recycling, organics, etc.), an amount of refuse to be collected (e.g., a number of bags, specifying that a large item (e.g., furniture, yard waste, etc.) will be removed, etc.), or other information regarding the refuse collection.

Additionally or alternatively, the user device 50 may permit a customer to provide a refuse collection request 520 through a voice command. By way of example, the user device 50 may utilize a voice assistant (e.g., a voice-based virtual assistant) to interpret the voice commands. As used herein, the term “voice assistant” refers to any software and/or or hardware that interprets a vocal input as a command. The customer may provide the specific details refuse collection request 520 verbally. By way of example, the customer may state “please schedule a garbage pickup for this Thursday and a recurring recycling pickup on the first of each month at my home address.” The user device 50 and/or the service manager 60 may analyze this message and identify two separate refuse collection requests 520. The first request may indicate that garbage will be collected on the upcoming Thursday at a predetermined home location associated with the user. The second request may indicate that recyclables will be collected on the first day of each month from the predetermined home address.

The service manager 60 may use information from the refuse collection request 520 to determine the amount of refuse that will be collected (e.g., the refuse amount data 530) and/or the type of refuse that will be collected (e.g., the refuse type data 532). The customer may directly indicate the amount and/or type of refuse that will be collected. By way of example, the customer may indicate that they have three bags of garbage and one container (e.g., a standard-sized container) of recyclables that they would like to have collected. By way of another example, the customer may indicate that they would like to have an oversized object that they would like to have collected. Examples of potential oversized objects include furniture (e.g., couches, desks, mattresses, etc.), televisions, yard waste (e.g., tree limbs, bushes, large stones, etc.), construction waste (e.g., lumber, windows, doors, sinks, toilets, etc.), or other large objects. An oversized object may not fit within a standard size of refuse collection drone 20, and the service manager 60 may instead assign a specialized, larger refuse collection drone 20 for such a pickup. A refuse collection request 520 for an oversized item may include the dimensions of the oversized item to be collected.

### Customer Information

The memory 504 may store customer data 522 regarding or more customers (e.g., customer information). The customer data 522 may facilitate identifying the customer. The customer data 522 may indicate a name, demographic data (e.g., age, gender, etc.), a location of a preferred pickup zone (e.g., a home address, one or more commercial addresses, coordinates, etc.), payment/billing information (e.g., a bank account number, debit card number, or credit card number), or other information associated with the customer. The customer may provide the customer data 522 when initially signing up for the refuse collection service and/or update the customer data 522 through a user device 50 (i.e., the customer data 522 may be predetermined, prior to deployment of any refuse collection drones 20).

The customer may choose to have a pickup zone that varies based on their current location or the location of a user device 50 or a pickup zone at a fixed location (e.g., specified in the refuse collection request 520 or the customer data 522). If the customer chooses a variable pickup location, the user location data 510 may indicate the desired location of the pickup zone. If a user chooses a fixed location for the pickup zone, the desired location may be preselected by a user. By way of example, the user may indicate the desired location using an address or a coordinate. To provide an even greater degree of specificity, the user may indicate a certain feature at the address or coordinate that defines the desired location. By way of example, the desired location may be defined at or near a specific door (e.g., a front door, back door, a garage door, etc.), an end of a driveway, an end of a sidewalk, or another feature. In some embodiments, the feature that defines the desired location is common for multiple different customers. By way of example, a homeowner's association may designate the locations of the pickup zones for a neighborhood or building complex.

### Refuse Type and Amount Data

The memory 504 may store refuse amount data 530 indicating the amount (e.g., weight, volume, etc.) of refuse collected by the system 10. The refuse amount data 530 may be provided by the refuse collection drones 20 (e.g., as determined using the weight sensors 164), by the refuse depots 30 (e.g., as determined using the weight sensors 260), or by the refuse collection requests 520 (e.g., directly or determined based information contained within the refuse collection requests 520). The refuse amount data 530 may be associated with a particular refuse collection event and/or with a particular customer. By way of example, the refuse amount data 530 may indicate that 50 lbs of refuse was collected from Customer A at date/time B from a pickup zone at location C.

The memory 504 may store refuse type data 532 indicating the type (e.g., garbage, recyclables, organics, compostables, etc.) of refuse collected by the system 10. The refuse type data 532 may be provided by the refuse collection drones 20 (e.g., as determined using the cameras 166), and/or by the refuse depots 30 (e.g., as determined using the cameras 262), and/or by the refuse collection requests 520 (e.g., directly or determined based information contained within the refuse collection requests 520). The refuse type data 532 may be associated with a particular refuse collection event and/or with a particular customer. By way of example, the refuse amount data 530 may indicate that recyclable refuse was collected from Customer A at date/time B from a pickup zone at location C. The refuse amount data 530 and the refuse type data 532 may be used together to fully describe a particular refuse collection event.

### System Usage

Utilizing the refuse collection requests 520, the refuse amount data 530, the refuse type data 532, and the customer data 522, the service manager 60 may generate and store usage statistics 534 in the memory 504. The usage statistics 534 may provide a representation of the operation of the system 10 and how the system 10 is being used. The usage statistics 534 indicate how the system 10 is being utilized by particular individuals or groups of individuals. The usage statistics 534 may indicate the amount and type of refuse being collected and how those values vary over time. The usage statistics 534 may be broken down by individual customers, neighborhoods, townships, cities, states, countries, or other regions.

The usage statistics 534 may provide insights to governmental entities, to the company operating the system 10, to individual customers, or to other entities. The usage statistics 534 may indicate the relative amounts of each type of refuse being collected (e.g., 20% recyclables, 80% non-recyclables, etc.). The usage statistics 534 may indicate certain individuals, groups of individuals, or regions that are producing above or below the average amount of refuse. The usage statistics 534 may indicate trends over time (e.g., cyclical or annual trends, long-term trends, etc.). By way of example, the usage statistics 534 may indicate greater amounts of refuse are collected during certain parts of the year (e.g., more refuse being collected during the holiday months, more compostable refuse being collected in the spring than during the winter, etc.). By way of example, the usage statistics 534 may indicate that certain individuals or regions are producing more or less refuse over time.

The service manager 60 may provide the usage statistics 534 for presentation to users (e.g., customers) or entities (e.g., the company operating the system 10, a governmental entity, etc.). By way of example, an entity may query the service manager 60 to provide a particular set of usage statistics 534 (e.g., usage statistics 534 associated with a particular customer or region for a particular time period). A customer or entity may act on the usage statistics 534. By way of example, a governmental entity may utilize the usage statistics 534 to further sustainability efforts. The usage statistics 534 may identify regions having undesirable refuse production habits (e.g., that are producing large amounts of refuse or that are recycling only a small portion of their produced refuse) and concentrate sustainability efforts on those regions (e.g., by concentrating funding on programs to improve the refuse production habits of those regions).

In some embodiments, the service manager 60 generates and provides instructions or recommendations based on the usage statistics 534. By way of example, the service manager 60 may provide recommendations to a customer or group of customers (e.g., customers within a particular region) that are intended to improve their refuse production habits (e.g., by produce less refuse or recycling a larger portion of their refuse). The service manager 60 may assign penalties or incentives to facilitate enforcement of those recommendations. By way of example, the service manager 60 may assign additional fees for customers with undesirable refuse habits. By way of another example, the service manager 60 may assign billing credits (i.e., a reduction in billed fees) for customers with desirable refuse habits.

### Dynamic Resource Assignment

The service manager 60 may adjust the number of refuse collection drones 20, refuse depots 30, and/or refuse vehicles 40 assigned to a particular region based on usage statistics 534. In some embodiments, the refuse collection drones 20, the refuse depots 30, and/or the refuse vehicles 40 are placed in the desired region by another vehicle. Alternatively, the refuse collection drones 20 and/or the refuse vehicles 40 may move themselves to the desired region. By way of example, the service manager 60 may command the refuse collection drones 20 to move from a first area that is predicted to have a reduced refuse production to a second area that is predicted to have an increased refuse production. By way of another example, if the usage statistics 534 indicate that a region will have an overall increase in refuse production, more refuse collection drones 20, refuse depots 30, and/or refuse vehicles 40 may be added to the system 10 within that region. By adjusting the number of refuse collection drones 20, refuse depots 30, and/or refuse vehicles 40 to suit changes in demand within a particular region (e.g., predicted by the usage statistics 534), the system 10 can ensure that an appropriate number of refuse vehicles 40 will be available to service the demand of that region.

In some embodiments, the system 10 includes multiple refuse depots 30 within range of a given refuse collection drone 20 (i.e., a refuse collection drone 20 is capable of navigating to multiple different refuse depots 30 under its own power). In some embodiments, each refuse collection drone 20 is assigned to a particular refuse depot 30, such that the refuse collection drone 20 consistently returns to a given refuse depot 30. In other embodiments, the service manager 60 may instruct a refuse collection drone 20 to begin from a first refuse depot 30 and return to a second refuse depot 30. The service manager 60 may reassign a refuse collection drone 20 to a different refuse depot 30 based on the refuse amount data 530. By way of example, the service manager 60 may reassign a refuse collection drone 20 to the second refuse depot 30 in response to an indication that the centralized storage 32 of the first refuse depot 30 has exceeded a threshold fill level. The service manager 60 may reassign a refuse collection drone 20 to a different refuse depot 30 based on the number of available charging stations 34. By way of example, the service manager 60 may reassign a refuse collection drone 20 to the second refuse depot 30 in response to a determination that none of the charging stations 34 of the first refuse depot 30 are available.

### Customer Billing

Referring still to FIG. 15, the service manager 60 is configured to generate billing data 540 and store the billing data 540 in the memory 504. The billing data 540 indicates the amount owed by each customer in exchange for services provided by the system 10 or services to be provided by the system 10 in the future. The service manager 60 may utilize any of the data generated by the service manager 60 to generate the billing data 540. By dynamically adjusting pricing, the service manager 60 may be able to facilitate or discourage demand and maintain a consistent usage of the system 10. The service manager 60 may also adjust pricing to account for the usage level of each specific customer (e.g., as opposed to charging a flat rate per month regardless of usage).

The user devices 50 may inform the customer of a projected cost of a collection event in advance. By way of example, the user device 50 may display the projected cost on a user interface 420 as part of the process for requesting a refuse collection event. The user device 50 may also display any factors affecting the projected cost, such as the current demand and/or the type of refuse that is being collected. The customer may be required to accept the projected cost prior to initiating the collection event.

The billing data 540 may be generated based on the refuse collection requests 520. By way of example, the service manager 60 may charge based on the number of refuse collection events requested by the customer. The service manager 60 may charge a flat fee for each request. The service manager 60 may provide a discount for a threshold number of collection events within a given period of time (e.g., monthly, weekly, etc.).

The service manager 60 may charge based on the date and/or time of refuse collection events requested by the customer. By way of example, the service manager 60 may charge more for refuse collection events occurring during days or times of elevated demand, or the service manager 60 may offer discounts for collection events occurring during times of low demand. The periods of elevated demand or low demand may be static and predetermined. Elevated demand periods may include time periods surrounding holidays (e.g., Christmas, New Years, etc.), weekends, mornings (e.g., 7:00 AM to 10:00 AM), and evenings (e.g., 5:00 PM to 10:00 PM). Low demand periods may include weekdays, midday (e.g., 10:00 AM to 5:00 PM), or nights (e.g., 10:00 PM to 7:00 AM). In some embodiments, the elevated demand periods and low demand periods may be determined based on the usage statistics 534. For example, the service manager 60 may monitor the demand for a test period (e.g., a month, a year, etc.) and set the elevated demands periods and/or low demand periods based on the demand throughout of the test period.

The billing data 540 may be generated based on the drone status data 514. By way of example, the service manager 60 may utilize the drone status data 514 to provide dynamic pricing based on the current demand of the system 10. The service manager 60 may determine how many of the refuse collection drones 20 are currently in use or otherwise unavailable to respond to customer requests (e.g., traveling to a customer, filled with refuse, containing a package, etc.). As the number of unavailable refuse collection drones 20 increases (i.e., as the number of available refuse collection drones 20 decreases), the service manager 60 may increase the projected cost of the refuse collection event.

The billing data 540 may be generated based on the refuse amount data 530 and/or the refuse type data 532. The service manager 60 may charge more for collecting greater amounts of refuse. By way of example, the service manager 60 may charge per unit weight of refuse collected (e.g., based on the weight sensed by the weight sensor 164). By way of another example, the service manager 60 may utilize the refuse collection request 520 to determine a size of refuse collection drone 20 that is required to fulfil the refuse collection request. The system 10 may implement a surcharge (i.e., increase pricing) for larger refuse collection drones 20. The service manager 60 may adjust pricing based on the type of refuse being collected. The serve manager 60 may charge a predetermined rate (e.g., $20 per collection, $0.50 per pound, etc.) for each type of refuse (e.g., non-recyclables, compostables, recyclables, etc.). The service manager 60 may charge an additional fee for collecting oversized items (e.g., as indicated by the customer or by an inability to close the cover 170). The service manager 60 may provide billing credits for certain types of refuse (e.g., materials having a scrap value).

The service manager 60 may communicate the billing data 540 to the associated customer through the user device 50. By way of example, the service manager 60 may communicate the billing data 540 as an email, a notification on an application, a text message, or another type of communication. Alternatively, the service manager 60 may communicate the billing data 540 to the associated customer through a paper bill.

### Drone Selection and Path Generation

The service manager 60 may generate path data or navigation instructions, shown as drone routes 550, for the refuse collection drones 20 to use to navigate between the refuse depots 30 and the pickup zones of the customers. By way of example, in response to receiving a refuse collection request 520, the service manager 60 may begin generating a drone route 550. The service manager 60 may review the drone status data 514 to identify refuse collection drones 20 that are eligible to complete the refuse collection event. Refuse collection drones 20 may be considered ineligible if the refuse collection drone 20 is currently experiencing an error. In some embodiments, a refuse collection drone 20 is considered to be ineligible if the refuse collection drone 20 is in the process of navigating back to the refuse depot 30 after executing another refuse collection event or being emptied by the refuse depot 30.

The service manager 60 may utilize the user location data 510, the refuse collection request 520, and the drone location data 512 to select an eligible refuse collection drone 20 for completing the refuse collection event. The service manager 60 may attempt to select the refuse collection drone 20 that is capable of arriving at the pickup zone most quickly. By way of example, the service manager 60 may estimate an amount of time that will be required for each refuse collection drone 20 based on a distance between the refuse collection drone 20 and the pickup zone indicated by the user location data 510 and/or the refuse collection request 520. If the refuse collection drone 20 is currently in the process of returning refuse to the refuse depot 30, the service manager 60 may adjust the estimated arrival time of the refuse collection drone 20 accordingly.

Additionally or alternatively, the service manager 60 may use the refuse amount data 530, the refuse type data 532, and/or the usage statistics 534 to select an eligible refuse collection drone 20 for completing the refuse collection event. By way of example, using refuse amount data 530 provided by the customer in advance of the refuse collection event and/or historical usage statistics 534, the service manager 60 may predict the amount of refuse that will need to be collected during a refuse collection event. Using the drone status data 514, the service manager 60 may determine which refuse collection drones 20 have sufficient available capacity to retrieve the predicted amount of refuse, and thus are eligible for completing the refuse collection event. By way of example, certain refuse collection drones 20 may be designated for collecting only certain types of refuse (e.g., non-recyclables, recyclables, organics, oversized items, etc.). Using the refuse type data 532, the service manager 60 may determine which refuse collection drones 20 are eligible for collecting the type of refuse associated with a given refuse collection event.

Certain users may wish to dispose of items securely, such that their refuse is not accessible to other users. By way of example, a first customer may wish to avoid a situation in which they deposit their refuse in the storage volume 132, and a second customer subsequently accesses the storage volume 132 to deposit additional refuse while the first customer's refuse remains in the storage volume 132. To accommodate such users, the system 10 may permit a user to submit a privacy request (e.g., as part of the initial refuse collection request 520) indicating that their refuse should not be accessible to other customers. In response to a privacy request, the service manager 60 may determine that the corresponding refuse collection drone 20 is ineligible for future refuse collection events until the storage volume 132 has been emptied. The billing data 540 may include a surcharge in response to a privacy request.

Additionally or alternatively, the service manager 60 may use the drone status data 514 to optimize charge levels of the refuse collection drones 20 when selecting an eligible refuse collection drone 20. Each of the refuse collection drones 20 may have an associated charge level indicating a state of charge of the corresponding batteries 120. It may be desirable to utilize the refuse collection drones 20 in such a way as to ensure that the charge levels of the refuse collection drones 20 are sufficient to complete the planned routes. By way of example, the service manager 60 may estimate a distance that each refuse collection drone 20 is able to travel based on the current charge level. The service manager 60 may avoid selecting a refuse collection drone 20 whose charge level is insufficient to complete the planned route. By way of another example, the service manager 60 may weigh the selection to prefer using refuse collection drones 20 having higher charge levels. This may avoid a situation where refuse collection drones 20 having higher charge levels sit idly on the charging stations 34 while refuse collection drones 20 having lower charge levels are further depleted. When selecting a refuse collection drone 20 for a particular refuse collection event, the service manager 60 may balance the desire to have the refuse collection drone 20 arrive at the pickup zone quickly with the desire to balance the charge levels of the refuse collection drones 20 (i.e., the refuse collection drone 20 may be selected based on a charge level of the batteries 120 and a current location of the refuse collection drone 20).

Once the service manager 60 has selected a refuse collection drone 20, the service manager 60 may generate a drone route 550. Specifically, the service manager 60 may utilize map data to determine the fastest route between the current location of the refuse collection drone 20 (e.g., as indicated by the drone location data 512) and the pickup zone (e.g., as indicated by the user location data 510 and/or the refuse collection request 520). The map data may be predetermined and stored in the memory 504. Once the drone route 550 is determined, the service manager 60 may communicate the drone route 550 to the selected refuse collection drone 20.

The service manager 60 may adjust the drone route 550 to avoid known obstructions (e.g., as determined using the environment data of the refuse collection drones 20). The service manager 60 may adjust the drone route 550 based on changes in the location of the pickup zone. By way of example, the service manager 60 adjust the drone route 550 based on a user request through the user device 50, or based a change in the user location data 510. The service manager 60 may communicate any updates in the drone route 550 to the selected refuse collection drone 20.

While a refuse collection drone 20 navigates a drone route 550, the service manager 60 may command a user device 50 to provide status updates to the customer. Such status updates may include a current location of the collection drone 20 and an estimated time of arrival at the pickup zone. This information may be displayed on a screen of the user device 50 as a map.

The service manager 60 may generate path data or navigation instructions, shown as refuse vehicle routes 552, for the refuse vehicles 40 to use to navigate between the refuse depots 30. A refuse vehicle route 552 may include a fully formed path (e.g., turn-by-turn directions) for the refuse vehicle 40 to follow. Alternatively, a refuse vehicle route 552 may include a request for a refuse vehicle 40 to arrive at a particular refuse depot 30. The refuse vehicle routes 552 may include instructions that are followed by an operator of the refuse vehicle 40. Alternatively, the refuse vehicle routes 552 may include instructions that are followed by an autonomous control system of the refuse vehicle 40.

The service manager 60 may generate the refuse vehicle routes 552 based on the demands of the refuse depots 30 (e.g., the fill levels of the centralized storages 32). By way of example, the service manager 60 may utilize the refuse amount data 530 to determine the fill level of each centralized storage 32 of each refuse depot 30. The service manager 60 may determine that a refuse vehicle 40 should travel to and empty a particular refuse depot 30 when the fill level of a centralized storage 32 at the refuse depot 30 exceeds a threshold fill level. Alternatively, the service manager 60 may predict when a refuse depot 30 should be emptied by a refuse vehicle 40 based on the usage statistics 534. The usage statistics 534 may indicate how much refuse that a refuse depot 30 is predicted to receive (e.g., based on historical trends within a particular region).

### Manual Intervention Requests

Referring to FIG. 15, the service manager 60 generates manual intervention requests 560 requesting for a user to perform a manual intervention. The manual intervention request 560 may cause the system 10 to provide instructions for one or more users to complete the manual intervention. The instructions may be provided by the customer display 168 of a refuse collection drone 20, a vehicle interface 350 of a refuse vehicle 40, a user interface 420 of a user device 50, and/or another user interface.

The service manager 60 may generate the manual intervention requests 560 based on the drone status data 514. Specifically, the service manager 60 may generate the manual intervention requests 560 in response to the drone status data 514 indicating that a refuse collection drone 20 has experienced an error or is likely to experience an error requiring manual intervention. Such errors may immobilize the refuse collection drone 20 or otherwise prevent the refuse collection drone 20 from completing an assigned task.

The manual intervention requests 560 may include instructions for one or more users that are intended to address the error. By way of example, the instructions may instruct the user to perform maintenance on the refuse collection drone 20 (e.g., replacing a component, lubricating a component, etc.). By way of another example, the instructions may instruct the user to charge the batteries 120 of the refuse collection drone 20. By way of another example, the instructions may instruct the user to reposition the refuse collection drone 20 back onto a path, such that the refuse collection drone 20 regains sufficient traction to travel. By way of another example, the instructions may instruct the user to remove an obstacle. In response to receiving the manual intervention request 560, the user may comply with the request (e.g., by performing maintenance, by removing an obstacle, etc.) or by adjusting the operating instructions of the refuse collection drone 20 (e.g., by designating a new drone route, by designating a new pickup zone, by canceling the request for refuse collection, etc.).

The manual intervention requests 560 may be transmitted to a customer (e.g., through a user device 50). By way of example, a manual intervention request 560 may provide instructions to a customer instructing the customer to clear an obstacle preventing the refuse collection drone 20 from reaching the pickup zone of the customer. In one such example, the manual intervention request 560 includes a text-based instruction stating “a vehicle is preventing us from accessing your designated pickup zone. Please move the vehicle or designate a new pickup zone.” The manual intervention request 560 may also include an image of the obstacle obstructing the path of the refuse collection drone 20 (e.g., captured by the environment sensors 162).

The manual intervention requests 560 may be transmitted to personnel (e.g., operators, maintenance technicians, etc.) associated with the system 10. By way of example, the service manager 60 may provide a maintenance request to a technician outlining an identifier (e.g., a serial number) identifying the refuse collection drone 20, the current location of the refuse collection drone 20, the maintenance to be performed, and the components required to perform the maintenance. By way of another example, the service manager 60 may provide a request to an operator to move the refuse collection drone 20 back to a path. The request may include an identifier identifying the refuse collection drone 20, the current location of the refuse collection drone 20, and a location of the closest portion of the drone path where the refuse collection drone 20 should be returned.

Additionally or alternatively, the manual intervention request 560 may provide instructions for a customer to complete a refuse collection event. The instructions may be presented by a user device 50 associated with the customer and/or by a customer display 168 on the refuse collection drone 20. By way of example, the instructions may request for the customer to place refuse within the storage volume 132. The instructions may instruct the customer of what type of refuse is to be collected (e.g., the customer display 168 may indicate “non-recyclable trash only” or “recyclables only” or “compostables only,” etc.). The instructions may request for the customer to close the cover 170.

If the customer does not comply with the instructions of the manual intervention request 560 in a predetermined timeframe, the system 10 may take various remedial actions. By way of example, the timeframe may be based on the time elapsed from sending the original instructions, based on the time elapsed from when the refuse collection drone 20 arrived at the pickup zone PZ, etc. The remedial actions may include a notification (e.g., visual, audible, haptic, etc.). The remedial actions may include control of the refuse collection drone 20 (e.g., movement of the refuse collection drone 20). The remedial actions may include changes to the billing data 540 (e.g., charging the customer a fine, removing the charge for refuse collection, etc.). In one non-limiting example, the service manager 60 begins a timer when a refuse collection drone 20 arrives in a PZ associated with a customer and instructs the customer to load refuse into the storage volume 132. After the timer reaches a first threshold without a manual intervention, the user device 50 provides a first notification to the customer (e.g., a push notification reminder). After the timer reaches a second threshold without a manual intervention, the refuse collection drone 20 provides a second notification to the customer (e.g., an audible alarm, such as a voice command indicating “you have 5 minutes left to deposit your trash”). After the timer reaches a third threshold without a manual intervention, the refuse collection drone 20 may return to the refuse depot 30, and the service manger 60 may charge the customer a fine or penalty for missing the scheduled collection in the billing data 540.

### System Response to Weather and Traffic

Referring to FIG. 15, the service manager 60 manages operation of the system 10 based on weather data 570. The weather data 570 may include information regarding past, present, or predicted weather conditions or other environmental conditions in an area associated with the system 10. By way of example, the weather data 570 may include winds, rainfall, snowfall, lightning, natural disasters or other emergencies (e.g., fires, tornadoes, etc.). The system 10 may generate the weather data 570. By way of example, the refuse collection drones 20, the refuse depots 30, the refuse vehicles 40, and/or the user devices 50 may include sensors (e.g., temperature sensors, pressure sensors, humidity sensors, wind sensors, etc.) that provide the weather data. By way of another example, the service manager 60 may retrieve the weather data 570 from an external source(s) (e.g., a third party weather forecast provider) through the network 70.

Using the weather data 570, the service manager 60 may identify an obstructive event (e.g., a weather event, a natural disaster, etc.) that would hinder movement of the refuse collection drones 20 and/or potentially cause damage to the refuse collection drones 20. The service manager 60 may identify an obstructive event in progress or predict a future obstructive event. By way of example, the obstructive event may be a large snowfall that would hinder movement of the refuse collection drones 20 along a road or path. By way of another example, the obstructive event may be a wildfire, tornado, hurricane, or other natural disaster that could potentially cause damage to the refuse collection drones 20. The service manager 60 may associate the obstructive event with a location or area.

Similarly, the service manager 60 may manage operation of the system 10 based on traffic data 572. The traffic data 572 may include information regarding past, present, or predicted traffic conditions in an area associated with the system 10. By way of example, the traffic data 572 may include traffic flow, road closures, traffic accidents, etc. The system 10 may generate the traffic data 572. By way of example, the refuse collection drones 20, the refuse vehicles 40, and/or the user devices 50 may include sensors (e.g., cameras, vehicle speed sensors, accelerometers, etc.) that provide data indicating the current travel speeds of vehicles in certain locations. By way of another example, the service manager 60 may retrieve the traffic data 572 (e.g., as third party data 580) from an external sources (e.g., a third party traffic data providers) through the network 70.

Using the traffic data 572, the service manager 60 may identify an obstructive event (e.g., an accident, a road closure, a slowdown, etc.) that would hinder movement of the refuse collection drones 20 and/or potentially cause damage to the refuse collection drones 20. The service manager 60 may identify an obstructive event in progress or predict a future obstructive event. The service manager 60 may associate the obstructive vent with a location or area.

Upon identifying an obstructive event in proximity to a refuse collection drone 20, the service manager 60 may seek to minimize exposure of that refuse collection drone 20 to that obstructive event. The service manager 60 may command the refuse collection drone 20 to seek an area of shelter from the obstructive event. By way of example, the refuse collection drone 20 may navigate to a refuse depot 30 and/or a charging station 34. By way of another example, the refuse collection drone 20 may navigate to a garage or an overpass. Once the refuse collection drone 20 has reached the area of shelter, the refuse collection drone 20 may remain there (e.g., in a locked-down mode or hibernation state) until the obstructive event has passed. The service manager 60 may adjust scheduling of refuse collection events to accommodate the disruption caused by the inactivity of the refuse collection drone 20. By way of another example, the service manager 60 may adjust the drone routes 550 to avoid traffic slowdowns, road closures, or accidents.

### Third Party Integration

Referring to FIG. 15, the service manager 60 manages operation of the system 10 based on third party data 580. The service manager 60 may communicate with one or more third party service providers to receive the third party data 580 and/or provide data to the third party service providers. By way of example, the third party data 580 may be provided by ecommerce platforms that permit online purchase of products. By way of another example, the third party data 580 may be provided by productivity software suites that provide email, calendar, and messaging services. By way of another example, the third party service provider may be a weather tracking and prediction service that provides the weather data 570.

In some embodiments, the third party data 580 is specific to a given customer. To enable direct communication between the service manager 60 and the third party service providers, the customer may provide the service manager 60 with login credentials (e.g., usernames, passwords, two factor authentication codes, etc.). The service manager 60 may utilize the login credentials to authenticate a connection between the service manager 60 and the third party service providers.

In some embodiments, the third party data 580 includes data related to purchases made by the customer. By way of example, the third party data 580 may indicate what products were purchased and how many products were purchased. By way of another example, the third party data 580 may indicate a size of product purchased. By way of another example, the third party data 580 may indicate a type of packaging of the product purchased (e.g., cardboard, a wooden pallet, packing pellets, plastic wrap, etc.). By way of another example, the third party data 580 may include tracking data for any shipments (e.g., when the product is expected to arrive). By way of another example the third party data 580 may include any requested product returns.

In some embodiments, the third party data 580 includes data related to a customer's personal data (e.g., retrieved from a productivity suite). By way of example, the third party data 580 may include the customer's calendar or schedule (e.g., meetings, appointments, vacations, when they are expected to return home or leave, etc.). By way of another example, the third party data 580 may include the customer's emails or messages (e.g., indicating potential scheduled events or purchases, etc.).

In some embodiments, the third party data 580 include advertisements (e.g., for products or services). The system 10 may display the advertisements on the user device 50 (e.g., through an application) and/or on the customer display 168 of a refuse collection drone. In some embodiments, the advertisements include targeting parameters that indicate where, when, and/or to whom the advertisements should be presented. By way of example, the third party data 580 may indicate specific customers to whom the advertisements should be targeted, and the service manager 60 targets those advertisements to user devices 50 and refuse collection drones 20 associated with those customers. By way of another example, the third party data 580 may indicate a time period when the advertisements should be presented, and the service manager 60 controls user devices 50 and refuse collection drones 20 to provide the advertisements within the requested time period. By way of another example, the third party data 580 may indicate a range of locations (e.g., a geofenced area) where the advertisements should be presented, and the service manager 60 controls user devices 50 and refuse collection drones 20 to provide the advertisements within the requested range of locations.

### Refuse Collection Prompts

In some embodiments, the service manager 60 is configured to monitor for one or more conditions that may be indicative of a customer requiring a refuse collection. In response to identifying such a condition, the service manager 60 may control the user device 50 associated with the customer to provide a notification or prompt. The prompts may ask if a refuse collection event is desired and permit the user to schedule a desired refuse collection event.

In some embodiments, the prompts are provided to the customer at predetermined intervals (e.g., weekly, biweekly, monthly, etc.). The interval may be selected by the user when initially creating their account with the system 10. Alternatively, the interval may be determined by the provider of the system 10. If a user does not desire a refuse collection event at the time of the prompt, the user may select a period of time to snooze the prompt.

In some embodiments, the service manager 60 learns the routine of the customer and provides prompts based on a customer's predicted desire for a refuse collection event. By way of example, the service manager 60 may conduct an observational period (e.g., a month, a year, continuously ongoing, etc.) for each new customer, during which the service manager 60 monitors and stores the refuse collection requests 520 for the customer (e.g., historical refuse collection requests). The service manager 60 may determine the average period of time between each refuse collection requests 520 and utilize that as the interval between prompts. Additionally, or alternatively, the service manager 60 may monitor for patterns corresponding to the refuse collection requests 520 and predict when the customer will desire refuse collection in the future. By way of example, the service manager 60 may determine that the customer is likely to request refuse collection more often during certain time periods (e.g., at certain times of day, certain days of the week, during certain seasons, after certain holidays, etc.). By way of another example, the service manager 60 may determine that the customer is likely to request refuse collection after certain weather patterns (e.g., storms with winds above a threshold speed, storms that produce above a threshold amount of precipitation, etc.). Based on the historical refuse collection requests 520 for that customer and current conditions (e.g., current date and time, current weather data 570, etc.), the service manager 60 may determine that a customer is likely to desire a refuse collection event and, in response to such a determination, provide a prompt to the customer.

In some embodiments, the service manager 60 provides prompts based on the third party data 580. The service manager 60 may utilize the third party data 580 to determine when a package has been delivered. In response to a determination that a package has been delivered, the service manager 60 may subsequently issue a prompt asking if the customer desires a refuse collection event to dispose of the packaging from the package. The service manager 60 may delay the prompt for a waiting period after the delivery of the package to permit the customer to open the package.

In some embodiments, the service manager 60 utilizes the third party data 580 (e.g., calendar) to determine the customer's schedule. The service manager 60 may analyze the customer's schedule to determine identify a period of time when the customer is more likely to desire a refuse collection event. By way of example, the service manager 60 may predict that the customer is likely to desire a refuse collection event when the customer's schedule indicates that they are likely to be home (e.g., on weekends, evenings, days indicated as being company-wide holidays in the customer's work calendar, etc.). The service manager 60 may provide a prompt to the customer in response to such a prediction. The service manager 60 may determine that a prompt should not be provided when the customer's schedule indicates that they are unlikely to be home (e.g., when the customer is scheduled to be on vacation, flights, appointments, etc.).

In some embodiments, the service manager 60 utilizes data from the connected devices 52 to predict when a customer is likely to desire a refuse collection event. In some embodiments, the service manager 60 utilizes data from the connected devices 52 to determine when the customer is present in their home. By way of example, an activation of a garage door opener, a light, a motion detector, or a door lock may indicate that customer is home. In response to an indication that the customer is present in their home, the service manager 60 may determine that the customer is more likely to desire a refuse collection event. In some embodiments, one of the connected device 52 is a refuse bin. The refuse bin includes a sensor that monitors a fill level of the refuse bin. In response to the fill level exceeding a threshold fill level, the connected device 52 may provide a signal to the service manager 60 indicating that the customer will soon require a refuse collection event. In response to receiving the signal, the service manager 60 may provide a prompt to the customer.

In some embodiments, the service manager 60 monitors the location of the customer directly. By way of example, the service manager 60 may utilize sensor data from the location sensor 430 of a user device 50 carried by the customer to determine the location of the customer. The service manager 60 may determine that the customer is more likely to desire a refuse collection event when the customer is within a threshold distance of their home. By way of example, the service manager 60 may establish a geofence around the customer's home, and the service manager 60 may provide a prompt to the customer when the user device 50 enters the geofence.

### Package Delivery

In some embodiments, the refuse collection drones 20 are configured to transport cargo (e.g., packages, goods, letters, etc.) to customers. The system 10 may serve as the final leg of a delivery process, receiving bulk packages from another delivery service (e.g., a postal service or ecommerce platform) and distributing the packages to customers within a community. By utilizing the system 10, the delivery service may reduce the number of stops required to deliver to the community. Additionally, the customers within the community gain the benefit of secure, on demand delivery. The refuse collection drones 20 may additionally retrieve cargo from customers and transport that cargo to a point for pickup by a delivery service.

Referring to FIGS. 8 and 15, in operation the delivery service may deposit one or more packages PKG for delivery into the package storage 36. The delivery service may communicate with the service manager 60 to indicate that the packages PKG have been deposited. In some embodiments, the delivery service may provide package identifier data indicating the destination of each package PKG (e.g., a destination address, an intended recipient, etc.). This package identifier data may be provided as part of the third party data 580 (e.g., the third party may be a delivery service). Alternatively, the service manager 60 may retrieve the package identifier data from image data provided by the cameras 262. By way of example, the package identifier data may be extracted from an image of a barcode or a text-based address. Using the package identifier data, the service manager 60 may identify a customer associated with a destination of the package.

Upon determining that there is a package PKG designated for delivery to a customer, the service manager 60 may provide a notification to the customer (e.g., through their corresponding user device 50). The notification may provide the customer with an option to schedule a delivery time (e.g., at 8:00 PM, as soon as possible, etc.). Based on the customer's response to the notification, the service manager 60 may schedule a delivery at an appropriate time.

To prepare for the delivery, the service manager 60 may select an available refuse collection drone 20. To prepare the refuse collection drone 20 for the delivery, the service manager 60 may utilize the washout system 264 to remove any debris or residue left in the storage compartment 132 from transporting refuse. Specifically, the service manager 60 may command the refuse collection drone 20 into a position accessible by the washout system 264. The service manager 60 may automatically control the operation of the washout system 264 and the movement of the refuse collection drone 20 in tandem to ensure that the entirety of the storage compartment 132 is cleaned. In some embodiments, the camera 262 and/or the camera 166 is utilized to verify that the storage compartment 132 has been cleaned. If debris is detected by the cameras, the cleaning process may be repeated.

After the storage compartment 132 is cleaned, the service manager 60 may control the refuse collection drone 20 to move into a position nearby the package storage 36. The cover 170 may be moved to the open position (e.g., by the cover actuator 174). The identified package PKG may be removed from the package storage 36 and placed into the storage volume 132. In some embodiments, the package PKG is removed from the package storage 36 by the refuse interface 230. In other embodiments, the refuse depot 30 includes a secondary package interface that engages and moves the package PKG into the storage volume 132. After the package PKG has been placed into the storage volume 132 (e.g., as verified by the weight sensor 164), the cover 170 is closed, and the lock 176 is engaged.

The service manager 60 provides a drone route 550 for the refuse collection drone 20 to navigate to a pickup zone PZ associated with the customer for which the package PKG is destined. As the refuse collection drone 20 approaches the pickup zone PZ, a notification may be provided to the customer (e.g., through an associated user device 50). The lock 176 is disengaged, the cover 170 is opened, and the customer removes the package PKG.

### Snow Removal

During operation, a customer may request snow removal from the system 10. In some embodiments, the request is provided through a user device 50 associated with the customer. The service manager 60 may periodically review the weather data 570. Based on the weather data 570, the service manager 60 may determine an amount of snowfall in an area nearby the customer. In response to a determination that greater than a threshold amount of snowfall has occurred or is predicted to occur, the service manager 60 may provide a notification prompting the user to request snow removal.

A request for snow removal may include a definition of an area where the snow removal is desired. The area may be predefined by the customer (e.g., when setting up the system 10) or at the time of the request. By way of example, a user may indicate “please remove snow from my driveway,” as part of the request. Using data from the environment sensors 162, the controller 142 may determine the boundaries of the area where the snow removal is requested. By way of another example, a customer may be provided with a screen illustrating a plan view of their home, and the user may highlight the areas where snow removal is desired.

In some embodiments, the plow 190 or other snow removal element is removably coupled to the 100 of the refuse collection drone 20. In such an embodiment, the plow 190 may be stored at the refuse depot 30 or another location and coupled to the chassis 100 when snow removal is desired. The service manager 60 may store the storage location of the plow 190 in a memory. In response to a request for snow removal, the service manager 60 may control a refuse collection drone 20 to move to the storage location of the plow 190. The refuse collection drone 20 may include an interface (e.g., a latch, a clutch, a magnet, etc.) that is selectively engaged to couple the plow 190 to the chassis 100. In some embodiments, the refuse collection drone 20 is capable of engaging with the plow 190 without human intervention.

In response to the request for snow removal, the system manager 60 may generate a drone route 550 that causes the refuse collection drone to remove the snow from the identified area. The plow 190 may remove the snow as the refuse collection drone 20 passes over the area. Accordingly, the drone route 550 may pass through the area. In some embodiments, the drone route 550 passes through the area multiple times (e.g., in a zig zag pattern) to permit removal from the entire area. By way of example, the drone route 550 may be selected such that the plow 190 passes over the entirety of the area at least once to completely remove snow from the area.

### Locking Storage Volume

Referring to FIGS. 4 and 15, in some embodiments, the system 10 automatically controls the lock 176 of a refuse collection drone 20 to selectively prevent movement of the cover 170. The lock 176 may be controlled by the service manager 60, the controller 142, and/or any other device of the system 10. The lock 176 may prevent unauthorized addition or removal of objects (e.g., refuse, packages, etc.) from the storage volume 132. In some embodiments, the cover 170 seals against the bin 130 when closed to prevent ingress of debris (e.g., dirt, water, etc.) into the storage volume 132, protecting the objects from the debris. The lock 176 may also prevent the cover 170 from opening unintentionally due to wind or other environmental forces.

The system 10 may automatically engage the lock 176 when the refuse collection drone 20 is in transit (e.g., between the pickup zone PZ and the refuse depot 30). In some embodiments, the system 10 automatically engages or disengages the lock 176 in response to the refuse collection drone 20 crossing a geofence boundary (e.g., around the refuse depot 30, around a pickup zone PZ, etc.). In some embodiments, the system 10 automatically engages the lock 176 in response to the sensor 172 detecting that the cover 170 has closed. In some embodiments, the system 10 requires an interaction from a customer and/or a user device 50 of a customer to disengage the lock 176 (e.g., when the refuse collection drone 20 is in the pickup zone PZ). By way of example, the service manager 60 may compare the location of the refuse collection drone 20 with the location of the user device 50 associated with a customer that requested a refuse collection event or a package delivery. In response to a determination that the refuse collection drone 20 is within a threshold distance of the user device 50, the lock 176 may automatically disengage. By way of another example, the system 10 requires a user interaction with the user device 50 or the customer display 168 (e.g., entering a passcode, accepting a popup notification, providing a voice command, etc.).

### Alternative Configurations

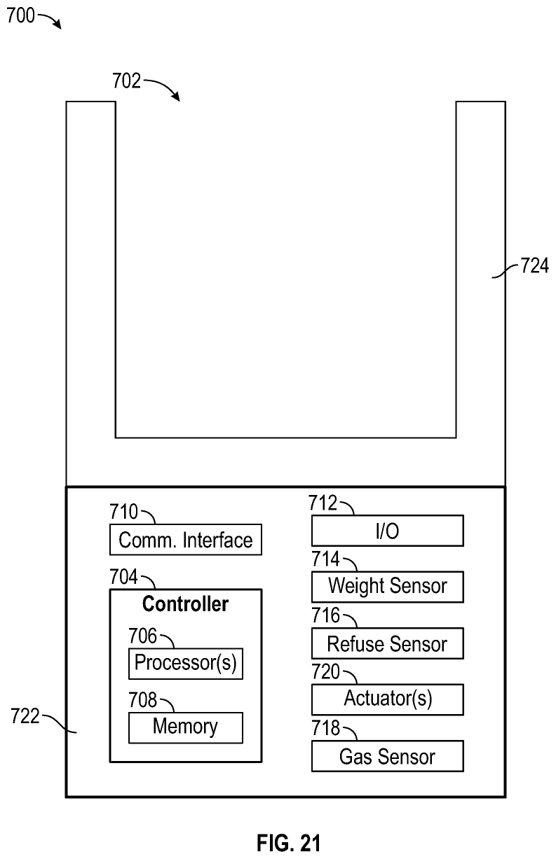

Referring to FIG. 16, a refuse collection system is shown as system 600 according to an exemplary embodiment. The system 600 may be substantially similar to the system 10 except as otherwise stated herein. In the system 10, the refuse depot 30 is immobile, and the refuse collection drones 20 and refuse vehicles 40 propel themselves to travel to the refuse depot 30. In contrast, the refuse depot 30 and the refuse vehicles 40 are replaced with a mobile refuse depot 610. The mobile refuse depot 610 includes the features of the refuse depot 30, such as the centralized storage 32, the charging stations 34, the refuse interface 230, and the refuse actuators 232, on a mobile chassis. For example, the mobile refuse depot 610 may include the frame 310, the engine 320, and the wheels 322 of the refuse vehicle 40. The mobile refuse depot 610 may be manually controlled by an operator and/or autonomously controlled by a controller.

FIG. 16 illustrates an application of the system 600 in a neighborhood NH similar to the neighborhood NH of FIG. 2A. In operation, the mobile refuse depot 610 travels along a refuse collection route along the streets S of the neighborhood NH. The refuse collection drones 20 may initially be stationed on charging stations 34 within the mobile refuse depot 610. When the mobile refuse depot 610 enters the neighborhood NH, the refuse collection drones 20 may exit the mobile refuse depot 610 and move along paths P toward the pickup zones PZ to collect refuse R. After the refuse R is collected, the refuse collection drones 20 return to the mobile refuse depot 610 to unload the refuse R into the centralized storage 32. Throughout this process, the mobile refuse depot 610 may move along the street S. The speed of the mobile refuse depot 610 may be slow enough relative to the speeds of the refuse collection drones 20 to facilitate the refuse collection drones 20 collecting the refuse R and returning to the mobile refuse depot 610 without the refuse collection drones 20 falling behind the mobile refuse depot 610. Due to refuse collection drones 20 moving with the mobile refuse depot 610, the system 600 may be required to operate according to a predetermined schedule, as opposed to the customer-dictated scheduling of the system 10.

In an alternative embodiment, the charging stations 34 are not positioned on the mobile refuse depot 610. Instead, each house is provided with a corresponding refuse collection drone 20 and charging station 34. The refuse collection drone 20 normally remains stationary and idle at the home H, during which time the refuse collection drone 20 can be loaded with refuse by a customer and charged by the charging station 34. When the mobile refuse depot 610 arrives in the neighborhood NH, the refuse collection drone 20 automatically travels to the mobile refuse depot 610 to deposit refuse. After the refuse has been transferred, the refuse collection drone 20 returns to the corresponding house H and once again becomes idle.

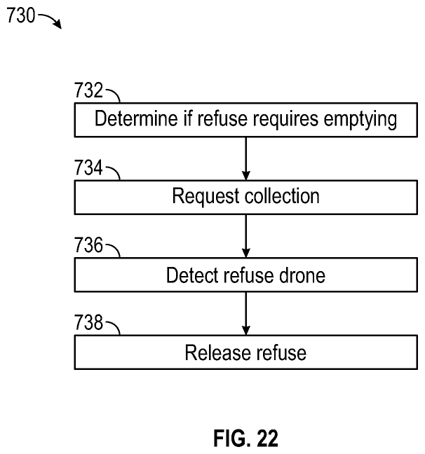

FIG. 17-19 illustrate various alternative embodiments of the refuse collection drones 20.

### Local Connected Refuse Container

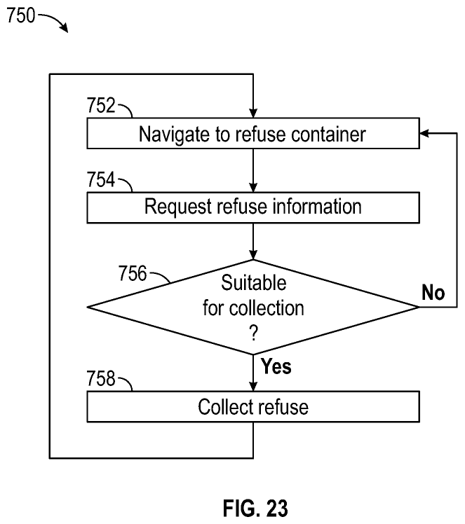

In reference to FIG. 20, the system 10 includes a refuse container 700 (e.g., a connected refuse container, a connected refuse bin, a local refuse container, etc.), according to an exemplary embodiment. The refuse container 700 may be located outside of the home of a customer of the system 10. Alternatively, the refuse container 700 may be located so that it may be used by multiple customers. For example, the refuse container 700 may be centrally located in a cul-de-sac, in a neighborhood, on a block, or proximate another type of clustering of homes or dwellings. The refuse container 700 is configured to be emptied by the refuse collection drone 20. The refuse container 700 may be configured to receive the refuse collection drone 20 into a lower portion of the refuse container 700. The refuse collection drone 20 may signal the refuse container 700 to indicate its presence. In response to the signal, the refuse container 700 may release (e.g., dump, move, push into, etc.) the refuse within the refuse container 700 into the refuse collection drone 20. Alternatively, the refuse container 700 may be configured to be retrieved by the refuse collection drone 20 and replaced with another refuse container 700.

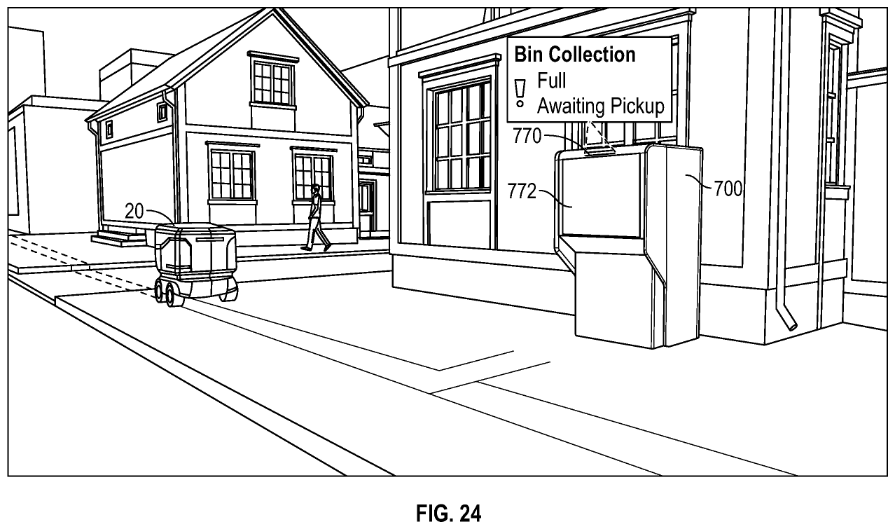

Referring to FIG. 21, a refuse container 700 is shown, according to an exemplary embodiment. The refuse container 700 defines a storage volume 702 (e.g., a refuse volume, a waste volume, etc.) in which a customer of the system 10 may place refuse for later retrieval by a refuse collection drone 20. The refuse container 700 is shown to include a controller 704. The controller 704 can be any type of device that can be instructed to carry out sequences of arithmetic or logical operations contained in a program. The controller 704 includes one or more processors 706 and a memory 708. The one or more processors 706 can be implemented as one or more general purpose processors, one or more application specific integrated circuits (ASICs), one or more field programmable gate array (FPGAs), a group of processing components, or other suitable electronic processing components.

The memory 708 (e.g., memory, memory unit, storage device, etc.) can include one or more devices (e.g., RAM, ROM, flash memory, hard disk storage, etc.) for storing data and/or computer code for completing or facilitating the various processes, layers, and modules described in the present disclosure. The memory 708 can be or include volatile memory or non-volatile memory. The memory 708 can include database components, object code components, script components, or any other type of information structure for supporting the various activities and information structures described in the present disclosure. According to some embodiments, memory 708 is communicably coupled to the one or more processors 706 via the controller 704 and includes computer code for executing (e.g., by the controller 704 or the one or more processors 706) one or more processes described herein.

The refuse container 700 further includes a communications interface 710, operatively coupled to the controller 704. The communications interface 710 is configured to transfer data between the refuse container 700 and other components of the system 10 (e.g., refuse collection drones 20, the refuse depot 30, the refuse vehicle 40, the user devices 50, the service manager 60, the network 70, etc.). The communications interface 710 may facilitate wired and/or wireless communication.

The refuse container 700 further includes one or more buttons, displays, switches, knobs, etc., shown as I/O devices 712, operatively coupled to the controller 704. The I/O devices 712 can include components configured to, individually or in combination, receive information from, and/or present information to, a customer of the system 10. In an exemplary embodiment, I/O devices 712 includes a button or a touchscreen interface. The button or touchscreen interface may be positioned on an outside surface of the refuse container 700. A customer of the system 10 may press the button when the refuse container 700 is full and needs to be emptied by a refuse collection drone 20.

The I/O devices 712 may further include sensors, contacts, interfaces, etc., to detect the presence of a refuse drone 20 in position to retrieve refuse from the refuse container 700. For example, the refuse container 700 may be configured to be mechanically engaged by a refuse drone 20 (e.g., docked with the refuse drone 20) when the refuse collection drone 20 is positioned to retrieve refuse from the refuse container 700. The I/O devices 712 may include a sensor to indicate when engagement between the refuse drone 20 and the refuse container has occurred.

The refuse container 700 further includes one or more refuse amount sensors (which may also be referred to as fill indicator sensors). In the embodiment of FIG. 21, the refuse amount sensors include a weight sensor 714 operatively coupled to the controller 704. The weight sensor 714 is configured to provide refuse amount data (e.g., weight data) relating to the amount of refuse loaded into the storage volume 702. By way of example, the weight sensor 714 may measure the change in weight supported by the storage volume 702 over time. The controller 704 may use the weight data to determine the amount (e.g., weight) and/or a fill level of refuse loaded into the refuse container 700 by a customer of the system 10. The weight data may be used by the controller 704 to determine if or when a refuse collection drone 20 should be requested (e.g., hailed) to collect the refuse material within the storage volume 702.

The refuse container 700 further includes one or more refuse type sensors or image sensors, shown as refuse sensor 716, operatively coupled to the controller 704. The refuse sensor 716 is configured to provide data relating to the type of refuse within the storage volume 702. The controller 704 may analyze the refuse type data to determine if a specific type of refuse drone 20 should be requested to empty the refuse container 700 (e.g., a refuse drone 20 adapted to collecting and transporting a specific type of refuse). For example, a refuse drone 20 may be adapted to collect and transport one of glass, plastic, metal, electronics, food waste, yard waste, non-recyclable waste, recyclable waste, compostable waste, mixed waste, etc.

In some embodiments, the refuse container 700 includes a gas sensor 718 configured to measure the concentration of a noxious or odiferous gas in the ambient air proximate the gas sensor 718. For example, the gas sensor 718 may be or include an electrochemical gas sensor (e.g., hydrogen sulfide (H₂S) sensor, ammonia (NH₃) sensor, methane (CH₄) sensor, carbon dioxide (CO₂) sensor, etc.), a volatile organic compound (VOC) sensor, a metal oxide semiconductor (MOS) sensor, a photoionization detector (PID), a colorimetric and/or chemoresistive odor array (e.g., Electronic Nose (E-nose)), or a humidity and/or temperature sensor. The gas sensor 718 may be positioned within, or otherwise in gaseous communication with, the interior of the storage volume 702, to measure the concentration of the noxious or odiferous gas being emitted by the refuse deposited in the refuse container 700. The gas sensor 718 may be operably coupled with the controller 704 and configured to output gas concentration data to the controller 704. The controller 704 may analyze the gas concentration data to, for example, determine if or when a refuse collection drone 20 should be requested to collect the refuse deposited in the refuse container 700 (e.g., when the odor or other gas level exceeds an odor or gas level threshold).

The refuse container 700 further includes one or more actuators or controllable mechanisms, shown as actuator 720, operatively coupled to the controller 704. The actuator 720 is configured to facilitate discharge of the refuse container 700 by the refuse drone 20 (e.g., to release, or expel, waste from the storage volume 702 into a refuse collection drone 20). In an exemplary embodiment, the refuse container 700 is configured to receive a refuse drone 20 into a lower portion 722 of the refuse container 700 (e.g., the refuse drone 20 can drive into a recess or opening defined by the lower portion 722 of the refuse container 700). The storage volume can be defined by an upper portion 724 of the refuse container (e.g., a portion of the refuse container above the lower portion or the recess defined by the lower portion). The actuator 720 may be a retention plate configured to retain refuse within the storage volume 702. When a refuse drone is received into the lower portion 722, the controller 704 may actuate the retention plate to allow the refuse within the storage volume to drop into the refuse drone 20 positioned within the lower portion 722 of the refuse container 700. In some such embodiments, the refuse container 700 includes a slide, a chute, or a guiding mechanism to direct refuse from the storage volume 702 to the refuse drone 20.

In another exemplary embodiment, the upper portion 724 of the refuse container is completely detachable from the lower portion 722. A refuse drone 20 may be configured to empty the refuse container 700 by removing the upper portion 724 from the lower portion 722 and replacing the upper portion 724 with another upper portion 724. In such embodiments, the actuator 720 is a mechanism configured to mechanically couple and decouple the upper portion 724 and the lower portion 722. In still another exemplary embodiment, the refuse collection drone 20 is configured to retrieve the entire refuse container 700 and replace the refuse container 700 with another refuse container 700. In some such embodiments, the actuator is an actuatable coupler configured to releasably secure the refuse container 700 at a particular location or site.

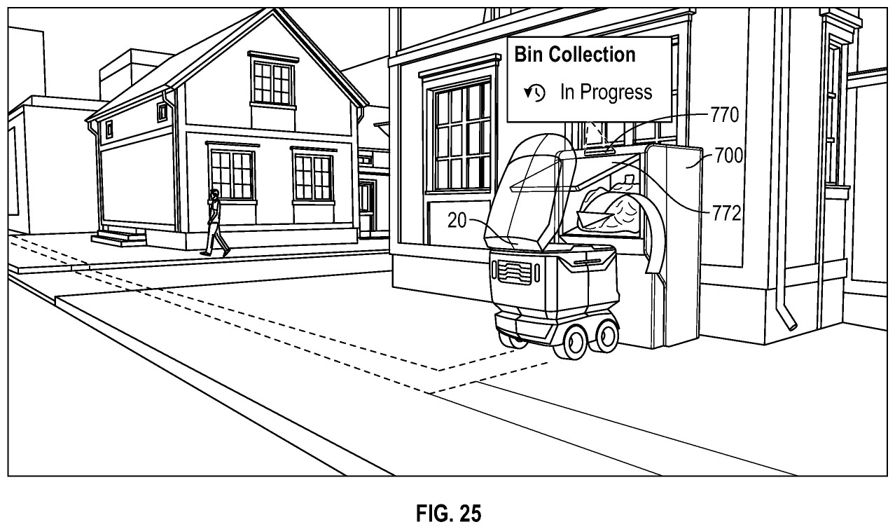

FIG. 22 illustrates a method 730 of collecting refuse, according to an exemplary embodiment. The method 730 may be implemented by the refuse container 700, or the controller 704, and will therefore be described with reference to FIG. 21. In other embodiments, the method 730 may include additional, fewer, or different steps.

The method 730 includes determining if the refuse container 700 is full or requires emptying, at operation 732. In some embodiments, operation 732 includes determining, by the controller 704, if the refuse container 700 requires emptying. The controller 704 may determine the refuse container 700 requires emptying by receiving an input from the I/O devices 712 indicating the refuse container 700 requires emptying. For example, and as described in reference to FIG. 21, a user of the system 10 may press a button or interface with a touchscreen on the refuse container 700 to indicate that the storage volume 702 of the refuse container 700 is full. In another example, the controller 704 may determine that the refuse container 700 requires emptying when the amount of refuse within the storage volume 702, as indicated by the weight sensor 714, exceeds or is near a maximum amount storable by the refuse container 700 or transportable by a refuse drone 20 (e.g., when the fill level of the refuse container 700 exceeds a fill level threshold). In yet another example, the controller 704 may determine that the refuse container 700 requires emptying when the gas concentration data, output by the gas sensor 718, indicates that the concentration of noxious or odiferous gas emitted from the refuse deposited in the refuse container 700 exceeds an odor or gas level threshold.

The method 730 includes requesting collection, at operation 734. In some embodiments, operation 734 includes requesting, by the controller 704, a refuse collection drone 20 be dispatched to empty the refuse container 700. The controller 704 may transmit a message or request, via the communications interface 710 to the system 10, or a component of the system 10 (e.g., the service manager 60, the network 70, a refuse drone 20, etc.). The controller 704 may broadcast the message or request to multiple components of the system 10 or to the entire system 10. On receipt of the message or request that the refuse container 700 be emptied, a refuse drone 20 may be dispatched (e.g., by the service manager 60) to the location of the refuse container 700. Alternatively, if the service manager 60 determines that a refuse collection drone 20 is not available to perform the collection, the service manager may schedule dispatch of a refuse collection drone 20 at a later time. In some embodiments, upon receipt of the message or request, the service manager 60 may add the refuse container 700 to a route (e.g., an ordered set of locations to be visited) to be completed by a refuse collection drone 20.

The method 730 includes detecting a refuse drone is in position to empty the refuse container 700, at operation 736. In an exemplary embodiment, operation 736 includes detecting, by the controller 704, that a refuse drone is present and in position to empty the refuse container 700. In some embodiments, and as described in reference to FIG. 21, the refuse drone is configured to drive, and be received, into the lower portion 722 of the refuse container. In some such embodiments, the controller 704 may detect the presence of the refuse drone with a sensor positioned within the lower portion 722 and configured to detect the presence of a refuse drone 20 within the lower portion 722. In some embodiments, the refuse drone 20 is configured to dock, or couple, with the refuse container 700. In some such embodiments, the controller 704 may detect the presence of the refuse drone with a sensor configured to indicate docking is completed. In some embodiments, the controller 704 may detect the presence of a refuse collection drone 20 by receiving, via the communications interface 710, a message or signal sent by the refuse drone 20 indicating that the refuse drone is in position to collect the refuse from the refuse container 700.

The method 730 includes releasing the refuse within the refuse container 700, at operation 738. In an exemplary embodiment, operation 738 includes releasing, by the controller 704, the refuse within the refuse container 700. The controller 704 may release the refuse within the refuse container by operating the actuator 720. For example, where the refuse container 700 is configured to receive a refuse drone 20 into the lower portion 722, the controller 704 may actuate a retention plate to allow refuse within the storage volume 702 to descend into the refuse collection drone 20. In another example, where the upper portion 724 and the lower portion 722 of the refuse container are detachable, the controller 704 may operate the actuator to decouple the upper portion 724 and the lower portion 722. The refuse drone 20 may then engage and remove the upper portion 724 and replace it with another upper portion 724. In still another example, where the refuse drone 20 is configured to retrieve the entire refuse container 700 and replace it with another refuse container 700, the controller 704 may operate the actuator 720 to release the refuse container from its position.

Once the refuse container 700 has been emptied into a refuse collection drone 20, or the refuse collection drone 20 has retrieved the entire refuse container 700, or a releasable portion of the refuse container 700, the refuse collection drone 20 may proceed to the refuse depot 30, where the refuse drone 20 may be emptied into the refuse depot 30. Alternatively, the refuse collection drone 20 may proceed to other locations to collect refuse until the refuse collection drone 20 is full and needs to be emptied. At which point, the refuse collection drone may then travel to the refuse depot 30 to be emptied and return to service.

In an exemplary embodiment, a refuse collection drone 20 is configured to navigate a route and to collect refuse deposited in refuse containers 700 positioned along the route. The route may correspond to a neighborhood, or other collection of proximately located buildings. The refuse containers 700 may include individual use containers for a single residence or apartment, or shared units that are filled by multiple different customers. The refuse collection drone 20 may automatically navigate the route without receiving a request for refuse collection from a customer of the system 10 (e.g., made via a user device 50) or a refuse container 700 positioned along the route. The refuse collection drone 20 may navigate the route, collecting refuse deposited in the refuse containers positioned along the route, until the refuse collection drone 20 is full (e.g., until the storage volume 55 of the bin 31 of the refuse drone 20 is at or near a maximum capacity). When the refuse collection drone 20 becomes full, the refuse collection drone 20 may leave the route and travel to a refuse depot 30 to empty collected refuse. Once the refuse collection drone 20 is emptied at the refuse depot 30, the refuse collection drone may return to the route to continue collecting refuse deposited in refuse containers 700 positioned along the route. The refuse collection drone 20 may automatically navigate the route continuously (e.g., 7 days per week, 24 hours per day, etc.) to ensure the refuse containers 700 positioned along the route are emptied of deposited refuse when necessary.

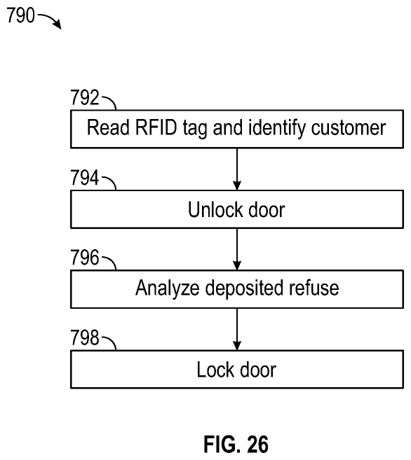

FIG. 23 illustrates a method 750 of automatically collecting refuse from refuse containers 700 positioned along a route, according to an exemplary embodiment. The method 730 may be implemented by the refuse collection drone 20, or the controller 142 thereof, and will therefore be described with reference to FIG. 4. In other embodiments, the method 750 may include additional, fewer, or different steps.

The method 750 includes navigating to a refuse container 700, at operation 752. In some embodiments, operation 752 includes causing, by the controller 142, a refuse collection drone 20 to navigate to the refuse container 700. The refuse container 700 may be one of multiple refuse containers 700 positioned along a route travelled by the refuse collection drone 20. The controller 142 of the refuse collection drone may store the location of the multiple refuse containers 700 along the route in memory. The controller 142 may utilize location data related to the current location of the refuse collection drone 20 provided by the location sensor 160 and location information corresponding to the refuse container 700 to navigate the refuse collection drone 20 to the refuse container 700.

Operation 752 may include positioning the refuse collection drone relative to the refuse container 700 so that the refuse drone may receive refuse from the refuse container 700 when expelled. In some embodiments, and as described in reference to FIG. 21, the refuse container 700 is configured to receive the refuse collection drone 20 into a lower portion 722 of the refuse container 700. In some such embodiments, operation 752 includes navigating the refuse collection drone 20 into the lower portion 722 of the refuse container 700. In some embodiments, the refuse container 700 is configured to dock, or couple, with the refuse collection drone 20. In some such embodiments, operation 752 includes causing the refuse collection drone 20 to dock with the refuse container 700.

The method 750 includes requesting refuse information, at operation 754. In some embodiments, operation 754 includes requesting, by the controller 142 of the refuse collection drone 20 (e.g., via the communication interface 150) information related to the type and amount of refuse currently deposited in the refuse container 700 from the refuse container 700. In some embodiments, and as described in reference to FIG. 21, the refuse container 700 includes a refuse sensor 716 operatively coupled to the controller 704 of the refuse container 700 and configured to provide data relating to the type of refuse within the storage volume 702 of the refuse container 700. The refuse container 700, or the controller 704 thereof, may determine the type of refuse within the refuse container 700 based on the refuse type data output by the refuse sensor 716. In some embodiments, the refuse container 700 includes one or more refuse amount sensors (e.g., the weight sensor 714, the gas sensors, etc.) operatively coupled to the controller 704 of the refuse container 700 and configured to provide refuse amount data relating to the amount of refuse within the storage volume 702 of the refuse container 700. Upon receiving the request for information related to the type and/or amount of refuse currently deposited in the refuse container 700, the refuse container 700, or the controller 704 thereof, may be configured to provide (e.g., transmit via the communications interface 710) to the refuse collection drone 20 the information related to the type and/or amount of refuse currently deposited in the refuse container 700.

The method 750 includes determining suitability for refuse collection, at operation 756. In some embodiments, operation 756 includes determining, by the controller 142 of the refuse collection drone 20, whether the refuse collection drone 20 has sufficient available capacity and is of a type suitable to collect the type and amount of refuse presently deposited in the refuse container 700, based on the refuse information requested and obtained at operation 754. In some embodiments, the refuse collection drone 20 is adapted to collect and transport a specific type of refuse (e.g., organic waste, recyclables, mixed trash, hazardous waste, etc.). In some such embodiments, operation 756 includes determining that the type of refuse currently deposited in the refuse container 700 is a type of refuse that the refuse collection drone 20 is adapted to collect and transport.

In some embodiments, and as described in reference to FIG. 4, the refuse collection drone 20 includes a refuse amount sensor (e.g., the weight sensor 164) configured to provide refuse amount data relating to the amount of refuse within the storage volume 132 of the refuse collection drone 20. In some such embodiments, operation 756 includes determining the available capacity of the refuse collection drone by subtracting the amount of refuse within the storage volume 132 of the refuse collection drone 20 from the total capacity of the storage volume 132 of the refuse collection drone 20. In some such embodiments, operation 756 includes comparing the amount of refuse currently deposited in the refuse container 700, as indicated by the information requested and obtained at operation 754, to the available capacity of the refuse collection drone 20 and determining the refuse collection drone 20 has sufficient available capacity to collect the refuse currently deposited in the refuse container 700 when the available capacity of the refuse collection drone is greater than the amount of refuse currently deposited in the refuse container 700.

If, at operation 756, it is determined that the refuse collection drone 20 is not suitable to collect the refuse presently deposited in the refuse container 700, the method 750 returns to operation 752, where the refuse collection drone 20 navigates to another one of the multiple refuse containers 700 positioned along the route taken by the refuse collection drone 20. If, at operation 756, it is determined that the refuse collection drone 20 is suitable to collect the refuse presently deposited in the refuse container 700, the method 750 proceeds to operation 758.

The method 750 includes collecting refuse, at operation 758. In some embodiments, operation 758 includes collecting, by the refuse collection drone 20, the refuse presently deposited in the refuse container 700. Operation 758 may include transmitting, by the refuse collection drone 20, or the controller 142 thereof, a message to the refuse container 700 to expel, release, or otherwise deposit the refuse presently within the storage volume 702 of the refuse container 700 into the storage volume 132 of the refuse collection drone 20. The refuse container may release the refuse presently within the refuse container 700 by operating the actuator 720. For example, where the refuse container 700 is configured to receive a refuse drone 20 into the lower portion 722 of the refuse container 700, the controller 704 of the refuse container 700 may actuate a retention plate to allow refuse within the storage volume 702 to descend into the refuse collection drone 20.

Once the refuse collection drone 20 has collected the refuse from the refuse container 700, the method 750 may return to operation 752, with the refuse collection drone 20 navigating to another one of the multiple refuse containers 700 positioned along the route. In some embodiments, the method 750 includes determining if the refuse collection drone 20 is at or near capacity by comparing the total capacity of the storage volume 132 of the refuse collection drone 20 to the amount of refuse presently within the storage volume 132 of the refuse collection drone 20. If the refuse collection drone 20 is at or near capacity, the method 750 may include navigating to the refuse depot 30 for unloading before the refuse collection drone returns to the route. If the refuse collection drone 20 is not at or near capacity, the method 750 may repeat until the refuse collection drone 20 is at or near capacity. That is to say, the refuse collection drone 20 may proceed to navigate along the route, collecting refuse from successive refuse containers 700, until the refuse collection drone 20 is at or near capacity. At which point, the refuse collection drone 20 may navigate to the refuse depot 30 for unloading before returning to the route.

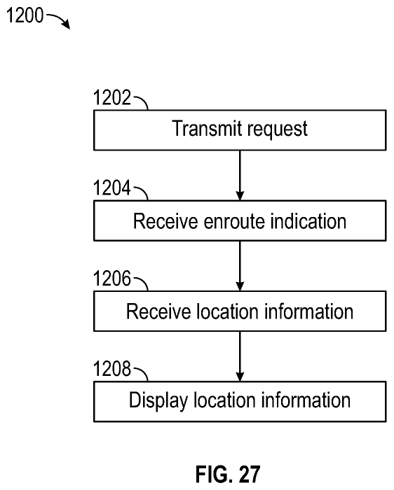

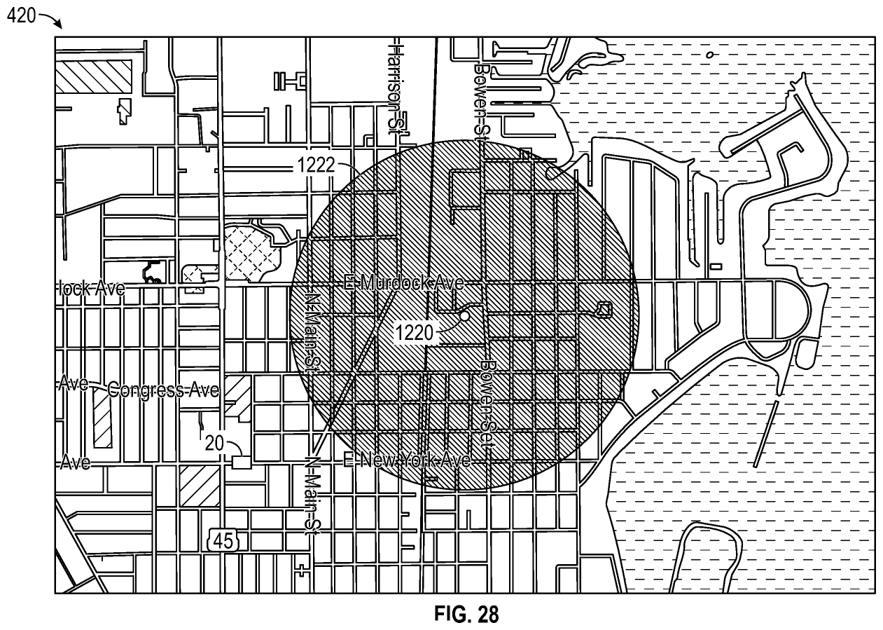

Referring to FIGS. 24-25, the refuse container 700 is shown according to an exemplary embodiment. The refuse container 700 includes a light 770. The light 770 is illuminated to indicate to a customer or user of the system 10 that the storage volume 702 is full. The light 770 may be one of the I/O devices 712. The refuse container 700 is shown to include a door 772 to restrict or allow access to the storage volume 702. When the storage volume 702 is full, the controller 704 may prevent further access to the storage volume 702 (e.g., by locking the door 772) to prevent additional refuse from being placed in the storage volume 702.

Referring to FIG. 25, specifically, when the refuse drone 20 has travelled to the refuse container 700 and is in position to receive or retrieve the refuse stored within the storage volume 702, the refuse container 700, or the controller 704, may begin a process of releasing or ejecting the refuse within the storage volume 702. The controller 704 may unlock the door 772. The controller 704 may open the door 772 so that refuse within the storage volume 702 may be ejected from the refuse container 700. The controller 704 may then actuate an ejection mechanism to force refuse from the storage volume 702 into a storage volume of the refuse collection drone 20. The controller 704 may illuminate a different color or in a time sequenced pattern to indicate that refuse collection is under way. The controller may additionally transmit messages to other components of the system 10 to indicate the status of the refuse collection process.

In an exemplary embodiment, the refuse container 700 includes a radio frequency identification (RFID) reader or another type of user/customer identification device. The RFID reader may be one of the I/O devices 712. The controller 704 of the refuse container may be configured to normally lock the door 772 and to only unlock the door 772 to allow refuse to be deposited into the refuse container 700 when an RFID tag assigned to a customer of the system 10 is presented to the RFID reader. By limiting access to the storage volume 702 of the refuse container 700 in this manner, the refuse container 700 ensures that only customers of the system 10 (e.g., authorized customers) may deposit refuse therein. Furthermore, by locking the door 772 between deposits, refuse deposited in the refuse container may be associated with a specific customer and individualized fees may be assessed based on the amount or type of refuse deposited.

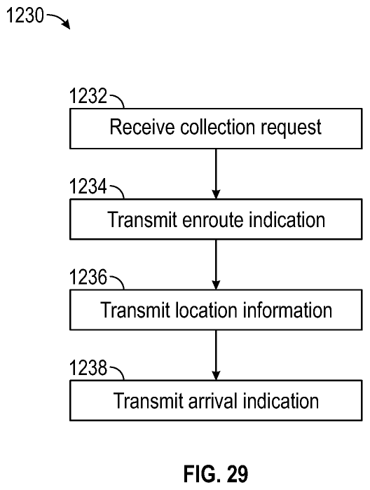

FIG. 26 illustrates a method 790 for restricting and selectively permitting access to the storage volume 702 of a refuse container 700, according to an exemplary embodiment. The method 730 may be implemented by the refuse container 700, or the controller 704 thereof, and will therefore be described with reference to FIG. 21. In other embodiments, the method 790 may include additional, fewer, or different steps.

The method 790 may include reading an RFID tag and identifying a customer associated with the RFID tag, at operation 792. In some embodiments, operation 792 includes reading, by the controller 704, an identification number stored on an RFID tag presented to, or placed near, the RFID reader of the refuse container 700. The controller 704 may compare the identification number to a database containing a record of customers of the system 10 and their associated identification numbers to determine if the identification number is associated with an authorized customer of the system 10. In some embodiments, operation 792 includes determining if the customer associated with the identification number is delinquent in paying for refuse collection. For example, in some embodiments, method 790 may terminate and not unlock the door 772 to permit access to the refuse container 700 if a customer is delinquent in paying for refuse collection.

The method 790 may include unlocking the door 772 to permit access to the storage volume 702 of the refuse container 700, at operation 794. In some embodiments, operation 794 includes actuating, by the controller 704, a locking mechanism to an unlocked position to enable the door 772 to be opened after determining that an RFID tag presented to the RFID reader is associated with a customer of the system 10. In some embodiments, operation 794 includes monitoring the position of the door 772 (e.g., via a position sensor associated with the door 772).

The method 790 may include analyzing refuse deposited into the storage volume 702 of the refuse container 700, at operation 796. In some embodiments, operation 796 includes analyzing, by the controller 704, the type and amount of refuse deposited by the customer after determining the door 772 has been closed by the customer. In some embodiments, the controller 704 determines the type and/or amount of refuse deposited by the customer associated with the identifier during the access event enabled by unlocking the door 772. Operation 796 may include obtaining, by the controller 704, refuse type data output by the refuse sensor 716. Operation 796 may additionally, or alternatively, include obtaining, by the controller 704, refuse amount data output by the refuse amount sensor (e.g., the weight sensor 714) and/or a gas level associated with the refuse material. In some embodiments, the controller 704 assesses fees owed by the customer based on the type and amount of refuse deposited by the customer. In some embodiments, the refuse type sensor is configured to detect contaminants or prohibited items (e.g., batteries such as lithium-ion batteries) in the refuse deposited by the customer. The controller 704 may assess additional fees upon detecting a contaminant or prohibited item within the refuse deposited by the customer.

The method 790 may include locking the door 772 to restrict access to the storage volume 702 of the refuse container 700 after refuse has been deposited therein and the door 772 has been closed, at operation 798. In some embodiments, operation 798 includes actuating, by the controller 704, a locking mechanism to a locked position to prevent the door 772 from being opened after determining that refuse has been deposited into the refuse container 700 and the door 772 has been closed. In some embodiments, operation 798 includes monitoring the position of the door 772 (e.g., via a position sensor associated with the door 772).

### Refuse Drone Hailing and Location Tracking

Referring again to FIG. 1, in some embodiments, the system 10 is configured so that a customer of the system 10 can request (e.g., hail) a refuse collection drone 20 to perform a refuse collection operation. The refuse collection drone 20 may be configured to safely navigate roadways and sideways to perform collection of waste (e.g., autonomously or semi-autonomously with assistance from a drone manager service, etc.). In some embodiments, the refuse collection drone 20 is configured to transmit a notification to a user device 50 when the refuse collection drone is enroute to the customer's location. The refuse collection drone 20 may also be configured to transmit location information to the user device 50 indicating a present location of the refuse collection drone 20. The refuse collection drone 20 may be configured to transmit updated location information to the user device 50 as the refuse collection drone 20 travels to the customer's location.

Finally, the refuse collection drone 20 may be configured to transmit a notification to the user device 50 when the refuse collection drone has arrived at the customer's location. Once the refuse collection drone 20 has collected the refuse at the customer's location, the refuse collection drone 20 may proceed to the refuse depot 30 and/or to a mobile depot (e.g., a full size refuse collection vehicle, etc.) to be emptied and/or charged, or the refuse collection drone 20 may return to the field to perform additional refuse collection operations before returning to the refuse depot 30. In some embodiments, the refuse collection drone 20 may transmit a notification to a user device once the refuse collection drone 20 has collected the refuse at the customer's location. In some embodiments, the system 10 is configured to periodically dispatch a refuse collection drone 20 to the customer's location at regular intervals (e.g., once a week, every Thursday, etc.). In some embodiments, the system 10 is configured to dispatch a refuse collection drone to the customer's location when a user device 50 or a connected device 52 signals that a refuse container is full and in need of collection by a refuse collection drone 20.

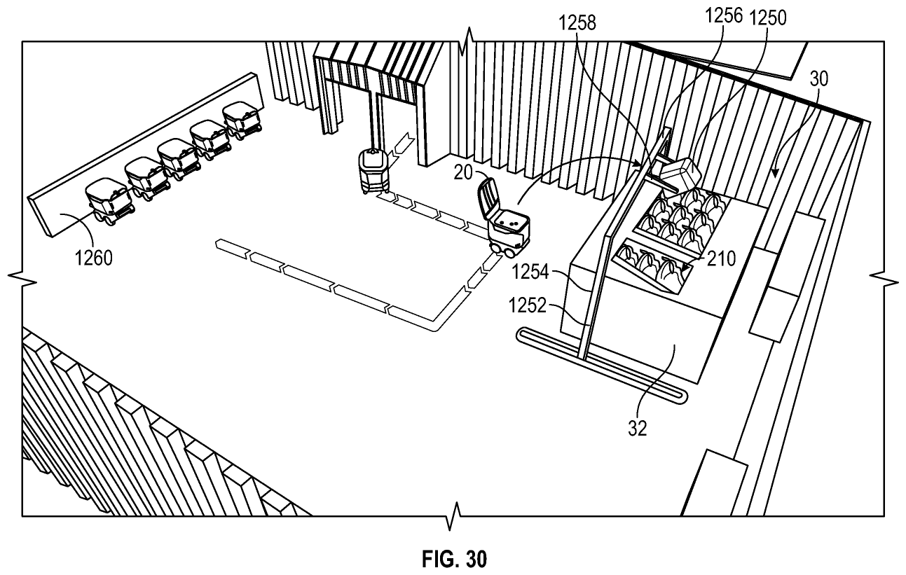

FIG. 27 illustrates a method 1200 of hailing a refuse collection drone 20, according to an exemplary embodiment. The method 1200 may be implemented by a user device 50 (e.g., a smartphone, a laptop computer, etc.) and will therefore be described with reference to FIG. 14. In other embodiments, the method 1200 may include additional, fewer, and/or different steps.

The method 1200 includes transmitting a request (e.g., hailing a refuse collection drone 20), at operation 1202. In some embodiments, operation 1202 includes receiving, by the controller 400 via the user interface 420, an input or request that a refuse collection drone be dispatched to the customer's location. In some embodiments, operation 1202 includes transmitting, by the controller 400 via the communications interface 410, that a refuse collection drone 20 be dispatched to the user's location. The controller 400 may transmit the request to the service manager 60 so that the service manager 60 can coordinate the scheduling or dispatch of a refuse collection drone to the customer's location. In some embodiments, the controller may transmit the request to a different component of the system 10 (e.g., a refuse collection drone 20, a refuse depot 30, etc.) to coordinate the dispatch of a refuse collection drone 20. The request transmitted by the controller 400 may include location information that the refuse collection drone 20 may use to navigate to the customer's location. In some embodiments, the controller 400 retrieves the location information from the location sensor 430 (e.g., the present location of the user device 50). In other embodiments, the refuse collection drone 20 is dispatched to a location associated with the customer who made the request (e.g., a location stored and maintained by the service manager).

The method 1200 includes receiving an enroute indication, at operation 1204. In some embodiments, operation 1204 includes receiving, by the controller 400, a message indicating that a refuse collection drone 20 has been dispatched to the customer's location in response to the request transmitted at operation 1202. The message may be sent by the refuse collection drone 20 once it has begun traveling to the customer's location. Alternatively, the message may be sent by the service manager 60 after the service manager has coordinated the dispatch of a refuse collection drone 20 to the customer's location. The controller 400 may display an indicator via the user interface 420 to inform the customer that a refuse collection drone 20 is enroute. The controller may create an alert, cause the user device to vibrate, etc. to inform the customer that a refuse collection drone 20 is enroute.

The method 1200 includes receiving location information, at operation 1206. In some embodiments, operation 1206 includes receiving, by the controller via the communication interface 410, information indicating the present location of the enroute refuse collection drone 20. The information may be transmitted by the enroute refuse collection drone 20. Alternatively, the information may be sent by the enroute refuse collection drone 20 to the service manager 60, and the service manager 60 may send the information to the user device 50.

The controller 400 may display the location information via the user interface 420 so that the customer and user of the user device 50 can monitor the progress of the enroute refuse collection drone 20. The enroute refuse collection drone 20 may periodically transmit, and the controller 400 of the user device 50 may periodically receive, updated location information.

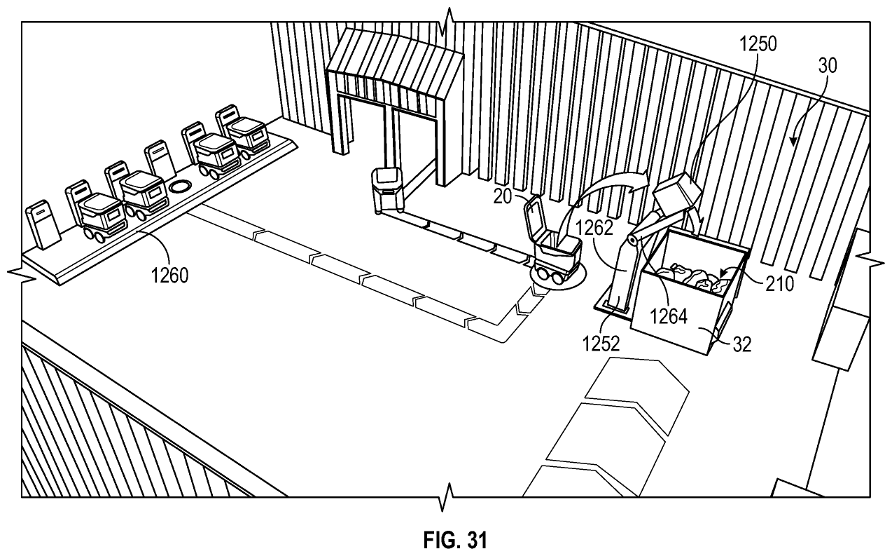

The method 1200 includes displaying the location information, at operation 1208. In an exemplary embodiment, operation 1208 includes displaying, by the controller 400 via the user interface 420, the location information received at operation 1206. The controller 400 may display the location information visually, as will be described below in reference to FIG. 28. For example, the controller 400 can overlay the customer's location and the location information indicating the present location of the enroute refuse collection drone 20 onto a map of a geographical area encompassing both the customer's location and the present location of the enroute refuse collection drone 20. The controller 400 may update the user interface 420 as updated location information is received.

The method 1200 may additionally include receiving a message indicating that the enroute refuse drone 20 has arrived and is prepared to collect refuse or is already collecting refuse. The message may be displayed to the customer so that the customer may take appropriate action (e.g., placing refuse in a location for pickup by the refuse collection drone 20, placing refuse within the refuse collection drone 20, etc.). Once refuse has been collected by the refuse collection drone 20, the refuse collection drone 20 may proceed to a refuse depot 30 to transfer the refuse. Alternatively, the refuse collection drone 20 may proceed to another location to retrieve additional refuse. In some embodiments, the method 1200 may additionally include receiving a message indicating that the refuse collection operation has been completed and the refuse collection drone 20 is prepared to depart from, or has already departed, the customer's location.

The method 1200 may alternatively be performed by a connected device 52 (e.g., a refuse container communicatively coupled to the system 10). The connected device 52 may perform the method 1200 when the connected device is full of discarded refuse and needs to be emptied. In some embodiments, requests for refuse collection, enroute indications, and location information are communicated between the refuse collection drone 20 and a remote device. The remote device may be, for example, a user device 50, the service manager 60, a connected device 52, or another device configured to communicate with the refuse collection drone 20.

Referring to FIG. 28, the user interface 420 of the user device 50 is shown, according to an exemplary embodiment. The user interface 420 displays the customer's location 1220 and the current location of an enroute refuse collection drone 20 overlaid on a map of a geographical area encompassing both the customer's location 1220 and the current location of the enroute refuse collection drone 20. In some embodiments, the customer can define a perimeter 1222 around the customer's location 1220. In some embodiments, the perimeter 1222 may be defined numerically (e.g., the customer may input a radius around their home) or the perimeter 1222 may be defined manually (e.g., where the user interface 420 is a touchscreen interface, the customer may draw a perimeter around their location). The user device 50 may automatically generate alerts when the enroute refuse collection drone 20 enters the perimeter 1222. Allowing the customer to define the perimeter 1222 ensures that the customer is alerted to the arrival of the enroute refuse collection drone 20 with sufficient time to take appropriate action (e.g., placing refuse in a location for pickup by the refuse collection drone 20, placing refuse within the refuse collection drone 20, etc.).

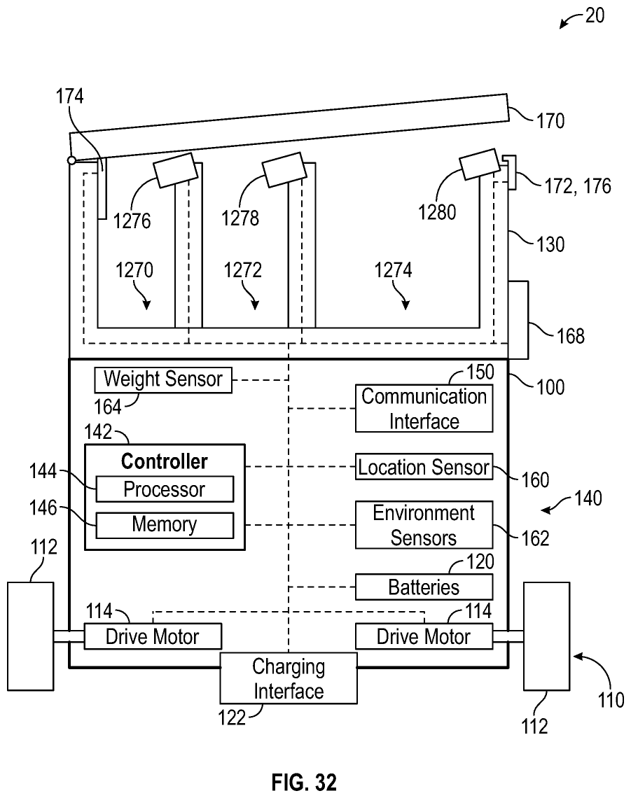

FIG. 29 illustrates a method 1230 of dispatching a refuse collection drone 20, according to an exemplary embodiment. The method 1230 may be implemented by a refuse collection drone 20, and will therefore be described with reference to FIG. 4. In other embodiments, the method 1230 may include additional, fewer, and/or different steps.

The method 1230 includes receiving a collection request, at operation 1232. In an exemplary embodiment, operation 1232 includes receiving, by the controller 142 via the communication interface, a request to perform a refuse collection. The request may be received from a user device 50 (e.g., a user device 50 performing method 1200). Alternatively, the message may be received from the service manager 60, which may coordinate the dispatch and scheduling of multiple refuse collection drones 20. The request may include location information indicating the requesting customer's location (e.g., the location to which the refuse collection drone 20 must travel). In some embodiments, operation 1232 includes causing, by the controller 142, the refuse collection drone 20 to begin travelling to the customer's location.

The method 1230 includes transmitting an enroute indication, at operation 1234. In an exemplary embodiment, operation 1234 includes transmitting, by the controller 142 via the communication interface 150, a message that the refuse collection drone has commenced travel to the customer's location. The message may be transmitted to the user device 50 used by the customer to request refuse collection. Alternatively, the message may be transmitted to the service manager 60 for relay to the customer. Once received by the customer's user device 40, the message may be used to create an alert or indicator to inform the customer that the refuse collection drone 20 is enroute.

The method 1230 includes transmitting location information, at operation 1236. In an exemplary embodiment, operation 1236 includes transmitting, by the controller 142 via the communication interface 150, location information. The location information indicates the present location of the refuse collection drone 20. The controller 142 may obtain the location information via the location sensor 160. The location information may be transmitted directly to the user device 50 used by the customer to request refuse collection, or the location information may be intermediated by the service manager 60. Operation 1236 may be repeated periodically as the refuse collection drone 20 travels to the customer's location. That is, the controller 142 may periodically obtain new location information indicating the present location of the refuse collection drone 20 and periodically transmit the new location information.

The method 1230 includes transmitting an arrival indication, at operation 1238. In an exemplary embodiment, operation 1238 includes transmitting, by the controller 142 via the communication interface 150, a message indicating that the refuse collection drone 20 has arrived at the customer's location. The controller 142 may determine that the refuse collection drone 20 has arrived at the customer's location by comparing the present location of the refuse collection drone 20 (e.g., obtained from the location sensor 160) to the customer's location (e.g., a location associated with the customer or a location included with the request for refuse collection. The arrival message may be transmitted to the user device 50 used to request refuse collection or the arrival message may be intermediated by the service manager 60. The arrival message may be used by the customer's user device to alert the customer of the refuse collection drones arrival so that the customer can take appropriate action (e.g., loading the refuse collection drone 20, placing refuse in a location for collection by the refuse collection drone 20, etc.).

In some embodiments, the method 1230 includes transmitting, by the controller 142 via the communication interface 150, a message indicating that the refuse to be collected at the customer's location has been collected and that the refuse drone 20 is preparing to depart from, or has already departed, the customer's location. Once the refuse collection drone 20 has retrieved the refuse to be collected at the customer's location, the refuse collection drone may travel to a refuse depot 30 to transfer the refuse. Alternatively, the refuse collection drone 20 may proceed to another location (e.g., the location of another customer) to collect additional refuse. Alternatively, the refuse collection drone may return to a route.

### Refuse Drone with Removable Insert

Referring to FIGS. 30 and 31, in some embodiments of the present disclosure, the refuse collection drone 20 includes a removable insert 1250. The removable insert 1250 may define the storage volume 132 of the refuse collection drone 20 and be vertically slidable into and out of the refuse collection drone 20. The removable insert 1250 can advantageously enable refuse to be transferred from the storage volume 132 of the refuse collection drone 20 to the storage volume 210 of the refuse depot 30 (e.g., by a lifting assembly located at the refuse depot 30, by another drone or robot, etc.) without requiring the entire refuse collection drone 20 be engaged, lifted, and inverted. In some embodiments, the removable insert 1250 may be selectively coupled to the refuse collection drone 20 (e.g., kept in place by a lock, latch, or other actuatable retention component). In some such embodiments, the refuse collection drone 20 is configured to release the removable insert 1250 from the refuse collection drone 20 before the removable insert 1250 is emptied into the refuse depot 30 and to reengage the removable insert 1250 after the removable insert 1250 has been replaced into the refuse collection drone 20. In some embodiments, the removable insert 1250 defines a plurality of compartments, each designated for a different type of refuse.

In some embodiments, the refuse depot 30 includes a lifting assembly 1252 configured to engage, lift, and invert the removable insert 1250 so that refuse disposed therein is emptied into the storage volume 210 of the refuse depot 30. In some embodiments, and as shown in FIG. 30, the lifting assembly 1252 includes a pair of upright members 1254 positioned on opposite sides of the centralized storage 32 of the refuse depot 30. A horizontal member 1256 extends horizontally between upper portions of the upright members 1254 so that the horizontal member 1256 is substantially parallel to a top side of the centralized storage 32. A pair of engagement arms 1258 are rotatably coupled to the horizontal member 1256 and rotatable between an engagement position and a dumping position. When in the engagement position, the engagement arms 1258 are in position to engage (e.g., grab, couple with, etc.) the removable insert 1250 of a refuse collection drone. When in the dumping position, the engagement arms 1258 position the removable insert in an inverted orientation above the storage volume 210 of the centralized storage 32 so that refuse within the removable insert descends (e.g., falls, is dumped, etc.) into the storage volume 210 of the centralized storage 32.

In some embodiments, and as shown in FIG. 31, the lifting assembly 1252 includes a pair of upright arms 1262 and a pair of rotatable arms 1264 rotatably coupled to an upper portion of the upright arms 1262. The rotatable arms 1264 are rotatable between the engagement position and the dumping position to engage, lift, rotate, and invert the removable insert 1250 to empty refuse within the removable insert 1250 into the storage volume 210 of the centralized storage 21. In some embodiments, the controller 242 of the refuse depot 30 (described above in reference to FIG. 8) may be configured to operate the lifting assembly 1252 to engage the removable insert 1250 by actuating the lifting assembly 1252 between the engagement position and the dumping position based on the presence of a refuse collection drone 20.

In some embodiments, and as shown in FIGS. 30 and 31, the refuse depot 30 includes one or more charging system 1260. The charging system 1260 may be configured to recharge a battery of the refuse collection drone 20 before they are returned to service. The charging system 1260 may be configured to recharge multiple refuse collection drones 20 simultaneously.

### Refuse Drone with Multiple Compartments

In an exemplary embodiment, the refuse collection drone 20 includes multiple separate compartments, each of which is designated for a different type of refuse (e.g., mixed waste, recyclables, organic waste, hazardous materials, electronic waste, etc.). For example, the refuse collection drone 20 can include a compartment in which electronic waste can be placed, a compartment in which batteries (e.g., alkaline batteries, lithium-ion batteries, etc.) can be placed, and/or a sharps container in which sharp medical instruments (e.g., syringes) can be placed. Some or all of the compartments may be positioned on a side of the refuse collection drone 20 and/or adjacent to a main storage volume 132 of the refuse collection drone 20.

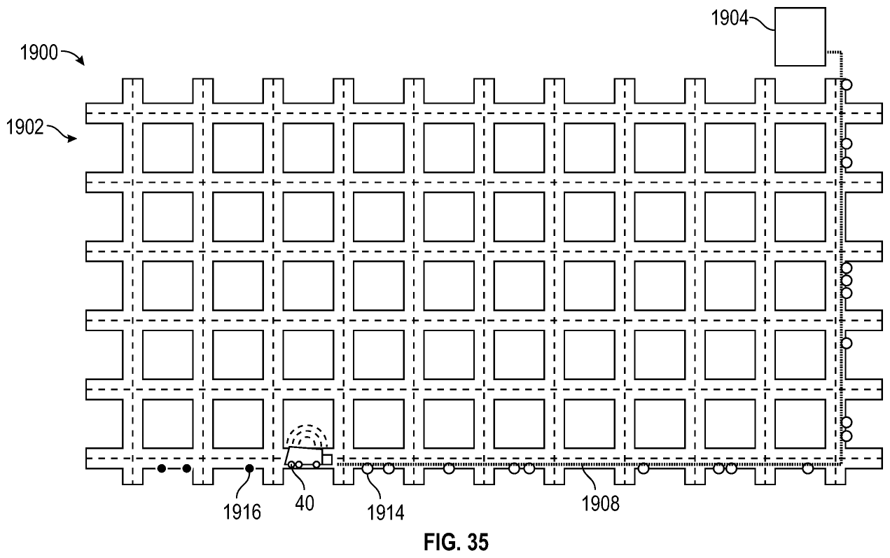

Referring to FIG. 32, the bin 130 of the refuse collection drone 20 is divided into multiple storage volumes. Each of the multiple storage volumes may be designated for a different type of waste. For example, the multiple storage volumes can include a first storage volume 1270 designated for a first type of refuse, a second storage volume 1272 designated for a second type of refuse, and a third storage volume 1274 designated for a third type of refuse. In some embodiments, each storage volume of the multiple storage volumes includes indicia (e.g., colors, symbols, etc.) associated with the type of refuse for which the storage volume is designated, to assist a customer in sorting and depositing refuse into the refuse collection drone 20. For example, the first storage volume 1270 may be green in color and be marked with the EU's Waste Electrical and Electronic Equipment (WEEE) Directive symbol, the second storage volume 1272 may be blue in color and be marked with the universal recycling symbol, and the third storage volume 1274 may be black in color are marked with a trash can symbol or the word “trash.”

In an exemplary embodiment, the refuse collection drone 20 includes one or more imaging sensors. The one or more imaging sensors may be communicably coupled with the controller 142. The one or more imaging sensors (e.g., cameras) can be positioned and configured to obtain and output image data related to the refuse deposited into the multiple compartments of the refuse collection drone 20. For example, the one or more imaging sensors may be positioned on the cover 170 of the refuse collection drone 20 and oriented downward so that the interior space of the bin 130 is within the field of view of the one or more imaging sensors. The controller 142 may be configured to determine the amount and type of refuse deposited into the refuse collection drone 20 based on the image data output by the one or more imaging sensors.

Referring again to FIG. 32, the refuse collection drone 20 can include a first imaging sensor 1276, a second imaging sensor 1278, and a third imaging sensor 1280. The first imaging sensor 1276 may be positioned on the refuse collection drone 20 so that the first storage volume 1270 is within the field of view of the first imaging sensor 1276 so that the first imaging sensor 1276 outputs image data related to refuse deposited in the first storage volume 1270. The second imaging sensor 1278 may be positioned on the refuse collection drone 20 so that the second storage volume 1272 is within the field of view of the second imaging sensor 1278 so that the second imaging sensor 1278 outputs image data related to refuse deposited in the second storage volume 1272. The third imaging sensor 1280 may be positioned on the refuse collection drone 20 so that the third storage volume 1274 is within the field of view of the third imaging sensor 1280 so that the third imaging sensor 1280 outputs image data related to refuse deposited in the third storage volume 1274. Each of the first imaging sensor 1276, the second imaging sensor 1278, and the third imaging sensor 1280 may be communicably coupled with the controller 142 of the refuse drone 20 so that the controller 142 can obtain image data related to refuse deposited in each of the first storage volume 1270, the second storage volume 1272, and the third storage volume 1274.

In an exemplary embodiment, the refuse collection drone 20 determines the amount and type of refuse deposited by a customer of the system 10 and assesses individualized fees based on the amount and type of refuse deposited. The refuse collection drone may also transmit a notification to the refuse depot 30 and/or mobile refuse depot (e.g., a full size refuse collection vehicle, etc.). In some embodiments, the refuse collection drone is configured to transmit the notification to one of a plurality of refuse depots or mobile refuse depots based on refuse type (e.g., to hail a recycling truck when recyclable materials are identified, a garbage truck when organic refuse is identified, etc.). The notification may include information related to the amount and type of refuse collected by the refuse collection drone 20 at the customer's location. The notification may be used by the refuse depot 30, or the components thereof, so that the refuse depot 30 may accommodate the arrival of the refuse collection drone 20 for emptying by the refuse depot 30. For example, the notification may indicate that contaminants were deposited into the refuse collection drone 20 by the customer so that personnel may be made available at the refuse depot 30 and/or so that a corresponding type of machinery may be hailed to facilitate emptying the refuse collection drone 20 to properly handle and dispose of the contaminants.

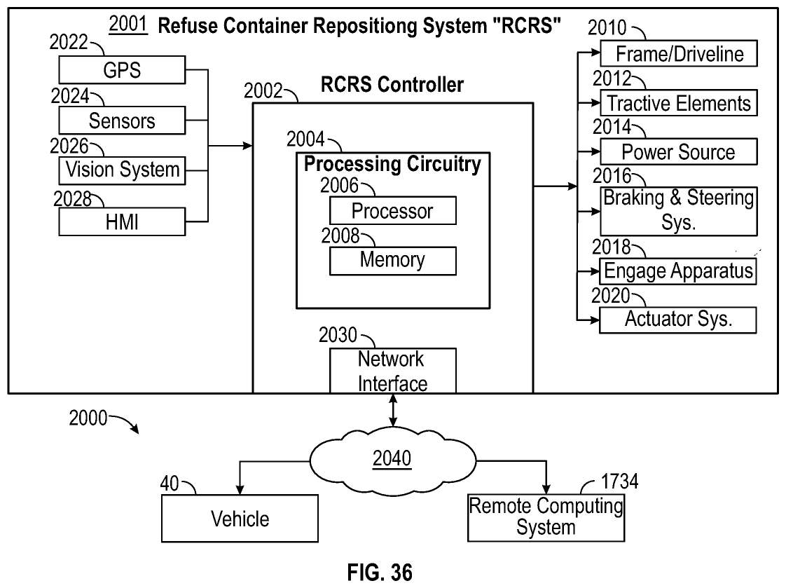

FIG. 33 illustrates a method 1290 for analyzing refuse deposited into the refuse collection drone 20 and assessing fees based on the type and amount of refuse deposited, according to an exemplary embodiment. The method 1290 may be implemented by a refuse collection drone 20 and will therefore be described with reference to FIG. 32. In other embodiments, the method 1290 may include additional, fewer, and/or different steps.

The method 1290 includes determining the amount of refuse deposited into the refuse collection drone 20 during a refuse collection operation, at operation 1292. In some embodiments, operation 1292 includes determining, by the controller 142, the amount of refuse deposited into refuse collection drone 20 during the refuse collection operation. In some embodiments, the controller 142 may obtain refuse amount data from the weight sensor 164 before and after the refuse collection operation. The controller 142 may then determine the amount of refuse by subtracting the weight of refuse within the refuse collection drone 20 before the refuse collection operation from the weight of refuse within the refuse collection drone 20 after the refuse collection operation. In some embodiments, the controller 142 may obtain level data from the camera 166 indicative of the volume of refuse within the refuse collection drone 20 before and after the refuse collection operation. The controller 142 may then determine the amount of refuse by subtracting the volume of refuse within the refuse collection drone 20 before the refuse collection operation from the volume of refuse within the refuse collection drone 20 after the refuse collection operation.

In some embodiments, and as described above in reference to FIG. 32, the bin 130 of the refuse collection drone 20 is divided into multiple compartments (e.g., the first storage volume 1270, the second storage volume 1272, and the third storage volume 1274). In some such embodiments, the controller 142 may obtain image data related to the amount of refuse in each of the multiple compartments from one or more imaging sensors (e.g., the first imaging sensor 1276, the second imaging sensor 1278, and the third imaging sensor 1280) before and after the refuse collection operation. In some such embodiments, the controller is configured to determine the amount of refuse deposited into each compartment of the multiple compartments by subtracting the amount of refuse within the compartment before the refuse collection operation from the amount of refuse within the compartment after the refuse collection operation. The controller 142 may determine the total amount of refuse deposited in the refuse drone 20 during a refuse collection operation by summing the amount of refuse deposited into each of the multiple compartments of the refuse collection drone 20 during the refuse collection operation.

The method 1290 includes determining the type of refuse deposited into the refuse collection drone 20 during a refuse collection operation, at operation 1294. In some embodiments, operation 1294 includes determining, by the controller 142, the type or types of refuse deposited into the refuse collection drone 20 during the refuse collection operation. In some embodiments, the controller 142 may obtain refuse type data indicative of the type of refuse within the refuse collection drone 20 from the camera 166. In some embodiments, the bin 130 is divided into multiple compartments (e.g., the first storage volume 1270, the second storage volume 1272, and the third storage volume 1274), each designated for a particular type of refuse. In some such embodiments, the controller 142 may obtain image data related to the amount of refuse in each of the multiple compartments from one or more imaging sensors (e.g., the first imaging sensor 1276, the second imaging sensor 1278, and the third imaging sensor 1280) before and after the refuse collection operation. In some such embodiments, the controller 142 determines if a particular type of refuse was deposited into the refuse collection drone 20 by determining if the amount of refuse within the compartment designated for the particular type of refuse increased after completing the refuse collection operation. In some such embodiments, the controller is configured to determine the amount of a particular type of refuse deposited into each compartment of the multiple compartments by subtracting the amount of refuse within the compartment before the refuse collection operation from the amount of refuse within the compartment after the refuse collection operation.

In some embodiments, operation 1294 includes determining, by the controller 142, whether contaminants or other prohibited articles of refuse were deposited into the refuse collection drone 20 during a refuse collection operation. The controller 142 may obtain image data related to the refuse within the refuse collection drone from an imaging sensor (e.g., camera 166, the first imaging sensor 1276, the second imaging sensor 1278, the third imaging sensor 1280, etc.). The controller 142 may implement an image processing method or process to identify contaminants or other prohibited articles of refuse based on the image data. In some embodiments, the refuse collection drone 20 may include one or more contaminant sensors (e.g., a spectral imaging sensor, a particle imaging sensor, a magnetic field sensor, an x-ray sensor, etc.) operably coupled with the controller 142 and positioned on or within the refuse collection drone 20 to detect contaminants within refuse deposited into the refuse collection drone 20. The controller 142 may determine whether contaminants were deposited into the refuse collection drone 20 during a refuse collection operation based on data output by the one or more contaminant sensors.

The method 1290 includes assessing fees for the performance of the refuse collection operation, at operation 1296. In some embodiments, operation 1296 includes assessing, by the controller 142, a fee to be charged to the customer associated with the location of the refuse collection operation for the refuse collection operation. In some embodiments, information related to the type and amount of refuse collected is transmitted by the controller 142 of the refuse collection drone 20 to the service manager 60, and the service manager 60 assesses the fee to be charged to the customer. The fee assessed may be based on the amount of refuse deposited into the refuse collection drone 20 during the refuse collection operation, as determined at operation 1292. Additionally, or alternatively, the fee assessed may be based on the type or types of refuse deposited into the refuse collection drone 20 during the refuse collection operation, as determined at operation 1292. In some embodiments, the customer is charged per unit of volume, weight, or mass of refuse deposited into the refuse collection drone 20 during a refuse collection operation, regardless of the type of refuse deposited. In some embodiments, the customer may be charged at different rates based on the type of refuse deposited into the refuse collection drone 20 during a refuse collection operation. For example, the customer may be charged at a first rate for mixed waste, a second rate for recyclables, and a third rate for electronic waste. The fee assessed at operation 1296 may include a surcharge if contaminants or other prohibited articles of refuse are detected at operation 1294.

In some embodiments, operation 1296 includes creating a record of the type and amount of refuse collected. For example, information related to the type and amount of refuse collected may be transmitted by the refuse collection drone 20 to the service manager 60. The service manager 60 may associate the information with a corresponding customer of the system 10. The record may be used to later justify the fees assessed for a refuse collection operation. The record may include a photograph of the refuse collected by the refuse collection drone 20 during the refuse collection operation (e.g., a photograph obtained from the camera 166, the first imaging sensor 1276, the second imaging sensor 1278, the third imaging sensor 1280, etc.).

The method 1290, includes providing notification or warning to the customer upon completion of the refuse collection operation, at operation 1298. In some embodiments, operation 1298 includes transmitting, by the controller 142, to the customer (e.g., via the user device 50) a notification that the refuse collection operation has been completed. The notification may include the fees assessed at operation 1296 and/or provide instruction as to how the fees may be paid. In some embodiments, the notification includes a warning that contaminants or other prohibited articles of refuse were detected within the refuse deposited into the refuse collection drone 20 during the refuse collection operation. The warning may include instructions to remove the contaminant or other prohibited articles of refuse from the refuse collection drone 20 before the refuse collection drone 20 departs the customer's location. Additionally, or alternatively, the warning may include details about the surcharge that will be assessed based on the presence of the contaminants or other prohibited articles of refuse deposited into the refuse drone 20 during the refuse collection operation.

In some embodiments, operation 1298 additionally, or alternatively, includes providing, by the controller 142, a notification to the refuse depot 30 upon completion of the refuse collection operation. The notification may include information related to the amount and type of refuse collected by the refuse collection drone 20 during the refuse collection operation. The notification may be used by the various components of the refuse depot 30 to prepare for the arrival of the refuse collection drone 20 at the refuse depot 30 for unloading. In some embodiments, the notification contains a warning that contaminants or other prohibited articles of refuse were detected in the refuse collected by the refuse drone 20 during the refuse collection operation. The warning may include instructions for handling the contaminants or other prohibited items by the components of the refuse depot 30. The warning may be forwarded to the service manager 60 so that personnel can be dispatched to handle and properly dispose of the contaminants or other prohibited articles of refuse.

The method 1290 includes routing the refuse collection drone 20 based on the type and/or amount of refuse collected during the refuse collection operation, at operation 1300. In some embodiments, the system 10 includes multiple refuse vehicles 40 and multiple refuse depots 30 capable of emptying refuse from the refuse collection drone 20. The system 10 may include refuse vehicles 40 and refuse depots 30 configured to collect, store, and or transport different types of refuse. For example, a particular refuse vehicle 40 or refuse depot 30 may be especially adapted to handle contaminants (e.g., electronic waste, batteries, paints, mercury containing products etc.). By way of another example, a particular refuse vehicle 40 or refuse depot 30 may be especially adapted to handle recyclable waste. By way of yet another example, a particular refuse vehicle 40 or refuse depot 30 may be especially adapted to handle mixed waste (e.g., trash, garbage, etc.).

In some embodiments, operation 1300 includes routing the refuse collection drone 20 to a particular refuse vehicle 40 or a refuse depot 30 capable of handling the type of refuse collected by the refuse drone 20, as determined at operation 1294. In some embodiments, operation 1300 includes routing, by the controller 142, the refuse drone to a particular refuse vehicle 40 or refuse depot 30 capable of handling the type of refuse collected by the refuse drone 20. In some embodiments, information related to the type of refuse collected by the refuse drone 20 is transmitted by the controller 142 to the service manager 60, and the service manager 60 routes the refuse drone to a particular refuse vehicle 40 or refuse depot 30 capable of handling the type of refuse collected by the refuse drone 20. The system 10 (e.g., the service manager 60) may maintain information related to the capabilities and location of each refuse depot 30 and/or refuse vehicle 40 of the system 10. A particular refuse depot 30 or refuse vehicle 40 may be selected, for routing thereto, based on its ability to handle the type of refuse collected by the refuse collection drone 20 and its proximity to the refuse collection drone 20. Once a particular refuse depot 30 or refuse vehicle 40 has been selected, the refuse collection drone 20, or the controller 142 thereof, may begin travelling to the particular refuse depot 30 or refuse vehicle 40 using information indicating the location of the particular refuse depot 30 or refuse vehicle 40 selected.

In some embodiments, operation 1300 includes routing the refuse collection drone 20 to a particular refuse vehicle 40 or a refuse depot 30 capable of handling the amount of refuse collected by the refuse drone 20, as determined at operation 1294. In some embodiments, operation 1300 includes routing, by the controller 142, the refuse drone 20 to a particular refuse vehicle 40 or refuse depot 30 capable of handling the amount of refuse collected by the refuse drone 20. In some embodiments, information related to the amount of refuse collected by the refuse collection drone 20 is transmitted by the controller 142 to the service manager 60, and the service manager 60 routes the refuse collection to a particular refuse depot 30 or refuse vehicle 40 capable of handling the amount of refuse collected by the refuse collection drone 20. The system 10 (e.g., the service manager 60) may receive and maintain information related to the current remaining refuse storage capacity of each refuse depot 30 and refuse vehicle 40 in the system 10. A particular refuse depot 30 (e.g., a particular staging area, landfill, etc.) and/or refuse vehicle 40 may be selected, for routing thereto, based on it having sufficient remaining refuse storage capacity to store the additional refuse collected by the refuse collection drone 20 and its proximity to the refuse collection drone 20. Once a particular refuse depot 30 or refuse collection vehicle 40 has been selected, the refuse collection drone 20, or the controller 142 thereof, may begin travelling to the particular refuse depot 30 or refuse vehicle 40 using information indicating the location of the particular refuse depot 30 or refuse vehicle 40.

### Refuse Container Repositioning and Collection System

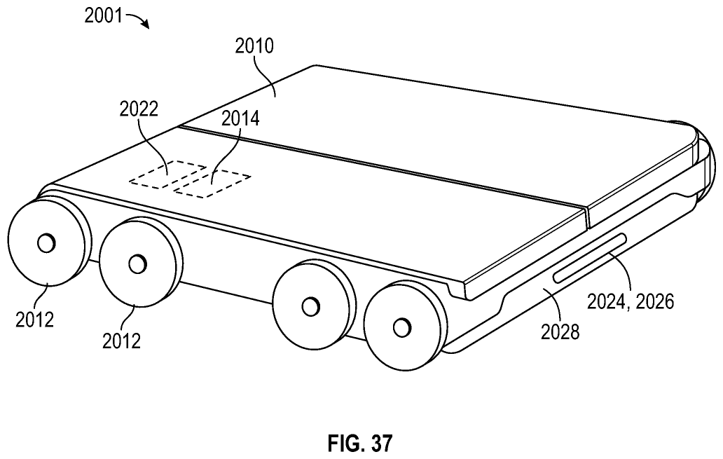

Referring generally to FIGS. 34-50, a refuse container repositioning system may be interoperable with a refuse container. The refuse container repositioning system may also be interoperable with a refuse vehicle (e.g., for deployment from the refuse vehicle). The refuse container repositioning system may remotely, autonomously, or semi-autonomously stage and/or arrange refuse containers (e.g., commercial refuse containers, garbage dumpsters, recycling dumpsters, etc.) such that they are readily retrievable by the refuse vehicle. Beneficially, an operator may deploy and/or control the refuse container repositioning system (e.g., separately from the refuse vehicle). For example, the operator may deploy and/or control the refuse container repositioning system based on a refuse collection schedule (e.g., on a refuse collection day and/or proximate to a pickup time) such that the refuse container may be positioned in a first location for customers to dispose of refuse, and moved by the refuse container repositioning system to a second location providing convenient and/or safer access for the refuse vehicle to engage the refuse container and collect refuse therefrom. The refuse container repositioning system may have a smaller profile, produce less noise, require less energy, and place personnel in less danger as compared to other refuse container repositioning methods by facilitating retrieval and return of refuse containers. Further, the refuse container repositioning system may access areas that the refuse vehicle may not be able to enter, such as narrow alleys, neighborhoods with noise restrictions, apartment complexes and/or garages, and the like, thereby increasing the scope of a refuse collection operation.

Referring to FIG. 34, the refuse vehicle 40 may include a control system 1700 that is configured to facilitate autonomous or semi-autonomous operation of the refuse vehicle 40, or components thereof. The control system 1700 includes a controller 1702 that is positioned on the refuse vehicle 40, a remote computing system 1734, a telematics unit 1732, one or more input devices 1750, and one or more controllable elements 1752. The input devices 1750 can include a Global Positioning System (“GPS”), multiple sensors 1726, a vision system 1728 (e.g., an awareness system), and a Human Machine Interface (“HMI”) 130. The controllable elements 1752 can include a driveline 1710 of the refuse vehicle 40, a braking system 1712 of the refuse vehicle 40, a steering system 1714 of the refuse vehicle 40, a lift apparatus 1716 (e.g., the lift assembly 340, etc.), a compaction system 1718 (e.g., a packer assembly, the packer 46, etc.), body actuators 1720 (e.g., tailgate actuators 24, lift or dumping actuators, etc.), and/or an alert system 1722.

The controller 1702 includes processing circuitry 1704 including a processor 1706 and memory 1708. Processing circuitry 1704 can be communicably connected with a communications interface of controller 1702 such that processing circuitry 1704 and the various components thereof can send and receive data via the communications interface. Processor 1706 can be implemented as a general purpose processor, an application specific integrated circuit (“ASIC”), one or more field programmable gate arrays (“FPGAs”), a group of processing components, or other suitable electronic processing components.

Memory 1708 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1708 can be or include volatile memory or non-volatile memory. Memory 1708 can include database components, object code components, script components, or any other type of information structure for supporting the various activities and information structures described in the present application. According to some embodiments, memory 1708 is communicably connected to processor 1706 via processing circuitry 1704 and includes computer code for executing (e.g., by at least one of processing circuitry 1704 or processor 1706) one or more processes described herein.

The controller 1702 is configured to receive inputs (e.g., measurements, detections, signals, sensor data, etc.) from the input devices 1750, according to some embodiments. In particular, the controller 1702 may receive a GPS location from the GPS 1724 (e.g., current latitude and longitude of the refuse vehicle 40). The controller 1702 may receive sensor data (e.g., engine temperature, fuel levels, transmission control unit feedback, engine control unit feedback, speed of the refuse vehicle 40, etc.) from the sensors 1726. The controller 1702 may receive image data (e.g., real-time camera data) from the vision system 1728 of an area of the refuse vehicle 40 (e.g., in front of the refuse vehicle 40, rearwards of the refuse vehicle 40, on a street-side or curb-side of the refuse vehicle 40, at the hopper of the refuse vehicle 40 to monitor refuse that is loaded, within the cab 16 of the refuse vehicle 40, etc.). The controller 1702 may receive user inputs from the HMI 1730 (e.g., button presses, requests to perform a lifting or loading operation, driving operations, steering operations, braking operations, etc.).

The controller 1702 may be configured to provide control outputs (e.g., control decisions, control signals, etc.) to the driveline 1710 (e.g., the engine 18, the transmission 22, the engine control unit, the transmission control unit, etc.) to operate the driveline 1710 to transport the refuse vehicle 40. The controller 1702 may also be configured to provide control outputs to the braking system 1712 to activate and operate the braking system 1712 to decelerate the refuse vehicle 40 (e.g., by activating a friction brake system, a regenerative braking system, etc.). The controller 1702 may be configured to provide control outputs to the steering system 1714 to operate the steering system 1714 to rotate or turn at least two of the tractive elements 20 to steer the refuse vehicle 40. The controller 1702 may also be configured to operate actuators or motors of the lift apparatus 1716 (e.g., lift arm actuators 44) to perform a lifting operation (e.g., to grasp, lift, empty, and return a refuse container). The controller 1702 may also be configured to operate the compaction system 1718 to compact or pack refuse that is within the refuse compartment 30. The controller 1702 may also be configured to operate the body actuators 1720 to implement a dumping operation of refuse from the refuse compartment 30 (e.g., driving the refuse compartment 30 to rotate to dump refuse at a landfill). The controller 1702 may also be configured to operate the alert system 1722 (e.g., lights, speakers, display screens, etc.) to provide one or more aural or visual alerts to nearby individuals.

The controller 1702 may also be configured to receive feedback from any of the driveline 1710, the braking system 1712, the steering system 1714, the lift apparatus 1716, the compaction system 1718, the body actuators 1720, or the alert system 1722. The controller may provide any of the feedback to the remote computing system 1734 via the telematics unit 1732. The telematics unit 1732 may include any wireless transceiver, cellular dongle, communications radios, antennas, etc., to establish wireless communication with the remote computing system 1734. The telematics unit 1732 may facilitate communications with telematics units 1732 of nearby refuse vehicles 10 to thereby establish a mesh network of refuse vehicles 10.

The controller 1702 is configured to use any of the inputs from any of the GPS 1724, the sensors 1726, the vision system 1728, or the HMI 1730 to generate controls for the driveline 1710, the braking system 1712, the steering system 1714, the lift apparatus 1716, the compaction system 1718, the body actuators 1720, or the alert system 1722. In some embodiments, the controller 1702 is configured to operate the driveline 1710, the braking system 1712, the steering system 1714, the lift apparatus 1716, the compaction system 1718, the body actuators 1720, and/or the alert system 1722 to autonomously transport the refuse vehicle 40 along a route (e.g., self-driving), perform pickups or refuse collection operations autonomously, and transport to a landfill to empty contents of the refuse compartment 30. The controller 1702 may receive one or more inputs from the remote computing system 1734 such as route data, indications of pickup locations along the route, route updates, customer information, pickup types, etc. The controller 1702 may use the inputs from the remote computing system 1734 to autonomously transport the refuse vehicle 40 along the route and/or to perform the various operations along the route (e.g., picking up and emptying refuse containers, providing alerts to nearby individuals, limiting pickup operations until an individual has moved out of the way, etc.).

The refuse vehicle 40 may include a user interface 2003. The user interface 2003 allows user inputs to be received and communicated to one or more RCRSs. Further, the user interface 2003 may communicate data, images, or messages related to one or more RCRSs. For example, the user interface 2003 may include a display screen, a touch screen, a controller, a joystick, a keyboard, one or more dials, knobs, switches, or the like. As discussed herein, the user interface 2003 may allow for an operator to toggle between a remote mode (e.g., where the RCRS is controlled by the operator via a controller, where the operator directly drives or operates the RCRS), an autonomous mode (e.g., where the RCRS operates substantially independently based on instructions and/or programming stored in its memory, etc.), and/or semi-autonomously (e.g., where the RCRS operates substantially independently while an operator observes and may make corrective/overriding actions). Further, the user interface 2003 may include on or more display devices such as LCD screens, mobile phones, applications, etc. to display information related to the RCRSs. The information may include camera feed or image data received from the RCRS, GPS data related to the RCRS, battery level of the RCRS, weight of refuse currently loaded on the RCRS, or the like.

The controller 1702 may be communicatively, electrically, or otherwise coupled to the deployable vehicle dock 2007. In this way, the controller 1702 may direct power to the deployable vehicle dock 2007 (e.g., to charge a RCRS upon receiving an indication that the RCRS is connected to a power connector of the deployable vehicle dock 2007). The controller 1702 may also display a connection status regarding the deployable vehicle dock, cause one or more RCRSs to couple/de-couple from the deployable vehicle dock 2007, or the like.

In some embodiments, the remote computing system 1734 is configured to interact with (e.g., control, monitor, etc.) the refuse vehicle 40 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 1734 may perform any of the route planning techniques as described in greater detail in U.S. application Ser. No. 18/111,137, filed Feb. 17, 2023, the entire disclosure of which is incorporated by reference herein. The remote computing system 1734 may implement any route planning techniques based on data received by the controller 1702. In some embodiments, the controller 1702 is configured to implement any of the cart alignment techniques as described in U.S. application Ser. No. 18/242,224, filed Sep. 5, 2023, the entire disclosure of which is incorporated by reference herein. The refuse vehicle 40 and the remote computing system 1734 may also operate or implement geofences as described in greater detail in U.S. application Ser. No. 17/232,855, filed Apr. 16, 2021, the entire disclosure of which is incorporated by reference herein.

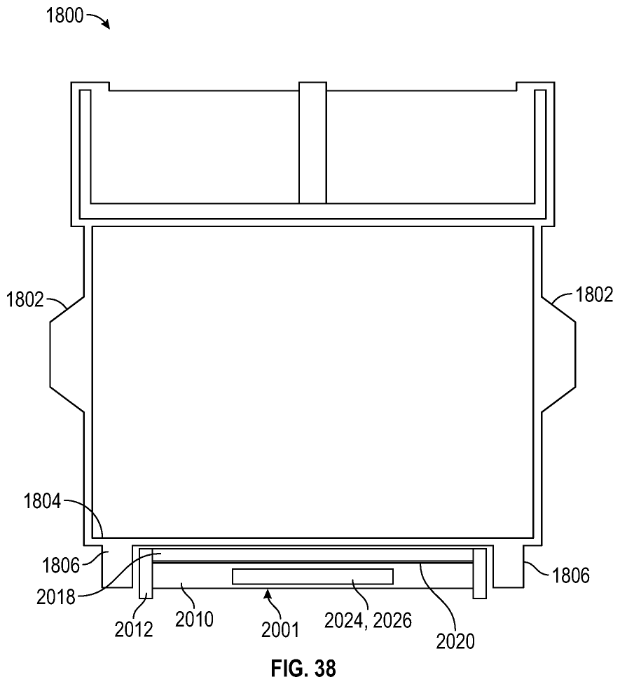

Referring to FIG. 35, a diagram 1900 illustrates a route 1908 through a municipality 1902 for the refuse vehicle 40. The route 1908 includes future stops 1914 along the route 1908 to be completed, and past stops 1916 that have already been completed. The route 1908 may be defined and provided by the remote computing system 1734. The remote computing system 1734 may also define or determine the future stops 1914 and the past stops 1916 along the route 1908 and provide data regarding the geographic location of the future stops 1914 and the past stops 1916 to the controller 1702 of the refuse vehicle 40. The refuse vehicle 40 may use the route data and the stops data to autonomously transport along the route 1908 and perform refuse collection at each stop. The route 1908 may end at a landfill 1904 (e.g., an end location) where the refuse vehicle 40 may autonomously empty collected refuse, transport to a refueling location if necessary, and begin a new route.

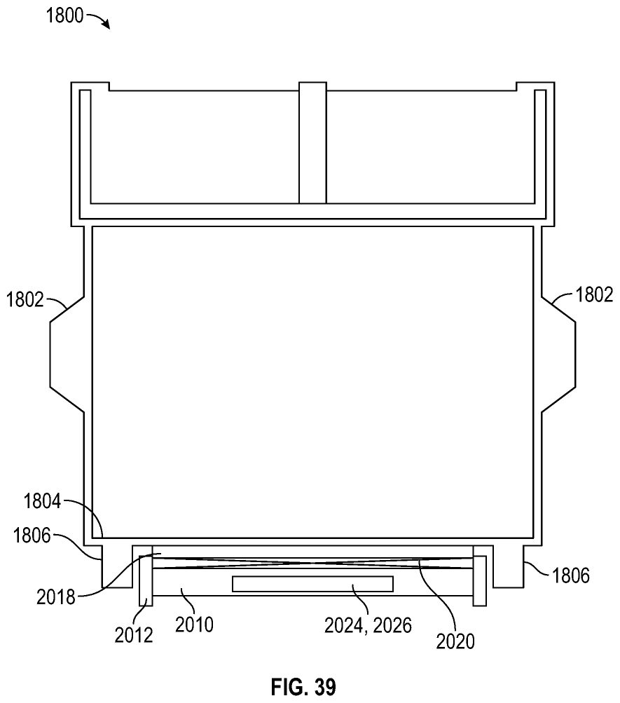

Referring to FIG. 36, a refuse collection system 2000 is shown that includes the refuse vehicle 40 and a RCRS 2001 (e.g., a drone, a robot, an autonomous machine, etc.). The refuse collection system 2000 may also include the remote computing system 1734 through which commands, data, and the like are transmitted to and from the refuse vehicle 40 and the RCRS 2001 via a network 2040. The network 2040 may be any type of network (e.g., intranet, Internet, VPN, a cellular network, a satellite network, etc.) that allows the refuse vehicle 40 and/or the RCRS 2001 to communicate with other remote systems. For example, vehicle 40 and/or RCRS 2001 may communicate with a server (e.g., a computer, a cloud server, etc.) to send and receive information regarding operations of the RCRS 2001 and/or the refuse vehicle 40. In some embodiments, the RCRS 2001 includes a controller (e.g., a control system, etc.), as described herein (e.g., a RCRS controller 2001, the control system 140, etc.).

As shown in FIGS. 36, 37, and 40 the RCRS 2001 includes various input devices such as a Global Positioning System (“GPS”) 522, one or more sensors 2024, a vision system 2026 (e.g., an awareness system), and a Human Machine Interface (“HMI”) 528. The RCRS 2001 also includes various controllable elements such as a deployable frame/driveline 2010, tractive elements 2012, a power source 2014, a braking and steering system 2016, a container engagement apparatus 2018 (e.g., a robotic arm, a lift assembly, a forklift connector, a grabber mechanism, etc.), and/or an actuator system 2020 (e.g., actuators to control the container engagement apparatus 2018, actuators to couple/decouple the RCRS 2001 to/from the refuse vehicle 40, actuators to fold/condense the frame 2010 for storage, motors, cylinders, pumps, etc.).

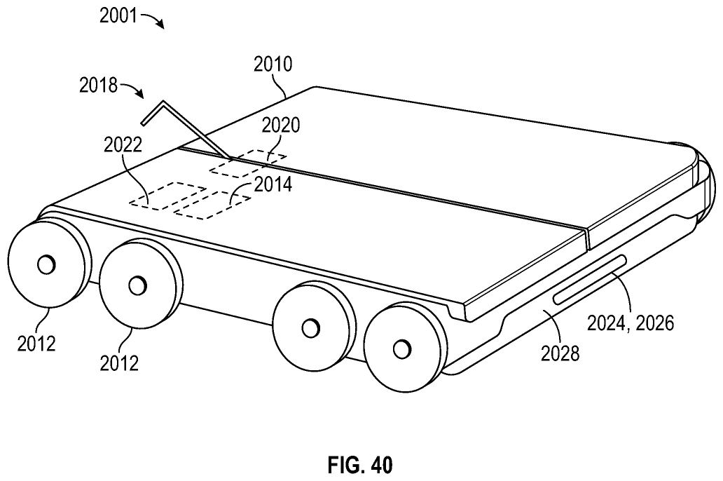

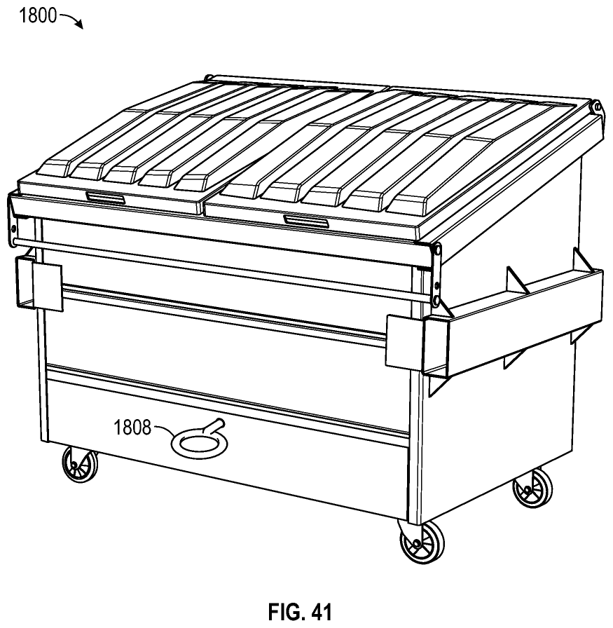

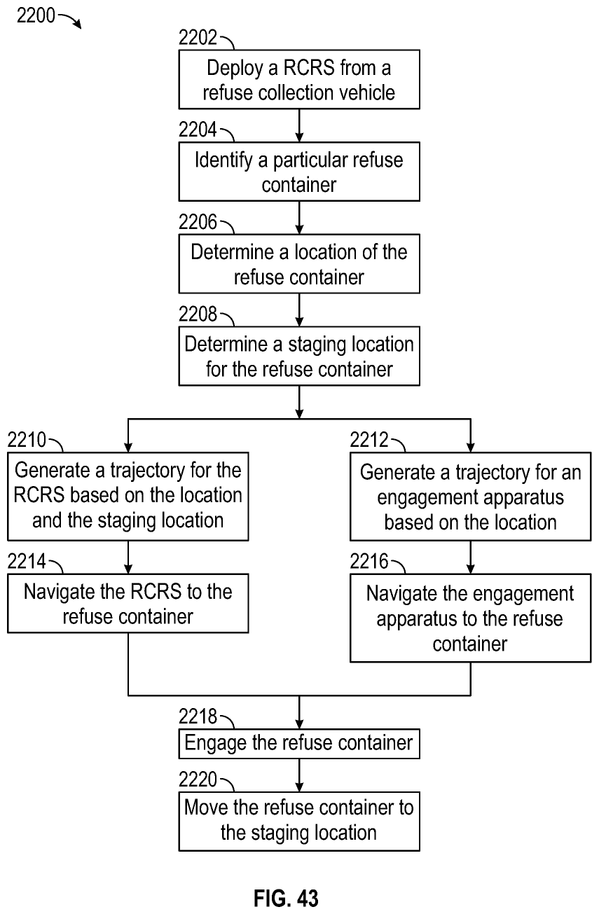

Referring to FIGS. 37 and 40, the frame 2010 may provide a structural foundation around which the other components of the RCRS 2001 are coupled. The frame 2010 may be composed of steel, metals, composite materials, or other suitable components to be deployed and collect, haul, lift, etc. refuse/refuse cans, etc. The frame 2010 may include a built-in driveline that includes components such as a transmission, gears, a prime mover (e.g., an electric motor), and other suitable components. Further, the frame 2010 may be configured to transition between a storage state and a deployed state. In the storage state, the frame/driveline 2010 may condense down, disassemble, fold together, flatten, etc. and reduce its size/profile. For example, connectors, hinges, or other bars/members of the frame 2010 may slidably engage and disengage to flatten the frame or condense the frame down to a block, panel, or other suitable shape. In some embodiments, components of the RCRS 2001 telescopically extend or collapse to deploy/store the RCRS 2001. While in the storage state, the frame/driveline 2010 may be lifted, coupled, and/or stored on the refuse vehicle 40. For example, the container engagement apparatus 2018 and the actuator system 2020 (e.g., a gripping arm or extension) may fold or collapse backward into a channel, pocket, or other compartment defined in the frame 2010. Further, the frame/driveline 2010 and other components of the RCRS 2001 may mount to or fit within the deployable vehicle dock 2007 while in the storage state. While in the deployed state, the frame/driveline 2010 may be assembled, fully extended, or otherwise configured such that the RCRS 2001 may navigate and operate to collect and engage with refuse cans, such as the refuse container 1800 shown in FIGS. 38, 39, 41, 43, and 46-48.

The tractive elements 2012 may include wheels, tracks, or other suitable attachments to allow the RCRS 2001 to navigate from the refuse vehicle 40 to one or more refuse containers 1800.

The power source 2014 can provide power to the RCRS 2001 and the components of the thereof. The power source 2014 can be embedded into or attached on to the frame 2010. The power source 2014 may include a battery. The battery may be a rechargeable or non-rechargeable type including an alkaline battery, a nickel-cadmium battery, a nickel-metal hydride battery, a lithium-ion battery, or a lead-acid battery. In a preferred embodiment, the power source 2014 is a battery which can be recharged using an interface such as a power connector, plug, etc. configured to couple to a power conduit or connector of the deployable vehicle dock 2007 of the refuse vehicle 40. Additionally, the power source 2014 may be charged separate from the refuse vehicle 40 via a charger, generator, or the like.

The braking and steering system 2016 allows the RCRS 2001 to navigate and change its path or direction in response to inputs, such as commands or signals from an operator via a remote or commands or signals from a RCRS controller 2002 as discussed herein. In some embodiments, the braking and steering system 2016 is a skid-steer system. In some embodiments, the tractive elements 2012 pivotable or steerable.

Referring to FIG. 36-42 and 49, the RCRS 2001 is configured to be deployed from the refuse vehicle 40 (e.g., at a time of the refuse vehicle 40 arriving to collect refuse from the refuse container 1800) and the container engagement apparatus 2018 allows the RCRS 2001 to selectively engage with the refuse containers 1800, collection bins, corals, doors, gates, and other structures to assist in a refuse collection operation. In some embodiments, the RCRS 2001 is configured to be deployed at a customer location (e.g., where the RCRS 2001 and/or the refuse container 1800 to be engaged by the RCRS 2001 is located at the customer location). For example, the RCRS 2001 may be deployed (e.g., autonomous, manually driven, driven via remote control, etc.) from a storage area at the customer location (e.g., from a garage and/or a charging station for the RCRS 2001), so the RCRS 2001 may travel to and engage the refuse container 1800.

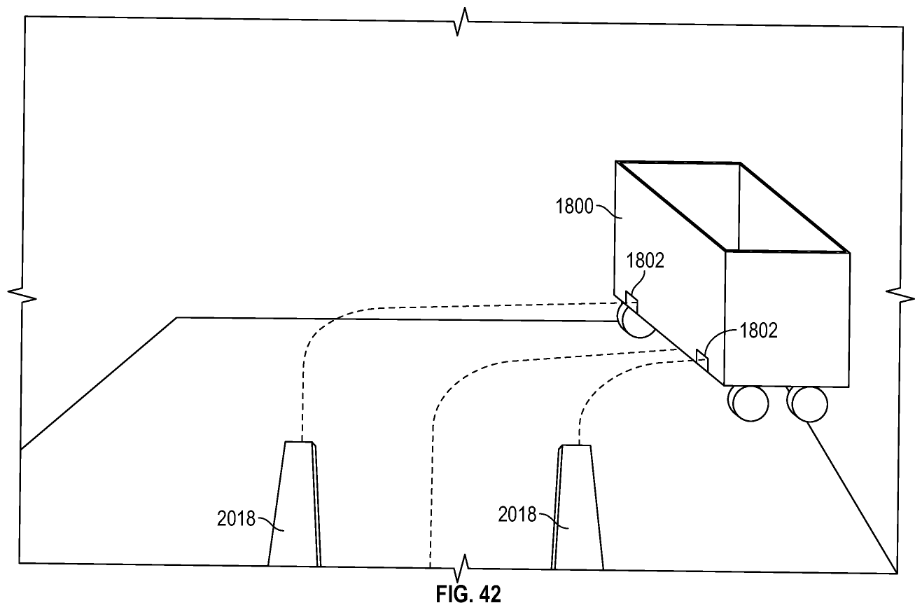

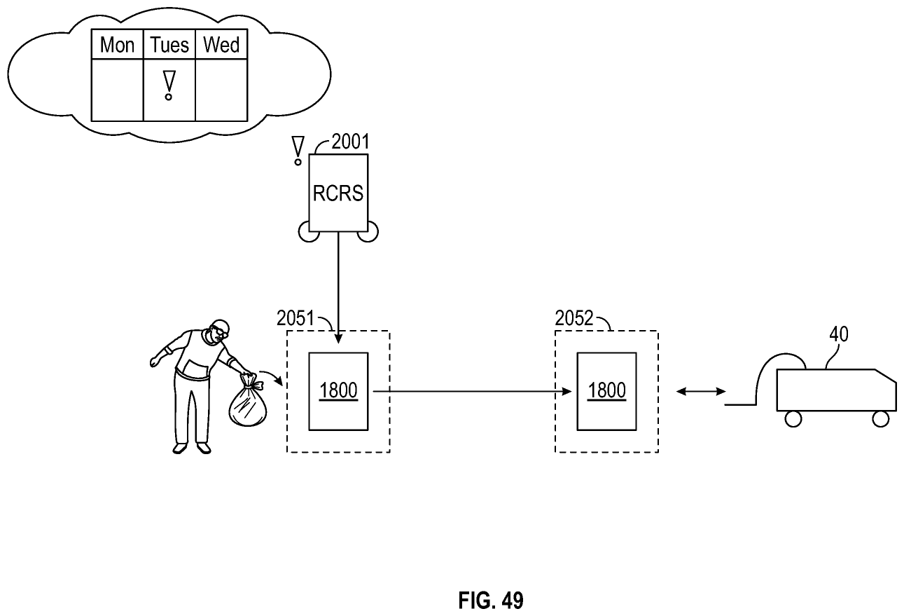

As shown in FIGS. 38 and 39, the container engagement apparatus 2018 is configured as a liftable or extendable platform movable relative to the frame 2010 and the actuator system 2020 is configured as a lift actuator (e.g., a scissor lift). Accordingly, the RCRS 2001 is configured to drive underneath the refuse container 1800 between caster wheels 1806 thereof and then extend the extendable platform to engage with a bottom 1804 of the refuse container 1800 to lift the refuse container 1800 from the ground. For example, the refuse container 1800 may be a 1-yard refuse container, an 8-yard refuse container, or another size of refuse container (e.g., a size between 1-yard and 8-yard, etc.). The RCRS 2001 may then navigate with the refuse container 1800 thereon to a staging location 2052 readily accessible to the refuse vehicle 40 (e.g., see FIG. 49).

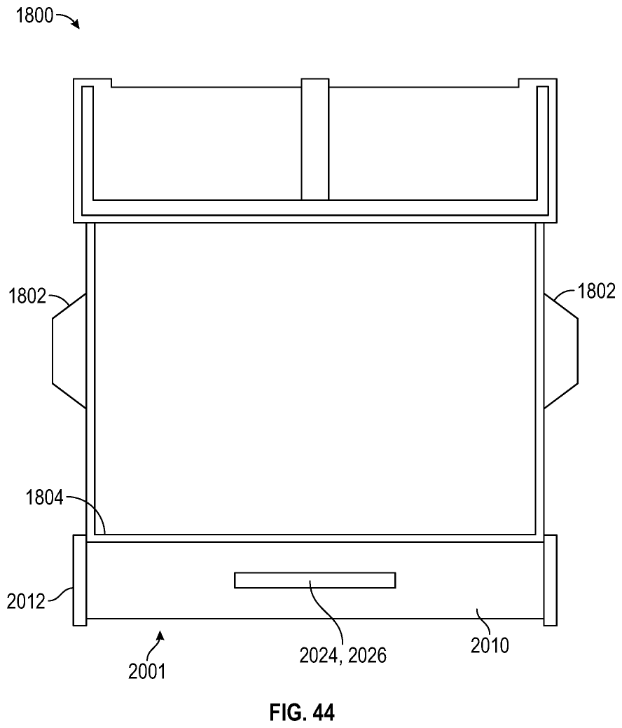

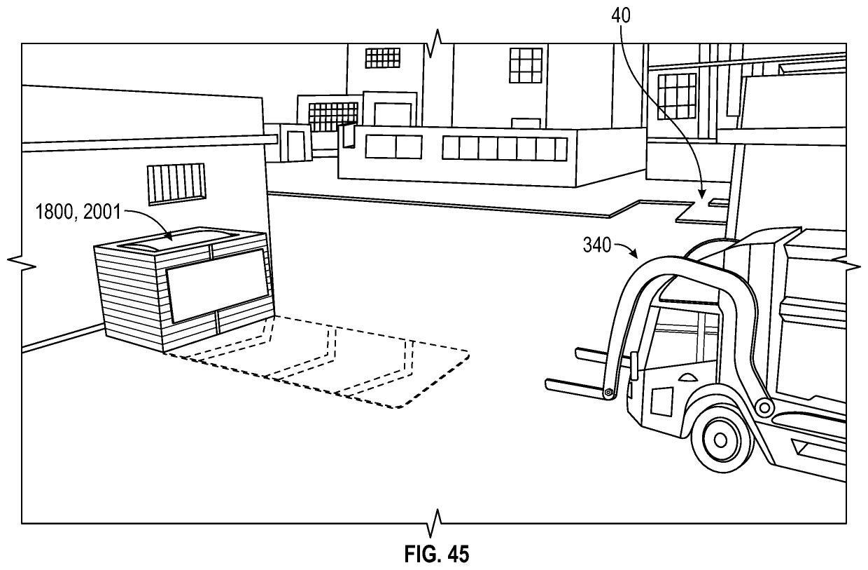

As shown in FIGS. 40 and 41, the container engagement apparatus 2018 includes a claw, a hook, a robotic arm, a tow bar, a tether, or grasping member that is configured to engage or grip a first portion or interface, shown as tow interface 1808, of the refuse container 1800. In this way, the RCRS 2001 may engage and move the refuse container 1800 to a staging location 2052 readily accessible to the refuse vehicle 40 (e.g., see FIG. 49). As shown in FIG. 42, the container engagement apparatus 2018 includes forks that are configured to engage a second portion or interface, shown as fork pockets 1802, of the refuse container 1800. The RCRS 2001 may then lift the refuse container 1800 via the forks and navigate with the refuse container 1800 on the forks to a staging location 2052 readily accessible to the refuse vehicle 40 (e.g., see FIG. 49).

As shown in FIG. 49, the refuse container 1800 may be positioned at a first location at the customer location, shown as collection location 2051, where the collection location 2051 provides accessibility for depositing refuse into the refuse container 1800 (e.g., accessibility for customers, users, and/or other drones or robots). The customer location may include a second location, shown as staging location 2052, for example, where the staging location 2052 may be a designated and/or accessible location for the refuse vehicle 40 to collect refuse from the refuse container 1800. For example, the staging location 2052 can reduce safety hazards to customers and/or users if said customer and/or user can be proximate to the refuse vehicle 40 during refuse collection, and/or reduces accidents involving the refuse vehicle 40 due to difficulties in engaging the refuse container 1800 (e.g., obstructions between the lift assembly 340 and the refuse container 1800, difficult angles and/or clearances for the refuse vehicle 40 to access the refuse container 1800, etc.). In some embodiments, the staging location 2052 is selected by an operator via the user interface 2003 of the refuse vehicle 40. In some embodiments, the staging location 2052 is automatically selected by the RCRS 2001 based on a location of the refuse vehicle 40 and/or a surrounding environment (e.g., obstacles, parked cars, buildings, etc.).

The sensors 2024 may include image/object sensors (e.g., any type of device that is configured to capture data associated with the detection of objects such as the refuse containers 1800). The sensors 2024 may include any type of image and/or object sensors, such as one or more visible light cameras, full-spectrum cameras, LIDAR cameras/sensors, radar sensors, infrared cameras, image sensors (e.g., charged-coupled device (CCD), complementary metal oxide semiconductor (CMOS) sensors, etc.), or any other type of suitable object sensor or imaging device. Data captured by the sensors 2024 may include, for example, raw image data from one or more cameras (e.g., visible light cameras) and/or data from one or more sensors (e.g., LIDAR, radar, etc.) that may be used to detect objects (e.g., obstacles, people, refuse containers 1800, etc.).

Generally, the sensors 2024 may be disposed at any number of locations throughout and/or around the RCRS 2001 for capturing image and/or object data from any direction. For example, the sensors 2024 may include a plurality of visible light cameras and LIDAR cameras/sensors mounted on the forward and lateral sides of RCRS 2001 for capturing data as the RCRS 2001 moves down a path (e.g., a roadway). In some embodiments, one or more of the sensors 2024 may be located on an attachment utilized by RCRS 2001, such as the container engagement apparatus 2018 described above. The sensors 2024 can also include a radio frequency identification (RFID) detector (e.g., an RFID reader, an RFID transponder, etc.) that is configured to wirelessly transmit energy to proximate RFID tags. The RFID detector may monitor responses that are received from nearby RFID tags. In particular, the refuse containers 1800 may include RFID tags that are configured to provide a response signal to the RFID detector. The RFID detector may be positioned on the container engagement apparatus 2018 or on an exterior surface of the RCRS 2001 such that the RFID detector is sufficiently close to the refuse containers 1800 to communicate with RFID tags. The sensors 2024 may also include separate QR code scanners or barcode scanners positioned on the container engagement apparatus 2018 (e.g., on the claw assembly 2140) or on an exterior of the RCRS 2001.

Accordingly, the RCRS 2001 may be configured acquire information regarding the refuse container 1800 (e.g., recycling, garbage, owner, etc.) from a RFID tag and/or a QR code thereon. For example, the RCRS 2001 may be tasked to retrieve a garage container associated with a respective business. However, the garbage container may be stored with a recycling container. By scanning/reading the RFID tags and/or QR codes on the various containers at the respective business, the RCRS 2001 can differentiate between the containers and retrieve the proper container.

In some embodiments, the sensors 2024 include one or more sensors configured to facilitate determining the weight of the refuse containers 1800. Therefore, as the RCRS 2001 maneuvers with a respective refuse container 1800, the weight of the respective refuse container 1800 can be determined (e.g., for billing purposes, for vehicle weight loading purposes, etc.).

The vision system 2026 may include a detection system, an environmental detection system, an environmental awareness system, etc. that is configured to detect and identify the environment surrounding the RCRS 2001. The environment may include adjacent objects, approaching objects, lane lines, obstacles, drivable surfaces, etc. The vision system 2026 may be configured to detect different types of objects such as refuse containers, the refuse vehicle 40, other vehicles, pedestrians, buildings, or any other object that may be adjacent the RCRS 2001. The vision system 2026 may use a variety of sensors, detectors, emitters, detection sub-systems, etc., to detect different types of objects. In some embodiments, the vision system 2026 may include radar sensors with sensing arcs configured to detect objects in the surrounding area of the RCRS 2001. In some embodiments, the radar sensors are positioned on the exterior of the RCRS 2001 such that the sensing arcs of the radar sensors overlap to generate a 360-degree sensing area. In some embodiments, the radar sensors are a combination of long and short-range sensors. According to some embodiments, the vision system 2026 includes camera sensors with sensing arcs. In some embodiments, the camera sensors include a visible light camera, infrared light camera, LiDAR sensor, radar sensor, ultrasonic sensor, and/or time-of-flight camera, which may be positioned on the exterior of the RCRS 2001 such that the sensing arcs of the camera sensors overlap to generate a 360-degree sensing area. In some embodiments, the camera sensors are a combination of narrow-angle sensors and wide-angle sensors. In additional embodiments, the vision system 2026 may include a combination of the radar sensors with the sensing arcs and the camera sensors with sensing arcs. The sensing arcs of the radar sensors and the sensing arc of the camera sensors may combine to provide 360 or near-360-degree coverage of the perimeter of the RCRS 2001.

The HMI 2028 may include a control panel, joystick, controller, keyboard, mouse, switches, or other device enabling operation of and allowing commands to be sent to the RCRS 2001. In this way, an operator may drive, pilot, or otherwise navigate the RCRS 2001, for example, while in the cab 16 of the refuse vehicle 40. In other embodiments, a switch, dial, or the like of the user interface 2003 of the refuse vehicle 40 may toggle a control mode that communicatively couples the controls of the refuse vehicle 40 to the controls of the RCRS 2001. In this way, the operator may use, for example, the steering wheel/joystick of the refuse vehicle 40, a screen or dashboard display, and other components of the refuse vehicle 40 to operate and navigate the RCRS 2001. The HMI 2028 may include a display device, a screen, or other indicator to display a camera feed, video feed, or other GUI associated with or captured by the RCRS 2001. In this way, while deployed, an operator may monitor, control, and/or guide the operation of the RCRS 2001, for example, to locate the refuse containers 1800 and position them at staging areas for collection. In other embodiments, the RCRS 2001 may operate autonomously and display one or more statistics, data sets, information sets, battery conditions, or the like to a user interface (e.g., user interface 2003 of the refuse vehicle 40). For example, the RCRS 2001 may generate a map, route, or list indicating locations of the refuse containers 1800, streets with no refuse cans, a total number of refuse containers to retrieve or that have been retrieved, a battery level remaining, a battery level or charging state of a stored RCRS 2001, etc.

As shown in FIG. 36, the RCRS 2001 includes a RCRS controller 2002 that is configured to facilitate remote, autonomous, or semi-autonomous operation of the RCRS 2001, or components thereof. The RCRS controller 2002 may be positioned on the RCRS 2001. In some embodiments, the RCRS controller 2002 includes one or more components located in different places. For example, one or more components or circuits associated with the RCRS controller 2002 may be located on the remote computing system 1734, on the telematics unit 1732 of the refuse vehicle 40, etc.

The RCRS controller 2002 includes processing circuitry 2004 including a processor 2006 and memory 2008. Processing circuitry 2004 can be communicably connected with a communications interface of RCRS controller 2002 such that processing circuitry 2004 and the various components thereof can send and receive data via the communications interface. Processor 2006 can be implemented as a general-purpose processor, an ASIC, one or more FPGAs, a group of processing components, or other suitable electronic processing components.

Memory 2008 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 2008 can be or include volatile memory or non-volatile memory. Memory 2008 can include database components, object code components, script components, or any other type of information structure for supporting the various activities and information structures described in the present application. According to some embodiments, memory 2008 is communicably connected to processor 2006 via processing circuitry 2004 and includes computer code for executing (e.g., by at least one of processing circuitry 2004 or processor 2006) one or more processes described herein.

The RCRS controller 2002 is configured to receive inputs (e.g., measurements, detections, signals, sensor data, etc.) from the GPS 2022, the sensors 2024, the vision system 2026, HMI 2028, the refuse vehicle 40, and/or the remote computing system 1734, according to some embodiments. In particular, the RCRS controller 2002 may receive a GPS location from the GPS 2022 (e.g., current latitude and longitude of the RCRS 2001). The RCRS controller 2002 may receive sensor data (e.g., refuse container 1800 location, obstacle location, battery power level, speed of the RCRS 2001, weight carried/hauled/pulled by the RCRS 2001, etc.) from the sensors 2024. The RCRS controller 2002 may receive image data (e.g., real-time camera data) from the vision system 2026 of an area of the RCRS 2001 (e.g., in front of the RCRS 2001, rearwards of the RCRS 2001, on a street-side or curbside of the RCRS 2001, at the container engagement apparatus 2018 of RCRS 2001 to monitor engagement with a refuse container 1800, corral door, or object, etc.). The RCRS controller 2002 may receive user inputs from the HMI 2028 and/or the user interface 2003 (e.g., button presses, requests to perform a lifting or loading operation, driving operations, steering operations, braking operations, etc.).

The RCRS controller 2002 may be configured to provide control outputs (e.g., control decisions, control signals, etc.) to the driveline 2010 (e.g., the electric motor, etc.) to operate the driveline 2010 to transport the RCRS 2001. The RCRS controller 2002 may also be configured to provide control outputs to the braking and steering system 2016 to activate and operate the braking and steering system 2016 to decelerate the RCRS 2001 (e.g., by activating a friction brake system, etc.). Control outputs may additionally operate the braking and steering system 2016 to rotate or turn at least two of the tractive elements 2012 to steer the RCRS 2001. The RCRS controller 2002 may also be configured to operate actuators or motors of the container engagement apparatus 2018 and the actuator system 2020 (e.g., claw assembly or arm actuators) to perform a lifting/hauling/dragging/can engagement operation (e.g., to grasp, pull, and return a refuse container).

The RCRS controller 2002 may also be configured to receive feedback from any of the driveline 2010, the braking and steering system 2016, the power source 2014, the container engagement apparatus 2018, the actuator system 2020, the GPS 2022, the sensors 2024, and/or the vision system 2026. The RCRS controller 2002 may provide any of the feedback to the remote computing system 1734, the telematics unit 1732, and/or the refuse vehicle 40.

The RCRS controller 2002 is configured to use any of the inputs from any of the GPS 2022, the sensors 2024, the vision system 2026, the HMI 2028, the user interface 2003, etc. to generate controls for the driveline 2010, the steering and braking system 2016, the container engagement apparatus 2018, and/or the actuator system 2020. In some embodiments, the RCRS controller 2002 is configured to operate the driveline 2010, the steering and braking system 2016, the container engagement apparatus 2018, and the actuator system 2020 to autonomously transport the RCRS 2001 along a route (e.g., self-driving), perform refuse container staging operations or refuse collection engagement operations autonomously, and transport empty refuse containers 1800 to a return area. The RCRS controller 2002 may receive one or more inputs from the remote computing system 1734 such as route data, indications of pickup locations along the route, route updates, customer information, pickup types, etc. The RCRS controller 2002 may use the inputs from the remote computing system 1734 to autonomously transport the RCRS 2001 along the route and/or to perform the various operations along the route (e.g., staging and locating refuse containers 1800, etc.).

The RCRS controller 2002 may include a network interface 2030. The processing circuitry 2004 can be communicably connected to the network interface 2030 such that processing circuitry 2004 and the various components thereof can send and receive data (e.g., camera data to a display device of the refuse vehicle 40). In some embodiments, the RCRS controller 2002 is communicably coupled with the network 2040 via the network interface 2030, for transmitting data to and/or receiving data from network connected devices. Network interface 2030 may include any type of wireless interface (e.g., antennas, transmitters, transceivers, etc.) for conducting data communications with the network 2040. In some embodiments, the network interface 2030 includes a cellular device configured to provide RCRS controller 2002 with Internet access by connecting the RCRS controller 2002 to a cellular tower via a 2G network, a 3G network, 4G network, a 5G network, a LTE network, etc. In some embodiments, the network interface 1930 includes other types of wireless interfaces such as Bluetooth, WiFi, Zigbee, etc.

In some embodiments, the RCRS controller 2002 is configured to receive over-the-air (“OTA”) updates or other data from a remote system (e.g., a server, a computer, etc.) via the network 2040. The OTA updates may include software and firmware updates for the RCRS controller 2002, for example. Such OTA updates may improve the robustness and performance on the RCRS controller 2002. In some embodiments, the OTA updates are received periodically to keep the RCRS controller 2002 up-to-date.

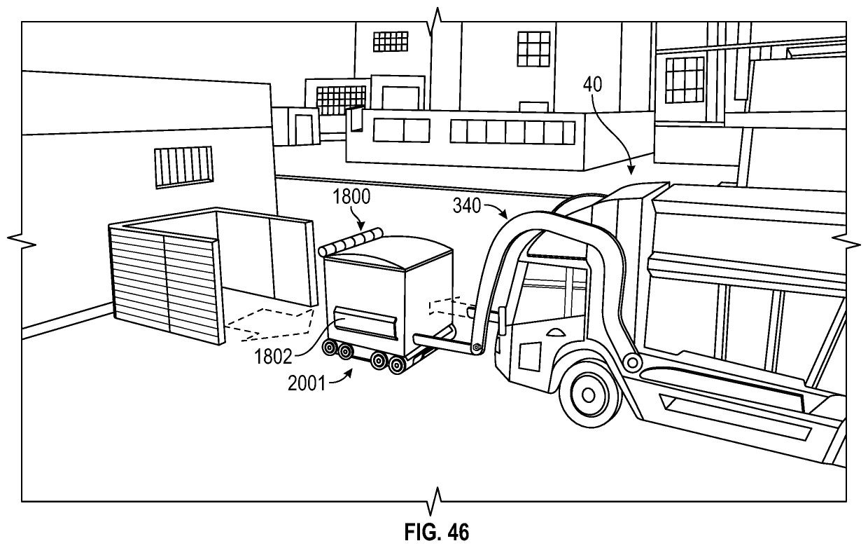

Turning to FIG. 43, a process 2200 for utilizing the refuse collection system 2000 is shown, according to some embodiments. Process 2200 may be implemented by an operator of a refuse vehicle 40 (e.g., via a user interface 2003, by manually uncoupling and deploying the RCRS 2001, etc.) at the start of a refuse collection operation. Process 2200 may be wholly or partially implemented by the controller 1702 of the refuse vehicle 40 and/or the RCRS controller 2002.

At step 2202, the RCRS 2001 is deployed, for example, from the deployable vehicle dock 2007 of the refuse vehicle 40 (e.g., decoupled from the lift assembly 340, deployed from underneath the refuse vehicle 40, etc.). In some embodiments, an operator exits the cab 16 of the refuse vehicle 40 to unload, unmount, decouple, or otherwise retrieve the RCRS 2001 from the deployable vehicle dock 2007. The operator may unplug a power connector or conduit from a charging port of the deployable vehicle dock 2007. In other embodiments, a signal (e.g., from the controller 1702, from the user interface 2003, etc.) initiates a process to automatically decouple or deploy the RCRS 2001 from the refuse vehicle 40. In some embodiments, the RCRS 2001 is removed from the refuse vehicle 40, transitioned from a stored state to a deployed state, and begins operations. For example, the frame 2010 of the RCRS 2001 may be telescopically extended, assembled, unfolded, or otherwise configured to begin a refuse collection operation.

At step 2204, a particular refuse container 1800 is identified. The RCRS 2001 may identify multiple objects including multiple refuse containers 1800. In order to initiate an engagement action, the particular refuse container 1800 may be identified, either automatically or based on a user input. In the first case, where the particular refuse container 1800 is automatically identified in order to initiate an engagement action, a controller (e.g., RCRS controller 2002) may implement a number of parameters for identifying the particular refuse container 1800. For example, the refuse container 1800 may be identified based on identifying features (e.g., size, color, shape, logos or markings, etc.) or may be selected based on its proximity to the refuse vehicle 40 (e.g., the closest refuse can may be identified first). In other embodiments, the particular refuse container 1800 may be located based on a displacement from a staging zone or a loading zone (e.g., located 5 feet or more from the curbside, etc.). The particular refuse container 1800 may be automatically identified in autonomous operations (e.g., where RCRS 2001 is autonomous) in order to reduce or eliminate operator input.

In some embodiments (e.g., semi-autonomous or non-autonomous operations), the particular refuse container 1800 may be selected by an operator. As described above, for example, the operator may be presented with the user interface 2003 and/or HMI 2028 for viewing captured data (e.g., image data) and identified objects. The operator may select, from the user interface, the particular refuse container 1800. Using the user interface 2003 as an example, the operator may select one of the refuse containers 1800, in order to initiate collection of the particular refuse container 1800.

At step 2206, a location of the identified refuse container 1800 is determined. In some embodiments, the location of the refuse container 1800 may be determined based on the location of the refuse vehicle 40 and/or the RCRS 2001. In some embodiments, sensor data from the sensors 2024 may be used to determine the location of the identified refuse container 1800. For example, data from LIDAR or radar sensors may be used to determine a location of the refuse container 1800, and/or may be used to supplement other data (e.g., from a visible light camera).

At step 2208, staging locations for one or more particular refuse containers 1800 are determined. For example, in autonomous or semi-autonomous operations, the RCRS 2001 may navigate and identify a particular refuse container 1800 and its location. The RCRS 2001 (e.g., via the RCRS controller 2002) may determine based on the location of the particular refuse container 1800 that the particular refuse container 1800 should be moved to a staging location. For example, the RCRS 2001 may determine (e.g., via sensors 2024) that the refuse container 1800 is inaccessible by the refuse vehicle 40 to collect, is located under overhead obstacles that would prevent the refuse vehicle 40 for lifting the refuse container 1800, etc. Accordingly, the RCRS 2001 may identify a clear or open location (e.g., an unoccupied space near the curbside) and identify the location as a staging location for the particular refuse container 1800. In other embodiments, (e.g., remote embodiments) the operator may identify a zone, a location, or a region as a target staging zone and instruct the RCRS 2001 to transport or move the particular refuse container 1800 to the identified staging zone. In this way, the operator may stage and set the location for the refuse containers 1800 along a particular route before navigating the refuse vehicle 40 along the route.

At step 2210, a trajectory is generated for the RCRS 2001 based on the location of the refuse container 1800. Simultaneously, at step 2212, a trajectory is generated for the container engagement apparatus 2018 of the RCRS 2001. The trajectories for the RCRS 2001 and the container engagement apparatus 2018 may indicate a path that the corresponding systems follow to reach and engage the refuse container 1800. The trajectory of the RCRS 2001, for example, may indicate a path or a set of movements for the RCRS 2001 to follow to move next to or under the refuse container 1800 so that the container engagement apparatus 2018 may move to engage the refuse container 1800 (e.g., the bottom 1804, the fork pockets 1802, the tow interface 1808, etc.). Similarly, the trajectory of the container engagement apparatus 2018 may indicate a path or a set of movements that the container engagement apparatus 2018 may follow to engage the refuse container 1800 (e.g., the bottom 1804, the fork pockets 1802, the tow interface 1808, etc.).

At steps 2214 and 2216, the RCRS 2001 and the container engagement apparatus 2018 navigate (e.g., move) to the refuse container 1800. In autonomous and/or semi-autonomous operations, the RCRS 2001 and the container engagement apparatus 2018 may be controlled or commanded (e.g., by RCRS controller 2002) to automatically navigate to the refuse container 1800. For example, the RCRS 2001 may automatically move to the refuse container 1800, and the container engagement apparatus 2018 may automatically move to engage the refuse container 1800, without operator input. In other embodiments, the trajectories generated at steps 2210 and 2212 may be presented to the operator (e.g., via user interface 2003) so that the operator may navigate the RCRS 2001 and/or the container engagement apparatus 2018 to the refuse container 1800. As an example, the trajectories may be presented via a user interface, indicating a path and/or movements that the operator should follow to navigate to the refuse container 1800. The operator may then utilize a controller, a joystick, etc. to control the RCRS 2001 and/or the container engagement apparatus 2018 to follow the path/movements to engage and stage the refuse container 1800.

In some embodiments, as the RCRS 2001 and/or the container engagement apparatus 2018 navigate (e.g., move) towards the refuse container 1800, image data and/or sensor data may be captured from the various subsystems of the RCRS 2001 and/or from the container engagement apparatus 2018. The captured image and/or sensor data may be transmitted to the remote computing system 1734, the vehicle 40, the telematics unit 1732, etc. in order to improve, modify, and/or otherwise adjust the movements of the RCRS 2001 and/or the container engagement apparatus 2018.

At step 2218, the refuse container 1800 is engaged by the container engagement apparatus 2018. The refuse container 1800 may be engaged by moving the container engagement apparatus 2018 in any suitable direction to engage a respective portion of the refuse container 1800 (e.g., the bottom 1804, the fork pockets 1802, the tow interface 1808, etc.). For example, the container engagement apparatus 2018 may move horizontally, vertically, and/or orthogonally to the RCRS 2001 in order to engage the refuse container 1800. Once the container engagement apparatus 2018 has secured the refuse container 1800, at step 2220, the container engagement apparatus 2018 and the RCRS 2001 may drag, pull, push, transport, or otherwise move the refuse container 1800 to the staging location. In other embodiments, the RCRS 2001 and/or the container engagement apparatus 2018 may interact with other commercial products (e.g., corral doors), debris, discarded/spilled refuse and engage with the object to assist in the refuse collection operation. Once at the staging location, the lift assembly 340 of the refuse vehicle 40 may engage the refuse container 1800 to dump the contents thereof into the refuse compartment 10. In some embodiments, the RCRS 2001 maneuvers the refuse container 1800 onto the forks of the lift assembly 340 without the refuse vehicle 40 needing to be maneuvered. Following the dumping process, the RCRS 2001 may return the refuse container 1800 to its original location, and then retrieve another refuse container 1800 or return to the refuse vehicle 40 to be transported to the location of another refuse container 1800.

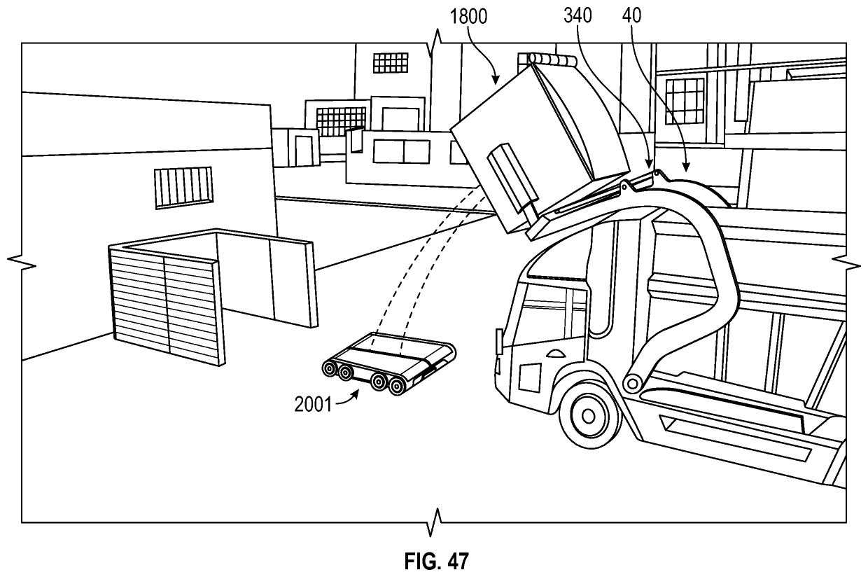

Referring now to FIG. 44-48, the RCRS 2001 is configured to be dedicated to, integrated into, coupled to, or associated with a respective refuse container 1800, rather than being deployed from the refuse vehicle 40.

In some embodiments, the RCRS 2001 is a retrofit solution. In such embodiments, the refuse container 1800 may rest on top of the RCRS 2001 with no additional couplings therebetween or the RCRS 2001 may include coupling interfaces that are securable to the refuse container 1800 (e.g., clamps, brackets, etc.). In some embodiments, the coupling interfaces are repositionable or decouplable (e.g., via motors, actuators, etc.) such that the refuse container 1800 is releasable from the RCRS 2001 when the refuse container 1800 is engaged by the lift assembly 340 of the refuse vehicle 40 (see, e.g., FIG. 47). In some embodiments, the coupling interfaces are fastened to the refuse container 1800 such that the refuse container 1800 is not released from the RCRS 2001 when the refuse container 1800 is engaged by the lift assembly 340 of the refuse vehicle 40 (see, e.g., FIG. 48).

In some embodiments, the RCRS 2001 is integrated into or manufactured with the refuse container 1800. In such embodiments, the components of the RCRS 2001 may be integrated into the refuse container 1800. By way of example, the driveline 2010, the power source 2014, the braking and steering system 2016, the GPS 2022, the sensors 2024, the vision system 2026, the RCRS controller 2002, etc. may be integrated into or coupled directly to the refuse container 1800. In such embodiments, the driveline 2010 may drive the caster wheels 1806 and/or one or more of the tractive elements 2012 may be integrated into the refuse container 1800. In such embodiments, the RCRS 2001 may substantially resemble a standard refuse container.

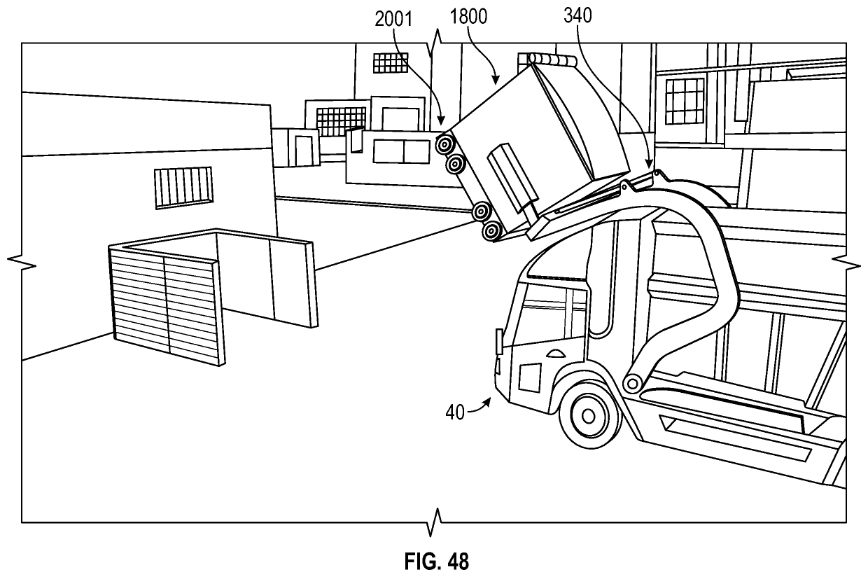

As shown in FIG. 45, the refuse collection system 2000 (e.g., the refuse vehicle 40, the RCRS 2001) is configured to initiate a container repositioning process when the refuse vehicle 40 and the RCRS 2001 are proximate one another and/or in response to a signal sent from the refuse vehicle 40 to the RCRS 2001. As shown in FIG. 46, the RCRS 2001 is configured to, autonomously and/or in response to remote signals from the refuse vehicle 40, reposition the refuse container 1800 proximate the refuse vehicle 40 to be engaged by the lift assembly 340 thereof. As shown in FIGS. 47 and 48, the lift assembly 340 is configured to engage and lift the refuse container 1800 and/or the RCRS 2001 to dump the contents of the refuse container 1800 within the refuse compartment 30. In some embodiments, the RCRS 2001 maneuvers the refuse container 1800 onto the forks of the lift assembly 340 without the refuse vehicle 40 needing to be maneuvered. The lift assembly 340 may then (a) return the refuse container 1800 onto the RCRS 2001 on the ground (i.e., when the RCRS 2001 is detachable or decouplable from the refuse container 1800) or (b) return the refuse container 1800 and the RCRS 2001 to the ground. Subsequently, the RCRS 2001 is configured to, autonomously and/or in response to remote signals from the refuse vehicle 40, reposition the refuse container 1800 back to its original storage location.

In some embodiments, the RCRS 2001 is configured to be deployed from the refuse vehicle 40 (e.g., to reposition the refuse container 1800 before the refuse vehicle 40 engages the refuse container 1800). For example, the RCRS 2001 may be deployed when the refuse vehicle 40 arrives to collect refuse from the refuse container 1800 (e.g., at a time of arrival of the refuse vehicle 40).

Referring to FIGS. 36-42 and 44-49, the RCRS 2001 may be deployed (e.g., to reposition the refuse container 1800) based on a schedule (e.g., a refuse collection schedule for the refuse collection system 2000). The RCRS 2001 may be autonomously deployed when it is a refuse collection day on the refuse collection schedule and/or proximate (e.g., at or before) a pickup time for the refuse at the customer location based on the refuse collection schedule (e.g., where the pickup time may be time and/or estimated time of arrival of the refuse vehicle 40). For example, the RCRS 2001 may determine the refuse collection day and/or the pickup time thereof (e.g., if a current time is the refuse collection day, and/or a time until the pickup time). Based on a current time being the refuse collection day and/or proximate to the pickup time, the RCRS 2001 may deploy (e.g., autonomous deploy) to engage and/or move the refuse container 1800 to the staging location 2052 for refuse therein to be collected by the refuse vehicle 40.

For example, the RCRS 2001 may be initially located (e.g., stored and/or housed at) a storage area at the customer location (e.g., a garage and/or a charging station), where the RCRS 2001 may travel to and engage the refuse container 1800 (e.g., at the collection location 2051). For example, the RCRS 2001 may move the refuse container 1800 from the collection location 2051 to the staging location 2052 on a refuse collection day and/or proximate to a pickup time of the refuse collection schedule (e.g., on a day and/or at a time where the refuse vehicle 40 is scheduled to arrive at the customer location to collect refuse). On the refuse collection day (e.g., before and/or at the pickup time), the RCRS 2001 may travel to the collection location 2051 to engage the refuse container 1800 (e.g., travel from the initial location at the customer location storing the RCRS 2001), where the RCRS 2001 engages the refuse container 1800 using the container engagement apparatus 2018. Once the refuse container 1800 is engaged, the RCRS 2001 may move the refuse container 1800 to the staging location 2052, so the refuse container 1800 may be engaged by the refuse vehicle 40. Thereby, the RCRS 2001 reduces safety hazards to customers and/or users (e.g., refuse vehicle operators) who may be proximate to the refuse vehicle 40 during refuse collection (e.g., and could be injured by the refuse vehicle 40 and/or overexertion when moving the refuse container 1800), and/or reduces accidents involving the refuse vehicle 40 and/or other equipment used to position the refuse container 1800 and/or collect refuse from said container, due to difficulties in engaging and/or moving the refuse container 1800 (e.g., obstructions between the lift assembly 340 and the refuse container 1800, difficult angles and/or clearances for the refuse vehicle 40 to access the refuse container 1800, etc.).

The RCRS controller 2002 may store (e.g., in the memory 2008 thereof) the refuse collection schedule for deployment of the RCRS 2001 based on the refuse collection schedule. In some embodiments, the RCRS 2001 (e.g., the RCRS controller 2002 thereof) may be communicably coupled to the remote computing system 1734 (e.g., via the network 2040), where the RCRS 2001 may receive the refuse collection schedule from the remote computing system 1734 (e.g., update the schedule to adjust a day being the refuse collection day and/or a pickup time for the customer).

In some embodiments, the RCRS 2001 may be communicably coupled to the refuse vehicle 40, where the RCRS 2001 receives data indicative of a location and/or an estimated arrival time for the refuse vehicle 40 at the customer location (e.g., real-time date indicating an estimated time of arrival for the refuse vehicle 40 when in route to customer location, such as notifications including the estimated arrival time, GPS data, etc.). For example, the estimated arrival time of the refuse vehicle 40 may be the pickup time (e.g., where said pickup time may change based on the route of the refuse vehicle 40), where the RCRS 2001 may move the refuse container 1800 to the staging location 2052 proximate to the pickup time (e.g., before the pickup time, such as at a set interval of time, for example, 15 minutes, before the refuse vehicle 40 arrives at the customer location).

In some embodiments, the RCRS 2001 may determine a weight of refuse within the refuse container 1800, for example, once the RCRS 2001 (e.g., via the container engagement apparatus 2018) engages the refuse container 1800. For example, the RCRS 2001 may include a weight sensor, such as a load cell and/or other measurement device, on the container engagement apparatus 2018. The weight sensor is configured to determine the weight of refuse within the refuse container 1800. For example, the weight sensor may measure a weight of the refuse container 1800 (e.g., similarly to a scale) and calculate the weight of refuse therein (e.g., where the weight of the refuse container 1800 when empty is known). For another example, the weight sensor may measure a force required to move the refuse container 1800 and calculate the weight based on the force (e.g., a horizontal force required to pull the refuse container 1800 and calculate the weight of refuse therein based on a relationship between the force and the weight of refuse). By determining the weight of refuse within the refuse container 1800, customers may be billed directly for the weight (e.g., amount) of refuse disposed of (e.g., disposal costs, overfilling fees, etc.), and/or the weight and/or amount of refuse collected by the refuse vehicle 40 may be tracked. In some embodiments, the RCRS 2001 may communicate with the remote computing system 1734 to send (e.g., transmit) the weight of refuse stored within the refuse container 1800, for example, so the weight of refuse may be tracked (e.g., for billing customers, to send to and/or track for the refuse vehicle 40, etc.). In some embodiments, the RCRS 2001 may communicate with the refuse vehicle 40 to send (e.g., transmit) the weight of refuse stored within the refuse container 1800 to the refuse vehicle 40 (e.g., so the weight of refuse may be tracked, etc.).

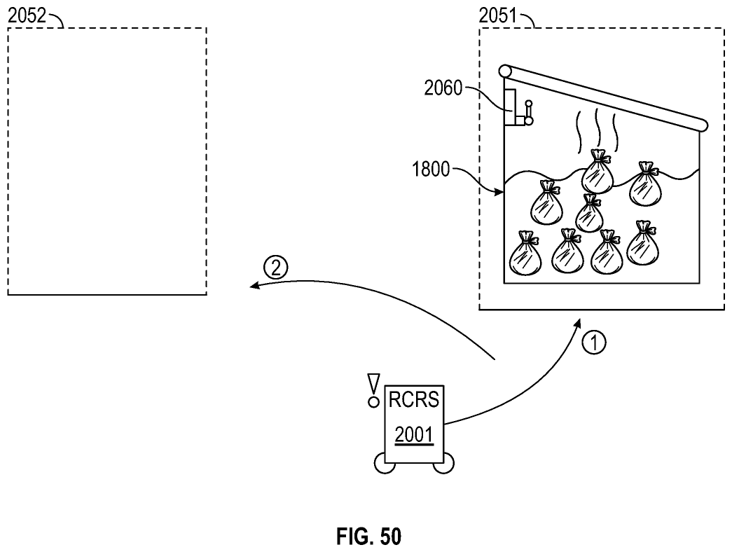

Referring to FIG. 50, the RCRS 2001 may be deployed to move the refuse container 1800 to the staging location 2052 (e.g., from the collection location 2051) based on receiving a signal from the refuse container 1800 (e.g., a sensor and/or communication device thereof) indicative of refuse within the refuse container 1800 to be collected (e.g., by the refuse vehicle 40) and/or the refuse container 1800 ready to be moved (e.g., to the staging location 2052). For example, the refuse container 1800 may include a sensor 2060 configured to detect a volume of refuse within the refuse container 1800 (e.g., where the sensor 2060 may be a camera, etc.), a weight of the refuse container 1800 and/or the refuse therein (e.g., where the sensor 2060 may be a load cell and/or a scale), and/or an odor emitted from the refuse container 1800 and/or the refuse therein (e.g., where the sensor 2060 may be a stink/odor detector). For example, the sensor 2060 may be or include an electrochemical gas sensor (e.g., hydrogen sulfide (H2S) sensor, ammonia (NH3) sensor, methane (CH4) sensor, carbon dioxide (CO2) sensor, etc.), a volatile organic compound (VOC) sensor, a metal oxide semiconductor (MOS) sensor, a photoionization detector (PID), a colorimetric and/or chemoresistive odor array (e.g., Electronic Nose (E-nose)), or a humidity and/or temperature sensor. The sensor 2060 may be positioned within, or otherwise in gaseous communication with, the interior of the refuse container, to measure the concentration of the noxious or odiferous gas being emitted by the refuse deposited in the refuse container.

In some embodiments, when a volume of refuse within the refuse container 1800 reaches (e.g., is greater than or equal to) a threshold fill level for the refuse container 1800, the RCRS 2001 may receive a signal (e.g. from the refuse container 1800, and/or the sensor and/or communication device thereof, etc.) indicative of the refuse container 1800 ready to be moved from the collection location 2051 to the staging location 2052. In some embodiments, when a weight of the refuse container 1800 (e.g., including the refuse therein) reaches (e.g., is greater than or equal to) a threshold fill level for the refuse container 1800, the refuse container 1800 may be moved from the collection location 2051 to the staging location 2052 (e.g., where the RCRS 2001 receives the signal indicative of the refuse container 1800 ready to be moved). By moving the refuse container 1800 once the threshold fill level has been reached (e.g., either by volume or by weight), the refuse container 1800 is substantially prevented from being overfilled (e.g., making it more difficult for a customer and/or user to deposit additional refuse into the already full container as the refuse container 1800 is not located at the collection location 2051). Preventing refuse containers from becoming overfilled reduces accidents when moving the refuse container 1800 (e.g., using the RCRS 2001) and/or during refuse collection by the refuse vehicle 40 (e.g., damage to the refuse vehicle 40, personal injury, damage to the RCRS 2001, etc.).

In some embodiments, when an odor level of (e.g., emanating from) the refuse container 1800 reaches (e.g., is greater than or equal to) a threshold odor level for the refuse container 1800, the RCRS 2001 may receive a signal (e.g. from the refuse container 1800) indicative of the refuse container 1800 ready to be moved from the collection location 2051 to the staging location 2052. For example, the refuse container 1800 and/or the collection location 2051 may include a sensor configured to detect an odor of refuse. Thereby, moving the refuse container 1800 once the threshold odor level has been reached reduces foul odors emitted from refuse within the refuse container 1800 as experienced by customers and/or users (e.g., since the refuse container 1800 is moved away from the collection location 2051, which is where the customer and/or user enters to deposit refuse).

In some embodiments, the sensors 2024 and/or the vision system 2026 of the RCRS 2001 may detect objects (e.g., obstacles) impeding a route of travel for the RCRS 2001. For example, when moving the refuse container 1800 from the collection location 2051 to the staging location 2052, the RCRS 2001 (e.g., via the sensors 2024 and/or the vision system 2026 thereof) may detect obstacles and navigate (e.g., route, travel, etc.) around said obstacles. In some embodiments, the RCRS 2001 can communicate a location of said obstacles to the refuse vehicle 40 and/or the remote computing system 1734. For example, if a location of the staging location 2052 is adjusted based on an obstacle interfering, the RCRS 2001 may communicate a new and/or adjusted location of the staging location 2052 to the refuse vehicle 40.

In some embodiments, the refuse collection system 2000 may include a companion configured to guide and/or operate the RCRS 2001 when moving the refuse container 1800. For example, the companion may be another RCRS, such as a second RCRS to route the RCRS 2001 (e.g., around obstacles) when moving the refuse container 1800. In some embodiments, the companion may be an operator and/or user, such as an operator of the refuse vehicle 40 and/or a personal located at the customer location. For example, the RCRS 2001 may be configured as a ride-on vehicle that an operator can control from a user interface onboard the RCRS 2001.

The companion may partially interfere with the sensors 2024 and/or vision system 2026 of the RCRS 2001 when onboard the RCRS 2001 (e.g., engaged with the container engagement apparatus 2018), such that the companion may determine a route (e.g., a safe route) around obstacles so the refuse container 1800 may be moved from the collection location 2051 to the staging location 2052 (e.g., where the companion leads the RCRS 2001 and the RCRS 2001 follows the companion with the refuse container 1800 onboard) in a leader-follower configuration. In some embodiments, the RCRS 2001 may be at least partially manually controlled by an operator to direct movements (e.g., drive, such as via the braking and steering system 2016) and/or move the refuse container 1800 (e.g., actuate the actuator system 2020 to activate the container engagement apparatus 2018 via).

For example, the RCRS 2001 may be remotely controlled (e.g., from a location spaced apart from the customer location) in real-time (e.g., where the RCRS controller 2002 is communicably coupled to a remote-control system, where the remote-control system is operated by an operator and/or a user). For another example, the RCRS 2001 may be operated (e.g., manually controlled) by an operator and/or a user proximate the RCRS 2001 (e.g., where the operator may be located onboard the RCRS 2001). For example, the RCRS 2001 may be communicably coupled to a drone management system along with other RCRSs in field, and so that the RCRSs may each be controlled remotely by operators through the drone management system. The drone management system may be configured to selectively switch the RCRS 2001 between an automatic and a manual control mode based on an operating status of the RCRS 2001, a location along route, and/or another triggering event. Such an arrangement can enable control over multiple RCRSs by a small set of remote operators, by limiting manual control to portions of the route that involve more complex maneuvering and/or observation.

When the RCRS 2001 is at least partially manually controlled (and/or during portions of autonomous operation), the RCRS 2001 may track (e.g., collect and/or store) a route transited by the RCRS 2001 (e.g., when manually driven), such that the RCRS 2001 may at least partially autonomously transit (e.g., follow) said route in an opposite direction (e.g., retrace the route, for example, to move the refuse container 1800 back to the collection location 2051 after moving the refuse container 1800 to the staging location 2052 via manually operation of the RCRS 2001, and/or, returning to the storage area such as the charging station after moving the refuse container 1800, etc.). By at least partially manually controlling the RCRS 2001 and/or using the companion to assist the RCRS 2001, refuse collection may be completed with increased safety, where the RCRS 2001 completes more dangerous tasks (e.g., lifting, pushing and/or pulling the refuse container 1800, engaging the refuse vehicle 40, etc.) without an operator (e.g., to reduce injury risks to operators), and/or the RCRS 2001 receives assistance when navigating around the customer location (e.g., via the companion and/or manual control) to reduce error and/or accidents during the RCRS 2001 operation (e.g., reduce crashes).

In some embodiments, where the RCRS 2001 is integrated into or manufactured with the refuse container 1800 (e.g., where the components of the RCRS 2001 may be integrated into or coupled directly to the refuse container 1800), the refuse container 1800 with the integrated RCRS 2001 may move between the collection location 2051 and the staging location 2052 for refuse collection, similarly to the RCRS 2001 (e.g., deployment based on the refuse collection schedule, traveling and/or engaging the refuse container 1800 via the container engagement apparatus 2018). In some embodiments, the refuse container 1800 with the integrated RCRS 2001 may move (e.g., drive) from the collection location 2051 to the staging location 2052 (e.g., on the refuse collection day and/or proximate the pickup time, based on a signal from the refuse vehicle 40 and/or the sensor 2060, etc.), where the RCRS 2001 may detach from the refuse container 1800 (e.g., a refuse storage portion of the integrated refuse container and RCRS) to reduce a weight of the refuse container 1800 when lifted.

The refuse vehicle 40 may deposit the refuse from the refuse container 1800 into the refuse vehicle 40 (e.g., using the lift assembly 340 to dump the refuse into the refuse compartment 30 of the refuse vehicle 40), where the RCRS 2001 remains on the ground (e.g., isn't lifted with the refuse container 1800 by the refuse vehicle 40). Once the refuse is collected into the refuse vehicle 40, the refuse vehicle 40 may move (e.g., lower) the refuse container 1800 proximate the RCRS 2001 on the ground (e.g., next to, back onto the RCRS 2001, etc.). The RCRS 2001 may attach (e.g., reattach) to the refuse container 1800. Once attached (e.g., reattached), the refuse container 1800 with the integrated RCRS 2001 may move to the collection location 2051 to collect refuse from customers and/or users. For example, while the RCRS 2001 is detachable from the refuse container 1800 (e.g., the storage portion thereof), the RCRS 2001 may be integrated with the refuse container 1800 such that the RCRS 2001 is configured to specifically engage (e.g., attach to) the refuse container 1800. In some embodiments, the refuse container 1800 with the integrated RCRS 2001 may include the weight sensor (e.g., load cell, etc.) to determine the weight of refuse stored within the refuse container 1800 (e.g., the RCRS 2001 may include the weight sensor when integrated into the refuse container 1800).

### Refuse Collection System

Larger venues (e.g., business parks, arenas, stadiums, amusement parks, etc.) include a large number of refuse containers that are manually emptied, for example, based on a schedule or at the discretion of the employees of the venue. This conventional process typically results in refuse containers being emptied that are not full, which can waste time, resources, and labor hours. The refuse collection system of the present disclosure includes refuse containers with fill sensors and/or odor sensors that measure when the refuse container is full or when an odor level exceeds a threshold odor level requiring emptying, and then signals a refuse vehicle (e.g., the refuse collection drone 20) to come empty the refuse container. The refuse container may also be configured to engage or otherwise interface with a refuse collection drone for removal and emptying of the contents of the refuse container. In this way, for example, the refuse collection process at large venues is streamlined and helps reduce labor hours and maintenance costs.

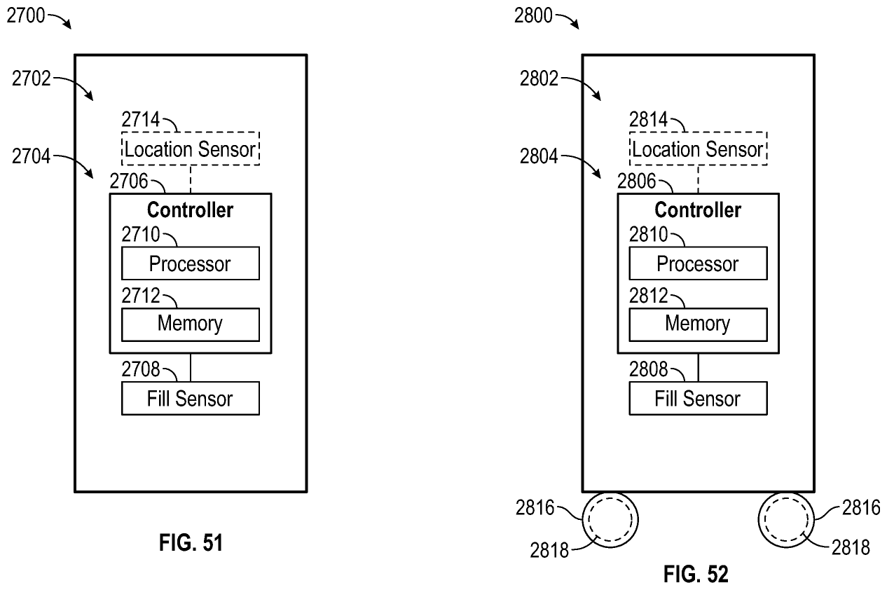

FIG. 51 shows an exemplary embodiment of a refuse container 700 according to the present disclosure. The refuse container 2700 may take various forms (e.g., a dumpster, a trash can, etc.). Regardless of the particular design of the refuse container 2700, the refuse container 2700 includes a storage volume 2702 that stores refuse and a control system 2704 having a controller 2706, and a fill sensor 2708. The controller 2706 includes a processor 2710 and at least one memory device, shown as memory 2712. The controller 2706 is in communication with the fill sensor 2708 and is configured to receive input data from the fill sensor 2708 to determine a fill status of the storage volume 2702.

In general, the fill sensor 2708 is configured to measure the fill status of the storage volume 2702 via one or more indicators. In some embodiments, the fill sensor 2708 is a weight sensor or a load cell that measures a weight of refuse within the storage volume 2702. In these embodiments, the controller 2706 is configured to determine the fill status of the storage volume 2702 based on one or more predetermined weight thresholds. For example, the controller 2706 is configured to determine that the fill status of the storage volume 2702 is full and the refuse container 2700 requires emptying after the weight of refuse measured by the fill sensor 2708 is greater than or equal to a weight threshold. In some embodiments, the fill sensor 2708 is an optical sensor or a camera that is configured to measure or detect a volume of refuse within the storage volume 2702. For example, the fill sensor 2708 may be configured to detect or measure a height of refuse within the storage volume 2702 and the controller 2706 is configured to determine that the fill status of the refuse within the storage volume 2702 is full when the height of the refuse is greater than or equal to a height threshold.

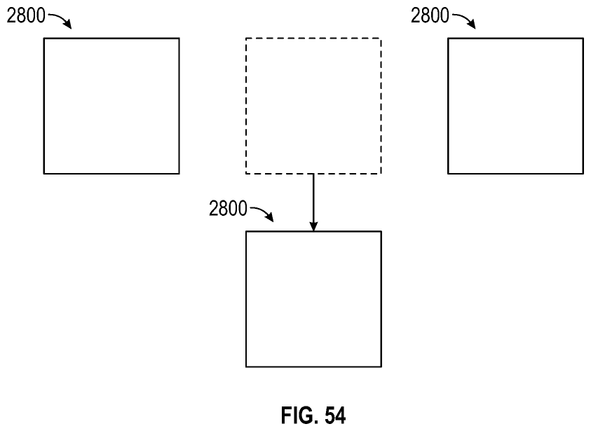

Regardless of the particular implementation of the fill sensor 2708, the inclusion of the fill sensor 2708 within the refuse container 2700 enables the refuse container 2700 to provide an indication to a collection vehicle (e.g., the refuse collection drone 20, the refuse vehicle 40, etc.) that the refuse container 2700 requires collection and emptying. In some embodiments, the refuse containers 2700 and the refuse collection vehicles (e.g., the refuse collection drone 20 and/or the refuse vehicles 40) form a refuse collection system. The controller 2706 is in communication with the refuse collection drone 20 and/or the refuse vehicle 40 so that the refuse collection drone 20 and/or the refuse vehicle 40 receives the indication from the controller 2706 that the refuse container 2700 is full and requires collection. In this way, for example, the refuse collection process at a large venue (e.g., business parks, arenas, stadiums, amusement parks, etc.) that includes a large number of the refuse containers 2700 is streamlined and more efficient, with only the refuse containers 2700 that have a full fill status, as indicated by the fill sensor 2708, being collected and emptied (see, e.g., FIG. 53).

In some embodiments, the full fill status indication is provided from the controller 2706 to the refuse collection drone 20, and the refuse collection drone 20 autonomously navigates to the particular refuse container 2700 and collects the refuse within the storage volume 2702. In these embodiments, the refuse container 2700 may include a location sensor 2714 (e.g., a GPS sensor) that provides a location of the refuse container 2700 to the refuse collection drone 20. In these embodiments, the refuse collection drone 20 may interface with the refuse container 2700 to allow the refuse collection drone 20 to collect the refuse within the storage volume 2702 (e.g., via a trap door on the refuse container 2700, via a grabbing mechanism on the refuse collection drone 20, etc.). In some embodiments, the full fill status indication is provided from the controller 2706 to an employee of the venue and the employee navigates to the refuse container 2700 and collects the refuse within the storage volume 2702.

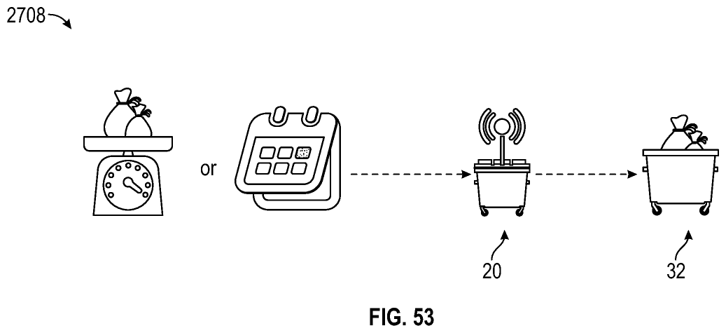

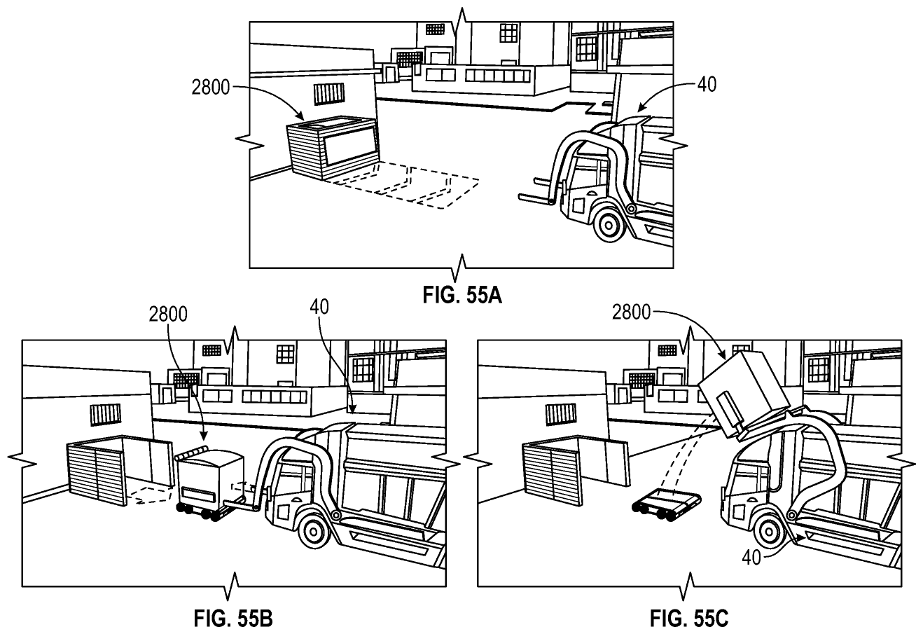

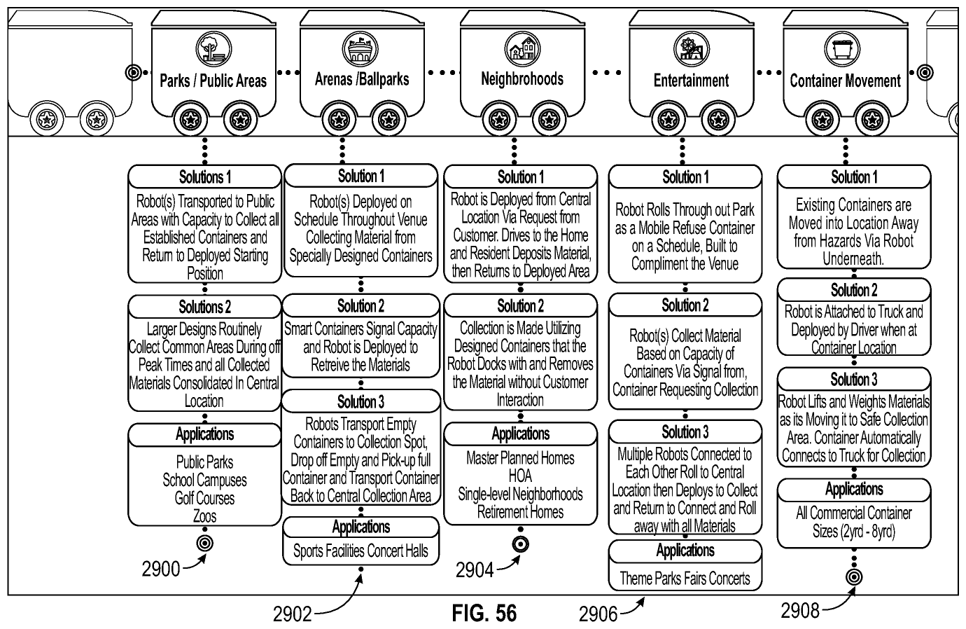

FIG. 52 shows an exemplary embodiment of the refuse container 2800 including a propulsion system (e.g., the propulsion system 110) that includes a plurality of wheels 2816 that are driven by one or more electric motors 2818. In these embodiments, the controller 2806 is configured to instruct the one or more electric motors 2818 to move or navigate the refuse container 2800 from a home position to a pickup position that is displaced from the home position. In this way, for example, the refuse container 2800 provides a visual indication of a full fill status and enables easy and efficient detection of a refuse container 2800 that requires collection (see, e.g., FIGS. 54 and 55A-55C). Once the refuse container 2800 is in the pickup location, the refuse collection drone 20 or the refuse vehicle 40 navigates to the pickup location and collects the refuse container 2800. Once the refuse container 2800 has been emptied, as indicated by the fill sensor 2808, the controller 2806 instructs the electric motors 2818 to navigate the refuse container 2800 from the pickup position back to the home position.

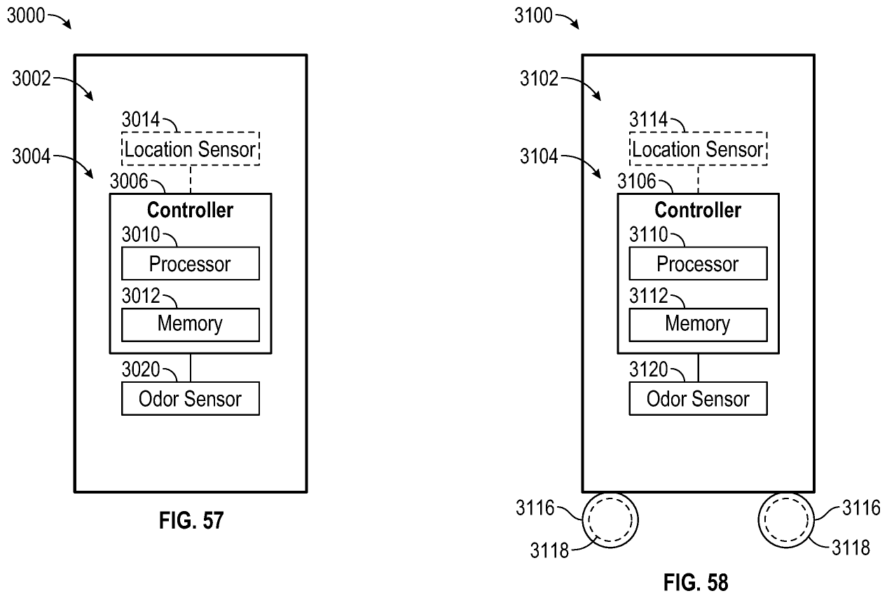

The incorporation of the controller 2806 and the fill sensor 2808 into the refuse container 2800 enables the refuse container 2800 to be a “smart container” that communicates its fill status and communicates with a collection vehicle (e.g., the refuse collection drone 20 and/or the refuse vehicle 40). The use of smart containers at large venues (see, e.g., FIG. 56) is particularly advantageous due to the number of containers within these venues and the amount of time spent manually collecting refuse from the containers, without any fill status information. FIG. 56 shows different exemplary methods of operating a refuse collection drone including at parks or other public areas 2900, arenas or ballparks 2902, neighborhoods, 2904, entertainment venues 2906, and for container movement 2908, such as described in more detail above.

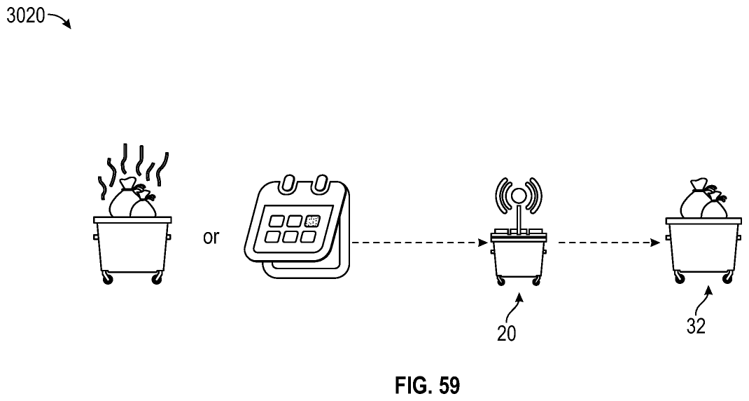

FIG. 57 shows an exemplary embodiment of the refuse container 3000 including an odor sensor 3020. The controller 3006 is in communication with the odor sensor 3020 and is configured to receive input data from the odor sensor 3020 to determine an odor status of the refuse in the storage volume 3002. In some embodiments, the odor sensor 3020 is disposed on the refuse container 3000 (e.g., internally, externally, etc.). For example, the odor sensor 3020 may be disposed in the storage volume 3002. In some embodiments, the odor sensor 3020 is disposed in the vicinity of the refuse container 3000 (e.g., adjacent to the refuse container 3000). For example, the odor sensor 3020 may be disposed on enclosure surrounding the refuse container 3000.

In general, the odor sensor 3020 is configured to measure the odor status of the refuse in the storage volume 3002 via one or more indicators. In some embodiments, the odor sensor 3020 is at least one of an electrochemical gas sensor (e.g., hydrogen sulfide (H₂S) sensor, ammonia (NH₃) sensor, methane (CH₄) sensor, carbon dioxide (CO₂) sensor, etc.), a volatile organic compound (VOC) sensor, a metal oxide semiconductor (MOS) sensor, a photoionization detector (PID), a colorimetric and/or chemoresistive odor array (e.g., Electronic Nose (E-nose)), or a humidity and/or temperature sensor. In these embodiments, the controller 3006 is configured to determine the odor status of the refuse in the storage volume 3002 based on one or more predetermined odor level thresholds.

The controller 3006 is configured to determine the odor status of the refuse in the storage volume 3002 and that the refuse container 3000 requires emptying after an odor level of refuse measured by the odor sensor 3020 satisfies (e.g., is greater than or equal to) an odor level threshold. For example, the controller 3006 is configured to determine the odor status of the refuse in the storage volume 3002 and that the refuse container 3000 requires emptying after an ammonia level of refuse measured by the odor sensor 3020 (e.g., the ammonia (NH₃) sensor) is greater than or equal to an ammonia level threshold. For another example, the controller 3006 is configured to determine the odor status of the storage volume 3002 and that the refuse container 3000 requires emptying after a methane level of the refuse measured by the odor sensor 3020 (e.g., the methane (CH₄) sensor) is greater than or equal to a methane level threshold. For yet another example, the controller 3006 is configured to determine the odor status of the refuse in the storage volume 3002 and that the refuse container 3000 requires emptying after a hydrogen sulfide level of the refuse measured by the odor sensor 3020 (e.g., the hydrogen sulfide (H₂S) sensor) is greater than or equal to a hydrogen sulfide level threshold, or that temperature and/or moisture levels within the refuse container 3000 satisfy temperature and/or moisture level thresholds.

Regardless of the particular implementation of the odor sensor 3020, the inclusion of the odor sensor 3020 within the refuse container 3000 enables the refuse container 3000 to provide an indication to a collection vehicle (e.g., the refuse collection drone 20, the refuse vehicle 40, etc.) that the refuse container 3000 requires collection and emptying based on sensor metrics that affect a person's perception of the status of the refuse container 3000 (e.g., whether the refuse container 3000 is full based on smell, etc.).

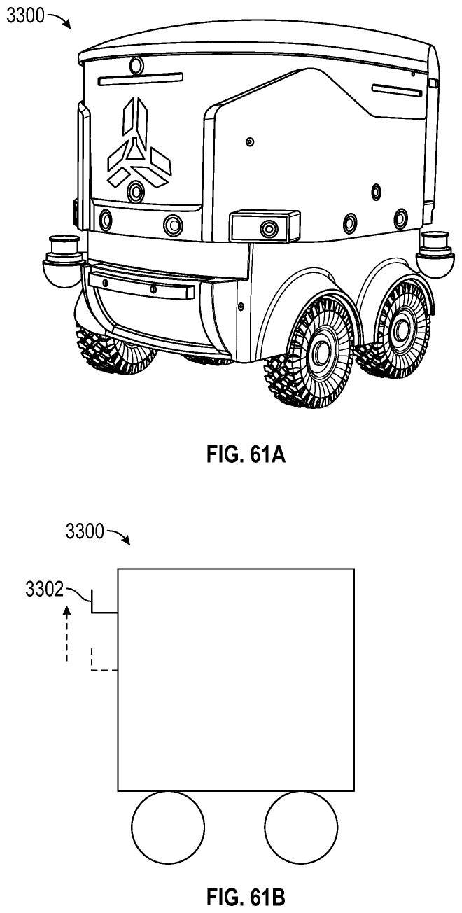

In some embodiments, the refuse containers 3000 and the refuse collection vehicles (e.g., the refuse collection drone 20 and/or the refuse vehicles 40) form a refuse collection system. The controller 3006 is in communication with the refuse collection drone 20 and/or the refuse vehicle 40 so that the refuse collection drone 20 and/or the refuse vehicle 40 receives the indication from the controller 3006 that the refuse container 3000 exceeds an odor threshold and requires collection. In this way, for example, the refuse collection process at a large venue (e.g., business parks, arenas, stadiums, amusement parks, etc.) that includes a large number of the refuse containers 3000 is streamlined and more efficient, with only the refuse containers 3000 exceeding the odor level threshold, as indicated by the odor sensor 3020, being collected and emptied (see, e.g., FIG. 59).

In some embodiments, the odor status indication is provided from the controller 3006 to the refuse collection drone 20, and the refuse collection drone 20 autonomously navigates to the particular refuse container 3000 and collects the refuse within the storage volume 3002. In these embodiments, the refuse container 3000 may include a location sensor 3014 (e.g., a GPS sensor) that provides a location of the refuse container 3000 to the refuse collection drone 20. In these embodiments, the refuse collection drone 20 may interface with the refuse container 3000 to allow the refuse collection drone 20 to collect the refuse within the storage volume 3002 (e.g., via a trap door on the refuse container 3000, via a grabbing mechanism on the refuse collection drone 20, etc.). In some embodiments, the odor status indication is provided from the controller 3006 to an employee of the venue and the employee navigates to the refuse container 3000 and collects the refuse within the storage volume 3002.

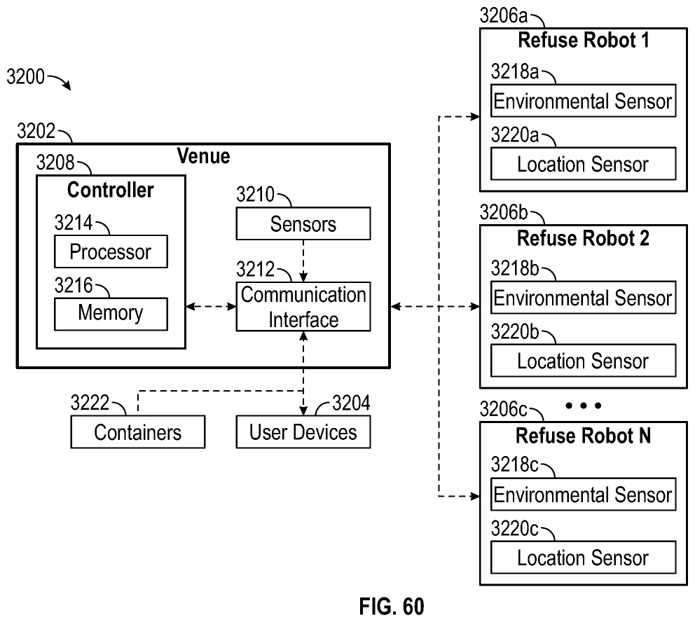

FIG. 58 shows an exemplary embodiment of the refuse container 3100 including the propulsion system (e.g., the propulsion system 110) that includes a plurality of wheels 3116 that are driven by the one or more electric motors 3118. In these embodiments, the controller 3106 is configured to instruct the one or more electric motors 3118 to move or navigate the refuse container 3100 from a home position to a pickup position that is displaced from the home position. In this way, for example, the refuse container 3100 provides a visual indication of the odor status and enables easy and efficient detection of a refuse container 3100 that requires collection (see, e.g., FIGS. 54 and 55A-55C). Once the refuse container 3100 is in the pickup location, the refuse collection drone 20 or the refuse vehicle 40 navigates to the pickup location and collects the refuse container 3100. Once the refuse container 3100 has been emptied, as indicated by the odor sensor 3120, the controller 3106 instructs the electric motors 3118 to navigate the refuse container 3100 from the pickup position back to the home position.

The incorporation of the controller 3106 and the odor sensor 3120 into the refuse container 3100 enables the refuse container 3100 to be a “smart container” that communicates its odor status and communicates with a collection vehicle (e.g., the refuse collection drone 20 and/or the refuse vehicle 40). The use of smart containers at large venues (see, e.g., FIG. 56) is particularly advantageous due to the number of containers within these venues and the amount of time spent manually collecting refuse from the containers, without any odor status information.

### Activity-Based Refuse Collection System

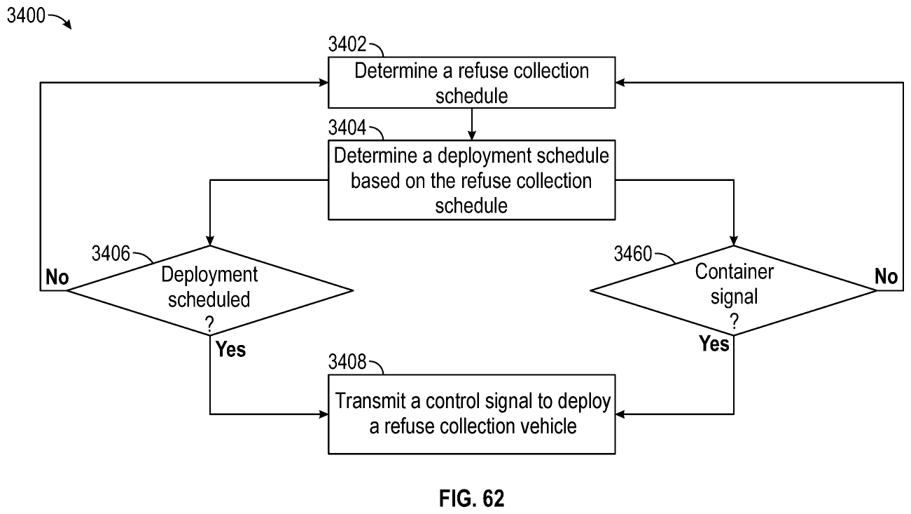

Referring to FIG. 60, an activity-based refuse collection system is shown as system 3200, according to an exemplary embodiment. The system 3200 is configured to automate the waste removal process at venues, such as for events or shared activities. For example, the venue may include stadiums (e.g., ballparks, football fields, etc.), amusement parks, bus depots, airports, and other types of event locations or hubs. In some embodiments, the system 3200 is configured to determine and execute a refuse collection schedule, which may include determining a frequency of refuse collection from various areas across the venue by one or more refuse collection drones 3206.

In some embodiments, the system 3200 is configured to determine the refuse collection schedule based on attendee activity across the venue, such as attendee density (e.g., participant density, occupant density, etc.) in different areas associated with the venue. In other embodiments, the system 3200 may be additionally or alternatively configured to determine the refuse collection schedule based on another activity level metric associated with activity levels across the venue. In some embodiments, the system is configured to determine activity levels based on sensor data from at least one of (i) sensors disposed in different areas within the venue, (ii) sensors onboard the refuse collection drones 20, and/or (iii) sensors disposed on the refuse containers within the venue. In addition to reducing the need for manual refuse collection techniques, which may be prone to human error, such refuse collection systems and methods can improve the overall efficiency of refuse collection within the venue and reduce the risk of overflow or spillage due to over-used refuse containers. Additionally, by focusing on high use areas within the venue (e.g., usage trends, etc.), the activity-based refuse collection system can maintain a cleaner environment with a fewer number of refuse collection drones.

The system 3200 includes a venue control system 3202, one or more user devices 3204, and a plurality of refuse collection drones 3206. The venue control system 3202 is configured to receive information (e.g., sensor data) from the user device(s) 3204 and/or the refuse collection drones 3206, determine attendee activity levels based on the information, and to determine a refuse collection schedule for the refuse collection drones 3206 based on the information.

The venue control system 3202 includes a controller 3208, one or more sensors 3210, and a communications interface 3212. The sensors 3210 are configured to generate sensor data indicative of activity levels across the venue, or in different areas within the venue. In some embodiments, the sensors 3210 include optical sensors (e.g., cameras) that are configured to monitor activities of attendees within the venue. For example, the sensors 3210 may be configured to generate sensor data indicative of occupancy levels in one or more areas within the venue. In other embodiments, the sensors include temperature sensors or other devices capable of generating data indicative of relative activity levels in different areas of the venue.

The controller 3208 is configured to receive sensor data from the sensors, the user device(s) 3204, and/or the refuse collection drones 3206, and to coordinate operation of the refuse collection drones 3206 based on the sensor data. The controller 3208 includes processing circuitry including a processor 3214 and memory 3216. Processor 3214 can be implemented as a general-purpose processor, an ASIC, one or more FPGAs, a group of processing components, or other suitable electronic processing components.

Memory 3216 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 3216 can be or include volatile memory or non-volatile memory. Memory 3216 can include database components, object code components, script components, or any other type of information structure for supporting the various activities and information structures described in the present application. According to some embodiments, memory 3216 is communicably connected to processor 3214 via processing circuitry and includes computer code for executing (e.g., by at least one of processing circuitry or processor 3214) one or more processes described herein.

The communications interface 3212 is configured to communicably couple the controller 3208 with the user devices 3204 and the refuse collection drones 3206. The communications interface 3212 may be configured to communicably couple the controller 3208 to a communications interface of refuse collection drones 3206, such that processing circuitry and the various components thereof can send and receive data via the communications interface 3212. The communications interface 3212 can include wired and/or wireless interfaces.

The user devices 3204 can include various types of mobile computing devices that are communicably coupled to the controller 3208. For example, the user devices 3204 may include mobile phones, tablets, or other types of personal computing devices. The user devices 3204 may be communicably coupled to the controller 3208 by a WiFi network within the venue. The controller 3208 may be configured to receive sensor data from the user devices 3204, which may include location data of the user devices 3204 within the venue, and to determine activity levels in different areas of the venue based on the sensor data.

As shown in FIG. 60, the refuse collection drones 3206 each include an environmental sensor 3218 and a location sensor 3220. The controller 3208 may be configured to receive sensor data from the environmental sensor 3218 and the location sensor 3220 (e.g., via the communications interface 3212) and to determine activity levels in different areas of the venue based on sensor data.

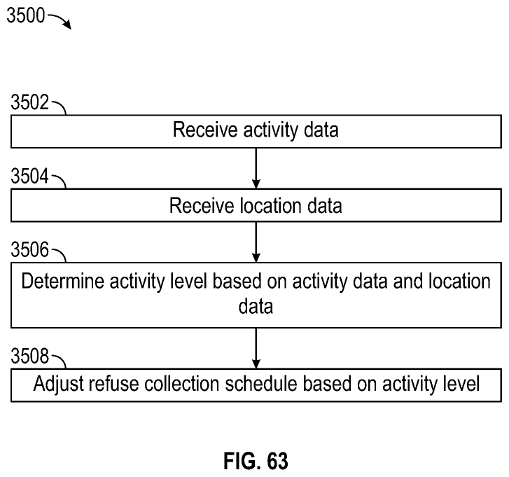

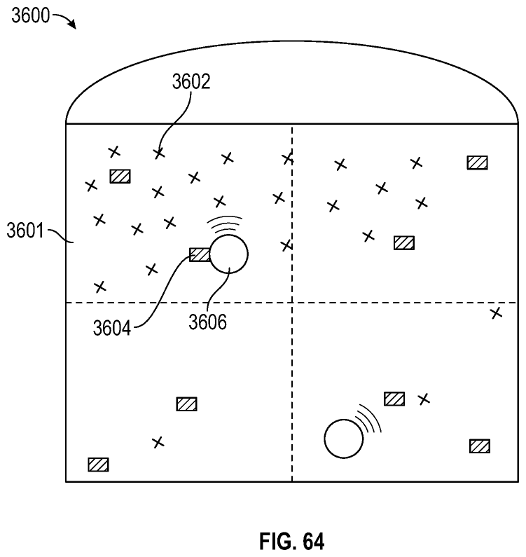

For example, referring to FIG. 61A-61B, a refuse collection drone 3300 is shown that includes multiple different types of sensors that can be used to track activity levels proximate to the refuse collection drone 3300. The sensors includes a proximity sensor (e.g., sonar sensor configured to use sound waves to detect and measure the distance to objects surrounding the refuse collection drone 3300, etc.), a light detection and ranging (Lidar) sensor that is configured to use laser light to measure distances and generate sensor data indicative of environments and attendees surrounding the refuse collection drone 3300), and/or optical sensors, such as cameras. The sensors may be disposed on each side of the refuse collection drone 3300 or on corners thereof.

In some embodiments, the sensors (e.g., the environmental sensors) also include a gas sensor configured to measure the concentration of a noxious or odiferous gas in the ambient air proximate the refuse collection drone 3300. For example, the gas sensor may be or include an electrochemical gas sensor (e.g., hydrogen sulfide (H₂S) sensor, ammonia (NH₃) sensor, methane (CH₄) sensor, carbon dioxide (CO₂) sensor, etc.), a volatile organic compound (VOC) sensor, a metal oxide semiconductor (MOS) sensor, a photoionization detector (PID), a colorimetric and/or chemoresistive odor array (e.g., Electronic Nose (E-nose)).

The refuse collection drone 3300 also includes waste receiving and/or collection elements to facilitate collection of refuse materials from refuse containers. For example, and as shown in FIG. 61B, the refuse collection drone 3300 includes a refuse container engaging element 3302 that is configured to engage and couple the refuse collection drone 3300 to a refuse container. In some embodiments, the refuse container engaging element 3302 includes a claw, a hook, a robotic arm, a tow bar, a tether, or grasping member that is configured to engage or grip a first portion or interface of the refuse container. The refuse collection drone 3300 may also include an actuator to reposition the refuse container engaging element 3302 relative to the body of the refuse collection drone 3300, which may be configured to secure the refuse container to the refuse collection drone 3300. In this way, the refuse collection drone 3300 may be configured to remove and replace full refuse containers with clean and empty refuse containers for subsequent use. In other embodiments, the refuse collection drone 3300 may include other elements to facilitate removal (e.g., emptying) of refuse material from the refuse containers, as described herein.

Referring again to FIG. 60, in some embodiments, the controller 3208 may also be communicably coupled to one or more refuse containers, shown as containers 3222, within the venue that are configured to receive refuse materials from attendees. In some embodiments, the containers 3222 includes fill level sensors that are configured to generate fill level data (e.g., weight information, volume and/or height of fill, or other fill level information indicative of a fill level of the containers 3222), and to transmit the fill level data to the controller 3208. In some embodiments, the containers 3222 also include gas sensors for measuring odiferous gas levels within the containers 3222 or adjacent to the containers 3222. The controller 3208 is configured to received sensor data from the fill level sensor(s) and/or the gas sensor(s) and to coordinate deployment and control over the refuse collection drones based on the sensor data, as will be further described. In some embodiments, the controller 3208, which may also include a remote or cloud-based computing system may also be configured to perform analytics, such as based on sensor data (e.g., user data, environmental data, activity data, location data, etc.) to provide better scheduling and improved service (e.g., calculated collection times based on trends, automated collection based on activity, etc.).

According to an exemplary embodiment, a method of scheduled reference collection includes determining a refuse collection frequency for one or more containers and controlling the refuse collection drones based on the refuse collection schedule (e.g., to satisfy the refuse collection frequency for each of the containers).

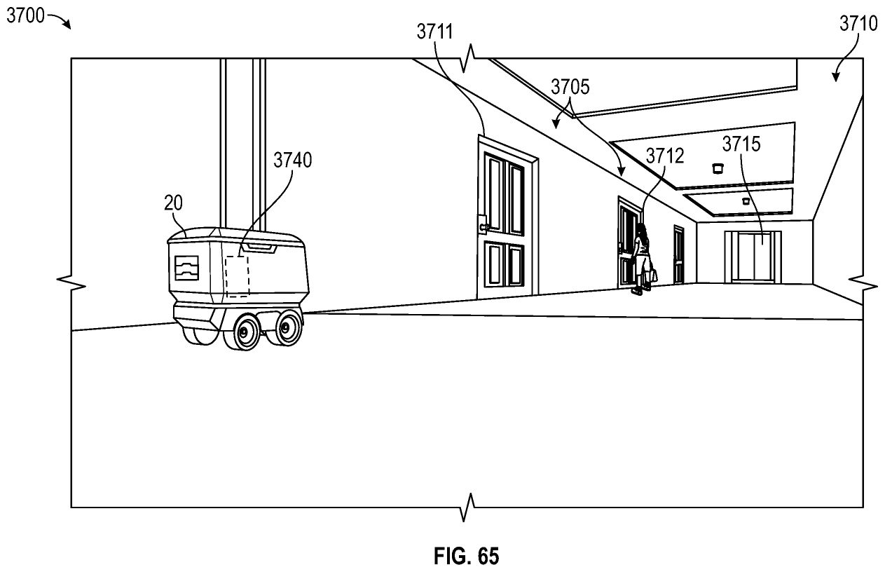

For example, referring to FIG. 62, a method 3400 of scheduling and/or determining a refuse collection control command to the refuse collection drones is shown, according to an exemplary embodiment. The method 3400 may be performed by the activity-based refuse collection system 3200 of FIG. 60 and will be described with reference to FIG. 60.

The method 3400 includes determining a refuse collection schedule, which may include the refuse collection frequency, for multiple containers that are associated with the venue, at 3402. In some embodiments, operation 3402 includes receiving a refuse collection frequency for at least one of the containers, such as based on user inputs (e.g., from one of the user devices, the venue, etc.). In some embodiments, operation 3402 may include retrieving a baseline refuse collection frequency from memory and/or from a database that is communicably coupled to the controller of the venue. In some embodiments, operation 3402 includes receiving a fill frequency and/or an activity level associated with the container (e.g., population density in the vicinity of the container, visits per hour, etc.).

The method 3400 includes determining a deployment schedule for the refuse collection drones based on the refuse collection schedule, at operation 3404. In some embodiments, operation 3404 includes determining distances between a depot or staging area for the refuse collection drones, and each of the containers, and/or a velocity associated with the drones during transit operations. Operation 3404 may include determining a deployment frequency and/or time based on the distances and/or velocities, at 3404. For example, the venue may include a first container that is disposed adjacent to a refuse collection depot and having a first fill frequency, and a second container that is disposed farther away from the depot than the first container and having a second fill frequency that is approximately equal to the first fill frequency. In such an implementation, operation 3404 may include determining a second deployment time to retrieve refuse material from the second container that is less than a first deployment frequency to retrieve refuse material from the first container. In this way, the controller an account for relative distances between containers within the venue to ensure that collection occurs for both containers within the associated fill frequency of each container.

The method 3400 may include determining whether a current time satisfies the deployment schedule, at 3406, and transmitting a control signal to deploy a refuse collection drone based on the control signal, at 3408.

In some embodiments, and as shown, the method 3400 includes determining a deployment schedule based on signals from the containers within the venue, at 3460. For example, operation 3460 may include receiving a signal from a fill level sensor and/or a gas sensor associated with the first container, and determining if the signal satisfies a fill level threshold and/or a gas level threshold. The method 3400 may include deploying a refuse collection drone responsive to a determination that the fill level and/or gas level is satisfied (e.g., that the fill level is within a fill level threshold of a max fill level, such as based on the distance between the container and the depot and a velocity of the refuse collection drone, etc.).

The method 3400 may include deploying a refuse collection drone responsive to the fill level and/or the gas level being satisfied, at 3408. Operation 3408 may include transmitting a control signal including a location of the container associated with the fill level and/or gas level data to a respective one of the refuse collection drones. If the fill level and gas level are not satisfied, the method 3400 may return to operation 3402 and repeat.

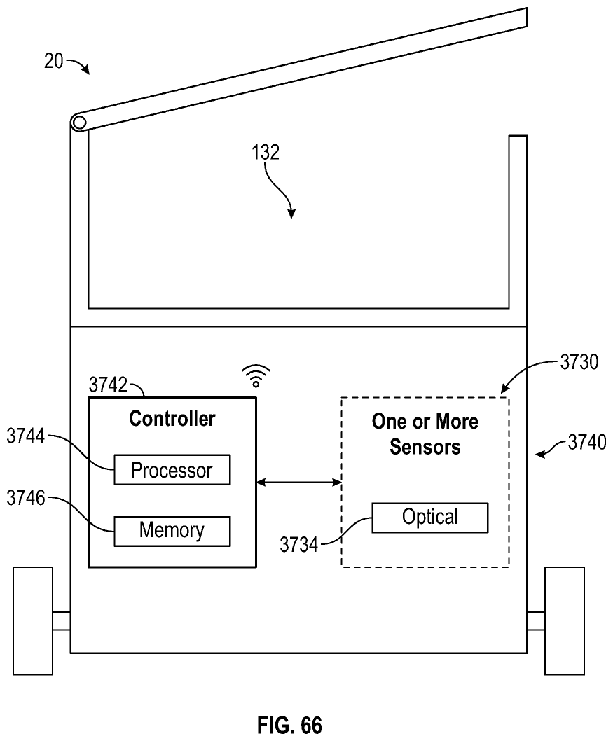

Referring to FIG. 63, a method 3500 of determining and/or adjusting a refuse collection schedule for one or more refuse collection drones is shown, according to an exemplary embodiment. The method 3500 may be performed by the activity-based refuse collection system 3200 of FIG. 60 and will be described with reference to FIG. 60.

The method 3500 includes receiving activity data regarding activity levels within a venue, at 3502, and location data regarding locations associated with the activity level data, at 3504. In some embodiments, operation 3502 includes receiving sensor data from the sensors within the venue, such as from cameras monitoring different areas of the venue. In some embodiments, operation 3502 includes receiving location data from one or more user devices within the venue. Additionally, or alternatively, operations 3502 and 3504 may include receiving sensor data from environmental sensors and location sensors onboard a refuse collection drone. In such implementations, operation 3502 may include receiving environmental sensor data from environmental sensors onboard the refuse collection drone that are indicative of activity levels (e.g., occupancy levels, attendee population density, etc.) in a region surrounding the refuse collection drone, and location data from location sensors (e.g., GPS data) indicative of the location of the refuse collection drone within the venue. In some embodiments, operation 3502 includes receiving fill and/or gas level data and/or locations data from fill sensors and/or gas sensors disposed on one or more refuse containers within the venue.

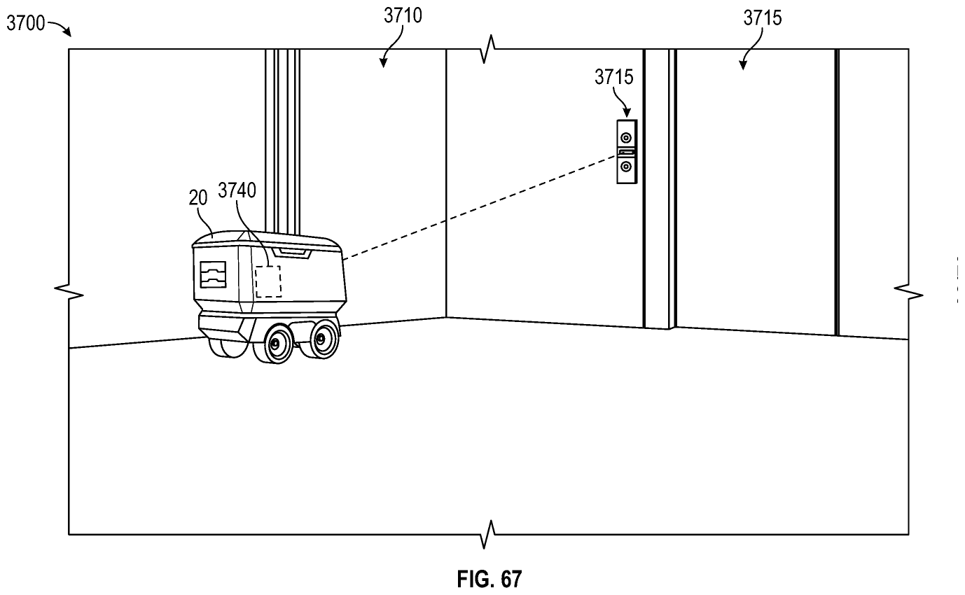

For example, referring to FIG. 64, a schematic diagram of an example venue 3600 is shown, according to an embodiment. The venue 3600 may be a stadium, an arena, or a region to accommodate an event. In other embodiments, the venue 3600 includes a transport hub, such as an airport, bus depot, or a train station. In the embodiment of FIG. 64, the venue 3600 is a concert hall including a stage. The venue 3600 is subdivided into multiple different areas or regions, shown as spaces 3601, in which attendees 3602 may occupy. Each area includes a refuse container 3604 (e.g., a garbage collection bin, etc.) that is emptied or replaced periodically by a refuse collection drone 3606. Sensors within the venue 3600 or disposed onboard the refuse collection drones may be used to generate sensor data indicative of occupancy in the areas or spaces 3601 proximate to the sensors, and/or a location of the sensors. In other embodiments, the location of the sensors and/or drones may be determined based on predetermined locations, or refuse collection schedules for the refuse collection drones.

Referring again to FIG. 63, in some embodiments, the method 3500 includes determining an activity level based on the activity data and the location data, at 3506. In some embodiments, operation 3506 includes determining reflection levels, heat levels, odor levels and/or other gas levels, and/or other metrics associated with attendee density in different spaces of the venue based on the activity level data. In some embodiments, operation 3506 also includes identifying, assigning, or otherwise associating the activity levels with different regions and/or areas within the venue. In some embodiments, the method includes determining activity levels based on historical refuse collection data from the refuse collection drones (e.g., a weight of different ones of the refuse containers collected at periodic intervals, etc.).

The method 3500 includes adjusting a refuse collection schedule for the refuse collection drones based on the activity levels, at 3508. In some embodiments, operation 3508 includes adjusting a refuse collection frequency and/or interval of collecting refuse from one or more refuse containers within the venue. In other embodiments, operation 908 includes adjusting a refuse collection route of the refuse collection drones (e.g., an order of refuse collection performed by the refuse collection drones, a path taken by the refuse collection drones through the venue during a refuse collection route, etc.), or another refuse collection parameter associated with refuse collection scheduling.

Referring to FIG. 56, additional flow diagrams of methods of refuse collection are shown, according to various exemplary embodiments. The methods may be venue specific (e.g., different for a part or public area as compared to a stadium or other event venue, etc.). In some embodiments, and as shown for methods 2900 and 2906, the methods may also include performing refuse collection in response to user requests (e.g., from the user devices) and signals from specific refuse containers indicating that the containers are full, in addition to performing refuse collection based on activity level information associated with the event.

It should be appreciated that the venue systems and refuse collection drone systems and control methods of the present disclosure should not be considered limiting. Various other implementations are possible without departing from the inventive principles described herein. In some embodiments, the refuse collection drones may be configured to provide additional or other services to venue attendees. For example, at least one refuse collection drone may be configured as a hailable drink dispenser and/or cooler. In such implementations, the venue controller may be configured to operate (e.g., deploy, etc.) the refuse collection drone responsive to user requests for a beverage or other refreshment. In some embodiments, deployment may be activity-based as described above, and may involve period of roaming in which the refuse collection drone navigates highly populated areas in a manner similar to a mobile vendor at a ballpark or other venue.

Various other applications for the refuse collection drones are also contemplated. For example, the refuse collection drones may be configured as portable sanitary stations, which may include a portable hand washing station and/or a portable lavatory. By way of another example, the refuse collection drones may also include or define branding areas for displaying of customized branding (e.g., advertisements), such as to advertise or promote sustainability.

### Multi-Unit Building Refuse Collection System

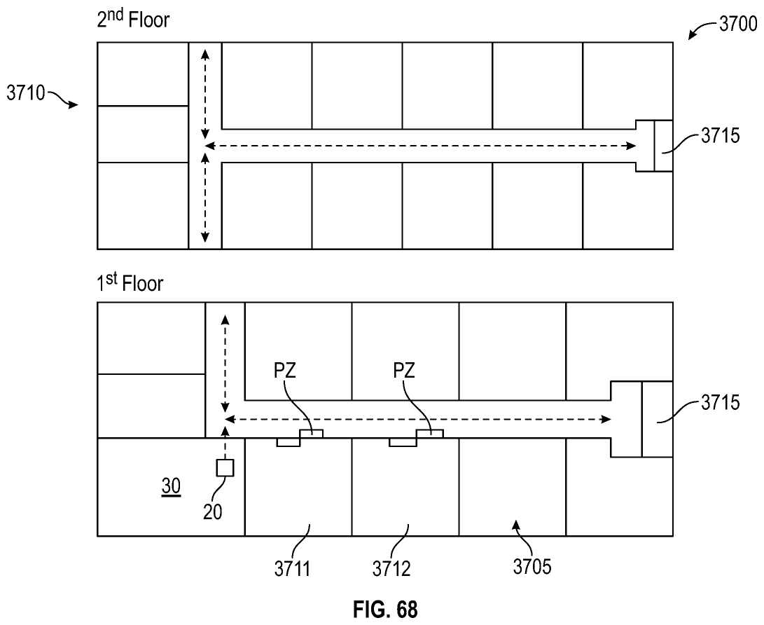

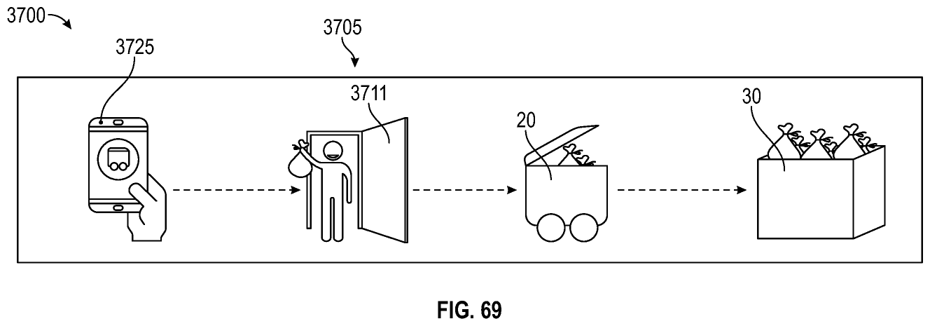

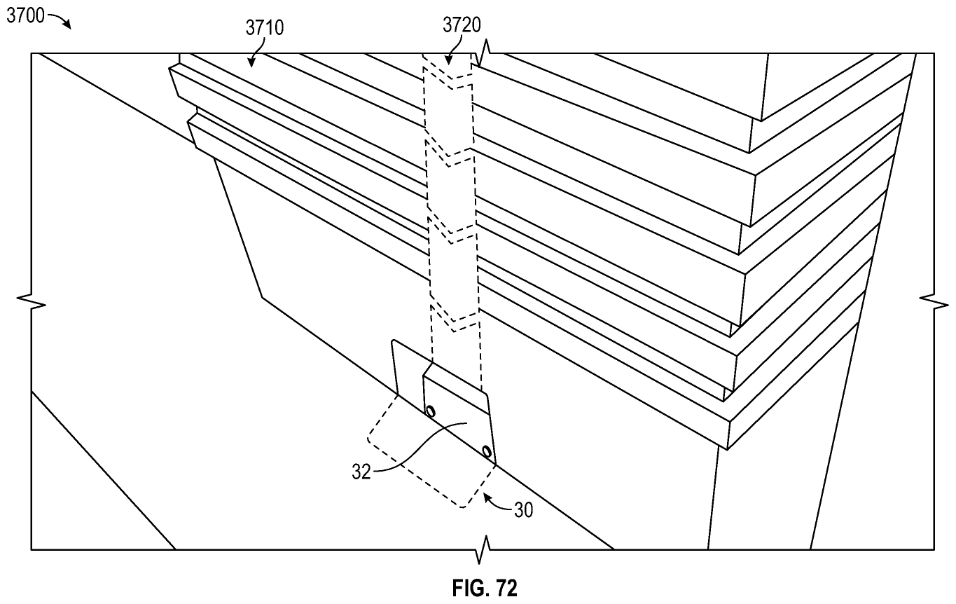

Referring generally to FIGS. 65-74, a refuse collection system may include one or more refuse collection drones, refuse depots, and refuse vehicles. For example, a refuse collection system for a multi-unit building includes a refuse collection drone configured to travel throughout the building. The refuse collection drone includes a storage volume, one or more sensors configured to provide sensor data indicative of the building (e.g., indicative of areas of the building in which the refuse collection drone is operating), and a controller communicably coupled to one or more sensors. The controller is configured to drive the refuse collection drone throughout the building between the plurality of units of the building, based on the sensor data from the one or more sensors; determine a presence of refuse to be collected; collect the refuse into the storage volume, based on determining the presence of refuse; determine a unit of the plurality of units where the refuse was collected, based on the sensor data from the one or more sensors; and drive the refuse collection drone to another unit of the plurality of units. The refuse collection drone may continuously navigate through the multi-unit building along a refuse collection route to detect the presence of refuse (e.g., outside a door of a unit) and collect said refuse. A user (e.g., a resident, an occupant) may request refuse collection and have the refuse collection drone come to the user's unit and collect the refuse. Once loaded with refuse, the refuse collection drone autonomously navigates to the refuse depot where the refuse is transferred to a centralized storage. Because the refuse collection system can provide continuous removal of refuse, the system can efficiently provide refuse collection for occupants (e.g., removing the need to walk to a centralized dumpster, trash room, or garbage chute in an apartment complex), and/or remove unsightly refuse from multi-unit building to prevent refuse from accumulating in public areas (e.g., in hotels where travelers leave refuse outside their door in the hallway).

In some embodiments, the refuse collection drone includes a communications interface providing network connectivity between the refuse collection drone and facilities access points within the building (e.g., elevators, doors, etc.) to navigate multi-stories buildings to collect materials and/or deliver materials directly to the requestor's doorway. In such embodiments, the system may enable the refuse collection drone to interact with elevators and/or other access points to request the floor needed autonomously. When discarding refuse material, the refuse collection drone may interact with waste receptacles to reduce cross-contamination of waste streams and/or to reduce the risk of contamination of waste streams.

Referring to FIGS. 65-68, a refuse collection system 3700 is configured for refuse collection at a multi-unit building 3710. For example, the multi-unit building 3710 may be an apartment complex, a dormitory, a hotel, a condominium, and/or another multi-unit complex. The multi-unit building 3710 may include a plurality of units 3705, where the units 3705 may be separated by floors, hallways, elevators, and/or doors. The refuse collection drone 20 is configured to navigate the multi-unit building 3710 to collect refuse and store said refuse within the refuse collection drone 20 (e.g., within the storage volume 132 thereof). The system 3700 may be similar to system 10, including components as described herein.

The refuse collection system 3700 may provide for network connectivity between the refuse collection drone 20 and one or more building systems, such as systems controlling various access points (e.g., doors, elevators, access hatches, etc.) of the multi-unit building 3710 so the drone 20 may autonomously navigate through the multi-unit building 3710 (e.g., open doors, call and travel in an elevator to access various floors, etc.) to complete various operations, such as collecting materials (e.g., refuse, packages, etc.) and delivering materials (e.g., packages). The refuse collection drone 20 may collect and/or deliver materials directly to a user's unit (e.g. proximate a user's doorway). After collecting refuse, the refuse collection drone 20 may interact with one or more refuse containers (e.g., trash bin, recycling bin, etc.) to deposit said collected refuse therein. The refuse collection system 3700 may provide for the refuse collection drone 20 to communicate with a refuse container to ensure the refuse is deposited into the correct container (e.g. recycling makes it into the recycling bin) and that there is minimal contamination of refuse (e.g., no contamination, below an acceptable threshold level) within respective refuse containers (e.g., minimal trash deposited into the recycling bin, no contaminants such as batteries within the trash bin or recycling bin, etc.). The refuse collection system 3700 can increase the efficiency of refuse collection within multi-unit buildings, increase convenience for occupants within the multi-unit buildings, provide for multiple types of refuse collection (e.g., trash and recycling) and the accurate collection of refuse thereof, increase safe refuse disposal practices (e.g., no contaminants, timely refuse collection, etc.), and/or increases the efficiency of package delivery services within multi-unit buildings.

The refuse collection drone 20 includes a control system 3740, including a controller 3742. The controller 3742 may include a processor 3744 and a memory 3746. For example, the control system 3740, the controller 3742, the processor 3744, and/or the memory 3746 may be the same as the control system 140, the controller 140, the processor 144, and/or the memory 146, as described herein. The control system 140 may be further configured to control the refuse collection drone 20 for refuse collection within the multi-unit building 3710, as described herein.

The refuse collection drone 20 may be configured to continuously move throughout (i.e., roam) the multi-unit building 3710 to collect refuse. For example, the memory 3746 may store location data for the multi-unit building 3710 (e.g., maps, layout, GPS data, etc.). For example, the location data may include floor plans, hallways layout, unit numbers, and/or other information for navigating the multi-unit building 3710. The refuse collection drone 20 may travel on a refuse collection route throughout the multi-unit building 3710 for refuse collection. The refuse collection route may be based on the location data of the multi-unit building 3710 for navigating the refuse collection drone 20.

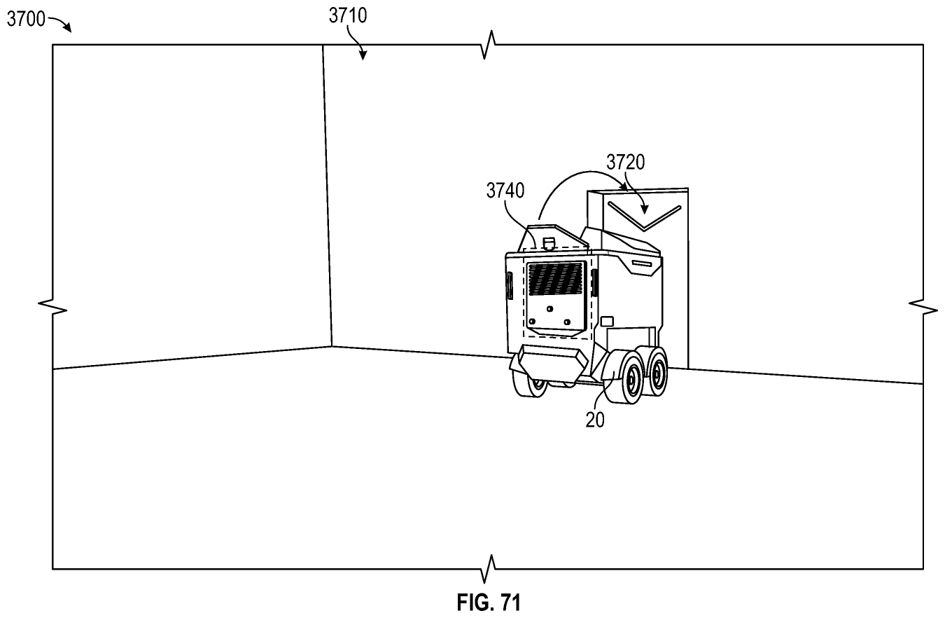

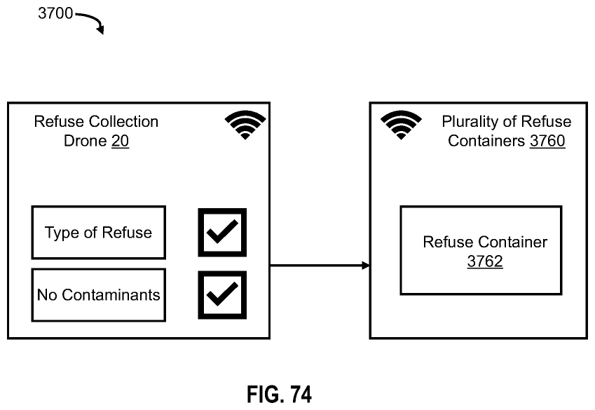

Referring to FIGS. 68 and 73, the refuse collection route may span across multiple floors of the multi-unit building 3710. In some embodiments, the refuse collection route may span throughout one or more zones of the multi-unit building 3710. For example, zones of the building may include a lobby, elevator, refuse container room (e.g., trash room), refuse chute access, communal space (e.g., common room), bathroom, secured area (e.g., private room, private corridor/wing, floor, etc.), office space, parking garage, gym, maintenance area, storage area (e.g., cellar, basement), pool, kitchen space, refuse depot, and others. The zones of the building may be separated (e.g., secured, spaced apart by, connected, etc.) by one or more access points, such as access point 3750, as shown in FIG. 73. A first zone 3752 of the multi-unit building 3710 may be connected to a second zone 3754 of the multi-unit building 3710 through the access point 3750, where the access point 3750 separates the zones 3752, 3754 of the multi-unit building 3710. For example, the first zone 3752 may be a lobby of the multi-unit building 3710, which may be connected to a plurality of units 3705 (e.g., rooms) within the multi-unit building 3710. The plurality of units 3705 may be accessed from a corridor (e.g., shared hallway between the units), where the plurality of units 3705 and/or the corridor may be the second zone 3754 of the multi-unit building 3710. The lobby is separated from the corridor for the plurality of units 3705 by the access point 3750, where the access point 3750 may be a security door (e.g., locked door, which may be unlocked via a key, key fob, card, and/or other authorized unlocking device). In some embodiments, the access point 3750 may be a door (e.g., a security door, elevator door, garage door, etc.), an access hatch (e.g., refuse chute hatch, refuse container lid, etc.), a gate (e.g., pool area gate, courtyard gate, etc.), and/or other barrier configured to separate zones of the multi-unit building 3710.

The refuse collection drone 20 may be communicably coupled to the access point 3750 (e.g., via a wireless communications network). The refuse collection drone 20 may be configured to engage the access point 3750 to cause the access point 3750 to actuate (e.g., to open and/or close when the access point 3750 is a door or a gate or an access hatch, to rise and/or lower when the access point 3750 is an elevator, etc.). For example, the refuse collection drone 20 may transmit (e.g., send) a signal to the access point 3750 (e.g., the building control system configured to control said access point 3750), where the signal is indicative of an actuation for the access point 3750 (e.g., open, close, rise, lower, etc.). The access point 3750 may be actuated (e.g., by one or more actuators thereof, such as an electric motor) corresponding to the signal received from the refuse collection drone 20 (e.g., the building control system for the access point 3750 may control the one or more actuators thereof to cause the actuation of the access point 3750). In some embodiments, the refuse collection drone 20 may manually actuate and/or cause activation of (e.g., using a robotic arm) the access point 3750 (e.g., opening and/or closing a door, pushing a button of an elevator, etc.). In some embodiments, the refuse collection drone 20 may be configured to form a wired connection with one or more access points during operation.

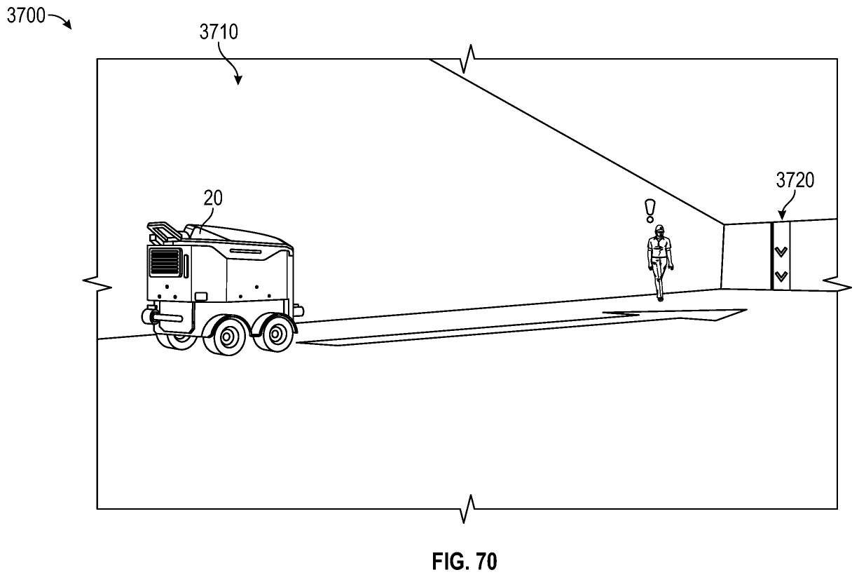

For example, as shown in FIGS. 67 and 68, the refuse collection drone 20 may be configured to travel in an elevator 3715 to reach multiple floors and/or zones of the multi-unit building 3710. For example, the elevator 3715 may be the access point 3750 separating one or more zones of the multi-unit building 3710. The refuse collection drone 20 may be configured to communicate with the elevator 3715. For example, the controller 3742 of the refuse collection drone 20 may be communicably coupled to (e.g., via a wireless connection) the elevator 3715. The controller 3742 may call the elevator 3715 to a current floor where the refuse collection drone 20 is located for the refuse collection drone 20 to board the elevator 3715. The controller 3742 may select a floor for the elevator 3715 to move to for the refuse collection drone 20 to complete the refuse collection route.

The controller 3742 may navigate the refuse collection drone 20 autonomously (e.g., without any directional control by a user) through the multi-unit building 3710. The refuse collection drone 20 may include one or more sensors 3730 configured to provide (e.g., create, send) sensor data to the controller 3742 for operating the refuse collection drone 20 to complete refuse collection within the multi-unit building 3710. For example, the one or more sensors 3730 may include one or more position, velocity, and/or acceleration sensors, such as the location sensor 160 for providing the location data relating to the current location of the refuse collection drone 20, the one or more environment sensors 162 for providing environment data relating to the environment surrounding the refuse collection drone 20, and/or other sensors, as described herein.

In some embodiments, the refuse collection drone 20 may be configured to detect refuse ready for collection, where the refuse collection drone 20 then collects said refuse. The one or more sensors 3730 may include an optical sensor 3734, for detecting the refuse. The optical sensor 3734 communicably coupled with the controller 3742 to communicate sensor data indicate of objects, including refuse, to the controller 3742 for refuse detection and/or collection. In some embodiments, the refuse collection drone 20 may use the one or more environmental sensors 162 for detecting refuse. The refuse collection drone 20 may be configured with data indicative of refuse (e.g., image data), where said data is stored in the memory 3746. The controller 3742 compares sensor data from the optical sensor 3734 (and/or from the environmental sensors 162) to the stored data indicative of refuse to determine if an object is refuse, and therefore may be collected by the refuse collection drone.

The refuse collection route may include the refuse collection drone 20 travelling through the multi-unit building 3710, such as along the hallways thereof, where the refuse collection drone 20 continually detects for refuse along the refuse collection route. When refuse is detected, the refuse collection drone 20 proceeds to collect said refuse and store the refuse within the storage volume 132 thereof (e.g., in the bin 130). The refuse collection drone 20 then continues along the refuse collection route until the refuse collection route is completed and/or until the refuse collection drone 20 (or the storage volume 132 thereof) is full of refuse. For example, the refuse collection route may include the refuse collection drone 20 travelling between the plurality of units 3705 (e.g., at pickup zones thereof), to determine if there is refuse ready to be collected at each unit. The pickup zones (“PZ”) may be within the units and/or outside the units (e.g., outside a door of the unit). For example, the refuse collection drone 20 may begin the refuse collection route at a starting location, such as the refuse depot 30, and travel to a first unit 3711 of the multi-unit building 3710 to determine if there is refuse ready to be collected at the first unit 3711 (e.g., a presence of refuse). If the refuse collection drone 20 detects refuse at the first unit 3711, the refuse collection drone 20 proceeds to collect said refuse and store the refuse within the storage volume 132 thereof (e.g., in the bin 130). The refuse collection drone 20 may continue the refuse collection route, whether or not refuse was detected, and travel to a second unit 3712 of the multi-unit building 3710. At the second unit 3712, the refuse collection drone 20 determines if there is refuse ready to be collected. The refuse collection drone 20 may continue along the refuse collection route to a plurality of additional units (e.g., a third unit, a fourth unit, etc.) until the refuse collection route is completed and/or until refuse collection drone 20 (or the storage volume 132 thereof) is full of refuse. The refuse collection drone 20 may be configured to determine (e.g., using a sensor) a fill level and/or an amount of refuse within the refuse collection drone 20. For example, the refuse collection drone 20 may use the weight sensor 164 and/or the camera 166 to determine when the refuse collection drone 20 is full of refuse. When the storage volume 132 is full (e.g., when a threshold fill level is reached, when a threshold amount of refuse is reached), the refuse collection drone 20 may be configured to travel to the refuse depot 30 to deposit the refuse. Once the refuse collection drone 20 is empty again (e.g., the refuse is deposited at the depot), the refuse collection drone 20 may resume the refuse collection route.

The refuse collection drone 20 may be configured to track where the refuse collection has been completed (e.g., where refuse was detected and collected). For example, when refuse is detected, the refuse collection drone 20 may use the location data to determine which unit of the multi-unit building 3710 said refuse was collected from. For example, the refuse collection drone 20 may resume the refuse collection route at a unit where refuse collection has not taken place (e.g., at the next unit after the last refuse collection before the refuse collection drone 20 travelled to the refuse depot 30). For another example, the refuse collection drone 20 may then stop detecting for refuse at the units where refuse collection has occurred for a period of time after refuse collection at said units. For another example, the refuse collection drone 20 may not travel along an already completed portion of the refuse collection route, such as a situation where the refuse collection drone 20 is returning from the refuse depot 30, and/or skip refuse collection at said units in the already completed portion until the refuse collection route is completed. By tracking which units refuse collection has already taken place, the refuse collection drone 20 increases refuse collection efficiency, by timely collecting refuse from units at the end of the refuse collection route and/or saving energy by quickly skipping through or bypassing the already completed portion of the refuse collection route.

Referring to FIGS. 65-69, the refuse collection drone 20 may be configured for refuse collection within the multi-unit building 3710 based on a refuse collection request (i.e., a signal indicative of refuse to be collected). The refuse collection drone 20 may determine that refuse is ready to be collected by receiving the refuse collection request. For example, the refuse collection drone 20 may receive the refuse collection request (e.g., from a user, a resident, an occupant) and travel to a specified location (e.g., a pickup zone), such as a unit of the multi-unit building 3710, to collect refuse. The pickup zone may be within the unit and/or outside the unit (e.g., outside a door of the unit). In some embodiments, each unit of the multi-unit building 3710 may include a communication device (e.g., communication device), such as a button, for sending the refuse collection request. The button may be communicably coupled to the control system 3740 of the refuse collection drone 20 and/or to the system 3700 (e.g., to the refuse depot 30 for dispatching the refuse collection drone refuse collection drone 20). The refuse collection request may include location data (e.g., the room number, room location) for the refuse collection robot 20 to navigate to the pickup zone.

The refuse collection request may be sent from a user device 3725 (e.g., a smartphone, a tablet, a communication device, etc.). For example, the user (e.g., the resident, the occupant) can integrate their personal device(s) into the system 3700 (e.g., via an app, a webpage, etc.) to send the refuse collection request. The user device may be integrated into the system 3700 by being communicably coupled to the controller 3742 of the refuse collection drone 20 and/or to the system 3700 (e.g., to the refuse depot 30 for dispatching the refuse collection drone refuse collection drone 20). After sending the refuse collection request, the user may leave the refuse at the pickup zone, and/or manually place the refuse within the refuse collection drone 20 upon arrival. The refuse collection drone 20 may notify the user when the refuse collection drone 20 arrives at the unit occupied by the user in the multi-unit building 3710. For example, it is common during hotel stays for travelers (i.e., the user) to order room service and then leave their refuse outside a hotel room for pickup. By providing the refuse collection drone 20, the user may send the refuse collection request for faster and/or more efficient refuse collection when needed, keeping hotel hallways clear of refuse, which mitigates foul odors, unsightly refuse, and/or prevents bugs or rodents from being drawn to the refuse in the hotel hallways, reduces labor costs for the hotel, and limits wasted usage of the drone when there is not refuse to be collected.

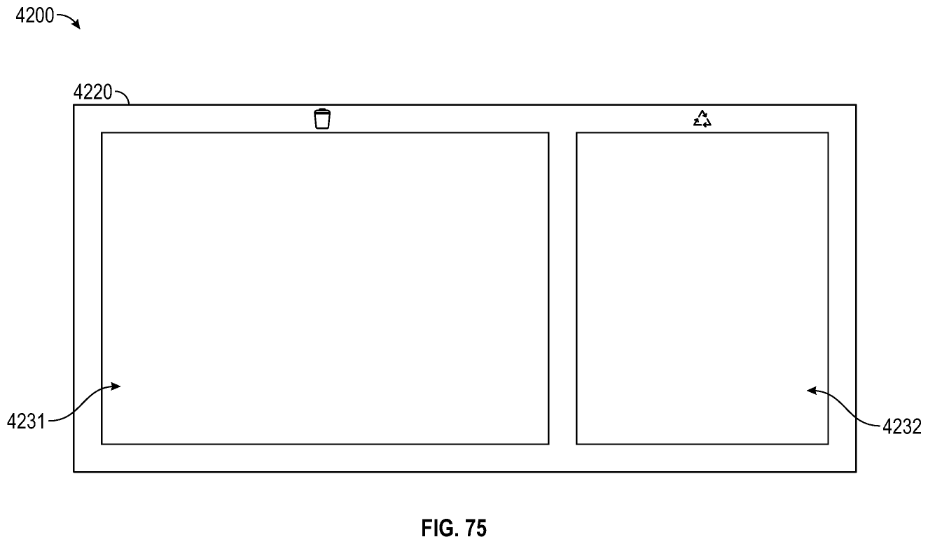

After collecting refuse, the refuse collection drone 20 may navigate through the multi-unit building 3710 to a refuse deposit location, such as the refuse depot 30, as described herein. The refuse collection drone 20 may deposit the collected refuse into a refuse container 3762 (e.g., where the container is positioned at the refuse deposit location). As shown in FIG. 74, the refuse collection drone 20 may be communicably coupled to the refuse container 3762 and/or a plurality of refuse containers 3760. The refuse collection drone 20 may determine a type of refuse (e.g., trash, recycling, compost, electronic waste, etc.) contained within the refuse collection drone 20 (e.g., within the storage volume 132 thereof), as described herein. The refuse collection drone 20 may determine a presence of contaminants (e.g., hazardous materials such as batteries, trash within recycling, etc.) within the refuse. For example, a contaminant may be detected by the one or more sensors 3730 (e.g., the camera 166 may observe a contaminant within the refuse being collected by the refuse collection drone 20, one of the one or more sensors 3730 may be a metal detector and/or other type of sensor configured to detect a specific contaminant within refuse). The control system 3740 (e.g., controller 3742, processor 3744, etc.) of the refuse collection drone 20 may be configured to receive sensor data from the one or more sensors 3730, where the data is indicative of the refuse being collected by the refuse collection drone 20, and determine the presence of the contaminant within the refuse, based on the sensor data.

The refuse collection drone 20 may communicate with (e.g., over a communications network) the plurality of refuse containers (e.g., the refuse container 3762) to ensure that the refuse is deposited into a refuse container configured for a type of refuse corresponding to the type of refuse collected by the refuse collection drone 20, and/or that the refuse does not include the contaminant. For example, the refuse collection drone 20 may communicate with the plurality of refuse containers 3760 to determine if the refuse collected by the drone 20 is the same type of refuse as the refuse container 3762 is configured to receive. The refuse collection drone 20 may determine which refuse container, of the plurality of refuse containers 3760, to deposit the collected refuse into, based on the type of refuse collected). For example, if the type of refuse is recycling, the refuse collection drone 20 may communicate with refuse container (e.g., via a radio frequency identification device (RFID) tag, a visual indicator, etc.) to determine which container is configured to receive recycling. For another example, if the type of refuse is trash (e.g., regular refuse, etc.), the refuse collection drone 20 may communicate with refuse containers to determine which container is configured to receive trash.

The refuse container 3762 may determine if the refuse deposited into the refuse container 3762 is the same type of refuse as the refuse container 3762 is configured to receive. For example, the refuse container 3762 may include one or more sensors, similar to the one or more sensors 3730 of the refuse collection drone 20. The refuse container 3762 may determine a type of refuse contained within the refuse collection drone 20, similarly to the determination of the type of refuse made by the refuse collection drone 20, as described herein. The refuse container 3762 determine a presence of contaminants (e.g., hazardous materials such as batteries, trash within recycling, etc.) within the refuse deposited into the refuse container 3762, similarly to the contaminant determination made by the refuse collection drone 20, as described herein. If the refuse container refuse container 3762 determines that the refuse is incorrectly (e.g., wrong type of refuse, presence of contaminants detected, etc.) deposited therein, the refuse container 3762 may transmit a notification (e.g., message, alert) to the refuse collection system 3700 to notify (e.g., alert) operators and/or owners of the multi-unit building 3710 and/or refuse collection services of the contaminated refuse within the refuse container 3762. By alerting to contaminated refuse within the refuse container 3762, the contaminated refuse (e.g., presence of contaminants, incorrect type of refuse within the container, etc.) may be removed from the refuse container 3762. In some embodiments, if the refuse container 3762 includes contaminated refuse, the refuse container 3762, and/or refuse therein, may be collected (e.g., by a refuse vehicle, etc.) according to the contaminated refuse therein for safe and efficient disposal of the refuse (e.g., if a contaminant is detected, a refuse vehicle configured to collect contaminants may be send to retrieve the refuse container 3762 for safe disposal of the contaminant).

In some embodiments, the refuse collection drone 20 may be configured to continuously travel through the multi-unit building 3710, where the refuse collection drone 20 may periodically stop and/or detect the user for collecting refuse from said user. In some embodiments, the refuse collection drone 20 may travel the refuse collection route on a set schedule, where the user may meet the refuse collection drone 20 at the pickup zone (e.g., outside their door) to deposit refuse into the refuse collection drone 20. In some embodiments, the refuse collection drone 20 tracking refuse collection data may be used to determine the set schedule for refuse collection.

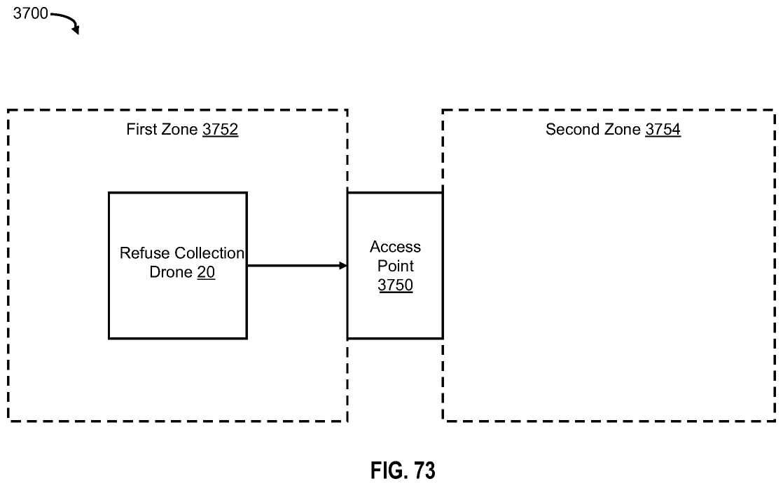

Referring to FIGS. 70-72, the refuse collection system 3700 of the multi-unit building 3710 includes a refuse chute 3720. For example, the refuse chute 3720 may be configured to receive refuse and transport said refuse to the refuse depot 30. The refuse depot 30 may include the centralized storage 32 (e.g., a dumpster) for temporarily holding deposited refuse. The refuse chute 3720 may be accessible from each floor of the multi-unit building 3710, where the refuse chute 3720 uses gravity to transport the refuse to the centralized storage 32.

The refuse collection drone 20 may be configured to engage the refuse chute 3720 to deposit refuse down the refuse chute 3720 for temporary collection in the centralized storage 32. After collecting refuse, including as part of the refuse collection route and/or after determining the storage volume 132 of the refuse collection drone 20 is full, the refuse collection drone 20 drives to the refuse chute 3720 (see FIG. 70). The refuse collection drone 20 (e.g., the control system 3740 thereof) may be communicably coupled to the refuse chute 3720, so the refuse collection drone 20 may open (i.e., access) the refuse chute 3720 to deposit refuse therein (see FIG. 71). In some embodiments, the refuse chute 3720 may include a mechanism for receiving refuse from the refuse collection drone 20. For example, the refuse collection drone 20 may be tipped and/or lifted (e.g., by the mechanism) to empty the refuse collection drone 20 using gravity. In some embodiments, the refuse collection drone 20 may include an emptying mechanism to deposit the refuse into the refuse chute 3720. Once the refuse is deposited into the refuse chute 3720, the refuse falls down to the refuse depot 30 and into the centralized storage 32 (see FIG. 72). The refuse is temporarily stored in the centralized storage 32 until the refuse vehicle 40 comes to collect the refuse from the refuse depot 30 of the multi-unit building 3710.

### Multi-Function Refuse Collection Drone

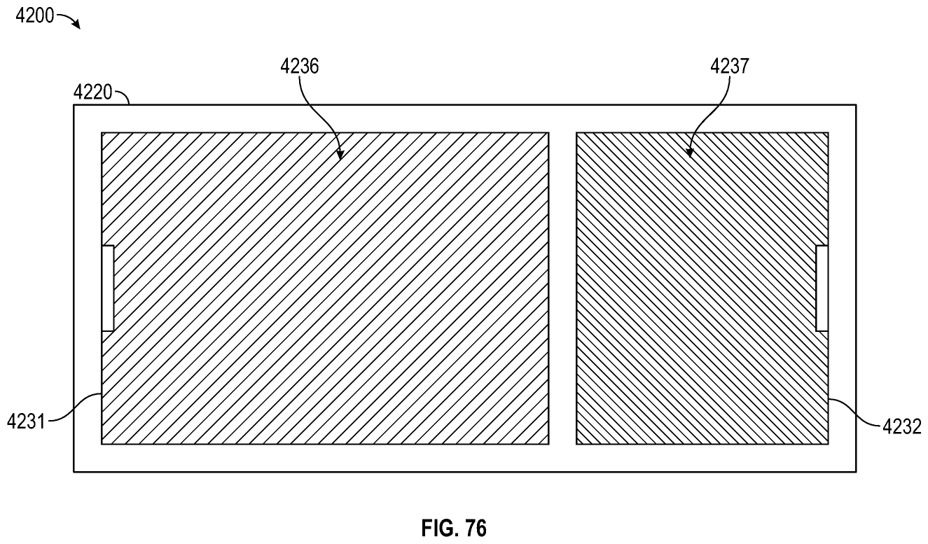

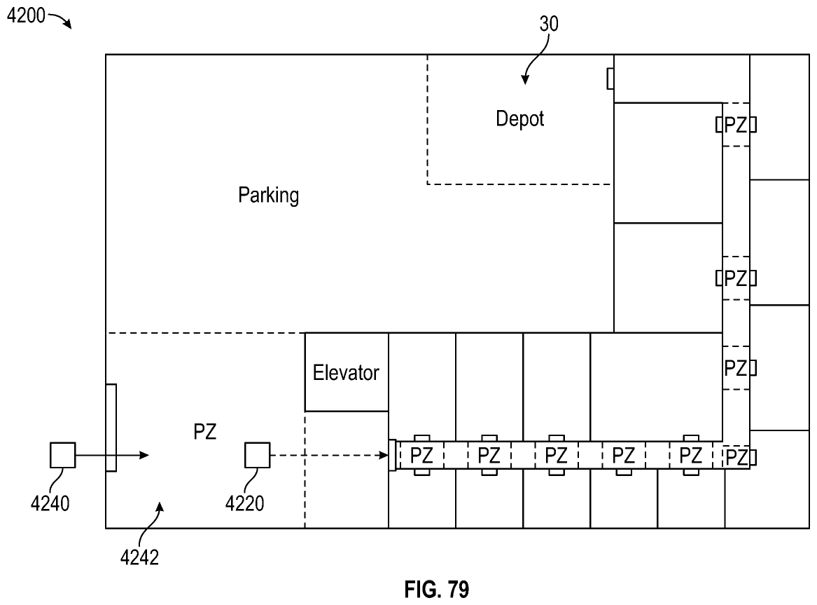

Referring generally to FIGS. 75-88, a refuse collection system includes one or more refuse collection drones, refuse depots, and refuse vehicles. For example, the system may be a multi-function system deploying a multi-function drone including a chassis, a propulsion system comprising one or more wheels and a drive motor to propel the one or more wheels, a battery to power the propulsion system, a first storage volume configured to receive a package for delivery and a second storage volume configured to store refuse, and a controller. The controller is configured to receive a request for pickup of refuse from a customer; receive the package and a delivery address from a delivery agent; and drive the drone to (i) deliver the package to the delivery address and (ii) to collect refuse from the customer. Once loaded with refuse, the refuse collection drone autonomously navigates to a refuse depot where the refuse is transferred to a centralized storage. This process may be repeated by multiple refuse collection drones until the refuse depot is filled, where a refuse vehicle then picks up the refuse for processing at a disposal facility. During the repeated refuse collection, the drones may also complete numerous deliveries. The refuse collection system provides refuse collection services at any time the customer desires, as opposed to operating according to a fixed schedule. Additionally, using the same drone to collect refuse and complete delivery services provides an efficient system that lowers costs and expedites refuse collection and delivery services for customers.

Referring to FIGS. 75-88, a multi-function refuse collection drone, shown as drone 4220, is configured for one or more collection, storage, delivery, and/or other services, including collecting and storing refuse, as described herein. In some embodiments, the refuse collection drone 20 may be configured as the multi-function refuse collection drone. The drone 4220 may include similar components to the refuse collection drone 20, for example, the chassis 100, the propulsion system 110, the wheels 112, the drive motors 114, the batteries 120, the charging interface 122, the control system 140, and/or other components, as described herein (see FIGS. 1-19). The drone 4220 may be configured for use in a multi-function system 4200. The multi-function system 4200 may include the system 10 and/or components thereof, as described herein.

The drone 4220 may include internal multiple compartmentalized storage volumes for storing different types of objects. For example, the drone 4220 may include a first storage volume 4231 and a second storage volume 4232. The first storage volume 4231 and the second storage volume 4232 are separated (e.g., by a divider, by a wall). The first storage volume 4231 may be configured for storing a first type of object. The second storage volume 4232 may be configured for storing a second type of object. In some embodiments, the first storage volume 4231 and the second storage volume 4232 may be configured to store the same and/or similar type of object (e.g., the first type, the second type, etc.). For example, various types of objects may be stored within the storage volumes 4231, 4232, such as refuse, including trash (e.g., waste), recyclable materials (e.g., plastic, cardboard, glass, metals, etc.), compost, electronic waste, etc., and/or deliverable items, such as packages (e.g., boxes, envelopes, mailbags, etc.), meal delivery, grocery delivery, etc.

In some embodiments, the storage volumes are similarly accessible (e.g., opening the cover 170). The drone 4220 may include an anti-contamination feature (e.g., air blower, internal lid, raised edges, retainers, etc.) to assist in separating the first storage volume 4231 and the second storage volume 4232 as to not contaminate either storage volume. In some embodiments, the storage volumes may be accessible from different points, for example, side doors and/or openings of the drone 4220. In some embodiments, the drone 4220 may be configured with additional storage volumes (e.g., a third storage volume, a fourth storage volume). The drone 4220 may separate each storage volume from the others similarly to the separation between the first storage volume 4231 and the second storage volume 4232, as described herein.

The drone 4220 may provide for collection of various types of refuse (e.g., waste, recycling, etc.) via multiple receptacles (e.g., the storage volumes) designated (e.g., configured for) a set type of refuse. Thereby, different types of refuse may be collected at once (e.g., during the same trip of the drone 4220, instead of having the drone 4220 take multiple trips to collect different types of refuse). The drone 4220 may deposit the various types of refuse into corresponding refuse containers, thereby increasing the effectiveness of a refuse collection operation and increasing environmentally friendly refuse collection (e.g., increasing the amount of refuse recycled and/or correctly recycled). In some embodiments, the receptacles being removable from the drone 4220 provides for the drone 4220 to be internally cleaned, and/or for easier cleaning of the storage volumes, and/or replacement of said receptacles when needed (e.g., too much damage, too much foul odor, etc.). In some embodiments, when a receptacle is removed, a lockbox (e.g., a secured container) may be inserted into the drone 4220 for delivery of a package or other deliverable item (e.g., food or grocery delivery, etc.). The lockbox placed inside the drone 4220 protects the package from being stolen, thereby increasing the safety of delivery services using the drone 4220. The lockbox may be selectively unlocked by a code provided to a customer (e.g., user, occupant or resident of a building, etc.), for example, from the drone 4220 (e.g., a controller and/or application thereof). By providing refuse collection and/or delivery services, the drone 4220 (e.g., an/or a fleet of drones) can efficiently service an area, such that refuse is collected regularly and/or packages are delivered quickly and securely. For example, in some embodiments, the customer may communicate with the drone 4220 to initiate (e.g., call the drone 4220 to the customer's location) refuse collection and/or delivery service. The drone 4220 (e.g., a controller and/or application thereof) may provide an estimated time of arrival to the customer, providing for faster service to the customer (e.g., less time spent waiting around for the drone 4220, less wait time for the drone 4220 at a customer location, etc.).

As shown in FIG. 75, the drone 4220 may be configured to store different types of refuse material separately. The first storage volume 4231 may be configured for a first type of refuse material. For example, waste may be stored in the first storage volume 4231. The second storage volume 4232 is configured for a second type of refuse material. The first storage volume 4231 and/or the second storage volume 4232, when configured for refuse, may be configured similarly to the storage volume 132, as described herein. For example, recycling (i.e., recyclable materials) may be stored in the second storage volume 4232. In some embodiments, the drone 4220 may be configured to separate refuse for safety, such as identifying contaminants and/or hazardous material in refuse and storing said hazardous material in one of the first storage volume 4231 and/or the second storage volume 4232. In some embodiments, the drone 4220 may be configured with the storage volumes configured to separately store refuse materials, such as separately storing different types of as recyclables (e.g., glass, metal, plastics, paper, etc.), compostable materials, batteries, and/or other material types desired to be differently disposed of. In some embodiments, the storage volumes may be equally sized. In some embodiments, one of the storage volumes may be larger or smaller than other storage volumes.

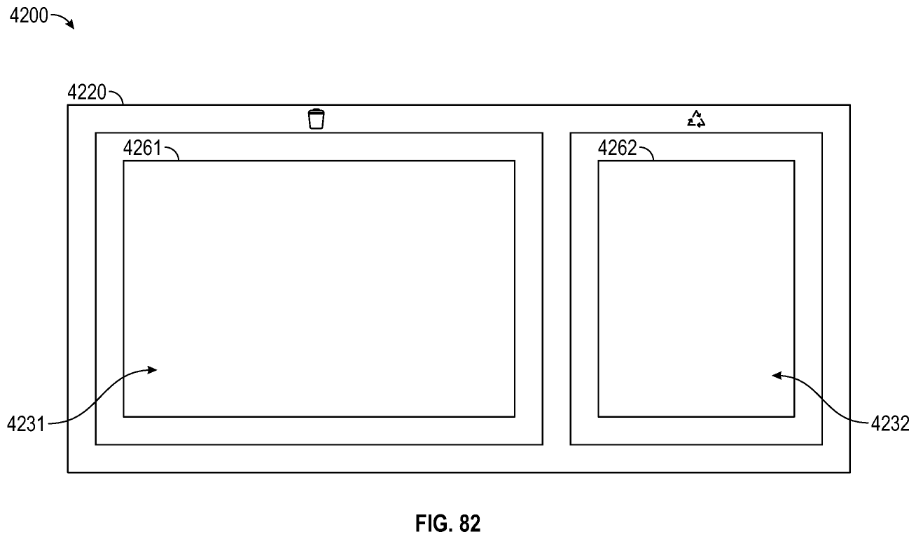

Referring to FIGS. 82-84, the drone 4220 may include one or more receptacles (e.g., bins, containers, lockboxes, etc.) configured to be positioned within the storage volumes (e.g., the first storage volume 4231, the second storage volume 4232). The drone 4220 may include 1, 2, 3, or 4 or more receptacles. A number of receptacles may correspond to a number of storage volumes within the drone 4220 (e.g., where one receptacle is positioned within each storage volume). In some embodiments, the one or more receptacles are removable from the storage volumes.

A first receptacle 4261 may be removably positioned within the first storage volume 4231. A second receptacle 4262 may be removably positioned within the second storage volume 4232. In some embodiments, the receptacles are repositionable such that the first receptacle 4261 may be positioned within the second storage volume 4232 and the second receptacle 4262 may be positioned within the first storage volume 4231.

The first receptacle 4261 may be configured for storing the first type of object. The second receptacle 4262 may be configured for storing the second type of object. For example, where the drone 4220 is configured to store different types of refuse material separately, the first receptacle 4261 may be configured to store the first type of refuse material (e.g., waste), and the second receptacle 4262 may be configured to store the second type of refuse material (e.g., recycling). The storage receptacles 4261, 4262 may be removable from the respective storage volumes 4231, 4232. For example, the first receptacle 4261 and/or the second receptacle 4262 may be removed for cleaning, maintenance, replacement, and/or to dispose of objects or material within the receptacles 4261, 4262 (e.g., depositing refuse from the receptacle into a refuse container, etc.) and/or storage volumes.

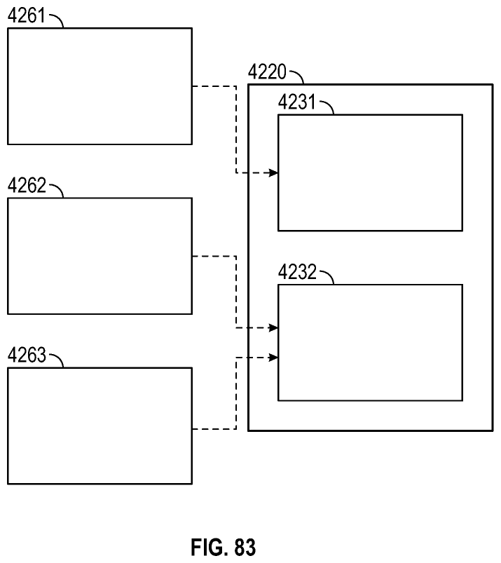

Referring to FIG. 83, having removable storage receptacles 4261, 4262 can enable multiple different configurations of the drone for various refuse collection and/or delivery services. For example, the drone 4220 may be configured with the first receptacle 4261 configured to store the first type of refuse material, such as waste, and the second receptacle 4262 configured to store the second type of refuse material, such as recycling. The second receptacle 4262 may be removed from the second storage volume 4232, and a third receptacle 4263 may be inserted into the second storage volume 4232 where the third receptacle 4263 is configured for storing a third type of refuse material (e.g., electronic waste, recycling or a sub-type thereof, etc.). Thereby, the drone 4220 may collected additional types of refuse. The configuration of receptacles (e.g., the first receptacle 4261 paired with the second receptacle 4262, the first receptacle 4261 paired with the third receptacle 4263, etc.) within the storage volumes 4231, 4232 of the drone 4220 may be selected based on refuse collection trends within the multi-function system 4200 (e.g., frequency of collection, type of refuse collected, amount of collection, etc.), a schedule of refuse collection (e.g., set collection times for different types of refuse), and/or user request (e.g., for collection of a specified type of refuse). In some embodiments, multiple (e.g., both) of the receptacles may be configured to collect the same type of refuse, thereby increasing a capacity (e.g., a volume) for collection of a type of refuse by the drone 4220 (e.g., the first receptacle 4261 and the second receptacle 4262 may be configured to store the same type of refuse).

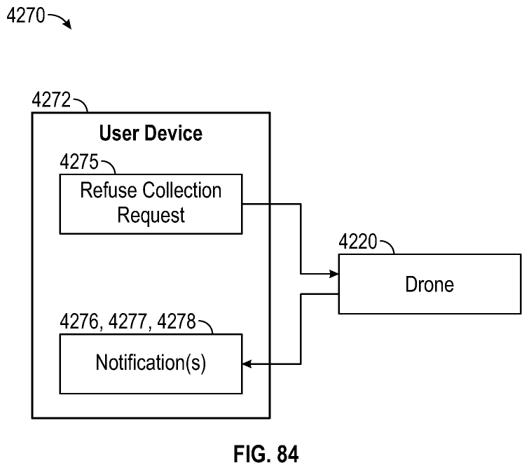

Referring to FIG. 84, the multi-function system 4200 may be configured for the drone 4220 to collect refuse from a customer (e.g., occupant, resident, user, etc.) based on a refuse collection request 4275. The system 4200 may include a refuse collection module 4270 (e.g., software application) to coordinate refuse collection between one or more refuse collection drones 20 and one or more customers of the system 4200. For example, the refuse collection module 4270 may be provided on (e.g., installed on, stored on, etc.) the controller 142 of the refuse collection drone 20 (e.g., where the refuse collection module 4270 may be provided on controllers for each drone within the system 4200). The refuse collection module 4270 may be provided on and/or accessible via the user device 4272.

The customer may transmit the refuse collection request 4275 via a user device 4272, which is communicably coupled (e.g., via a communications network) to the drone 4220 (e.g., the controller 142 thereof). The refuse collection request 4275 may include information relating to refuse collection, including, but not limited to, a type of refuse to be collected, an amount of refuse to be collected, a customer location (e.g., address, GPS coordinates, unit number, etc.), a refuse collection time (e.g., scheduling pickup), and/or customer identification and/or billing information. The customer may input the information relating to refuse collection via the user device 4272. In some embodiments, the user device 4272 may be a tablet, smartphone, computer, remote control, and/or other type of device.

Based on the refuse collection request 4275, the drone 4220 may be configured corresponding to the information relating to refuse collection for the customer (e.g., the information provided in the refuse collection request 4275). For example, if the refuse collection request 4275 indicates that two different types of refuse are to be collected (e.g., waste and recycling) the drone 4220 may be configured with the first receptacle 4261 positioned within the first storage volume 4231 and configured for storing the first type of refuse material (e.g., waste) and the second receptacle 4262 positioned within the first storage volume 4231 and configured for storing the second type of refuse material (e.g., recycling).

In some embodiments, the refuse collection request 4275 is transmitted to the refuse collection module 4270, where the refuse collection module 4270 may allocate the refuse collection request 4275 to a drone of the refuse collection drones 20, based on one or more parameters, including, but not limited to, proximity to the customer, refuse collection capacity (e.g., remaining storage space/volume, configuration for a type of refuse, etc.), availability of the drone (e.g., amount and/or duration of current or queued operations), and/or battery level of the drone. For example, based on the refuse collection request 4275, a drone with a corresponding configuration to the information relating to refuse collection from the refuse collection request 4275 may be dispatched.

Based on the refuse collection request 4275, the refuse collection module 4270 and/or the drone 4220 may transmit a notification 4276 to the customer (e.g., to the user device 4272), where the notification 4276 is indicative of an estimated time of arrival of the drone 4220 to the customer's location (e.g., a unit, an address, a pick-up zone, etc.). Once the drone 4220 arrives at the customer's location (e.g., after the drone 4220 drives to the customer's location), the drone 4220 and/or the refuse collection module 4270 may transmit a notification 4277 to the customer (e.g., to the user device 4272), where the notification 4277 is indicate of the drone 4220 having arrived at the customer's location. The customer may engage the drone 4220. For example, the customer may open the cover 170 of the drone 4220. The customer deposits the refuse into a storage volume and/or receptacle therein corresponding to the type of refuse being collected. For example, if the refuse is waste (e.g., regular trash), the customer may deposit said waste into the first receptacle 4261, where the first receptacle 4261 is configured to store waste. By way of another example, if the refuse is recycling, the customer may deposit said recycling into the second receptacle 4262, where the second receptacle 4262 is configured to store recycling. In some embodiments, the drone 4220 may include (e.g., on an inner surface of the cover 170, on the receptacles 4261, 4262, on a frame member visible adjacent to the storage volumes 4231, 4232, etc.) an identifier (e.g., a label) indicative of the type of refuse corresponding to each of the receptacle 4261, 4262.

After the refuse is collected by the drone 4220 (e.g., in the receptacles 4261, 4262), the drone 4220 travels to the refuse depot 30 and/or other waste disposal area to deposit the refuse. In some embodiments, after the refuse is collected from the customer, the drone 4220 may travel to collect additional refuse (e.g., from another customer) and/or complete other operations and/or services, such as delivering items (e.g., packages, food, etc.) to customers. In some embodiments, the drone 4220 may travel to a centralized location (e.g., a charging station, a waiting and/or idling area, etc.) to await another refuse collection request 4275 from a customer. In some embodiments, the drone 4220 may continually travel along a refuse collection route. Once the storage volumes 4231, 4232 of the drone 4220 are full (e.g., the drone 4220 has collected a threshold amount of refuse for the storage volumes 4231, 4232 and/or the receptacles 4261, 4262 therein), the drone 4220 travels to the refuse depot 30 to deposit the collected refuse. By separating the refuse by type of refuse during collection by the drone 4220, the refuse may be deposited into corresponding refuse containers at the refuse depot 30, thereby increasing the efficiency of refuse collection. For example, by collecting recyclables in a separate storage volume and/or receptacle therein, the rate of recycling of recyclable materials (e.g., instead of disposal as waste and/or into a landfill) is increased.

In some embodiments, the drone 4220 may autonomously retrieve the refuse from the customer's location. The customer may transmit the refuse collection request 4275, where the drone 4220 travels to the customer's location and collects refuse without the customer engaging the drone 4220 (e.g., opening the cover 170, depositing refuse within, etc.). For example, the drone 4220 may identify refuse to be collected at the customer's location (e.g., refuse placed in a designated pick-up zone, etc.). The drone 4220 may pick-up the refuse (e.g., using a robotic arm and/or a lift assembly, etc.) and deposit the refuse into the storage volume 4231, 4232 (e.g., the receptable 4261, 4262 therein).

In some embodiments, the drone 4220 (e.g., the controller 142 thereof) may be configured to determine a type of refuse of the refuse materials. For example, the drone 4220 may include a sensor (e.g., a camera) and/or incorporate one of the sensors disclosed herein (e.g., the camera 166, environmental sensors 162, location sensor 160) configured to provide sensor data indicated of refuse. The drone 4220 (e.g., in the memory 146) may store data indicative of types of refuse, where the control system 140 (e.g., the controller 142) is configured to determine a type of refuse based on comparing the sensor data indicative of refuse to the stored data indicative of a type of refuse. The drone 4220 may then store the refuse based on the type of refuse within one of the storage volumes. In some embodiments, the type of refuse may be included with the refuse. For example, an RFID tag on the refuse may include the type of refuse. The drone 4220 may read the RFID tag (e.g., using an RFID scanner) to properly store the refuse in one of the storage volumes. In some embodiments, the controller 142 may receive a signal indicative of a type of refuse when collecting said refuse. For example, the controller 142 may be communicably coupled with a refuse container, where the drone 4220 collects the refuse from said container. The controller 142 may be communicably coupled with a device, such as a user device, where a user selects a type of refuse to communicate to the controller 142 when the user requests refuse collection. Other methods of conveying the type of refuse may be used to properly store the refuse within the storage volumes of the drone 4220.

In some embodiments, the drone 4220 may be configured to detect contaminants (e.g., batteries, hazardous material, needles, incorrect type of refuse material, etc.) within the refuse deposited into the drone 4220 (e.g., the storage volumes 4231, 4232, and/or the receptacles 4261, 4262, thereof). For example, the drone 4220 may include a sensor (e.g., a camera, metal detector, etc.) and/or incorporate one of the sensors disclosed herein (e.g., the camera 166, environmental sensors 162, location sensor 160) configured to provide sensor data indicated of refuse and/or contaminants within said refuse. The drone 4220 (e.g., in the memory 146) may store data indicative of contaminants, where the control system 140 (e.g., the controller 142) is configured to determine a contaminant based on comparing the sensor data indicative of refuse and/or contaminants to the stored data indicative of contaminants. In some embodiments, based on the drone 4220 detecting contaminants within the refuse, the drone 4220 may transmit a notification 4278 to the customer, the notification 4278 indicative of the contaminants within the refuse (e.g., a warning). The customer may then remove the contaminants from the refuse and/or clear the notification 4278 to indicate a false detection. In some embodiments, the drone 4220 may transmit a notification (e.g., alert) to a refuse collection service indicative of the contaminants and/or possibility (e.g., the detection) of contaminants within the refuse.

In some embodiments, the drone 4220 may include a third storage volume and/or a third receptable (e.g., a third storage area). For example, the third storage area may be positioned in a different portion (e.g., a side, a rear, etc.) of the drone 4220 than the first storage volume 4231 and/or the second storage volume 4232. The third storage area may be configured to store a third type of refuse material. For example, the third type of refuse material may be a hazardous material (e.g., contaminant, such as batteries and/or sharp objects). In some embodiments, the third storage area may be smaller (e.g., have a volume less than) the storage volumes 4231, 4232 (e.g., because the third type of refuse material may be collected less frequently and/or in smaller quantities). By providing the third storage area for hazardous materials, the customer is provided a designated disposal area in the drone 4220, which reduces the frequency of customers disposing of hazardous waste incorrectly (e.g., in the first storage volume 4231). Thereby, the safety or refuse collection is increased.

In some embodiments, the control system 140 of the drone 4220 may further include a user interface or customer-facing interface, such as customer display 168, which is operatively coupled to the controller 142. The customer display 168 includes one or more input devices (e.g., buttons, touch screens, microphones, etc.) for a user to input information into the control system 140 for operating the drone 4220 to complete a service. For example, the user may input a type of refuse into the customer display 168 when depositing refuse into the drone 4220, enabling the refuse to be stored in the appropriate storage volume of the drone 4220.

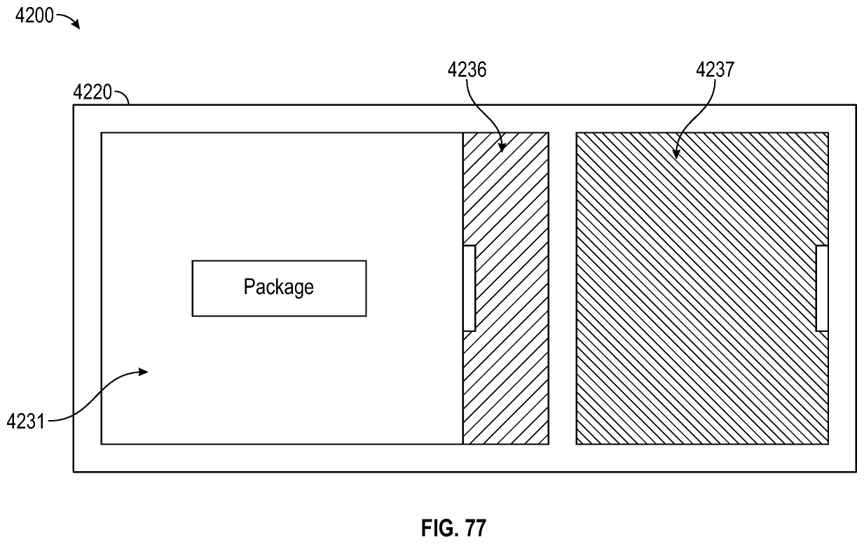

Referring to FIGS. 76-80 and 85-86,the multi-function system 4200 may include providing delivery services, where the drone 4220 is configured to provide said delivery services. For example, the drone 4220 may be configured to store packages and/or food items, and subsequently deliver the packages and/or food to a delivery address. When the drone 4220 is configured to provide delivery services, the first storage volume 4231 may be configured for said delivery service, where the second storage volume 4232 is configured for refuse collection. For example, the first storage volume 4231 may be climate controlled and/or climate controllable (e.g., heated, cooled) for providing delivery of food items (e.g., keeping food hot or cold based on the food item). For example, the first storage volume 4231 may be larger than the second storage volume 4232 when the drone 4220 is configured for delivery services. The first storage volume 4231 may be configured for delivery services, and the larger volume may provide for delivering larger packages. In some embodiments, the storage volumes may be equally sized. In some embodiments, the second storage volume 4232, when configured for refuse, may be configured similarly to the storage volume 132, as described herein.

When one of the storage volumes is configured for delivery services, the drone 4220 includes the anti-contaminant feature to prevent refuse from spilling out of the second storage volume 4232 and into the first storage volume 4231, thereby contaminating the item for delivery. For example, the drone 4220 may include the anti-contamination feature configured as one or more barriers (e.g., lids) for covering one or more of the storage volumes. The barriers may be configured to cover the storage volumes. In some embodiments, the barriers may form a seal with the storage volumes.

As shown in FIGS. 76-77, a first barrier 4236 covers the first storage volume 4231, while a second barrier 4237 covers the second storage volume 4232. In some embodiments, the first barrier 4236 may be locked in place over the first storage volume 4231 until the user inputs a code into the customer display 168 to unlock the first storage volume 4231, remove the first barrier 4236 (e.g., lift, slide, collapse, etc.), and retrieve their package and/or food. Locking the first storage volume 4231 further provides security measures to prevent theft and/or tampering with the package and/or food stored within. Other anti-contamination feature (e.g., air blower, raised edges, retainers, separate access points, etc.) may be used to prevent contamination of the package or food within the first storage volume 4231 when the second storage volume 4232 is configured to store refuse.

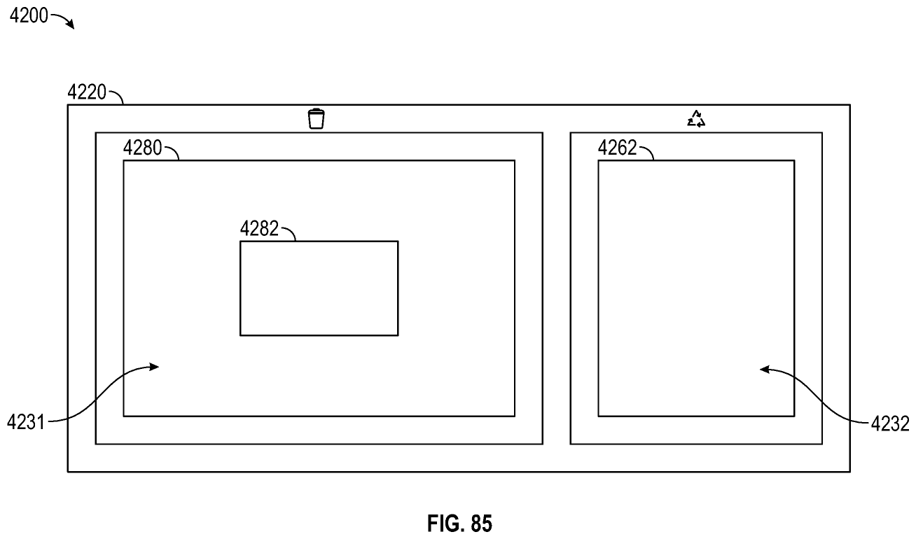

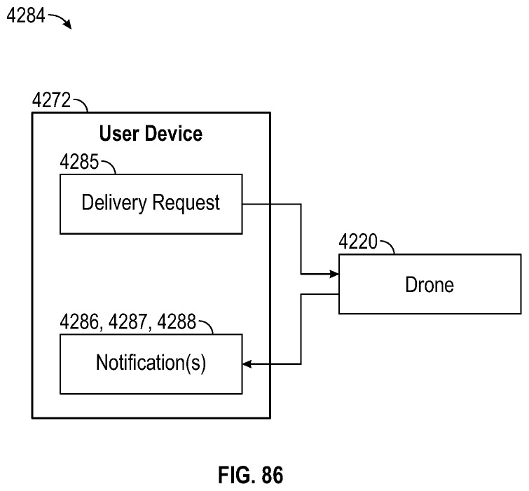

Referring to FIGS. 85-86, when the drone 4220 is configured to provide delivery services, a receptacle may be removably positioned within the storage volumes 4231, 4232 for delivery services. For example, secured container 4280 (e.g., a lockbox, etc.) may be removably positioned within at least one of the storage volumes 4231, 4232 for delivering an item (e.g., package, meal, groceries, etc.) within the secured container 4280.

The drone 4220 may be configured to receive a delivery request 4285 from the customer. For example, the drone 4220 may be configured for refuse collection, with the first receptacle 4261 and the second receptacle 4262, until the delivery request 4285 is received. When the delivery request 4285 is received, the drone 4220 may be configured, at least partially for, delivery services (e.g., the drone 4220 may be configured to delivery items within both storge areas 4231, 4232, and/or delivery an item in one storage volume while remaining configured for refuse collection in the other storage volume). For example, based on the delivery request 4285, the first receptacle 4261 may be removed from the first storage volume 4231, where the secured container 4280 is inserted into the first storage volume 4231 for delivery of the item therein. For another example, based on the delivery request 4285, the second receptacle 4262 may be removed from the second storage volume 4232, where the secured container 4280 is inserted into the second storage volume 4232 for delivery of the item therein. Once the delivery service has been completed (e.g., the customer receives the item stored within the secured container 4280), the secured container 4280 may be removed from the storage volume 4231, 4232. The receptacle 4261, 4262 may be inserted into the storage volume 4231, 4232, configuring the drone 4220 for refuse collection (e.g., until another delivery request 4285 is received and/or the secured container 4280 is inserted into the drone 4220).

The secured container 4280 may include a lid (e.g., cover) to provide a barrier and/or maintain the environment within the secured container 4280 to prevent contamination from refuse stored within the drone 4220. For example, when the drone 4220 is configured to provide refuse collection and delivery services, the secured container 4280 may be positioned within the first storage volume 4231, where the second receptacle 4262 may be positioned within the second storage volume 4232 and configured for storing refuse (e.g., waste), where the secured container 4280 and the second receptacle 4262 are thereby separated to prevent contamination of the item within the secured container 4280 (e.g., the package) by the refuse. In some embodiments, the secured container 4280 may be climate controlled and/or climate controllable (e.g., heated, cooled) for providing delivery of food items (e.g., keeping food hot or cold based on the food item).

The secured container 4280 may include a lock 4282 to secure the item within as the drone 4220 transports the item to the customer. The customer may unlock the secured container 4280 (e.g., via a physical key, via an electronic key, etc.) and retrieve the item within (e.g., their package, their meal, etc.). For example, the refuse collection drone and/or the lock 4282 may be communicably coupled to a user device and configured to receive signals from the user device to identify the user and/or to selectively unlock the lock 4282. Thereby, the secured container 4280 protects the item within and decreases the theft of packages, while increasing delivery speed of said packages to customers.

The drone 4220 may be configured to receive the delivery request 4285 from the customer. For example, via the user device 4272, the customer may input and/or transmit the delivery request 4285. The delivery request 4285 may include delivery information including, but not limited to, an item to be delivered and/or the type of item (e.g., package, meal, etc.), a customer location (e.g., address, GPS coordinates, unit number, etc.), a scheduled delivery time, customer identification and/or billing information, and/or a communications connection to a third party delivery service (e.g., shipping service, meal delivery service, a company, etc.).

For example, the customer may request delivery of the item by transmitting the delivery request 4285. The system 4200 may include a delivery module 4284 (e.g., software application) to coordinate delivery services between one or more refuse collection drones 20 and one or more customers of the system 4200. In some embodiments, the delivery module 4284 may be included with the refuse collection module 4270 (e.g., the delivery service and the refuse collection service may be provided as one software application running within the system 4200, such as on the controllers of the drone). For example, the delivery module 4284 may be provided on (e.g., installed on, stored on, etc.) the controller 142 of the refuse collection drone 20 (e.g., drone 4220). The delivery module 4284 may be provided on and/or accessible via the user device 4272.

In some embodiments, the delivery request 4285 is transmitted to the delivery module 4284, where the delivery module 4284 may allocate the delivery request 4285 to a drone of the refuse collection drones 20 based on one or more parameters, including, but not limited to, proximity to the customer, delivery capacity (e.g., available storage space/volume for the secured container 4280), availability of the drone (e.g., amount and/or duration of current or queued operations), and/or battery level of the drone. Once the delivery request 4285 is allocated to a drone, the drone 4220 may be dispatched to complete the delivery.

Based on the delivery request 4285, the item is inserted into the secured container 4280. The secured container 4280 may be locked (e.g., by actuating and/or closing the lock 4282). The item and/or the secured container 4280 is inserted into the drone 4220 (e.g., within one of the storage volumes 4231, 4232). A notification 4286 may be transmitted to the customer, with the notification 4286 including delivery status information, including, but not limited to, an identifier of the secured container 4280 the item is stored within (e.g., a container number), an identified of the drone 4220 completing the delivery (e.g., a drone number), an estimated time of delivery, and/or drone location data (e.g., to track the location of the drone 4220). Once the item is inserted into the drone 4220, the drone 4220 travels to the customer location to delivery said item.

A notification 4287 is transmitted to the customer, with the notification 4287 including secure (e.g., confidential, encrypted, etc.) unlocking information for the secured container 4280. For example, the notification 4287 may include a digital key configured to provide access (e.g., unlock) the secured container 4280. Once the drone 4220 arrives at the customer's location (e.g., after the drone 4220 drives to the customer's location), the drone 4220 and/or the delivery module 4284 may transmit a notification 4288 to the customer (e.g., to the user device 4272), where the notification 4288 is indicative of the drone 4220 having arrived at the customer's location.

In some embodiments, the notification 4287 and the notification 4286 may be one notification (e.g., sent to the customer as a single notification). In some embodiments, the notification 4287 and the notification 4288 may be one notification. When the drone 4220 arrives at the customer location, the customer engages the drone 4220 to retrieve the item therein. The customer retrieves the item from the drone 4220 (e.g., the storage volumes 4231, 4232 thereof). For example, the customer may remove the secured container 4280 from the drone 4220. The customer may unlock the secured container 4280 using the secured unlocking information (e.g., from the notification 4287). The customer may retrieve the item from the secured container 4280. The customer may insert the secured container 4280 (e.g., now empty) into the drone 4220. In some embodiments, the customer may deposit refuse into the drone 4220 when the drone 4220 is at the customer location (e.g., before, during, and/or after retrieving the item from the drone 4220 providing the delivery service). For example, if the secured container 4280 is positioned in the first storage volume 4231, the drone 4220 may be configured with the second receptacle 4262 within the second storage volume 4232, so the customer may deposit refuse (e.g., or a type of refuse material the second receptacle 4262 is configured to store) into the second receptacle 4262. Thereby, the drone 4220 increases the efficiency of delivery services and refuse collection services for the customer, by providing both services during one trip of the drone 4220.

After the drone 4220 completes the delivery, the drone 4220 may travel to a centralized location (e.g., a charging station, a waiting and/or idling area, etc.) to await another delivery request 4285 and/or a refuse collection request 4275 from a customer. Once the delivery is completed, the secured container 4280 may be removed from the drone 4220. In some embodiments, another item may be inserted into the secured container 4280 (e.g., for another delivery). In some embodiments, the first receptacle 4261 may be inserted into the drone 4220 to configure (e.g., reconfigured) the drone 4220 for refuse collection. In some embodiments, after the delivery is completed, the drone 4220 may travel to collect refuse and/or completed another delivery (e.g., from other customers).

In some embodiments, once the delivery has been completed, the delivery module 4284 may be updated to provide information delivery status information, such as delivery completed and/or an issue with the delivery. Documenting the delivery service provides receipts for record retention (e.g., to confirm delivery with the customer, to troubleshoot, etc.) and/or provides for delivery data to be tracked, thereby increasing the speed of delivery services and/or predicting customer trends (e.g., when delivery is often requested, so the drone 4220 may be configured with the secured container 4280 proactively).

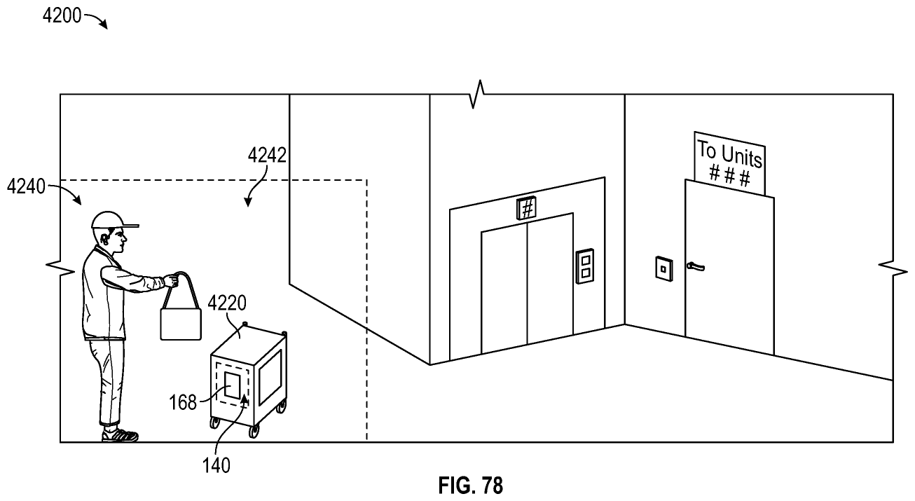

As shown in FIG. 78, a delivery agent 4240 (e.g., a person, another drone, an aerial-drone, etc.) may deliver the package and/or food to the drone 4220. For example, the delivery agent 4240 may travel to a drop-off zone 4242 (e.g., a building lobby, a staging area, the refuse depot 30), where the delivery agent 4240 engages the drone 4220. The drone 4220 may be waiting at the drop-off zone 4242 and/or may travel to the drop-off zone 4242 to meet the delivery agent 4240. The delivery agent 4240 may insert the package and/or food into the first storage volume 4231 of the drone 4220. For example, the delivery agent 4240 may insert the item (e.g., package, food, etc.) into the secured container 4280. The delivery agent 4240 may insert the secured container 4280 into the drone 4220 (e.g., one of the storage volumes 4231, 4232 thereof), as described herein. In some embodiments, the delivery agent 4240 may deliver the item to the centralized location and/or the drop-off zone 4242 (e.g., the front desk and/or lobby area of a building), where another delivery agent (e.g., a front desk worker, employee, etc.) may secure the item within the secured container 4280 and/or insert the item and/or the secured container 4280 into the drone 4220. In some embodiments, once the delivery agent 4240 has completed delivery to the drop-off zone 4242 and/or to the drone 4220, the customer may transmit the delivery request 4285 for the drone 4220 to complete delivery to the customer. In some embodiments, the delivery request 4285 may be transmitted automatically upon the delivery agent 4240 providing delivery to the drop-off zone 4242 and/or the drone 4220 (e.g., where the delivery module 4284 is communicably coupled to a third-party delivery service used by the delivery agent 4240).

In some embodiments, the delivery agent 4240 communicates a delivery address to the drone 4220, so the drone 4220 may complete the delivery. For example, the delivery agent 4240 may provide the delivery request 4285 to the drone 4220 (e.g., instead of the customer). The drone 4220 may be integrated with a third-party delivery service (e.g., delivery software for a food ordering and/or delivery app), where the delivery agent 4240 may use a user device communicably couplable to the drone 4220 (or the controller 142 thereof) to send the delivery instructions to the drone 4220. In some embodiments, the delivery agent 4240 may use the customer display 168 of the drone 4220 to input the delivery address for the drone 4220 to complete delivery. For example, the delivery address may be a unit number, where the drone 4220 is completing a delivery to a unit within a multi-unit building (e.g., hotel, apartment complex, condominium). The unit number may correspond to a pickup zone thereof (e.g., outside a door to the unit). In some embodiments, the delivery agent 4240 may input the delivery address into the drone 4220 for delivery in other environments, such as public areas and parks, stadiums, neighborhoods, and/or entertainment parks. The drone 4220 may be programmed to accommodate the type of environment it serves, as the delivery address could be uniquely configured for easy input by the delivery agent 4240 and transversed by the drone 4220 to complete delivery (e.g., marked delivery zones in a park, section number in a stadium, house number within a neighborhood, etc.).

Referring to FIG. 77 once the drone 4220 receives the package and/or food, the drone 4220 may complete the delivery similarly to operation of the drone 4220 for refuse collection, as described herein. For example, the delivery address may correspond to a pickup zone associated with a customer, as described herein, where the drone 4220 drives to the delivery address (i.e., pickup zone) to complete delivery. In some embodiments, the drone 4220 may be configured to leave the package and/or food at the delivery address (e.g., where the drone 4220 includes a mechanism to remove the package or food from the first storage volume 4231). In some embodiments, the drone 4220 may notify the user (i.e., the customer) upon arrival (and/or during transit), so the user may meet the drone 4220 at the delivery address and remove the package and/or food from the first storage volume 4231 of the drone 4220. For example, the drone 4220 (e.g., the controller 142 thereof) may send a notification to a user device located with the customer indicative of the location of the drone and/or delivery information. In some embodiments, the drone 4220 may pickup refuse from the customer during the delivery. The customer may deposit refuse into the second storage volume 4232 of the drone 4220 when picking up the package and/or food from the first storage volume 4231 of the drone 4220. The drone 4220 may then travel to the refuse depot 30 to deposit the refuse, as described herein, and/or return to the drop-off zone 4242 to await another delivery. The drone 4220 being configured with multiple functions (e.g., refuse collection, delivery) provides for more efficient drone usage within the system 10.

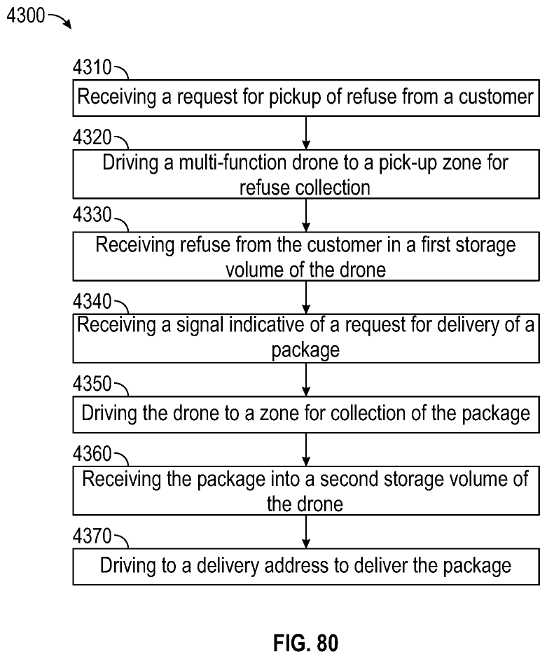

Referring to FIGS. 80-81 and 87-88, methods 4300, 4400, 4500, 4600 for automated multi-function service providing are depicted. For example, the method 4300, the method 4400, the method 4500, and/or the method 4600 provides for a drone to collect refuse and delivery packages and/or food items. The methods 4300, 4400, 4500, 4600 may include fewer, additional, and/or a different ordering of method steps. The methods 4300, 4400, 4500, 4600 may be completed using an embodiment of the multi-function system 4200, as described herein.

Referring to FIG. 80, the method 4300 includes receiving a request for pickup of refuse from a customer, at 4310. The method 4300 includes driving a multi-function drone to a pick-up zone for refuse collection, at 4320. The method 4300 includes receiving refuse from the customer in a first storage volume of the drone, at 4330. The method 4300 includes receiving a signal indicative of a request for delivery of a package, at 4340. The method 4300 includes driving the drone to a zone for collection of the package, at 4350. The method 4300 includes receiving the package into a second storage volume of the drone, at 4360. The method 4300 includes driving to a delivery address to deliver the package, at 4370.

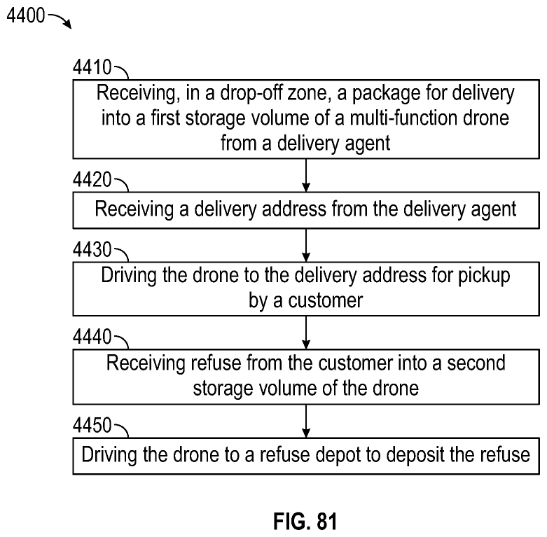

Referring to FIG. 81, the method 4400 includes receiving, in a drop-off zone, a package for delivery into a first storage volume of a multi-function drone from a delivery agent, at 4410. The method 4400 includes receiving a delivery address from the delivery agent, at 4420. The method 4400 includes driving the drone to the delivery address for pickup by a customer, at 4430. The method 4400 includes receiving refuse from the customer into a second storage volume of the drone, at 4440. The method 4400 includes driving the drone to a refuse depot to deposit the refuse, at 4450.

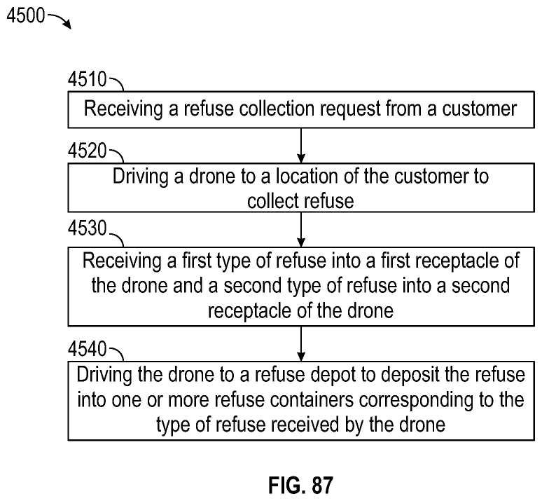

Referring to FIG. 87, the method 4500 includes receiving a refuse collection request from a customer, at 4510. The method 4500 further includes driving a drone to a location of the customer to collect refuse, at 4520. The method 4500 further includes receiving a first type of refuse into a first receptacle of the drone and a second type of refuse into a second receptacle of the drone, at 4530. The method 4500 further includes driving the drone to a refuse depot to deposit the refuse into one or more refuse containers corresponding to the type of refuse received by the drone, at 4540. In some embodiments, the method 4500 may include transmitting a notification to the customer, the notification indicative of an estimated time of arrival for the drone to collect refuse.

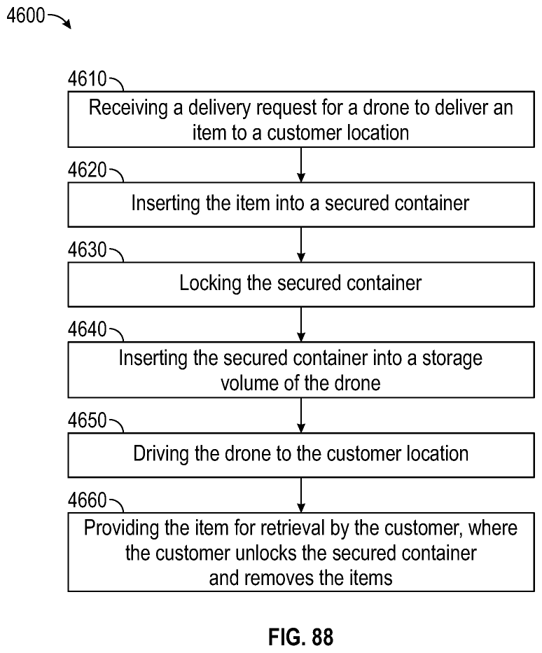

Referring to FIG. 88, the method 4600 includes receiving a delivery request for a drone to deliver an item to a customer location, at 4610. The method 4600 further includes inserting the item into a secured container, at 4620. The method 4600 further includes locking the secured container, at 4630. The method 4600 further includes inserting the secured container into a storage volume of the drone, at 4640. The method 4600 further includes driving the drone to the customer location, at 4650. The method 4600 further includes providing the item for retrieval by the customer, where the customer unlocks the secured container and removes the item, at 4660. In some embodiments, the method 4600 includes transmitting a notification to the customer, where the notification includes a digital key configured to unlock the secured container. In some embodiments, the method 4600 includes receiving refuse from the customer in a receptacle of the drone.

In some embodiments, the first storage volume 4231 and the second storage volume 4232 may be interchangeable, as used herein. For example, the drone 4220 may include a configuration where the first storage volume 4231 and the second storage volume 4232 are flipped, compared to as described herein, such that, when the drone is configured to provide delivery services, the first storage volume 4231 may be configured for refuse collection, while the second storage volume 4232 may be configured for delivery service. In some embodiments, the first receptacle 4261 and the second receptacle 4262 may be interchangeable, as used herein.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 and the system 600 as shown in the various exemplary embodiments is illustrative only. Additionally, any element disclosed in one embodiment may be incorporated or utilized with any other embodiment disclosed herein. For example, the mobile refuse depot 610 of the exemplary embodiment shown in at least FIG. 16 may be incorporated in the system 10 of the exemplary embodiment shown in at least FIG. 2A. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse collection system comprising:
a refuse container defining a storage volume configured to receive refuse, the refuse container comprising a controller and an actuator; and
a refuse collection drone configured to collect the refuse from the refuse container;
wherein the controller is configured to:
determine that an amount of the refuse within the storage volume exceeds a threshold amount;
transmit a collection request in response to determining that the amount of the refuse exceeds the threshold amount;
detect that the refuse collection drone is positioned to receive the refuse from the refuse container; and
actuate the actuator to release at least a portion of the refuse from the storage volume into the refuse collection drone.

2. The refuse collection system of claim 1, wherein:
the refuse container further comprises a weight sensor configured to provide weight data to the controller relating to the amount of the refuse within the storage volume; and
the controller is further configured to determine that the amount of the refuse within the storage volume exceeds the threshold amount based on the weight data.

3. The refuse collection system of claim 1, wherein:
the refuse container further comprises a gas sensor configured to provide gas concentration data to the controller relating to a concentration of gas emitted by the refuse within the storage volume; and
the controller is further configured to:
determine that the concentration of the gas emitted by the refuse within the storage volume exceeds a threshold gas concentration; and
transmit the collection request in response to determining that the concentration of the gas emitted by the refuse within the storage volume exceeds the threshold gas concentration.

4. The refuse collection system of claim 1, wherein:
the refuse container further comprises a user input device configured to receive a user input indicating a request to empty the refuse container and provide the user input to the controller; and
the controller is further configured to transmit the collection request in response to receiving the user input indicating the request to empty the refuse container.

5. The refuse collection system of claim 1, wherein:
the refuse container defines an opening configured to receive the refuse collection drone below the storage volume; and
actuation of the actuator causes the refuse within the storage volume to descend through the opening into the refuse collection drone.

6. The refuse collection system of claim 5, wherein the refuse container further comprises a chute configured to guide the refuse descending through the opening into the refuse collection drone.

7. The refuse collection system of claim 1, wherein:
the refuse container comprises a releasable portion defining the storage volume; and
the actuator is configured to release the releasable portion for engagement and transport by the refuse collection drone.

8. The refuse collection system of claim 7, wherein the refuse container is configured to receive a second releasable portion after the releasable portion is released for engagement and transport by the refuse collection drone.

9. The refuse collection system of claim 1, wherein the refuse container further comprises:
a door configured to selectively restrict access to the storage volume;
a locking mechanism configured to selectively lock the door; and
an identification device configured to read an identifier associated with a customer and provide the identifier to the controller;
wherein the controller is further configured to:
receive the identifier from the identification device;
compare the identifier to identification numbers associated with authorized customers; and
actuate the locking mechanism to unlock the door in response to determining that the identifier is associated with one of the authorized customers.

10. The refuse collection system of claim 9, wherein:
the refuse container further comprises a refuse sensor configured to provide refuse type data to the controller relating to the refuse deposited into the storage volume; and
the controller is further configured to determine, based on the refuse type data, that the refuse deposited into the storage volume includes a contaminant or a prohibited item.

11. A method of collecting refuse using a refuse collection drone, the method comprising:
navigating to a refuse container positioned along a route traveled by the refuse collection drone;
requesting refuse information from the refuse container, the refuse information indicating at least one of an amount of refuse within the refuse container or a type of refuse within the refuse container;
determining that the refuse collection drone is suitable to collect the refuse within the refuse container based on the refuse information; and
collecting the refuse from the refuse container in response to determining that the refuse collection drone is suitable to collect the refuse within the refuse container.

12. The method of claim 11, wherein determining that the refuse collection drone is suitable to collect the refuse within the refuse container comprises determining that the refuse collection drone has sufficient available capacity to collect the amount of refuse indicated by the refuse information.

13. The method of claim 11, wherein determining that the refuse collection drone is suitable to collect the refuse within the refuse container comprises determining that the refuse collection drone is configured to collect the type of refuse indicated by the refuse information.

14. The method of claim 11, further comprising navigating to a second refuse container positioned along the route.

15. The method of claim 11, further comprising:
determining that an amount of refuse within a storage volume of the refuse collection drone exceeds a threshold amount; and
navigating to a refuse depot in response to determining that the amount of refuse within the storage volume of the refuse collection drone exceeds the threshold amount.

16. A refuse container comprising:
a body defining a storage volume configured to receive refuse;
a door configured to selectively restrict access to the storage volume;
a locking mechanism configured to selectively lock the door;
an identification device configured to read an identifier associated with a customer; and
a controller configured to:
receive the identifier from the identification device;
compare the identifier to identification numbers associated with authorized customers; and
actuate the locking mechanism to unlock the door in response to determining that the identifier is associated with one of the authorized customers, to permit a customer associated with the identifier to deposit refuse into the storage volume.

17. The refuse container of claim 16, wherein:
the refuse container further comprises a refuse sensor configured to provide refuse type data to the controller; and
the controller is further configured to determine, based on the refuse type data, a type of refuse deposited into the storage volume by the customer associated with the identifier after the door is unlocked.

18. The refuse container of claim 17, wherein the controller is further configured to determine, based on the refuse type data, that the refuse deposited into the storage volume by the customer associated with the identifier after the door is unlocked includes a contaminant or a prohibited item.

19. The refuse container of claim 16, wherein:
the refuse container further comprises a weight sensor configured to provide weight data to the controller; and
the controller is further configured to determine, based on the weight data, an amount of refuse deposited into the storage volume by the customer associated with the identifier after the door is unlocked.

20. The refuse container of claim 19, wherein the controller is further configured to:
determine, based on the weight data, a total amount of refuse within the storage volume; and
prevent further access to the storage volume in response to the total amount of refuse exceeding a threshold amount.

21. A refuse collection system, comprising:
a refuse collection drone comprising:
a chassis;
one or more tractive elements supported by the chassis and configured to facilitate transport of the refuse collection drone;
a refuse container coupled to the chassis and defining a storage volume configured to receive refuse therein;
a location sensor configured to provide drone location information indicative of a present location of the refuse collection drone; and
a controller configured to:
receive, from a remote device, a request to perform a refuse collection operation at a customer location;
cause the refuse collection drone to travel to the customer location to perform the refuse collection operation in response to receiving the request;
transmit, to the remote device, an indication that the refuse collection drone is enroute to perform the refuse collection operation;
obtain the drone location information from the location sensor while the refuse collection drone travels to the customer location; and
transmit, to the remote device, the drone location information.

22. The refuse collection system of claim 21, wherein the remote device is a user device associated with a customer of the refuse collection system.

23. The refuse collection system of claim 21, wherein the remote device is a service manager configured to coordinate dispatch of the refuse collection drone.

24. The refuse collection system of claim 21, wherein the request includes customer location information indicating the customer location.

25. The refuse collection system of claim 21, wherein the controller is configured to periodically transmit updated drone location information while the refuse collection drone travels to the customer location.

26. The refuse collection system of claim 21, wherein the controller is further configured to transmit, to the remote device, an arrival indication indicating that the refuse collection drone has arrived at the customer location.

27. The refuse collection system of claim 21, wherein:
the refuse container comprises a removable insert defining the storage volume; and
the refuse collection system further comprises a refuse depot, the refuse depot comprising:
a container defining a depot storage volume; and
a lift assembly configured to engage the removable insert and invert the removable insert to empty refuse from the storage volume into the depot storage volume.

28. A refuse collection system, comprising:
a refuse collection drone comprising:
a chassis;
one or more tractive elements supported by the chassis and configured to facilitate transport of the refuse collection drone; and
a removable insert supported by the chassis and defining a drone storage volume configured to receive refuse therein; and
a refuse depot comprising:
a container defining a depot storage volume; and
a lift assembly configured to selectively engage the removable insert, lift the removable insert from the chassis, and invert the removable insert to empty refuse from the drone storage volume into the depot storage volume.

29. The refuse collection system of claim 28, wherein the removable insert is vertically slidable into and out of the refuse collection drone.

30. The refuse collection system of claim 28, wherein the removable insert is selectively coupled to the refuse collection drone by an actuatable retention component.

31. The refuse collection system of claim 28, wherein the lift assembly is configured to return the removable insert to the refuse collection drone after emptying refuse from the drone storage volume into the depot storage volume.

32. The refuse collection system of claim 28, wherein the refuse depot further comprises a charging system configured to recharge the refuse collection drone.

33. The refuse collection system of claim 28, wherein the removable insert defines a plurality of compartments, each designated for a different type of refuse.

34. A refuse collection drone, comprising:
a chassis;
one or more tractive elements supported by the chassis and configured to facilitate transport of the refuse collection drone;
a refuse container coupled to the chassis and defining a plurality of compartments, each designated for a different type of refuse;
one or more sensors positioned to obtain data related to refuse deposited in the plurality of compartments; and
a controller configured to determine, based on the data, an amount of refuse deposited into the plurality of compartments during a refuse collection operation and a type of refuse deposited into the plurality of compartments during the refuse collection operation.

35. The refuse collection drone of claim 34, wherein the one or more sensors comprise one or more imaging sensors positioned to obtain image data related to refuse deposited in the plurality of compartments.

36. The refuse collection drone of claim 34, wherein the one or more sensors comprise a plurality of sensors, and wherein each compartment of the plurality of compartments is within a field of view of at least one sensor of the plurality of sensors.

37. The refuse collection drone of claim 34, wherein the controller is further configured to determine the amount of refuse deposited into the plurality of compartments during the refuse collection operation by determining an amount of refuse deposited into each compartment of the plurality of compartments during the refuse collection operation and summing the amount of refuse deposited into each compartment.

38. The refuse collection drone of claim 34, wherein the controller is further configured to determine whether a contaminant or prohibited article has been deposited into one or more of the plurality of compartments.

39. The refuse collection drone of claim 38, wherein the controller is further configured to transmit a warning indicating that the contaminant or prohibited article has been deposited into the one or more of the plurality of compartments.

40. The refuse collection drone of claim 34, wherein the controller is further configured to route the refuse collection drone based on the amount of refuse deposited into the plurality of compartments during the refuse collection operation or the type of refuse deposited into the plurality of compartments during the refuse collection operation.

41. A refuse container repositioning and collection system comprising:
a refuse vehicle including a lift system; and
a refuse container repositioning system, the refuse container repositioning system configured to deploy based on a refuse collection schedule, the refuse container repositioning system including:
a drive system;
a container engagement apparatus configured to engage a refuse container; and
a control system configured to control the drive system and the container engagement apparatus to retrieve the refuse container from a collection location and move the refuse container to a staging location where the refuse container is accessible by the lift system of the refuse vehicle.

42. The refuse container repositioning and collection system of claim 41, wherein the control system of the refuse container repositioning system is configured to:
determine a pickup time on the refuse collection schedule for the refuse vehicle to collect refuse from a customer location;
drive the refuse container repositioning system to the collection location;
actuate the container engagement apparatus to engage the refuse container; and
drive the refuse container repositioning system to the staging location.

43. The refuse container repositioning and collection system of claim 41, wherein the refuse container repositioning system is autonomously deployed at a customer location to move the refuse container to the staging location for refuse collection by the refuse vehicle.

44. The refuse container repositioning and collection system of claim 43, wherein the refuse container repositioning system is at least partially manually controlled.

45. The refuse container repositioning and collection system of claim 44, wherein the refuse container repositioning system is remotely controlled from a location spaced apart from the customer location.

46. The refuse container repositioning and collection system of claim 41, wherein the container engagement apparatus is a lift assembly configured to raise the refuse container above a ground surface, wherein the refuse container repositioning system moves the refuse container to the staging location when the refuse container is raised.

47. The refuse container repositioning and collection system of claim 41, wherein:
the refuse container comprises a towing interface; and
the container engagement apparatus comprises a grabber mechanism configured to engage the towing interface of the refuse container, wherein the refuse container repositioning system moves the refuse container to the staging location when the grabber mechanism is engaged with the towing interface.

48. The refuse container repositioning and collection system of claim 41, wherein the refuse container repositioning system is deployed from the refuse vehicle proximate the staging location or the collection location.

49. The refuse container repositioning and collection system of claim 41, wherein the control system of the refuse container repositioning system is configured to:
identify the refuse container for the refuse vehicle to collect refuse therefrom;
determine the staging location for the refuse container; and
navigate the refuse container repositioning system to the collection location.

50. The refuse container repositioning and collection system of claim 41, wherein the control system of the refuse container repositioning system is configured to:
receive a signal indicative of a fill level of refuse within the refuse container exceeding a threshold fill level for the refuse container;
drive the refuse container repositioning system to the collection location, based on the signal;
actuate the container engagement apparatus to engage the refuse container; and
drive the refuse container repositioning system to the staging location.

51. The refuse container repositioning and collection system of claim 41, wherein the control system of the refuse container repositioning system is configured to:
receive a signal indicative of an odor level of refuse within the refuse container exceeding a threshold odor level for the refuse container;
drive the refuse container repositioning system to the collection location, based on the signal;
actuate the container engagement apparatus to engage the refuse container; and
drive the refuse container repositioning system to the staging location.

52. The refuse container repositioning and collection system of claim 41, wherein the refuse container repositioning system comprises a weight sensor configured to determine a weight of refuse within the refuse container when the refuse container repositioning system is engaged with the refuse container.

53. The refuse container repositioning and collection system of claim 41, further comprising a refuse container repositioning companion system configured to:
determine a route between the collection location and the staging location; and
guide the refuse container repositioning system along the route between the collection location and the staging location.

54. A method for repositioning and collecting refuse from a refuse container, the method comprising:
determining a collection location by identifying a refuse container for refuse to be collected therefrom by a refuse vehicle;
determining a staging location for the refuse container, the refuse container accessible via a lift system of the refuse vehicle when positioned at the staging location;
driving a refuse container repositioning system to the refuse container at the collection location;
engaging the refuse container via a container engagement apparatus of the refuse container repositioning system; and
moving the refuse container from the collection location to the staging location.

55. The method of claim 54, further comprising collecting refuse from the refuse container positioned at the staging location via the lift system of the refuse vehicle.

56. The method of claim 54, further comprising deploying the refuse container repositioning system from the refuse vehicle proximate the collection location or the staging location.

57. The method of claim 54, further comprising deploying the refuse container repositioning system from a customer location including the collection location and the staging location.

58. The method of claim 57, further comprising:
determining a pickup time on a refuse collection schedule for the refuse vehicle to collect refuse from a customer location including the collection location and the staging location; and
autonomously moving the refuse container from the collection location to the staging location before the pickup time, based on the pickup time on the refuse collection schedule.

59. A refuse vehicle comprising:
a body defining a refuse compartment;
a lift system configured to engage a refuse container and deposit refuse material from the refuse container into the refuse compartment; and
a refuse container repositioning system deployable from the refuse vehicle, and wherein the refuse container repositioning system includes:
a drive system;
a container engagement apparatus configured to engage the refuse container; and
a control system configured to control the drive system and the container engagement apparatus, the control system configured to:
operate the drive system to drive the refuse container repositioning system from the refuse vehicle to a collection location of the refuse container;
operate the container engagement apparatus to engage the refuse container at the collection location; and
operate the drive system to drive the refuse container repositioning system to move the refuse container to a staging location, wherein the refuse container is accessible by the lift system of the refuse vehicle at the staging location.

60. The refuse vehicle of claim 59, wherein the control system of the refuse container repositioning system is further configured to:
determine the collection location by identifying the refuse container for the refuse vehicle to collect refuse therefrom; and
determine the staging location for the refuse container.

61. A refuse container system comprising:
a refuse container; and
a refuse container repositioning system configured to support or be integrated into the refuse container, the refuse container repositioning system including:
a drive system; and
a control system configured to control the drive system to bring the refuse container from a collection location to a staging location where the refuse container is accessible by a lift system of a refuse vehicle.

62. The refuse container system of claim 61, wherein the refuse container repositioning system is detachable from the refuse container via a container engagement apparatus.

63. The refuse container system of claim 62, wherein the refuse container repositioning system detaches from the refuse container when the refuse container is positioned at the staging location.

64. The refuse container system of claim 62, wherein the refuse container repositioning system detaches from the refuse container proximate to the refuse vehicle engaging the refuse container via the lift system.

65. The refuse container system of claim 64, wherein the refuse container repositioning system attaches to the refuse container after the refuse vehicle collects refuse from the refuse container, the refuse container positioned on a ground surface via the lift system of the refuse vehicle.

66. The refuse container system of claim 61, wherein the control system of the refuse container repositioning system is configured to:
determine a pickup time on a refuse collection schedule for the refuse vehicle to collect refuse from the refuse container; and
drive the refuse container from the collection location to the staging location.

67. The refuse container system of claim 66, wherein the refuse container repositioning system autonomously moves the refuse container to the staging location for refuse collection by the refuse vehicle, based on the refuse collection schedule for the refuse container.

68. The refuse container system of claim 61, wherein the control system of the refuse container repositioning system is configured to:
receive a signal from the refuse vehicle indicative of the refuse vehicle arriving at a customer location to collect refuse from the refuse container; and
drive the refuse container to the staging location.

69. The refuse container system of claim 61, wherein the refuse vehicle is configured to lift the refuse container off of the refuse container repositioning system and position the refuse container onto the refuse container repositioning system after collecting refuse from the refuse container.

70. The refuse container system of claim 61, wherein the refuse container repositioning system comprises a weight sensor configured to determine a weight of refuse within the refuse container when the refuse container repositioning system is engaged with the refuse container.

71. A method for repositioning and collecting refuse from a refuse container, the method comprising:
determining a staging location for the refuse container, the refuse container accessible via a lift system of a refuse vehicle when positioned at the staging location; and
driving a refuse container via a drive system of a refuse container repositioning system that is coupled to the refuse container from a collection location to the staging location, based on a refuse collection schedule for the refuse container.

72. The method of claim 71, wherein detaching the refuse container repositioning system from the refuse container includes detaching the refuse container repositioning system from the refuse container proximate to the refuse vehicle engaging the refuse container via the lift system.

73. The method of claim 71, further comprising attaching the refuse container repositioning system to the refuse container after the refuse vehicle collects refuse from the refuse container.

74. The method of claim 73, wherein the refuse container repositioning system attached to the refuse container when the refuse container is positioned on a ground surface via the lift system of the refuse vehicle.

75. The method of claim 71, further comprising collecting refuse from the refuse container positioned at the staging location via the lift system of the refuse vehicle.

76. The method of claim 71, further comprising:
determining a pickup time on the refuse collection schedule for the refuse vehicle to collect refuse from a customer location including the collection location and the staging location; and
autonomously moving the refuse container from the collection location to the staging location before the pickup time, based on the pickup time on the refuse collection schedule.

77. The method of claim 71, further comprising:
receiving a signal from the refuse vehicle indicative of the refuse vehicle arriving at a customer location to collect refuse from the refuse container; and
driving the refuse container to the staging location, based on the signal from the refuse vehicle.

78. The method of claim 71, further comprising determining a weight of refuse within the refuse container via a weight sensor of the refuse container repositioning system when the refuse container repositioning system is engaged with the refuse container.

79. A control system comprising:
one or more processing circuits comprising one or more memory devices coupled to one or more processors, the one or more memory devices configured to store instructions thereon that, when executed by the one or more processors, cause the one or more processors to:
determine a staging location for a refuse container at a customer location, the refuse container accessible via a lift system of a refuse vehicle when positioned at the staging location; and
drive a refuse container via a drive system of a refuse container repositing system that is coupled to the refuse container from a collection location to the staging location, based on a refuse collection schedule for the refuse container.

80. The control system of claim 79, wherein the one or more processors are to:
determine a pickup time on the refuse collection schedule for the refuse vehicle to collect refuse from the refuse container; and
drive the refuse container from the collection location to the staging location proximate the pickup time.

81. A refuse collection system comprising:
a refuse collection vehicle;
a refuse container defining a storage volume;
a fill sensor configured to detect a fill status of the storage volume; and
a controller in communication with the fill sensor, the controller being configured to:
determine if the fill status indicates that the storage volume is full; and
in response to determining that the storage volume is full, provide an indication to the refuse collection vehicle that the storage volume is full.

82. The refuse collection system of claim 81, wherein:
the fill sensor is a weight sensor configured to measure a weight of refuse in the storage volume; and
the controller is configured to determine the fill status of the storage volume based on one or more predetermined weight thresholds.

83. The refuse collection system of claim 81, wherein:
the fill sensor is an optical sensor configured to measure a height of refuse in the storage volume; and
the controller is configured to determine the fill status of the storage volume based on one or more predetermined height thresholds.

84. The refuse collection system of claim 81, wherein the refuse collection vehicle is configured to:
receive the indication that the storage volume is full; and
autonomously navigate to the refuse container to collect refuse within the storage volume.

85. The refuse collection system of claim 81, wherein the refuse container further comprises a location sensor configured to provide a location of the refuse container to the refuse collection vehicle.

86. The refuse collection system of claim 81, wherein the controller is further configured to in response to determining that the storage volume is full, provide an indication to an employee that the storage volume is full.

87. A refuse collection system comprising:
a refuse container defining a storage volume;
a fill sensor configured to detect a fill status of refuse material within the storage volume; and
a controller in communication with the fill sensor, the controller being configured to:
determine if the fill status indicates that the storage volume is full; and
in response to determining that the storage volume is full, instruct one or more electric motors to navigate the refuse container from a home position to a pickup position.

88. The refuse collection system of claim 87, wherein:
the fill sensor is a weight sensor configured to measure a weight of refuse in the storage volume; and
the controller is configured to determine the fill status of the storage volume based on one or more predetermined weight thresholds.

89. The refuse collection system of claim 87, wherein:
the fill sensor is an optical sensor configured to measure a height of refuse in the storage volume; and
the controller is configured to determine the fill status of the storage volume based on one or more predetermined height thresholds.

90. The refuse collection system of claim 87, further comprising a refuse collection vehicle, configured to in response to the refuse container navigating from the home position to a pickup position, navigate to the pickup position and collect refuse in the storage volume.

91. The refuse collection system of claim 90, wherein the refuse container further comprises a location sensor configured to provide a location of the refuse container to the refuse collection vehicle.

92. The refuse collection system of claim 87, further comprising an odor sensor configured to detect an odor status of refuse in the storage volume, wherein the controller is in communication with the odor sensor and further configured to:
determine if the odor status indicates that an odor level exceeds an odor level threshold; and
in response to determining that the odor level exceeds the odor level threshold, instruct the one or more electric motors to navigate the refuse container from the home position to the pickup position.

93. The refuse collection system of claim 87, wherein the controller is further configured to in response to determining that the refuse container has navigated to the pickup position, provide an indication to an employee that the storage volume is full.

94. A refuse collection system comprising:
a refuse collection vehicle;
a refuse container defining a storage volume;
an odor sensor configured to detect an odor status of refuse in the storage volume; and
a controller in communication with the odor sensor, the controller being configured to:
determine if the odor status indicates that an odor level exceeds an odor level threshold; and
in response to determining that the odor level exceeds the odor level threshold, provide an indication to the refuse collection vehicle that the odor level exceeds the odor level threshold.

95. The refuse collection system of claim 94, wherein the odor sensor is at least one of an electrochemical gas sensor, a volatile organic compound sensor, a metal oxide semiconductor sensor, a photoionization detector, a colorimetric and/or chemoresistive odor array, a humidity sensor, or a temperature sensor.

96. The refuse collection system of claim 94, wherein the refuse collection vehicle is configured to:
receive the indication that the odor level exceeds the odor level threshold; and
autonomously navigate to the refuse container to collect refuse within the storage volume.

97. The refuse collection system of claim 94, wherein the refuse container further comprises a location sensor configured to provide a location of the refuse container to the refuse collection vehicle.

98. The refuse collection system of claim 94, wherein the controller is further configured to in response to determining that the odor level exceeds the odor level threshold, provide an indication to an employee that the odor level exceeds the odor level threshold.

99. The refuse collection system of claim 94, further comprising a fill sensor configured to detect a fill status of the storage volume, wherein the controller is further configured to:
determine if the fill status indicates that the storage volume is full; and
in response to determining that the storage volume is full, provide an indication to the refuse collection vehicle that the storage volume is full.

100. The refuse collection system of claim 94, wherein the odor sensor is at least one of disposed on the refuse container or disposed in a vicinity of the refuse container.

101. A method comprising:
receiving activity data and location data from sensors within a venue;
determining an activity level of multiple areas within a venue based on the activity data and the location data; and
adjusting a refuse collection schedule associated with refuse collection by a plurality of refuse collection drones based on the activity level.

102. The method of claim 101, wherein receiving the activity data and the location data comprises receiving at least one of: optical sensor data from one or more cameras monitoring the venue, location data from one or more user devices within the venue, or sensor data from one or more environmental sensors or one or more location sensors onboard at least one of the refuse collection drones.

103. The method of claim 101, wherein determining the activity level comprises determining at least one of occupancy level, attendee density, visits per hour, reflection level, heat level, odor level, or gas level for each of the multiple areas.

104. The method of claim 101, wherein adjusting the refuse collection schedule comprises adjusting a refuse collection frequency or a refuse collection interval for at least one refuse container located in at least one of the multiple areas.

105. The method of claim 101, wherein adjusting the refuse collection schedule comprises adjusting a refuse collection route of at least one of the refuse collection drones.

106. The method of claim 101, wherein adjusting the refuse collection schedule comprises adjusting an order of collection among a plurality of refuse containers.

107. The method of claim 101, further comprising receiving fill level data from a fill level sensor associated with a refuse container within the venue, and wherein adjusting the refuse collection schedule is further based on the fill level data.

108. The method of claim 101, further comprising receiving gas level data from a gas sensor associated with at least one refuse container within the venue, and wherein adjusting the refuse collection schedule is further based on the gas level data.

109. The method of claim 101, further comprising determining a deployment schedule for the refuse collection drones based on the refuse collection schedule by accounting for (i) a distance between a depot and each refuse container and (ii) a velocity associated with drone transit.

110. The method of claim 109, wherein accounting for the distance comprises determining, for a first refuse container and a second refuse container having approximately equal fill frequencies, wherein the second refuse container is farther from the depot than the first refuse container, a deployment time for the second refuse container that is earlier than a deployment time for the first refuse container.

111. The method of claim 101, wherein the sensors include at least one of a temperature sensor, a proximity sensor, a light detection and ranging (LiDAR) sensor, or a gas sensor.

112. A refuse collection system comprising:
a plurality of refuse collection drones;
a plurality of refuse containers disposed within a venue; and
a venue control system comprising processing circuitry configured to:
receive activity data and location data indicative of attendee activity across multiple areas of the venue;
determine an activity level for the multiple areas based on the activity data and the location data; and
determine or adjust a refuse collection schedule for the plurality of refuse collection drones based on the activity level.

113. The refuse collection system of claim 112, wherein the venue control system is configured to receive the activity data and the location data from sensors disposed in different areas within the venue.

114. The refuse collection system of claim 112, wherein the venue control system is configured to receive the activity data and the location data from at least one of (i) sensors onboard at least one of the refuse collection drones, or (ii) sensors disposed on at least one of the refuse containers.

115. The refuse collection system of claim 114, wherein at least one of the refuse containers comprises a fill level sensor configured to generate fill level data indicative of a fill level of the refuse container, and wherein the venue control system is configured to deploy at least one of the refuse collection drones responsive to the fill level data satisfying a fill level threshold.

116. The refuse collection system of claim 114, wherein at least one of the refuse containers comprises a gas sensor configured to generate gas level data indicative of an odiferous gas level, and wherein the venue control system is configured to deploy at least one of the refuse collection drones responsive to the gas level data satisfying a gas level threshold.

117. A refuse collection drone comprising:
an environmental sensor configured to generate sensor data indicative of activity proximate to the refuse collection drone;
a location sensor configured to generate location data indicative of a location of the refuse collection drone within a venue; and
a communications interface configured to be communicably coupled to a venue control system, the communications interface configured to transmit the sensor data and the location data to a venue control system, and receive a refuse collection schedule based on the sensor data and the location data.

118. The refuse collection drone of claim 117, wherein the environmental sensor comprises at least one of a proximity sensor, a light detection and ranging (Lidar) sensor, or an optical sensor.

119. The refuse collection drone of claim 117, wherein the environmental sensor comprises a gas sensor configured to measure a concentration of at least one of hydrogen sulfide (H2S), ammonia (NH3), methane (CH4), or carbon dioxide (CO2), or a volatile organic compound (VOC) sensor.

120. The refuse collection drone of claim 117, further comprising:
a refuse container engaging element configured to engage a refuse container to facilitate refuse collection; and
an actuator configured to reposition the refuse container engaging element to secure the refuse container to the refuse collection drone.

121. A refuse collection system comprising:
a building comprising a plurality of zones connected by one or more access points, the one or more access points selectively separating the plurality of zones; and
a refuse collection drone configured to travel throughout the building, the refuse collection drone comprising:
one or more sensors; and
a controller communicably coupled to one or more sensors, wherein the controller is configured to:
navigate the refuse collection drone throughout the building between the plurality of zones, based on sensor data from the one or more sensors;
transmit a signal to an access point within the building, the access point separating a first zone of the building from a second zone of the building, the signal configured to cause the access point to actuate; and
navigate the refuse collection drone from the first zone to the second zone via the access point to collect refuse within the second zone of the building.

122. The refuse collection system of claim 121, wherein the refuse collection drone is configured to autonomously travel between the plurality of zones of the building through the one or more access points, based on the sensor data indicative of the building.

123. The refuse collection system of claim 121, wherein the access point is a door.

124. The refuse collection system of claim 121, wherein the access point is an elevator.

125. The refuse collection system of claim 121, wherein the one or more sensors are configured to provide a second sensor data indicative of a type of refuse within a storage volume of the refuse collection drone.

126. The refuse collection system of claim 125, wherein the controller is further configured to determine, based on the second sensor data, a type of refuse collected by the refuse collection drone.

127. The refuse collection system of claim 126, wherein the controller is further configured to communicate with a plurality of refuse containers positioned proximate the building to determine a refuse container of the plurality of refuse containers configured to receive the type of refuse collected by the refuse collection drone.

128. The refuse collection system of claim 127, wherein the controller is further configured to:
drive the refuse collection drone throughout the building and to the refuse container of the plurality of refuse containers; and
cause the refuse from the storage volume of the refuse collection drone to be deposited into the refuse container configured to receive the type of refuse collected by the refuse collection drone.

129. The refuse collection system of claim 121, wherein the building comprises a plurality of units, wherein the refuse collection drone is configured to travel along a refuse collection route between the plurality of units to collect refuse from pickup zones corresponding to the plurality of units.

130. The refuse collection system of claim 129, wherein the controller is further configured to:
cause the refuse collection drone to collect refuse from a pickup zone; and
determine a unit of the plurality of units corresponding to the pickup zone that refuse was collected from by the refuse collection drone.

131. The refuse collection system of claim 129, wherein the controller is further configured to:
receive a refuse collection request corresponding to a unit of the building;
drive the refuse collection drone throughout the building to the unit, based on the refuse collection request; and
cause the refuse collection drone to collect refuse from the unit of the building.

132. The refuse collection system of claim 131, wherein the building comprises a refuse chute to transport refuse to a refuse container, wherein the controller of the refuse collection drone is configured to:
drive the refuse collection drone throughout the building to the refuse chute;
transmit a signal to the refuse chute to cause the refuse chute to actuate and provide access to the refuse collection drone; and
cause the refuse collection drone to deposit refuse through the refuse chute.

133. A refuse collection system comprising:
a building comprising a plurality of refuse containers configured to store multiple types of refuse; and
a refuse collection drone configured to travel throughout the building, the refuse collection drone comprising:
a storage volume;
one or more sensors configured to provide sensor data indicative of (i) the building and (ii) a type of refuse within the storage volume of the refuse collection drone; and
a controller communicably coupled to one or more sensors, wherein the controller is configured to:
determine, based on the sensor data from the one or more sensors, a type of refuse collected by the refuse collection drone;
communicate with the plurality of refuse containers to determine a refuse container of the plurality of refuse containers that corresponds with the type of refuse collected by the refuse collection drone;
navigate the refuse collection drone to the refuse container of the plurality of refuse containers that corresponds with the type of refuse collected by the refuse collection drone; and
cause the refuse collection drone to deposit the refuse from the storage volume of the refuse collection drone into the refuse container of the plurality of refuse containers that that corresponds with the type of refuse collected by the refuse collection drone.

134. The refuse collection system of claim 133, wherein the controller of the refuse collection drone is further configured to determine a presence of a contaminant within the refuse within the storage volume of the refuse collection drone.

135. The refuse collection system of claim 133, wherein the building comprises a plurality of units, wherein the refuse collection drone is configured to travel along a refuse collection route between the plurality of units to collect refuse from pickup zones corresponding to the plurality of units.

136. The refuse collection system of claim 135, wherein the controller is further configured to:
cause the refuse collection drone to collect refuse from a pickup zone; and
determine a unit of the plurality of units corresponding to the pickup zone that refuse was collected from by the refuse collection drone.

137. The refuse collection system of claim 133, wherein the controller is further configured to:
receive a refuse collection request corresponding to a unit of the building;
drive the refuse collection drone throughout the building to the unit, based on the refuse collection request; and
cause the refuse collection drone to collect refuse from the unit of the building.

138. A refuse collection drone comprising:
a drive system configured to move the refuse collection drone throughout a building and through one or more access points along a refuse collection route between a plurality of units to collect refuse from pickup zones corresponding to the plurality of units;
one or more sensors; and
a controller communicably coupled to one or more sensors, wherein the controller is configured to:
navigate the refuse collection drone throughout the building based on sensor data from the one or more sensors between the plurality of zones and through the one or more access points along the refuse collection route;
collect refuse from pickup zones corresponding to the plurality of units along the refuse collection route;
navigate the refuse collection drone throughout the building and to a refuse container within the building; and
deposit refuse into the refuse container.

139. The refuse collection drone of claim 138, wherein the controller is further configured to:
transmit a signal to an access point within the building, the access point separating a first zone of the building from a second zone of the building, the signal configured to cause the access point to actuate; and
drive the refuse collection drone from the first zone to the second zone via the access point to collect refuse within the second zone of the building.

140. The refuse collection drone of claim 138, wherein the one or more sensors are configured to provide sensor data indicative of (i) the building and (ii) a type of refuse within a storage volume of the refuse collection drone; and the controller is further configured to:
determine, based on the sensor data from the one or more sensors, a type of refuse collected by the refuse collection drone;
communicate with the plurality of refuse containers to determine a refuse container of the plurality of refuse containers configured to receive the type of refuse collected by the refuse collection drone;
drive the refuse collection drone throughout the building and to the refuse container of the plurality of refuse containers; and
cause the refuse collection drone to deposit the refuse from the storage volume of the refuse collection drone into the refuse container configured to receive the type of refuse collected by the refuse collection drone.

141. A multi-function drone comprising:
a chassis;
a propulsion system comprising one or more wheels and a drive motor to propel the one or more wheels;
a battery to power the propulsion system;
a first storage volume and a second storage volume;
a plurality of receptacles removably positioned within the first storage volume and the second storage volume, the receptacles comprising at least two of:
a first receptacle configured to store a first type of refuse material;
a second receptacle configured to store a second type of refuse material; and
a secured container configured to store an item for delivery to a customer; and
a controller configured to:
receive a refuse collection request from the customer;
receive a delivery request from the customer or a second customer; and
drive the drone to collect refuse from the customer into in at least one of the first receptacle and the second receptacle, based on the refuse collection request.

142. The multi-function drone of claim 141, wherein the controller is further configured to deliver the item stored within the secured container to the customer or the second customer, based on the delivery request.

143. The multi-function drone of claim 141, wherein the controller is further configured to transmit an unlock code to the customer, the unlock code to unlock the secured container delivered by the multi-function drone.

144. The multi-function drone of claim 141, wherein the controller is further configured to transmit an estimated time of arrival to the customer of the multi-function drone arriving at a location of the customer.

145. The multi-function drone of claim 141, wherein, based on the controller receiving the refuse collection request from the customer, the multi-function drone is configured to include the first receptacle configured to store the first type of refuse material and the second receptacle configured to store a second type of refuse material.

146. The multi-function drone of claim 141, wherein, based on the controller receiving the delivery request from the customer or the second customer, the multi-function drone is configured to include the first receptacle configured to store the first type of refuse material and the secured container.

147. The multi-function drone of claim 146, wherein, based on the controller receiving the delivery request, the second receptacle is removed from the second storage volume of the multi-function drone, and the secured container is inserted into the second storage volume.

148. The multi-function drone of claim 141, wherein the controller is further configured to receive a delivery address for the customer, in response to the secured container being inserted into the second storage volume of the multi-function drone.

149. The multi-function drone of claim 141, further comprising a third storage volume configured to receive refuse contaminants.

150. A method for servicing a building via a multi-function drone, the method comprising:
receiving a refuse collection request from a customer;
navigating the multi-function drone to a pick up zone corresponding to the customer for refuse collection;
collecting refuse from the customer into a first storage volume of the multi-function drone;
receiving a delivery request from the customer or a second customer, the delivery request to deliver a package stored in a second storage volume of the multi-function drone; and
navigating the multi-function drone based on the delivery request.

151. The method of claim 150, wherein collecting refuse from the customer comprises operating an actuator of the multi-function drone to deposit the refuse into the first storage volume of the multi-function drone.

152. The method of claim 150, further comprising driving the multi-function drone to a drop-off zone to receive the package into the second storage volume of the multi-function drone.

153. The method of claim 152, further comprising receiving a delivery address from a delivery agent corresponding to the customer or the second customer.

154. The method of claim 150, further comprising driving the multi-function drone to a refuse depot to deposit refuse from the first storage volume into a refuse container positioned at the refuse depot.

155. The method of claim 150, further comprising transmitting a notification to the customer or the second customer, based on the refuse collection request or the delivery request, the notification indicative of the multi-function drone arriving at a location of the customer or the second customer.

156. The method of claim 150, further comprising transmitting a notification to the customer or the second customer, based on the delivery request, the notification including secure credentials to access the package within the second storage volume of the multi-function drone.

157. A method for servicing a building via a multi-function drone, the method comprising:
navigating the multi-function drone to a pick up zone corresponding to a customer for refuse collection;
collecting a first type of refuse into a first receptacle of the multi-function drone;
collecting a second type of refuse into a second receptacle of the multi-function drone; and
navigating the multi-function drone to a refuse depot to deposit refuse into one or more refuse containers positioned at the refuse depot, the one or more refuse containers corresponding to one or more types of refuse received by the multi-function drone.

158. The method of claim 157, further comprising receiving a refuse collection request from the customer, the refuse collection request indicative of one or more types of refuse to be collected by the multi-function drone.

159. The method of claim 157, further comprising:
receiving a delivery request from the customer or a second customer, the delivery request to deliver a package stored in a secured container of the multi-function drone; and
driving the multi-function drone to the customer or the second customer to deliver the package.

160. The method of claim 159, further comprising:
removing the second receptacle from the multi-function drone; and
inserting the secured container into the multi-function drone.
